(19) United States
(12) Patent Application Publication
(10) Pub. No.: US 2013/0048023 A1
(43) Pub. Date: Feb. 28, 2013

(54) Cleaning system and method for ingestible product preparation system and method

(71) Applicants: Paul Holman, Seattle, WA (US); Royce A. Levien, Lexington, MA (US); Mark A. Malamud, Seattle, WA (US); Neal Stephenson, Seattle, WA (US); Christopher Charles Young, Seattle, WA (US)

(72) Inventors: Paul Holman, Seattle, WA (US); Royce A. Levien, Lexington, MA (US); Mark A. Malamud, Seattle, WA (US); Neal Stephenson, Seattle, WA (US); Christopher Charles Young, Seattle, WA (US)

(73) Assignee: Elwha LLC, a limited liability company of the State of Delaware

(21) Appl. No.: 13/200,830

(22) Filed: Sep. 30, 2011

Related U.S. Application Data
(63) Continuation-in-part of application No. 13/199,361, filed on Aug. 26, 2011.
Application No. 13/199,361 is a continuation-in-part of application No. 13/199,481, filed on Aug. 30, 2011.
Application No. 13/199,481 is a continuation-in-part of application No. 13/199,544, filed on Aug. 31, 2011.
Application No. 13/199,544 is a continuation-in-part of application No. 13/199,545, filed on Aug. 31, 2011.
Application No. 13/199,545 is a continuation-in-part of application No. 13/200,113, filed on Sep. 16, 2011.
Application No. 13/200,113 is a continuation-in-part of application No. 13/200,106, filed on Sep. 16, 2011.

(51) Int. Cl. B08B 3/04

(52) U.S. Cl. 134/18; 134/57 R

(57) ABSTRACT

A computationally implemented system and method that is designed to, but is not limited to: electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being. In addition to the foregoing, other method aspects are described in the claims, drawings, and text forming a part of the present disclosure.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation of U.S. Pat. No. [To Be Assigned], entitled SUBSTANCE CONTROL SYSTEM AND METHOD FOR DISPENSING SYSTEMS, naming Paul Holman, Royce A. Levien, Mark A. Malamud, Neal Stephenson, and Christopher Charles Young as inventors, filed 16 Sep. 2011, which is currently co-pending or is an application of which a currently co-pending application is entitled to the benefit of the filing date.

For purposes of the USPTO extra-statutory requirements, the present application constitutes a continuation of U.S. Pat. No. [To Be Assigned], entitled SUBSTANCE CONTROL SYSTEM AND METHOD FOR DISPENSING SYSTEMS, naming Paul Holman, Royce A. Levien, Mark A. Malamud, Neal Stephenson, and Christopher Charles Young as inventors, filed 16 Sep. 2011, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### SUMMARY

A method includes, but is not limited to electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment; and electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input.

In one or more various aspects, related machines, compositions of matter, or manufactures of systems may include, but are not limited to, virtually any combination of hardware, software, and/or firmware configured to effect the herein-referenced method aspects depending upon the design choices of the system designer (limited to patentable subject matter under 35 USC 101).

A system includes, but is not limited to: means for electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment; and means for electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input. In addition to the foregoing, other system aspects are described in the claims, drawings, and text forming a part of the present disclosure.

A system includes, but is not limited to a store and first clean electrical circuitry arrangement for electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment; and a second clean electrical circuitry arrangement for electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input. In addition to the foregoing, other system aspects are described in the claims, drawings, and text forming a part of the present disclosure.

An article of manufacture including a non-transitory signal-bearing storage medium bearing one or more instructions for electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment; and one or more instructions for electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic diagram depicting a first exemplary implementation of an ingestible product preparation system 10 including a cleaning system therefor.

FIG. 1A is a schematic diagram depicting a dispensing portion of a second version of the first exemplary implementation of the ingestible product preparation system 10 dispensing a second ingestible product therefrom.

FIG. 1B is a schematic diagram depicting a dispensing portion of a third version of the first exemplary implementation of the ingestible product preparation system 10 dispensing a third ingestible product therefrom.

FIG. 1C is a schematic diagram depicting a dispensing portion of a fourth version of the first exemplary implementation of the ingestible product preparation system 10 dispensing a fourth ingestible product therefrom.

FIG. 2 is a cross-sectional schematic view of the first exemplary implementation of the ingestible product preparation system 10 in FIG. 1.

FIG. 3 is a schematic view of a display screen of an exemplary implementation of the ingestible product preparation system 10 in FIG. 1 displaying first content.

FIG. 4 is a schematic view of a display screen of an exemplary implementation of the ingestible product preparation system 10 in FIG. 1 displaying second content.

FIG. 5 is a schematic view of a display screen of the first exemplary implementation of the ingestible product preparation system 10 in FIG. 1 displaying third content.

FIG. 6 is a schematic view of a display screen of the first exemplary implementation of the ingestible product preparation system 10 in FIG. 1 displaying fourth content.

FIG. 7 is a schematic view of a display screen of the first exemplary implementation of the ingestible product preparation system 10 in FIG. 1 displaying fifth content.

FIG. 8 is a block diagram depicting an exemplary implementation of the ingestible product preparation system 10 of FIG. 1 including exemplary subsystems.

FIG. 9 is a block diagram depicting a control and information processing subsystem s100 of an exemplary implementation of the ingestible product preparation system 10 of FIG. 1.

FIG. 10 is a block diagram depicting an information storage subsystem s200 of an exemplary implementation of the ingestible product preparation system 10 of FIG. 1.

FIG. 11 is a block diagram depicting an information user interface subsystem s300 of an exemplary implementation of the ingestible product preparation system 10 of FIG. 1.

FIG. 12 is a block diagram depicting a sensing subsystem s400 of an exemplary implementation of the ingestible product preparation system 10 of FIG. 1.

FIG. 13 is a block diagram depicting an electronic communication subsystem s500 of an exemplary implementation of the ingestible product preparation system 10 of FIG. 1.

FIG. 14 is a block diagram depicting a power subsystem s600 of an exemplary implementation of the ingestible product preparation system 10 of FIG. 1.

FIG. 15 is a block diagram depicting a material processing subsystem s700 of an exemplary implementation of the ingestible product preparation system 10 of FIG. 1.

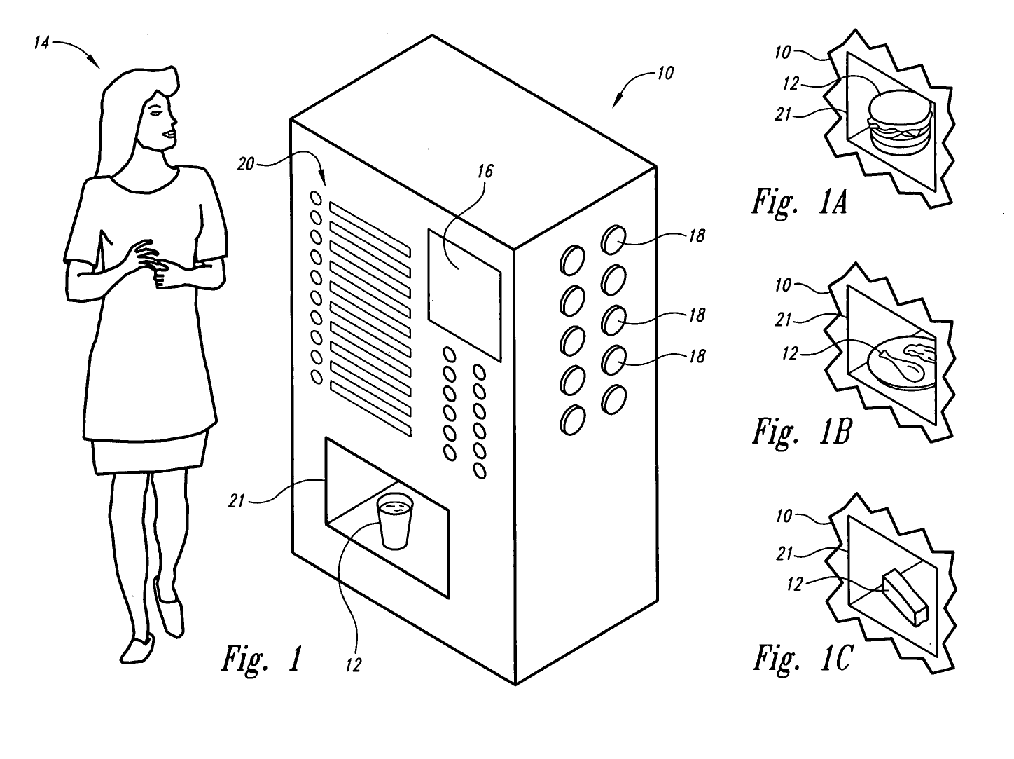

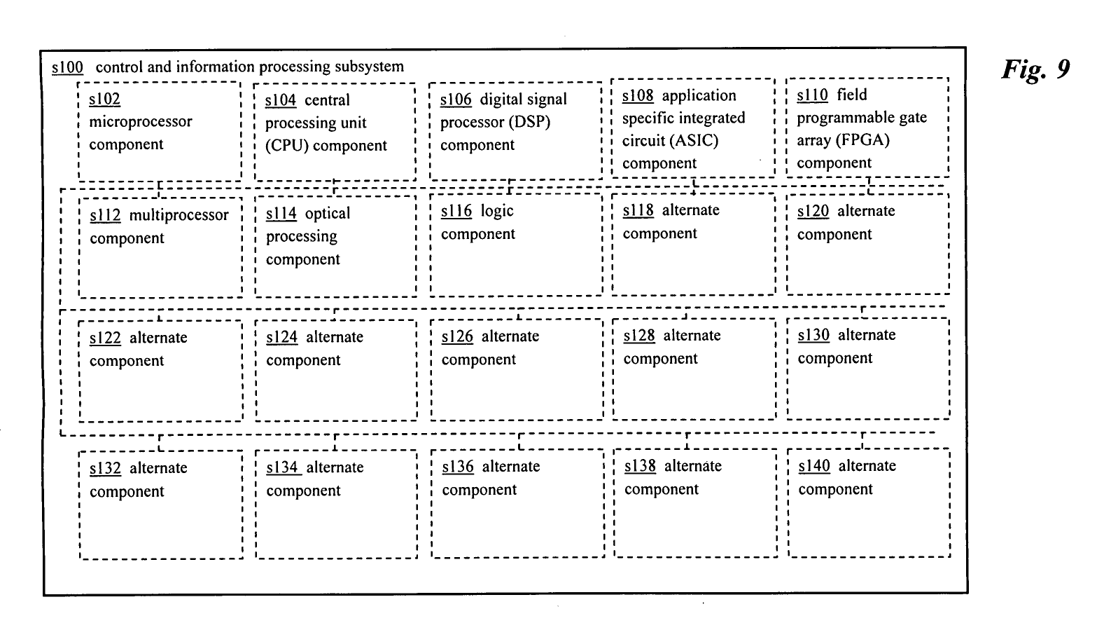

FIG. 9 is a block diagram depicting a control and information processing subsystem s100 of an exemplary implementation of the ingestible product preparation system 10 of FIG. 1.

FIG. 17 is a block diagram depicting one or more exemplary electrical circuitry arrangements of the ingestible product preparation system 10 of FIG. 1.

FIG. 18 is a block diagram depicting one or more exemplary electrical circuitry arrangements of the ingestible product preparation system 10 of FIG. 1.

FIG. 19 is a block diagram depicting one or more exemplary electrical circuitry arrangements of the ingestible product preparation system 10 of FIG. 1.

FIG. 20 is a block diagram depicting one or more exemplary electrical circuitry arrangements of the ingestible product preparation system 10 of FIG. 1.

FIG. 21 is a block diagram depicting one or more exemplary electrical circuitry arrangements of the ingestible product preparation system 10 of FIG. 1.

FIG. 22 is a block diagram depicting one or more exemplary electrical circuitry arrangements of the ingestible product preparation system 10 of FIG. 1.

FIG. 23 is a block diagram depicting one or more exemplary electrical circuitry arrangements of the ingestible product preparation system 10 of FIG. 1.

FIG. 24 is a block diagram depicting one or more exemplary instructions of the information storage subsystem s200 of the ingestible product preparation system 10 of FIG. 1.

FIG. 25 is a block diagram depicting one or more exemplary instructions of the information storage subsystem s200 of the ingestible product preparation system 10 of FIG. 1.

FIG. 26 is a block diagram depicting one or more exemplary instructions of the information storage subsystem s200 of the ingestible product preparation system 10 of FIG. 1.

FIG. 27 is a block diagram depicting one or more exemplary instructions of the information storage subsystem s200 of the ingestible product preparation system 10 of FIG. 1.

FIG. 28 is a block diagram depicting one or more exemplary instructions of the information storage subsystem s200 of the ingestible product preparation system 10 of FIG. 1.

FIG. 29 is a block diagram depicting one or more exemplary instructions of the information storage subsystem s200 of the ingestible product preparation system 10 of FIG. 1.

FIG. 30 is a block diagram depicting one or more exemplary instructions of the information storage subsystem s200 of the ingestible product preparation system 10 of FIG. 1.

FIG. 31 is a high-level flowchart illustrating an operational flow o10 representing exemplary operations related to electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment, and electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input at least associated with the depicted exemplary implementations of the system.

FIG. 32 is a high-level flowchart including exemplary implementations of operation O11 of FIG. 31.

FIG. 33 is a high-level flowchart including exemplary implementations of operation O11 of FIG. 31.

FIG. 34 is a high-level flowchart including exemplary implementations of operation O11 of FIG. 31.

FIG. 35 is a high-level flowchart including exemplary implementations of operation O11 of FIG. 31.

FIG. 36 is a high-level flowchart including exemplary implementations of operation O11 of FIG. 31.

FIG. 37 is a high-level flowchart including exemplary implementations of operation O11 of FIG. 31.

FIG. 38 is a high-level flowchart including exemplary implementations of operation O11 of FIG. 31.

FIG. 39 is a high-level flowchart including exemplary implementations of operation O11 of FIG. 31.

FIG. 40 is a high-level flowchart including exemplary implementations of operation O11 of FIG. 31.

FIG. 41 is a high-level flowchart including exemplary implementations of operation O11 of FIG. 31.

FIG. 42 is a high-level flowchart including exemplary implementations of operation O11 of FIG. 31.

FIG. 43 is a high-level flowchart including exemplary implementations of operation O11 of FIG. 31.

FIG. 44 is a high-level flowchart including exemplary implementations of operation O11 of FIG. 31.

FIG. 45 is a high-level flowchart including exemplary implementations of operation O11 of FIG. 31.

FIG. 46 is a high-level flowchart including exemplary implementations of operation O11 of FIG. 31.

FIG. 47 is a high-level flowchart including exemplary implementations of operation O11 of FIG. 31.

FIG. 48 is a high-level flowchart including exemplary implementations of operation O11 of FIG. 31.

FIG. 49 is a high-level flowchart including exemplary implementations of operation O11 of FIG. 31.

FIG. 50 is a high-level flowchart including exemplary implementations of operation O11 of FIG. 31.

FIG. 51 is a high-level flowchart including exemplary implementations of operation O11 of FIG. 31.

FIG. 52 is a high-level flowchart including exemplary implementations of operation O11 of FIG. 31.

FIG. 53 is a high-level flowchart including exemplary implementations of operation O11 of FIG. 31.

FIG. 54 is a high-level flowchart including exemplary implementations of operation O12 of FIG. 31.

FIG. 55 is a high-level flowchart including exemplary implementations of operation O12 of FIG. 31.

FIG. 56 is a high-level flowchart including exemplary implementations of operation O12 of FIG. 31.

FIG. 57 is a high-level flowchart including exemplary implementations of operation O12 of FIG. 31.

FIG. 58 is a high-level flowchart including exemplary implementations of operation O12 of FIG. 31.

FIG. 59 is a high-level flowchart including exemplary implementations of operation O12 of FIG. 31.

FIG. 60 is a high-level flowchart including exemplary implementations of operation O12 of FIG. 31.

FIG. 61 is a high-level flowchart including exemplary implementations of operation O12 of FIG. 31.

FIG. 62 is a high-level flowchart including exemplary implementations of operation O12 of FIG. 31.

FIG. 63 is a high-level flowchart including exemplary implementations of operation O12 of FIG. 31.

FIG. 64 is a high-level flowchart including exemplary implementations of operation O12 of FIG. 31.

FIG. 65 is a high-level flowchart including exemplary implementations of operation O12 of FIG. 31.

FIG. 66 is a high-level flowchart including exemplary implementations of operation O12 of FIG. 31.

FIG. 67 is a high-level flowchart including exemplary implementations of operation O12 of FIG. 31.

FIG. 68 is a high-level flowchart including exemplary implementations of operation O12 of FIG. 31.

FIG. 69 is a high-level flowchart including exemplary implementations of operation O12 of FIG. 31.

FIG. 70 is a high-level flowchart including exemplary implementations of operation O12 of FIG. 31.

FIG. 71 is a high-level flowchart including exemplary implementations of operation O12 of FIG. 31.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Generally, automated and semi-automated machines to make, manufacture, fabricate, or otherwise prepare and/or dispense ingestible products to be ingested by living beings such as humans, animals, plants, etc are known to a degree with interest existing for future development as well. Automated and semi-automated preparation of the ingestible products can incorporate all known forms of preparation of food and other ingestible products including but not limited to all known forms of energy addition to one or more ingredients of the ingestible products (such as through various forms of thermal heating or adding microwave, infrared, or ultrasonic energy), extracting energy from one or more ingredients of the ingestible products (such as through thermodynamic-cycle based cooling or peltier cooling), deposition methods (including deposition by layering or at the pixel level), and combinational methods (such as blending, mixing, ingredient injection, kneading, stirring, ultrasonic agitation, other agitational methods, etc.), etc.

Although ingestible products made, fabricated, or otherwise prepared and/or dispensed by semi-automated and automated machines are presently limited in scope to a degree, it is envisioned that with future development, this will change. Ingestible products can take many forms including, but not limited to, solids, semi-solids, liquids, gases, dispersions (such as true solutions, colloid dispersions, emulsions, foams, and gels) and vast combinations thereof. Ingestion by the living beings can occur through many pathways including, but not limited to, oral ingestion, transdermal ingestion, peg-tube ingestion, nasal ingestion, anal ingestion, injectable ingestion, tear-duct ingestion, and respiratory ingestion.

As depicted in FIG. 1, an exemplary implementation of an ingestible product preparation system 10 is shown to prepare and dispense ingestible products such as a liquid drink 12 to be consumed by a particular individual living being, such as a human being 14 shown. Other sorts of ingestible products can include but are not limited to sandwiches (as shown, for example, in FIG. 1A), full meals (as shown, for example, in FIG. 1B), food bars (as shown, for example, in FIG. 1C), meal replacements, snacks, plant and/or animal based products, nutraceuticals, pharmaceuticals, smoothies, etc. The ingestible product preparation system 10 is further depicted as showing display screen 16 and selection indicators 20 configured to provide information to users, such as the human being 14, what ingestible products are available to be prepared (such as from ingredient containers 18) and dispensed after preparation and to provide other sorts of information discussed herein. The display screen 16 can display textual and graphic information such as including but not limited to menu screens allowing users to select various preparation and dispensing options and information requests. Other implementations can include other devices and methods for information input and output including those further discussed below. The selection indicators 20 or other display devices can display selection information including origin, type, certification, classification, etc. of ingestible ingredients and/or products available including information related to various implementations of substance control methods, systems, and articles of manufacture disclosed herein and discussed further below. Device cleaning methods and systems can be included with operation of the ingestible product preparation system 10 to allow for choice, at least to a degree, by users regarding the extent and manner that devices and components of the ingestible product preparation system 10 are to be cleaned prior to preparation of one or more ingestible products. The display screen 16 can also inform users of previously executed cleaning procedures and/or prior digestible product preparations.

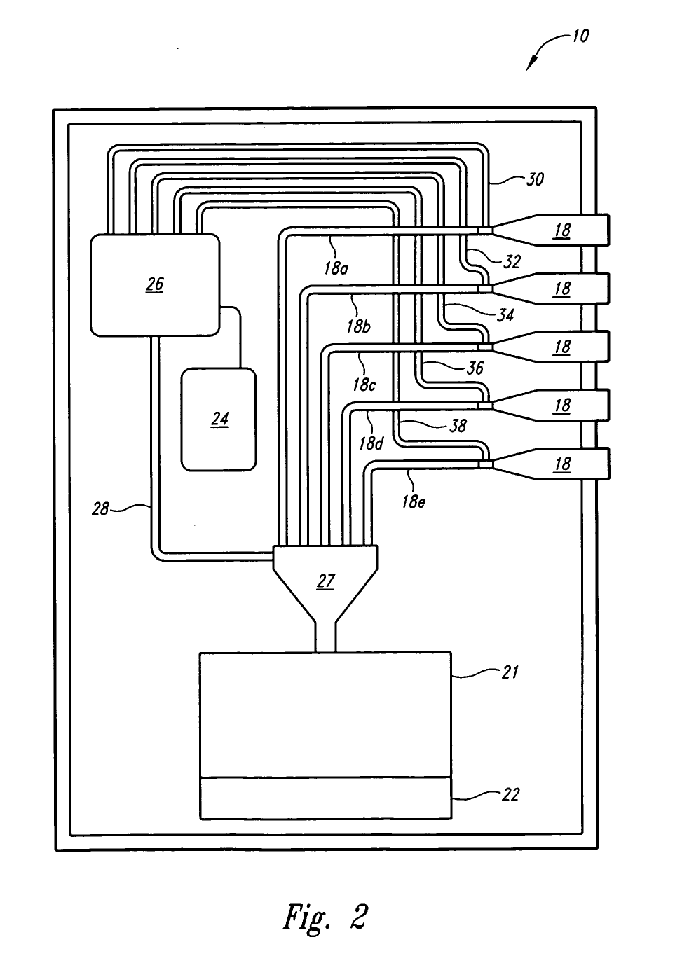

For instance, FIG. 2 is an exemplary cross-sectional schematic view of internal construction for the first version of the first exemplary implementation of the ingestible product preparation system 10 in FIG. 1. As shown in FIG. 2, system fixtures (e.g. tubing 18a-18e, 28, and 30-38, manifolds 26 and dispensing area surfaces 21 and 22) can provide surfaces that can retain various materials subsequent to preparation of digestible products. These various materials may undesirably interact with other materials used in subsequent operation of the ingestible product preparation system 10. Retained materials can also be a source of allergies, adverse interactions, or other ill effects with subsequent users. Thus, providing information about previous ingestible product preparation and cleaning options to subsequent users to help reduce problems and increase benefits in the use of the ingestible product preparation system 10.

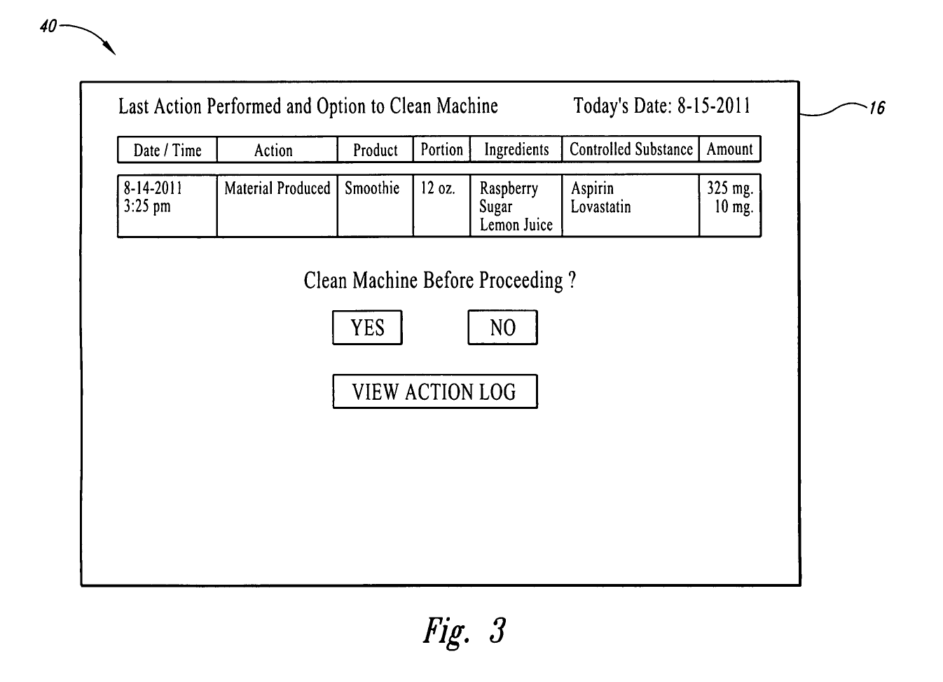

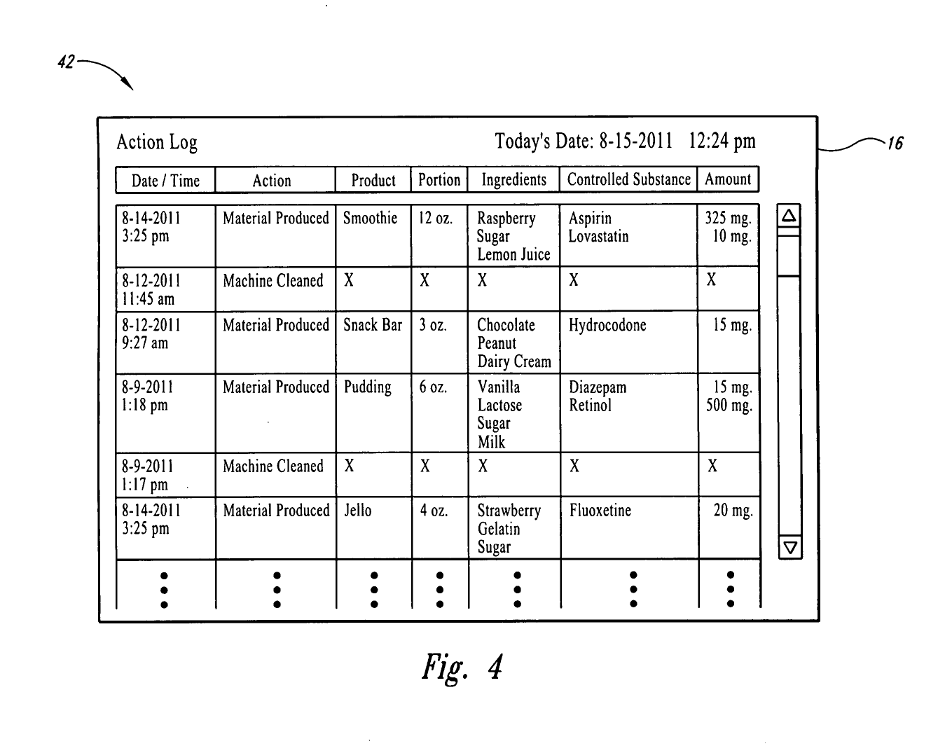

For instance, FIG. 3 depicts the display screen 16 showing content 40 as to a last ingestible product preparation performed immediately before in sequence to a current instance of ingestible product preparation selection. The content 40 includes date/time of the previous preparation, the action that was performed, name, size, ingredients, name and amount of controlled substances involved with the previously prepared product. The content 40 also includes a user selectable option to have cleaning performed before ingestible product preparation by selecting “yes” or to opt out by selecting “no.” There is also a user selectable option to have an action log of a chronological series of ingestible product preparation instances displayed such as shown with content 42 in FIG. 4.

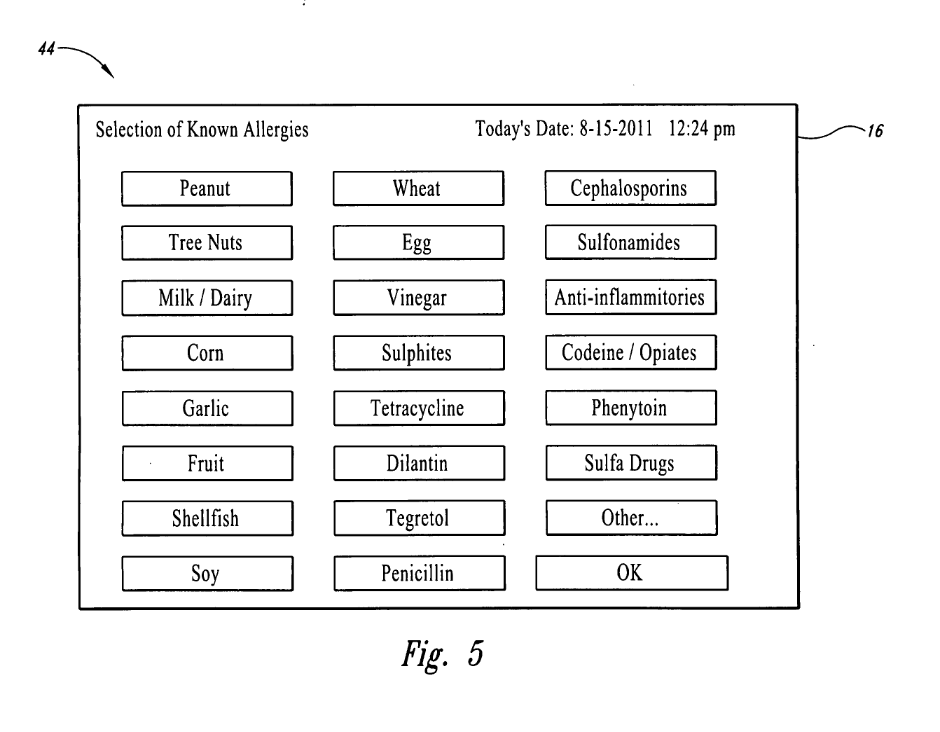

For instance, FIG. 5 depicts the display screen 16 showing content 44 having user selectable options to indicate what sorts of ingredients or general categories my cause problems, such as allergies, for the user. This information inputted by the user can then be used by the ingestible product preparation system 10 to assist in determining if one or more portions of the ingestible product preparation system 10 should be cleaned, such as by automated cleaning procedures performed thereby, prior to further one or more instances of ingestible product preparation.

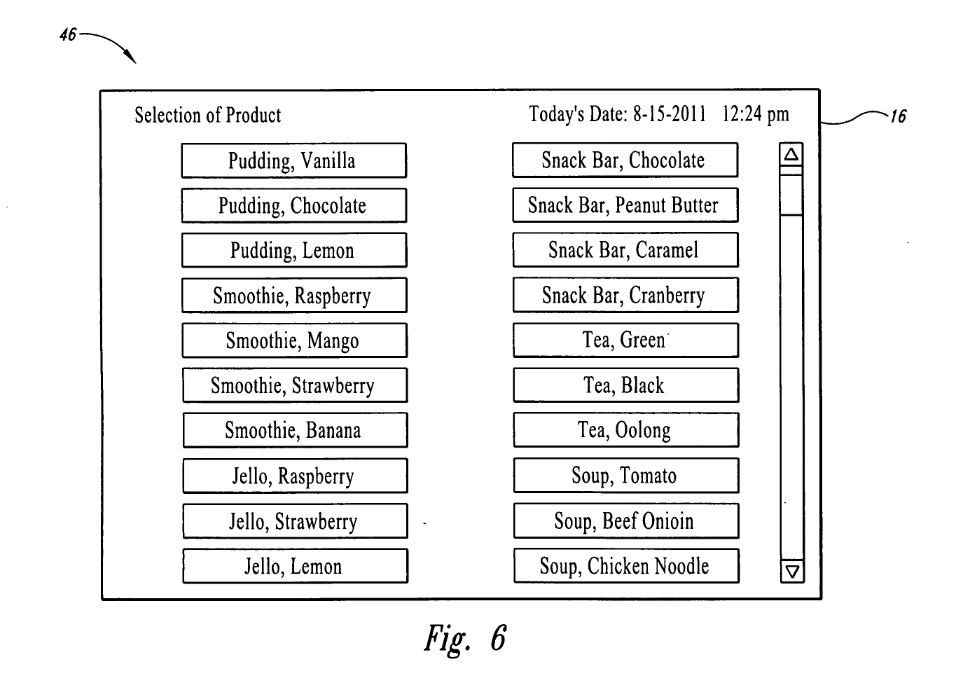

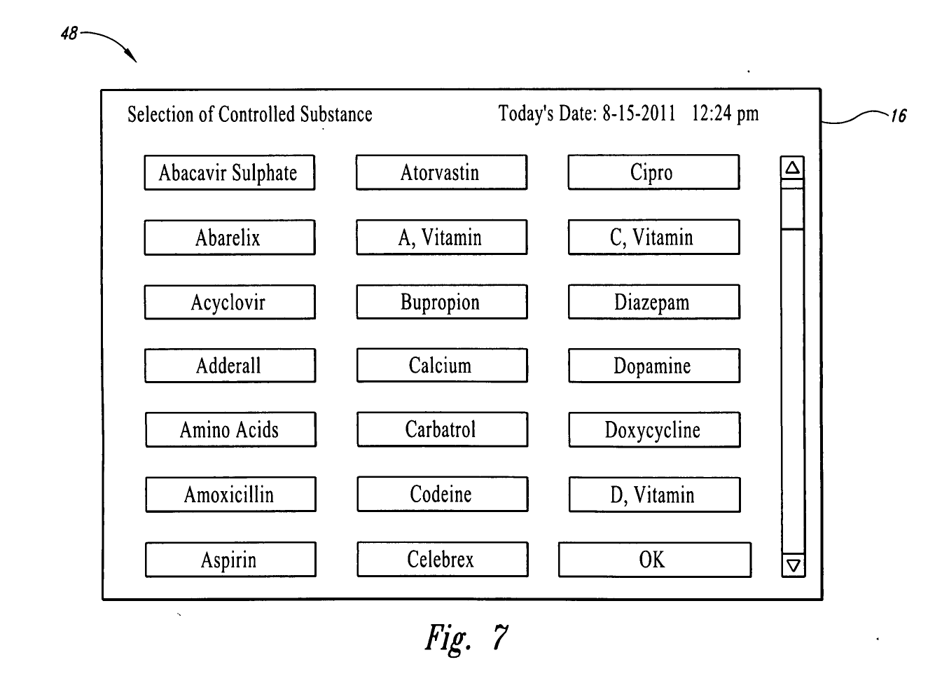

For instance, FIG. 6 depicts the display screen 16 showing content 46 having user selectable options to indicate what one or more ingestible products are desired for the ingestible product preparation system 10 to prepare. For instance, FIG. 7 depicts the display screen 16 showing content 48 having user selectable options to indicate what one or more controlled substances are desired for inclusion by the ingestible product preparation system 10 in ingestible product preparation. In some implementations, this information can also be used by the ingestible product preparation system 10 to determine if one or more cleaning procedures should be executed prior to further ingestible product preparation.

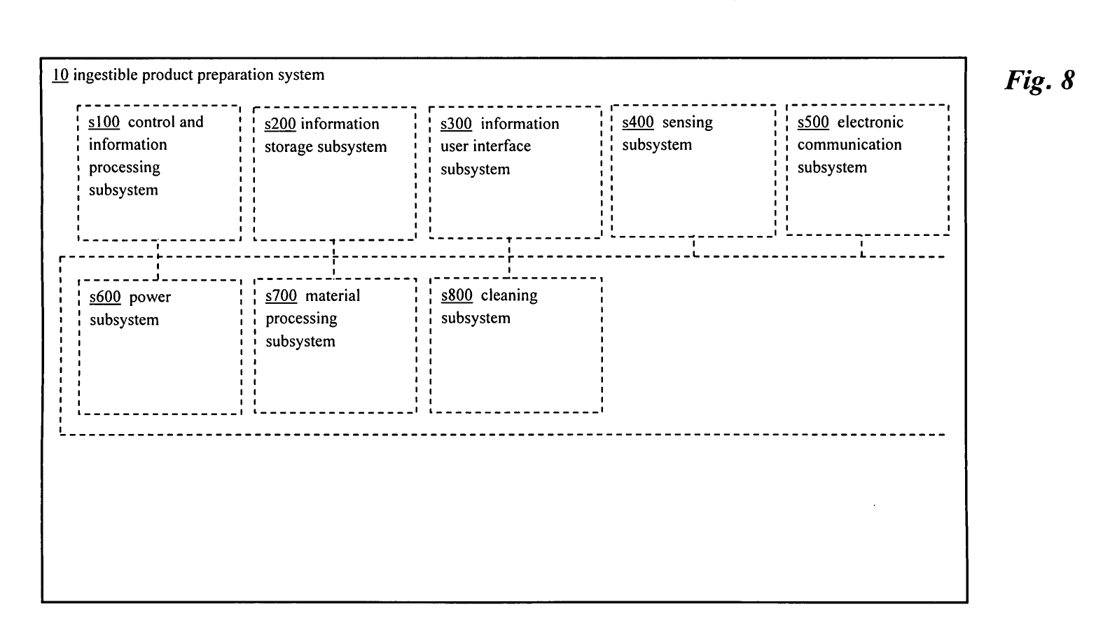

An exemplary version of the ingestible product preparation system 10 is shown in FIG. 8 to optionally include various subsystems such as control and information processing subsystem s100, information storage subsystem s200, information user interface subsystem s300, sensing subsystem s400, electronic communication subsystem s500, power subsystem s600, material processing subsystem s700, and cleaning subsystem s800.

An exemplary implementation of the control and information processing subsystem s100 is shown in FIG. 9 to optionally include various components such as microprocessor component s102, central processing unit (CPU) component s104, digital signal processor (DSP) component s106, application specific integrated circuit (ASIC) component s108, field programmable gate array (FPGA) component s110, multiprocessor component s112, and optical processing component s114.

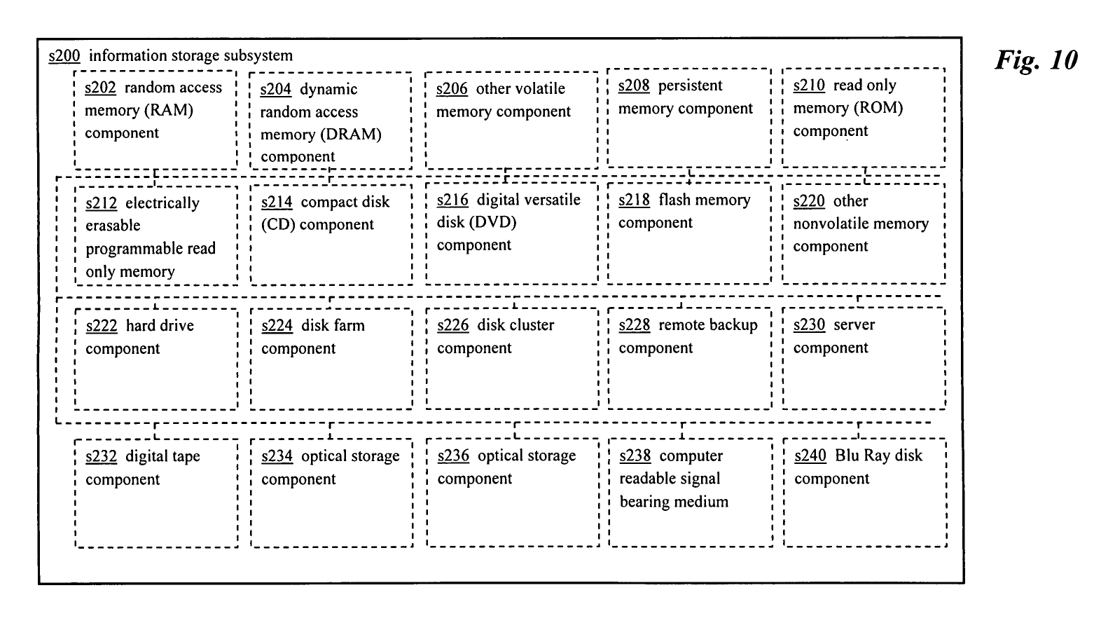

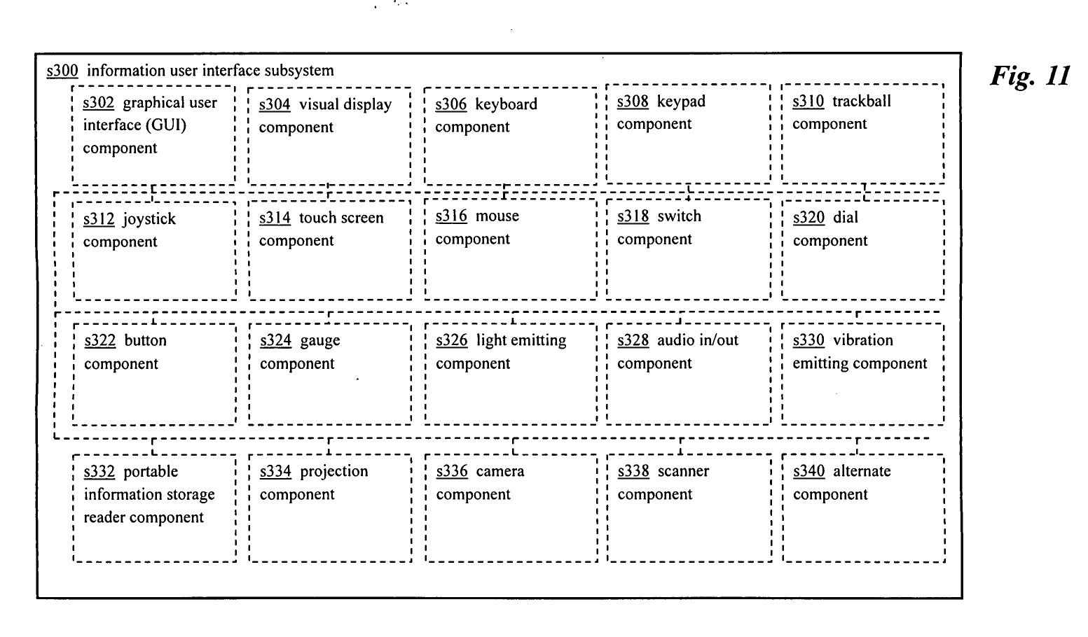

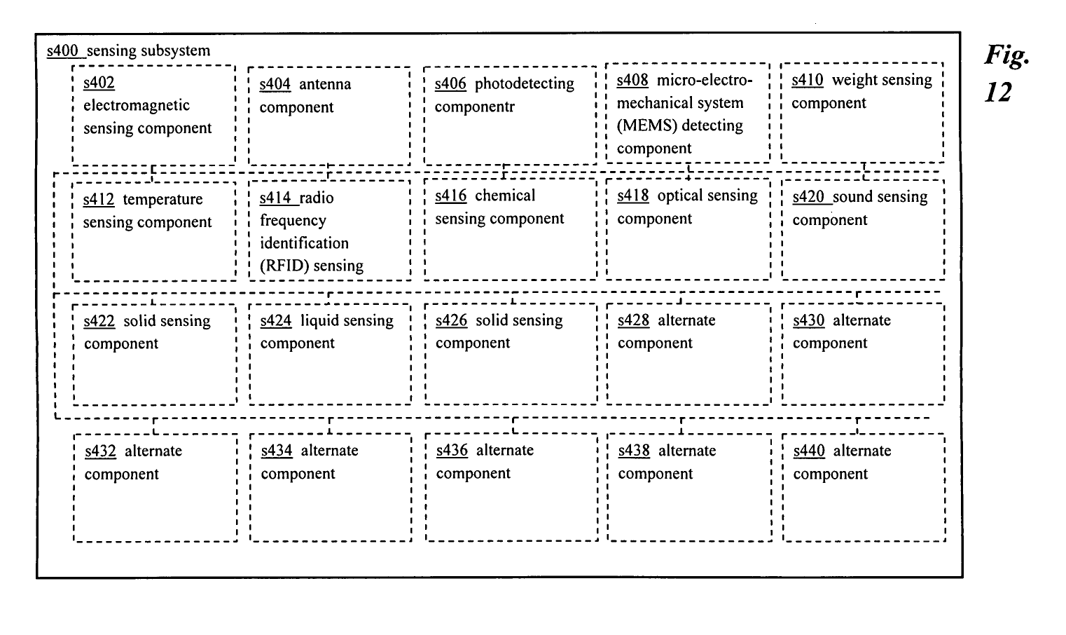

An exemplary implementation of the information storage subsystem s200 is shown in FIG. 10 to optionally include various components such as random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, and Blu Ray disk component s240.

An exemplary implementation of the information user interface subsystem s300 is shown in FIG. 11 to optionally include various components such as graphical user interface (GUI) component s302, visual display component s304, keyboard component s306, keypad component s308, trackball component s310, joystick component s312, touch screen component s314, mouse component s316, switch component s318, dial component s320, button component s322, gauge component s324, light emitting component s326, audio in/out component s328, vibration emitting component s330, portable information storage reader component s332, projection component s334, camera component s336, and scanner component s338.

An exemplary implementation of the sensing subsystem s400 is shown in FIG. 12 to optionally include various components such as electromagnetic sensing component s402, antenna component s404, photodetecting component s406, micro-electro-mechanical system (MEMS) detecting component s408, weight sensing component s410, temperature sensing component s412, radio frequency identification (RFID) sensing component s414, chemical sensing component s416, optical sensing component s418, sound sensing component s420, solid sensing component s422, liquid sensing component s424, and solid sensing component s426.

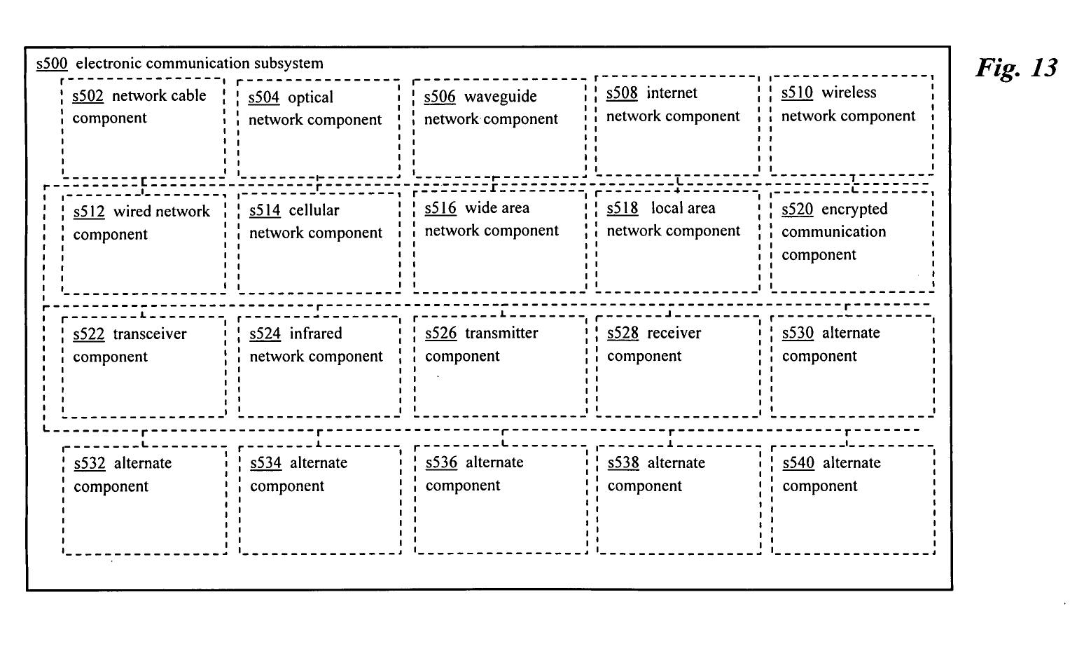

An exemplary implementation of the electronic communication subsystem s500 is shown in FIG. 13 to optionally include various components such as network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, and receiver component s528.

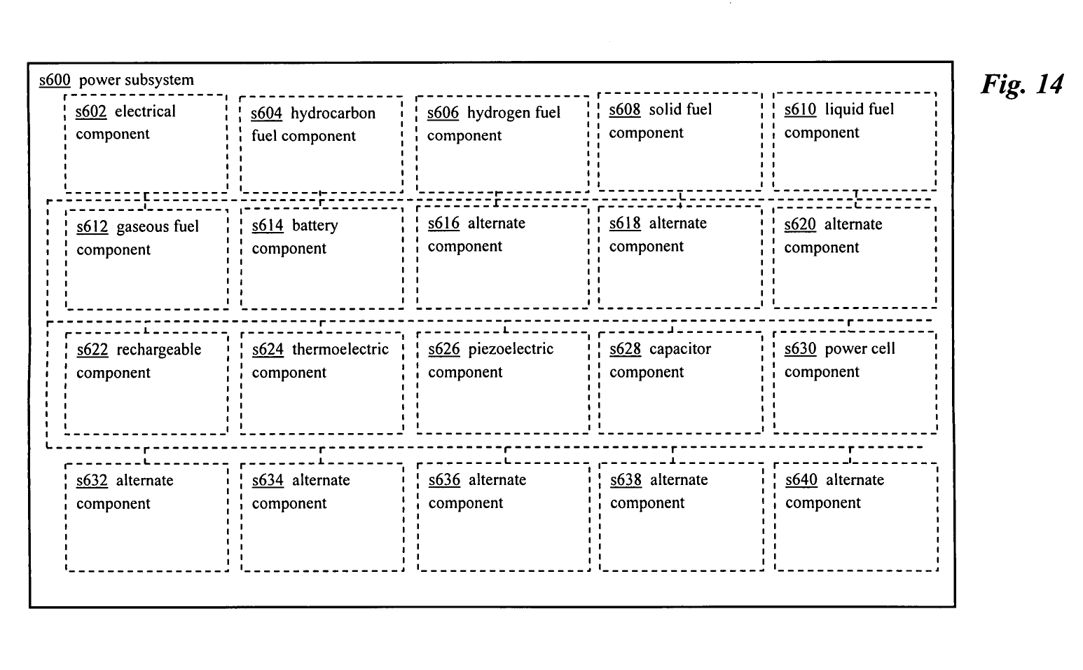

An exemplary implementation of the power subsystem s600 is shown in FIG. 14 to optionally include various components such as electrical component s602, hydrocarbon fuel component s604, hydrogen fuel component s606, solid fuel component s608, liquid fuel component s610, gaseous fuel component s612, and battery component s614.

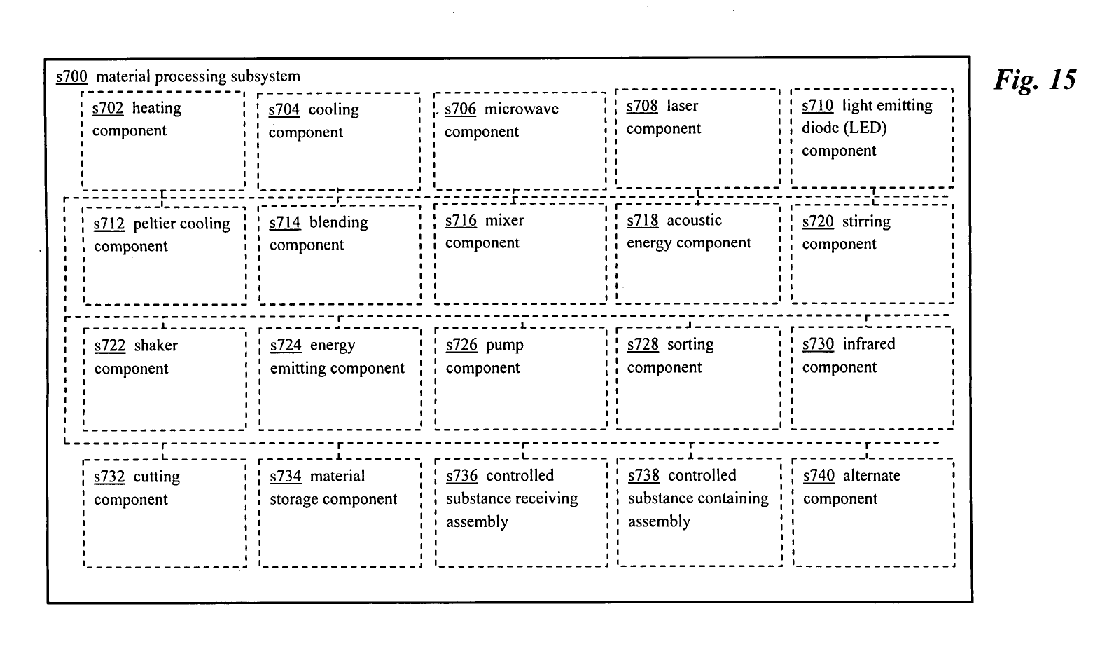

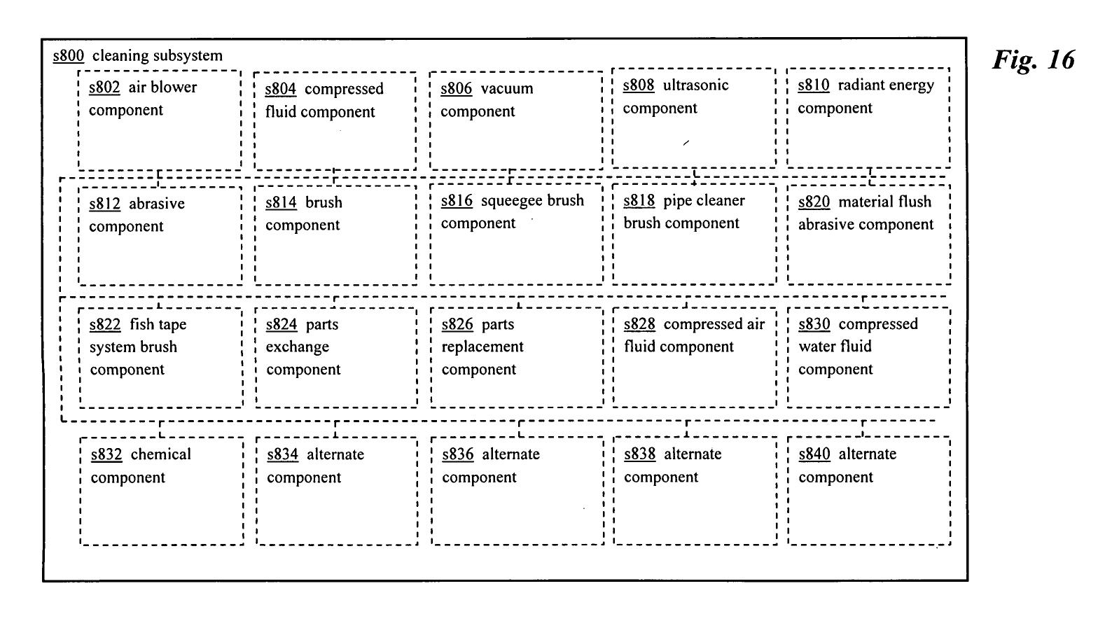

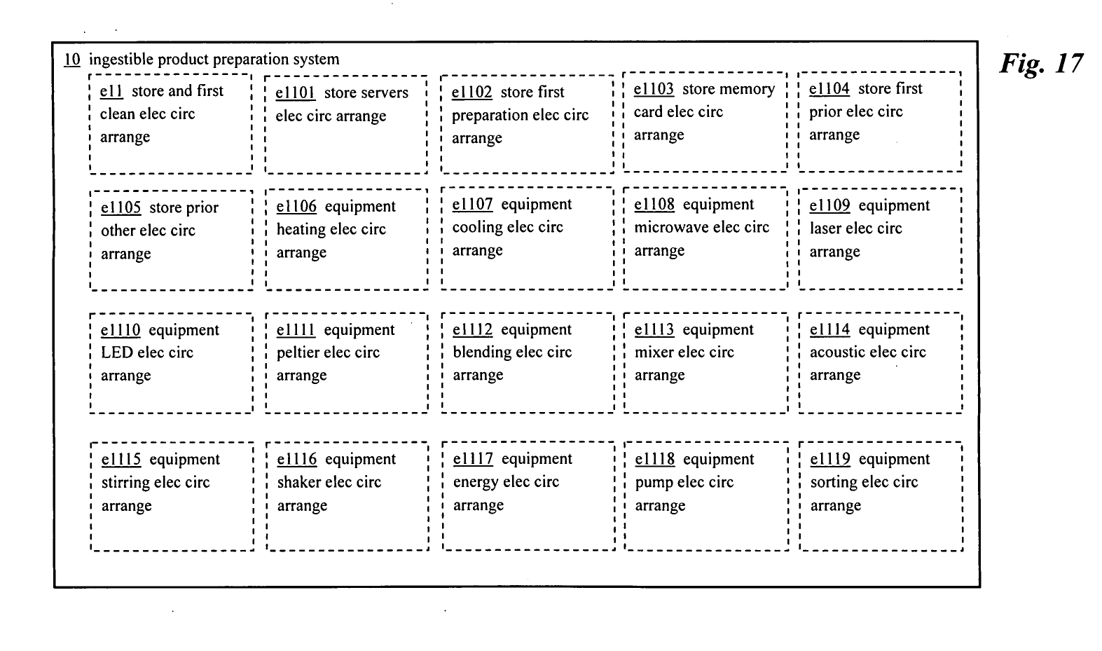

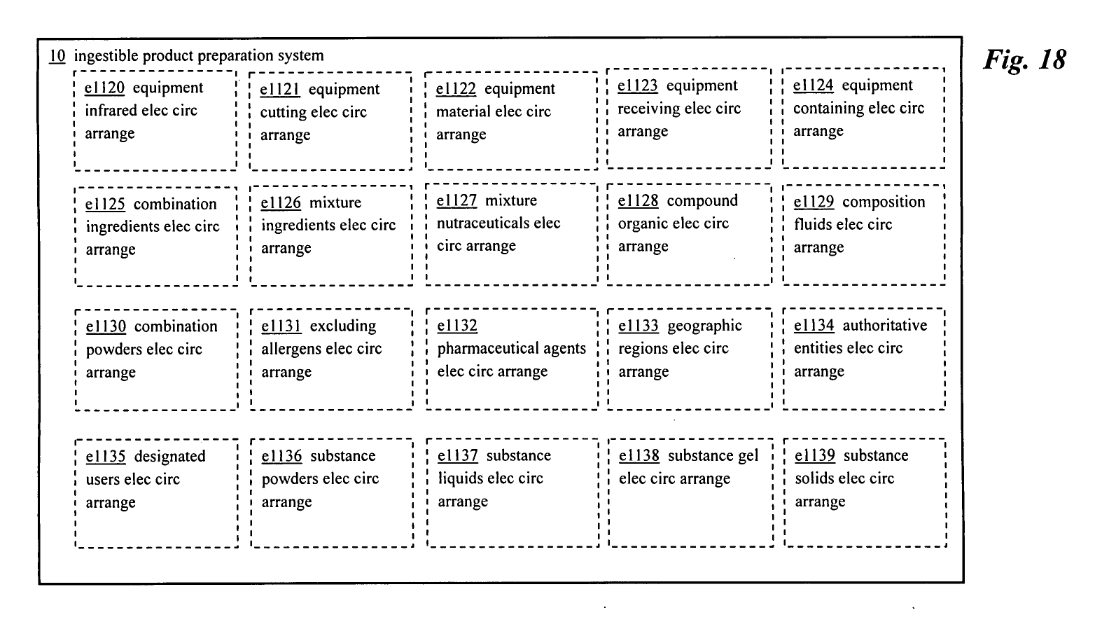

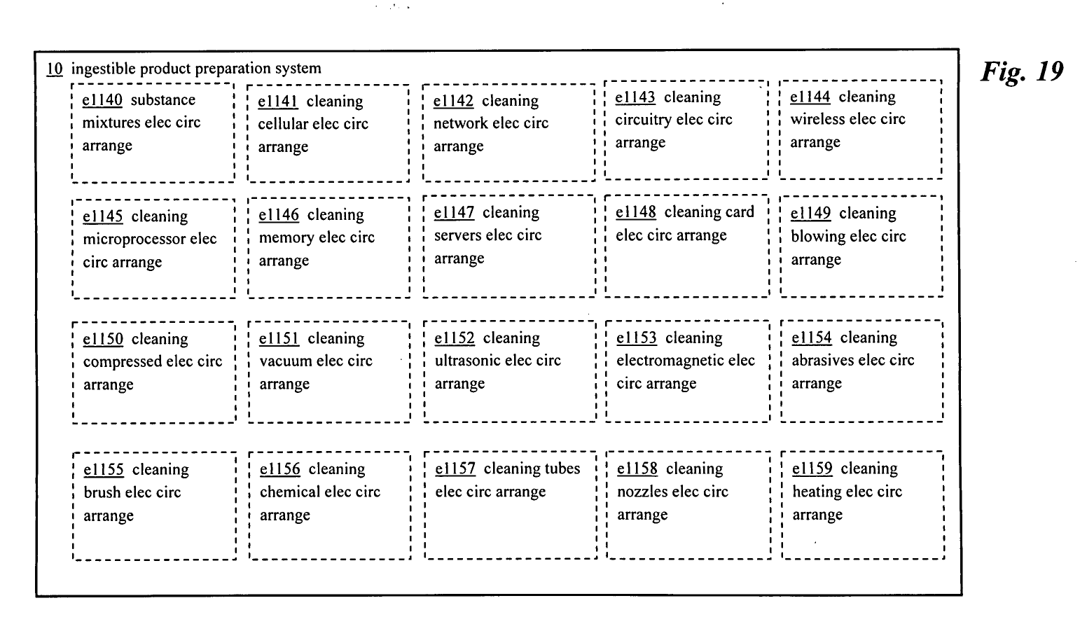

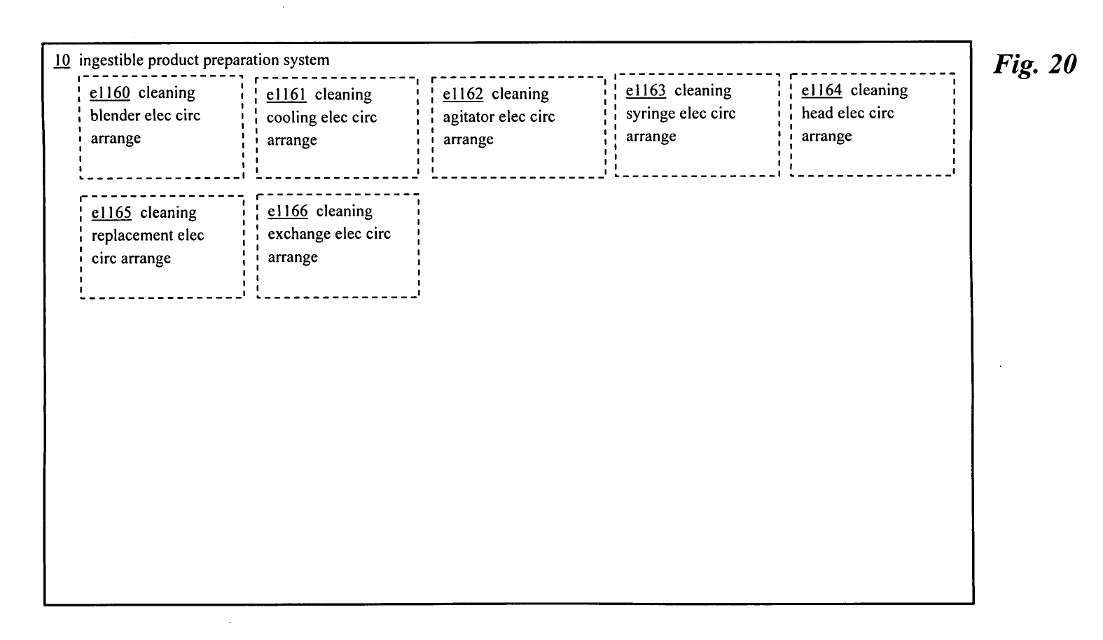

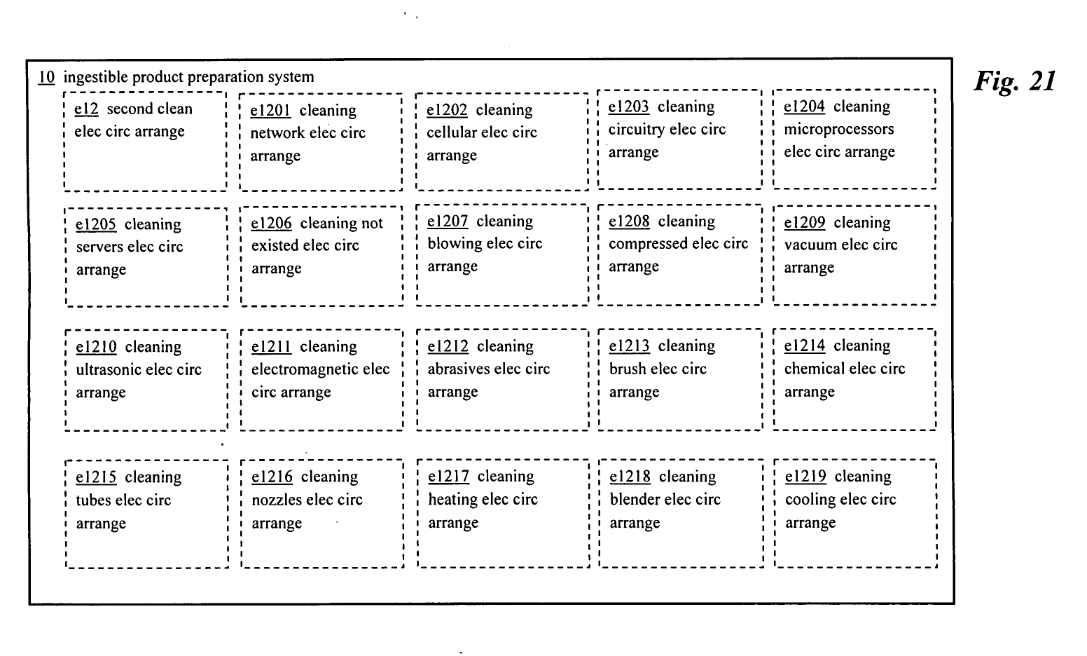

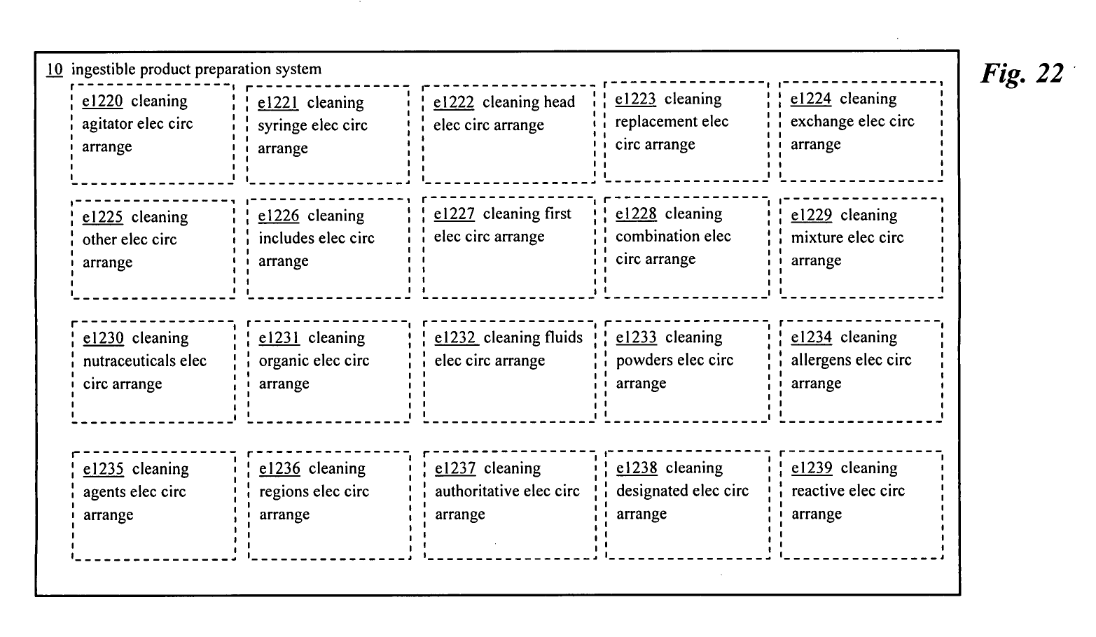

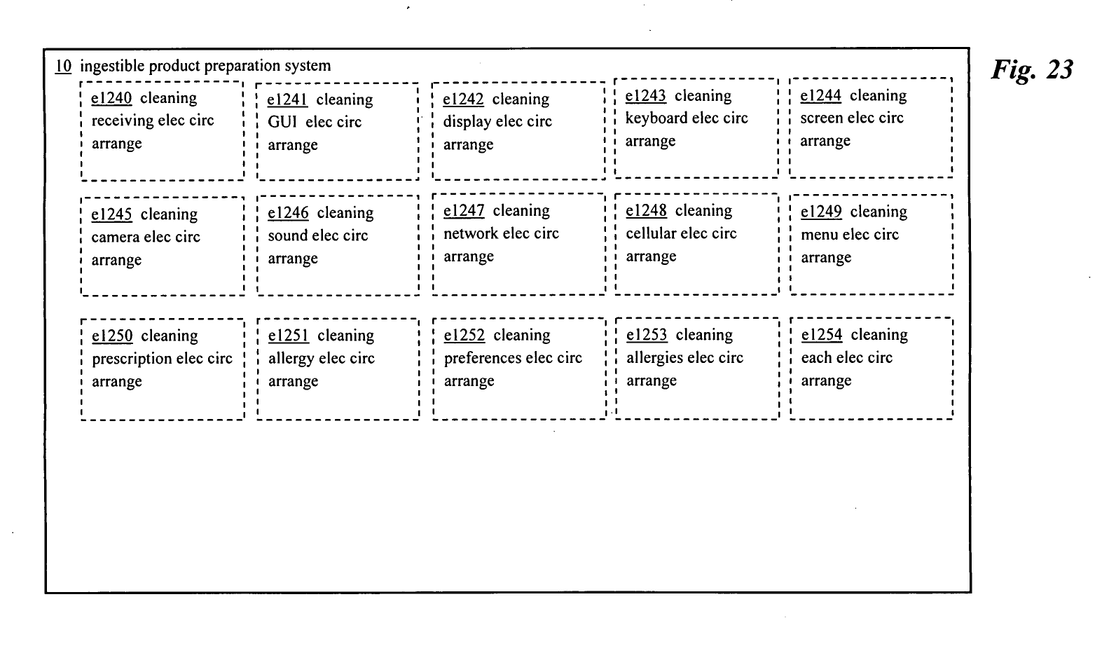

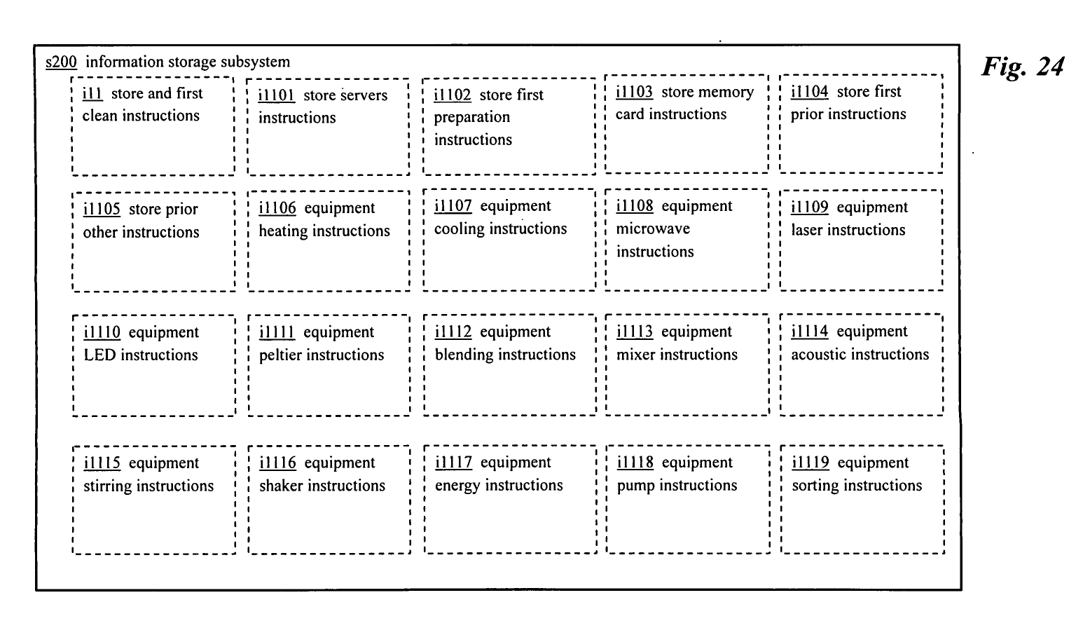

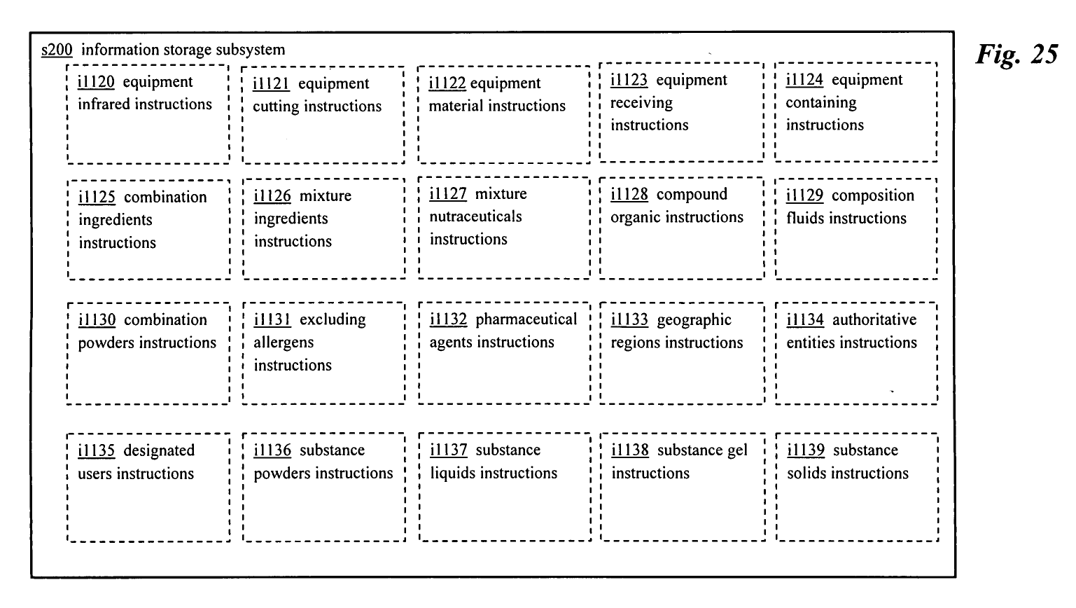

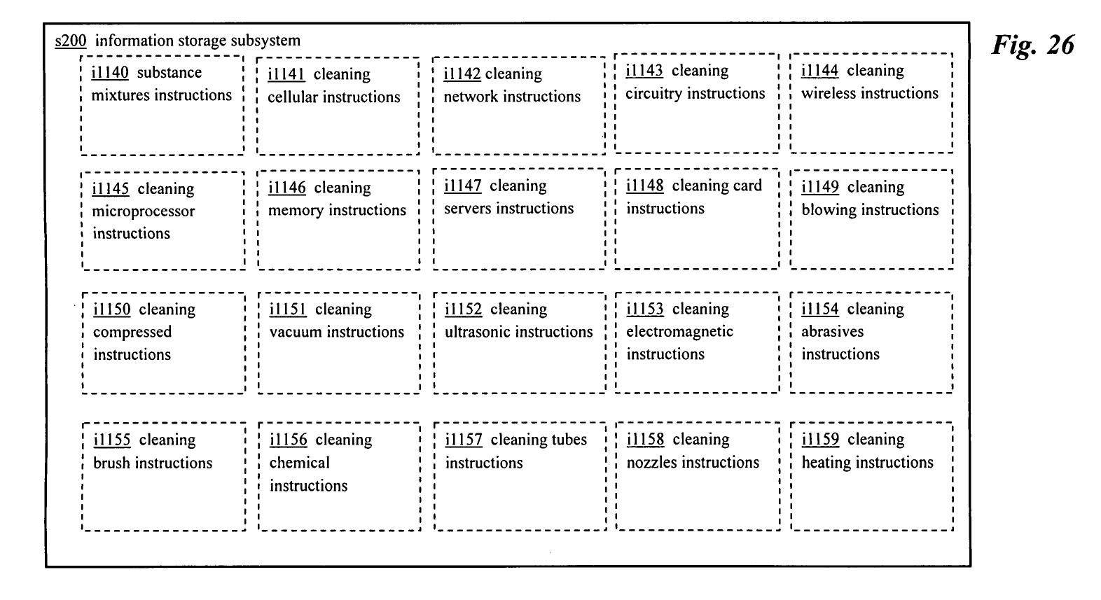

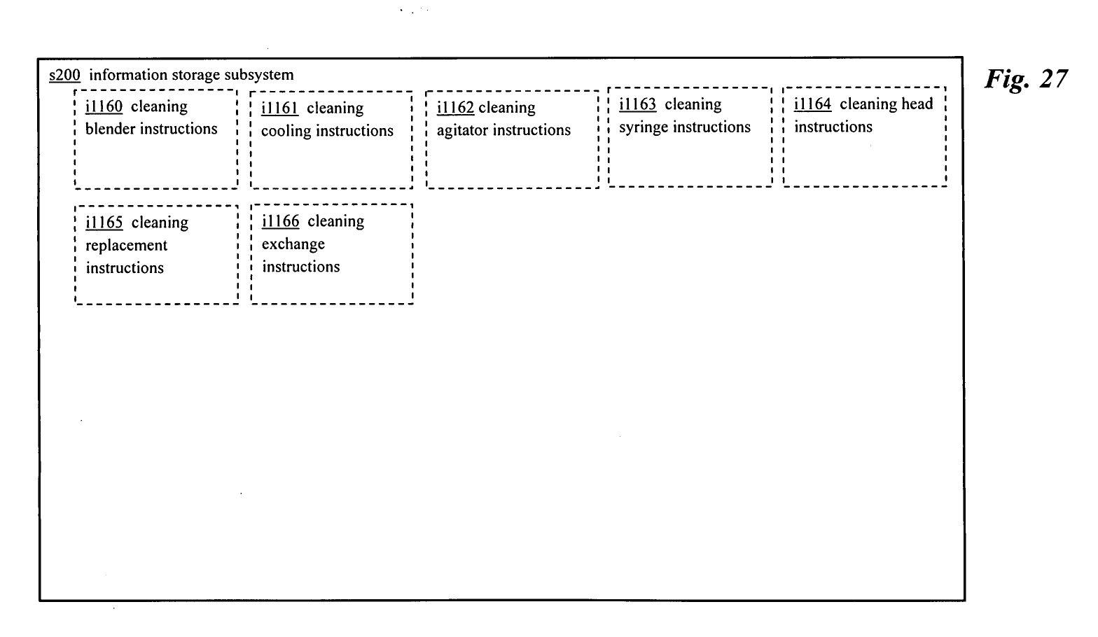

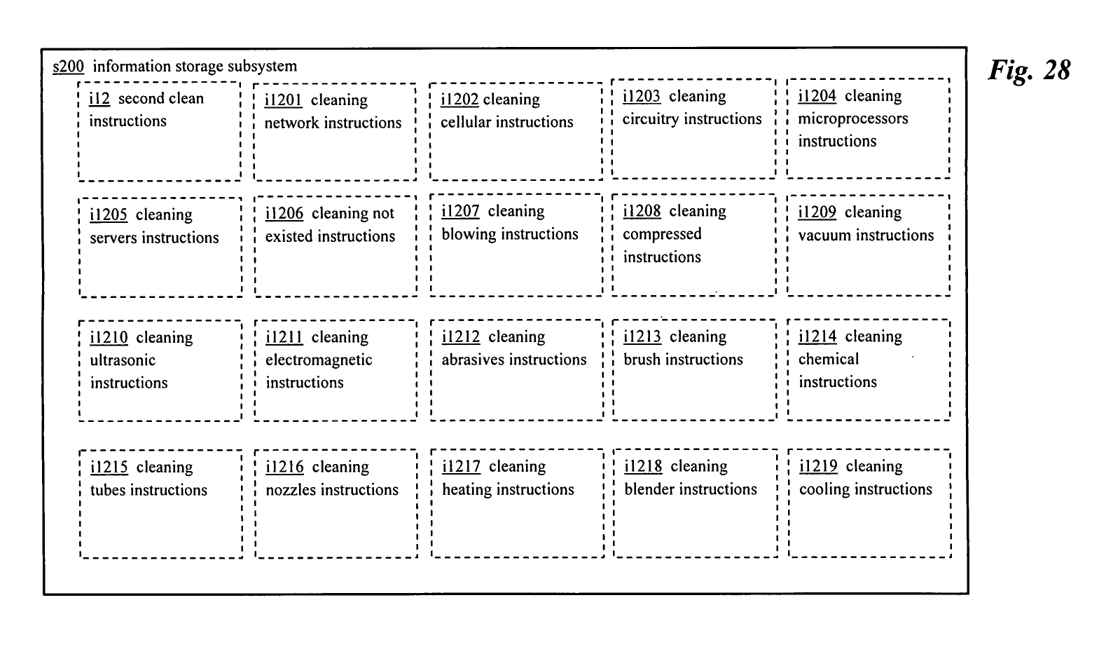

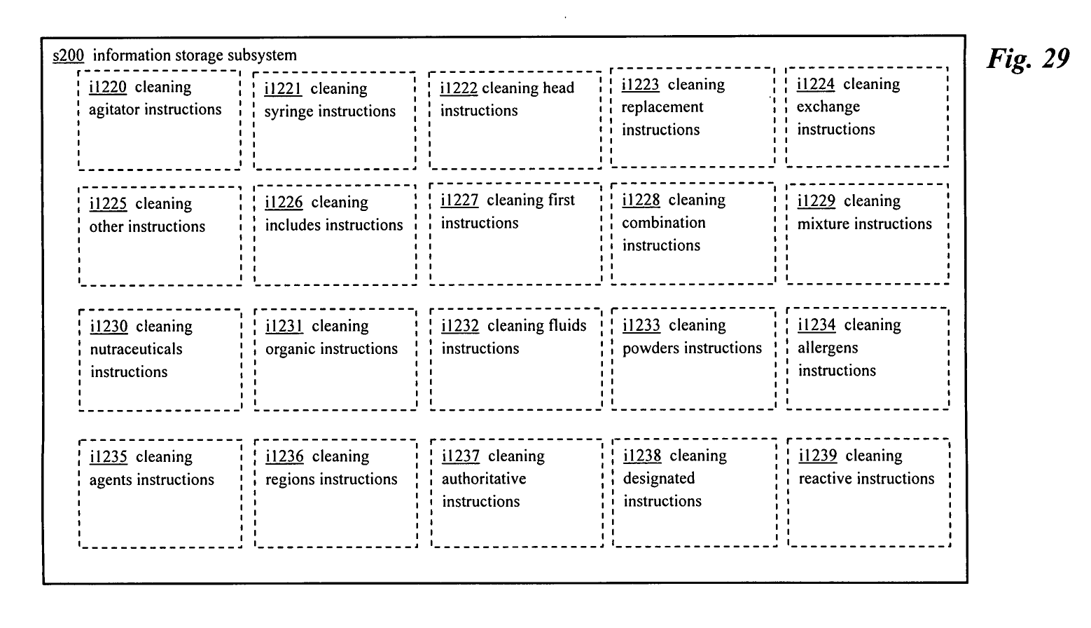

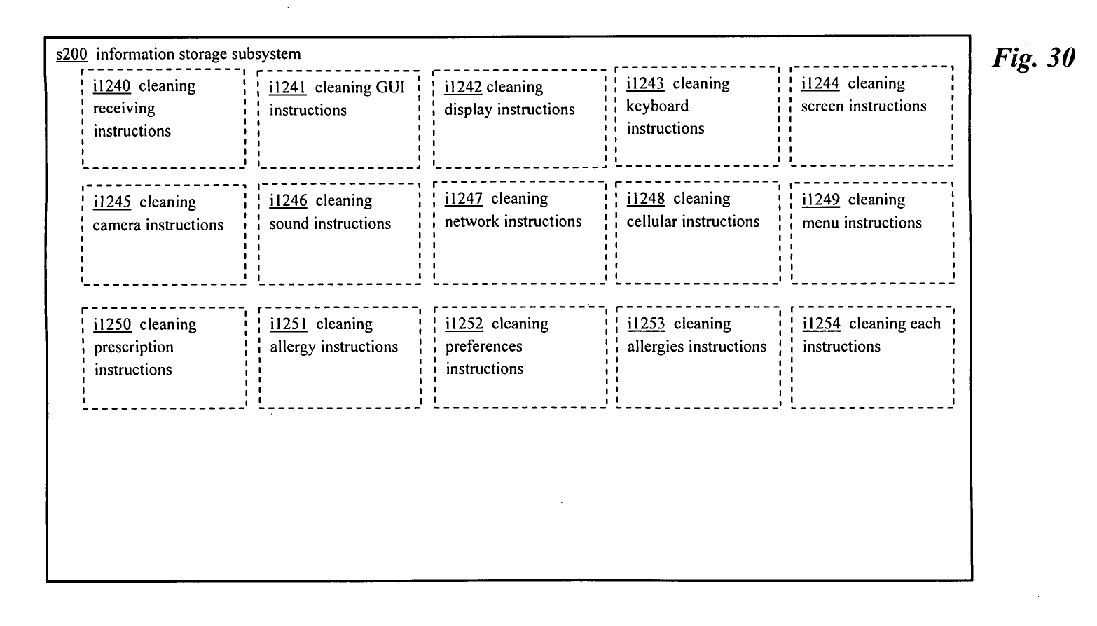

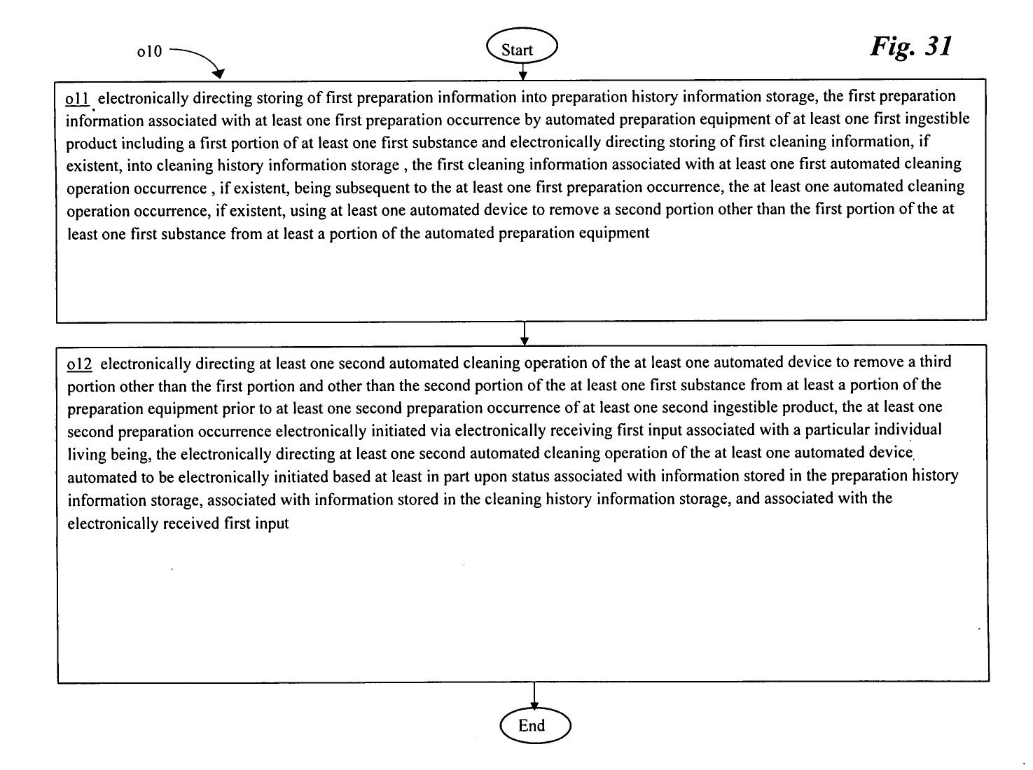

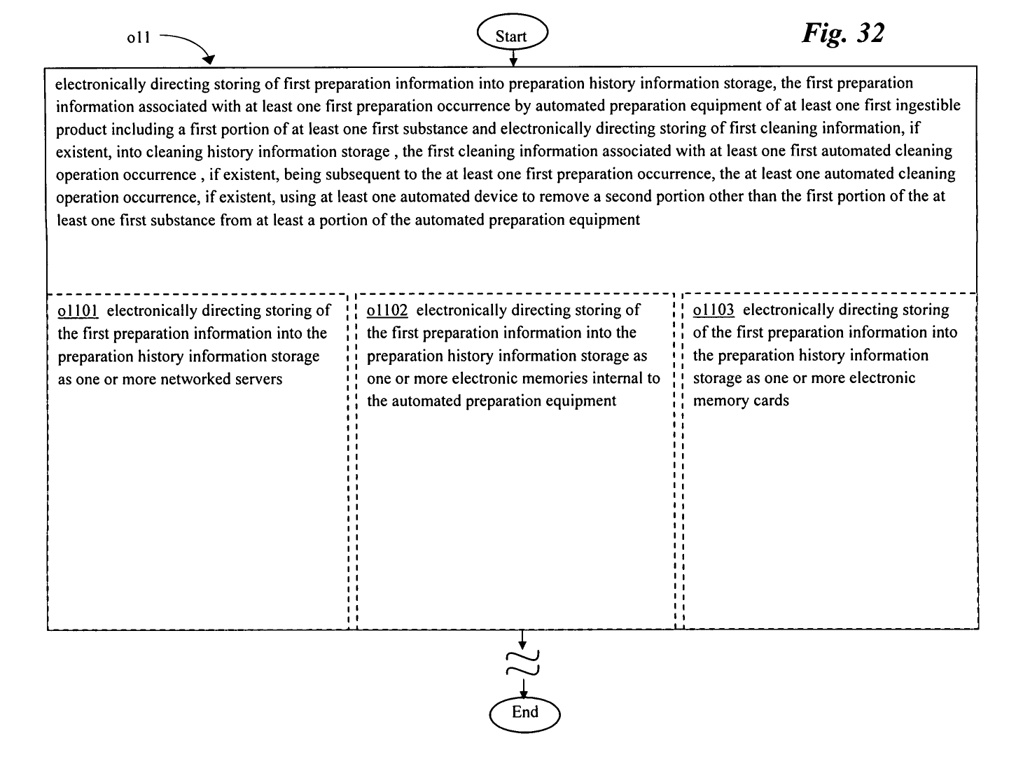

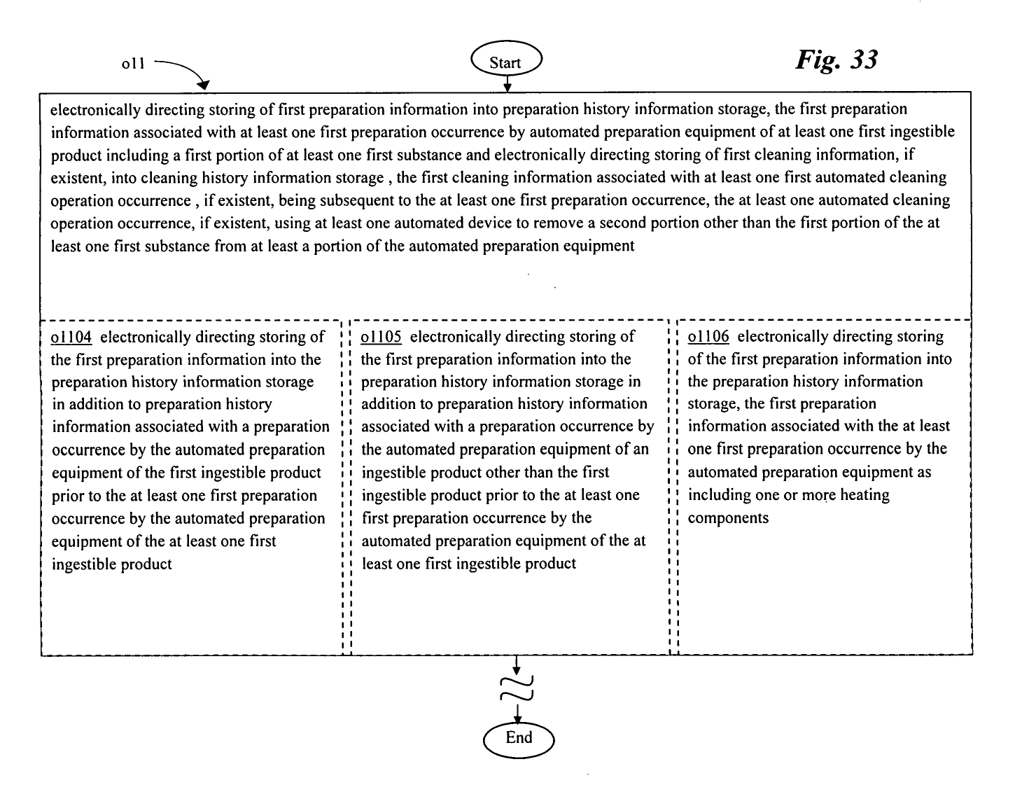

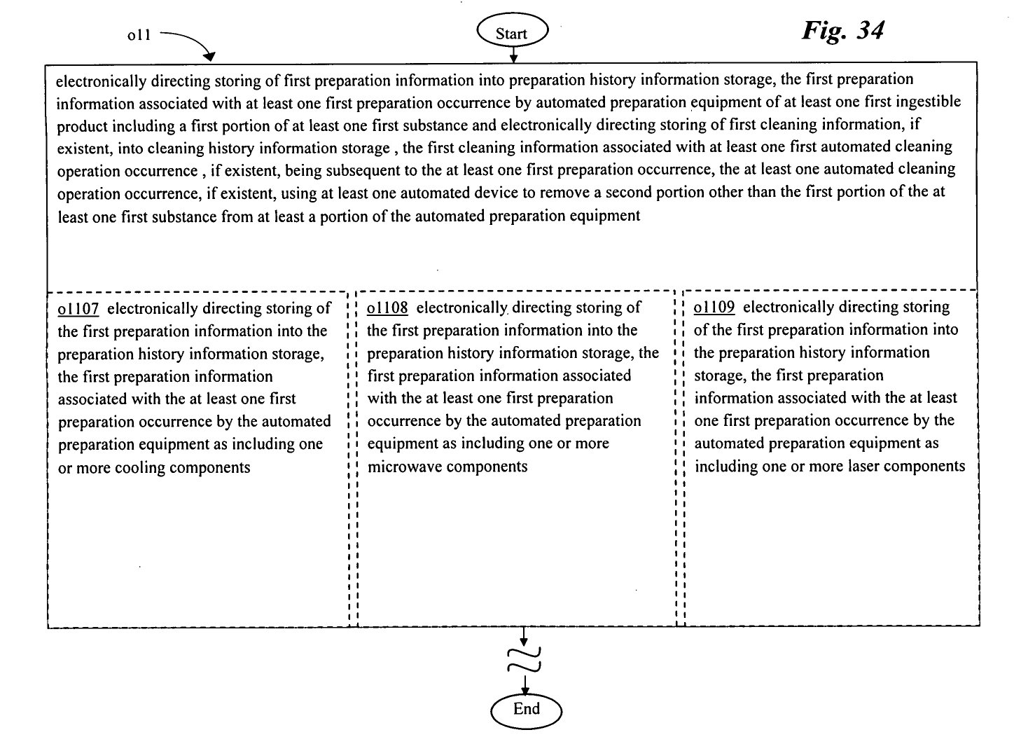

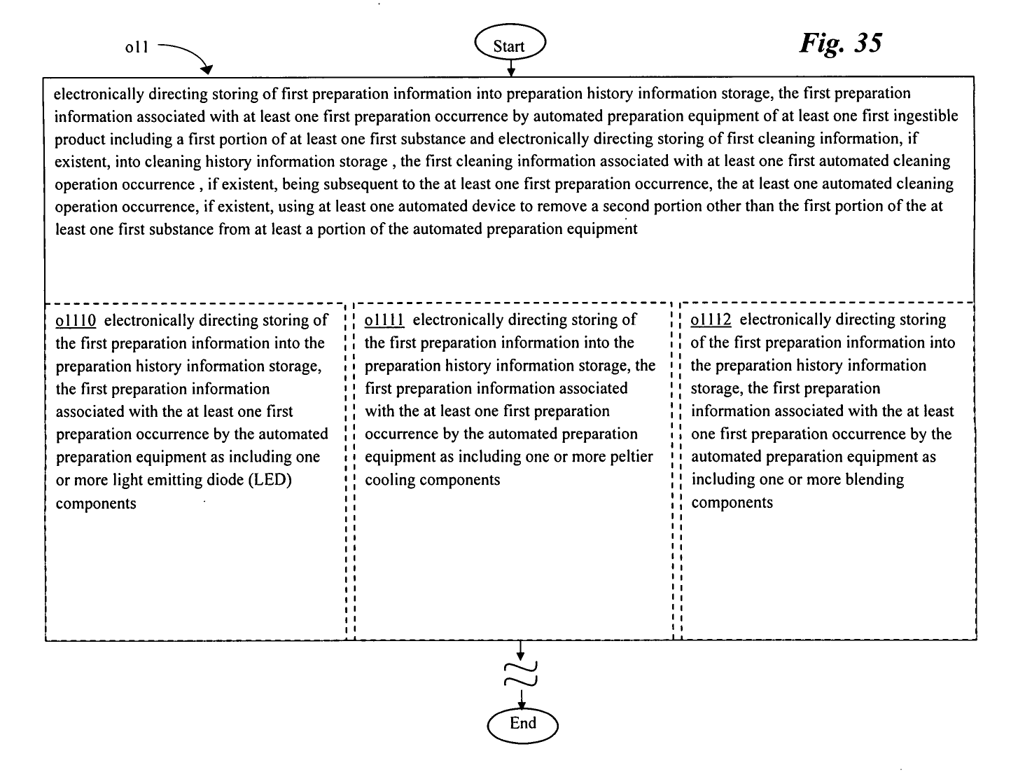

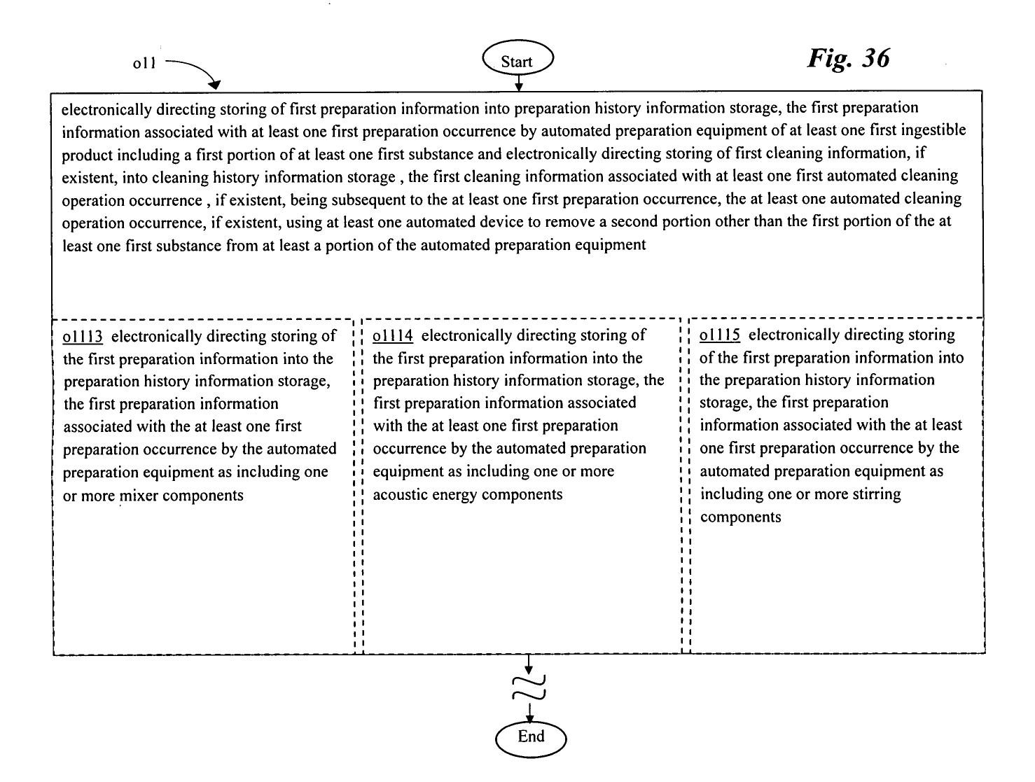

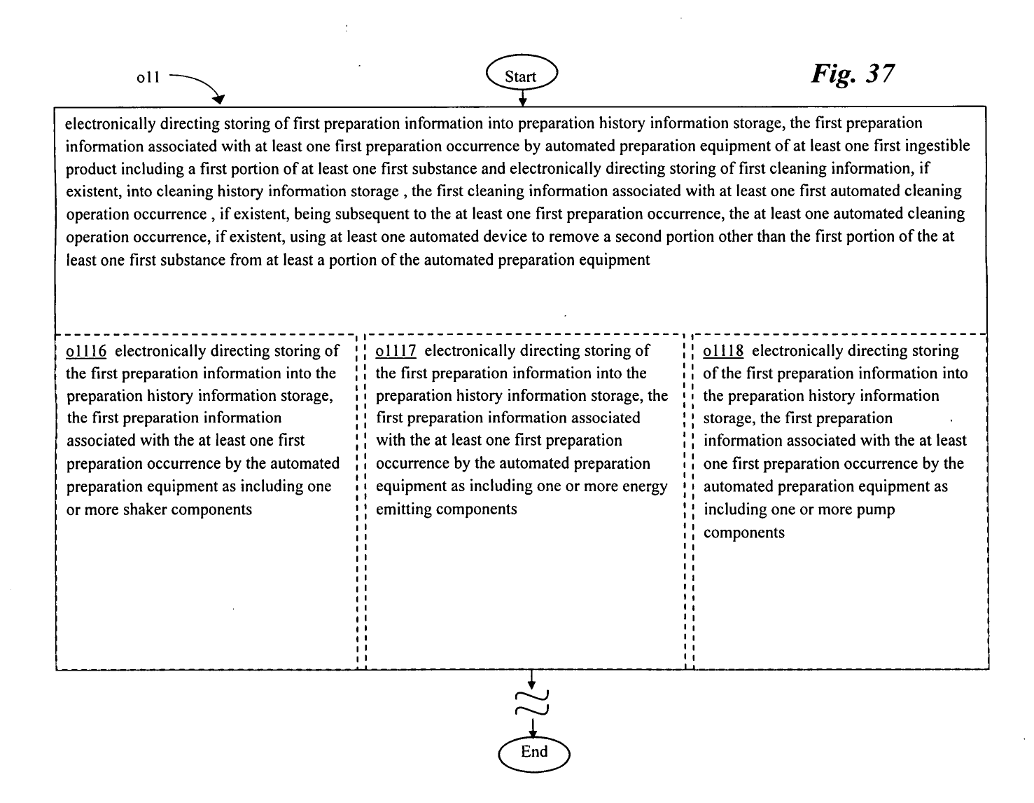

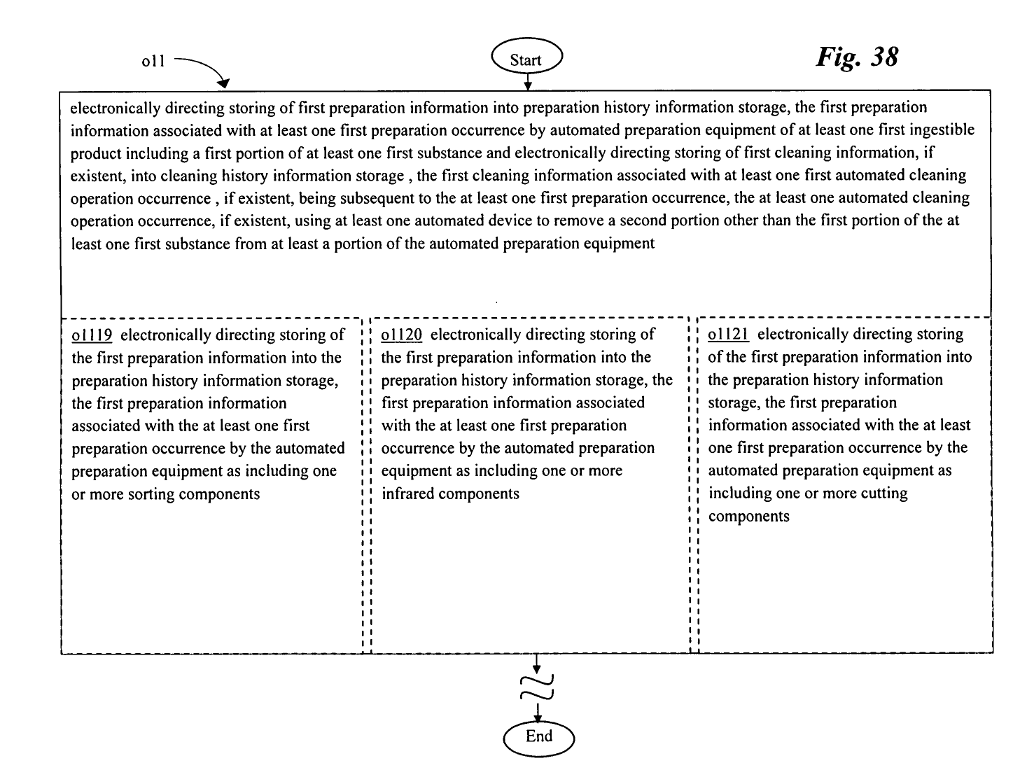

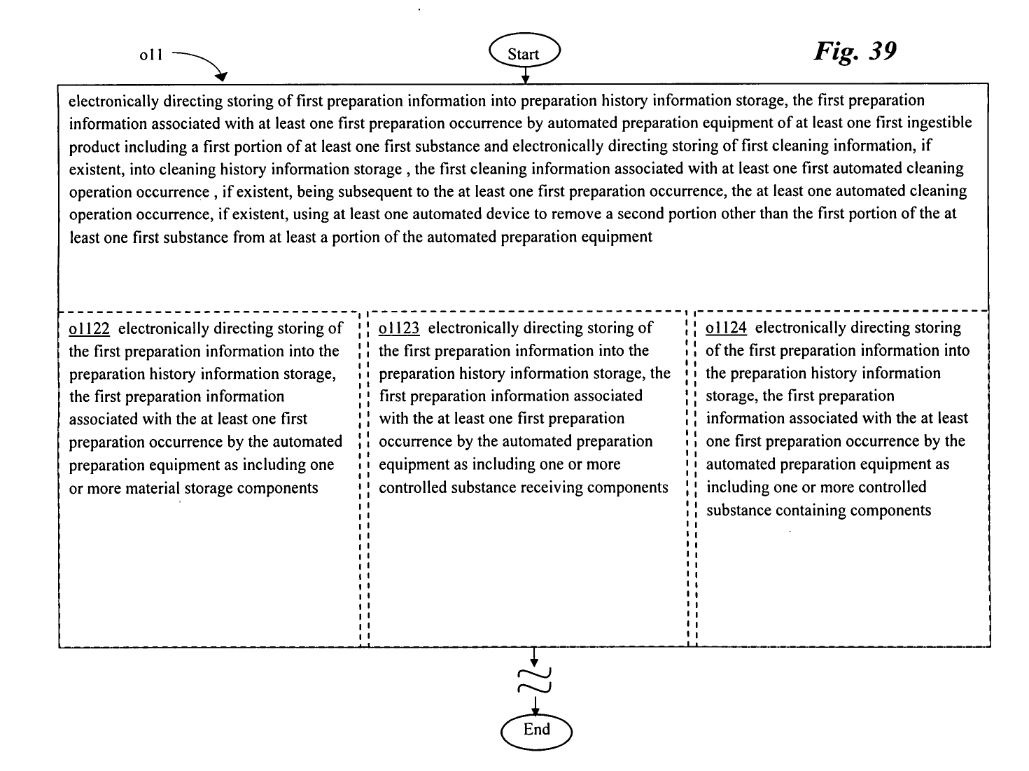

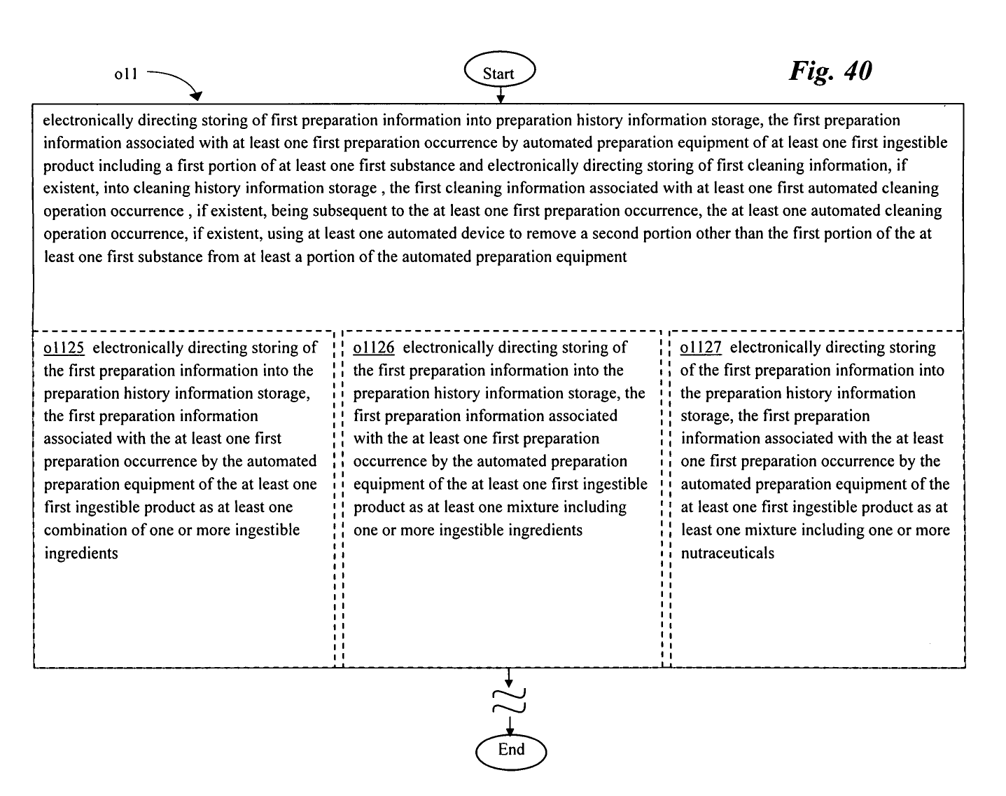

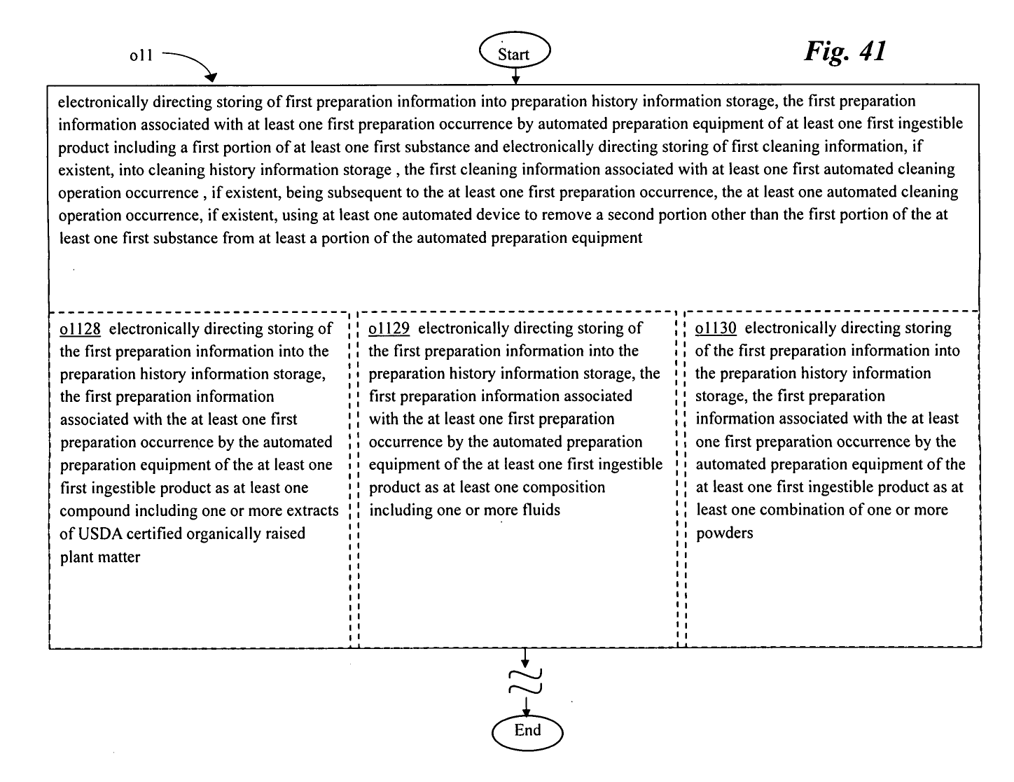

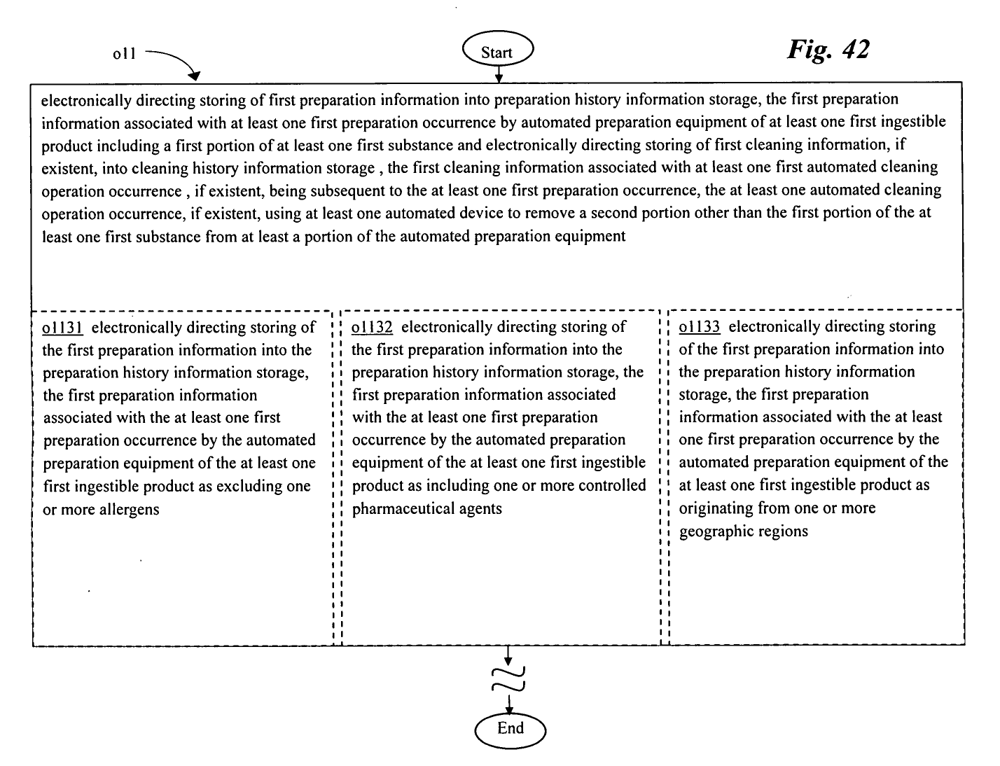

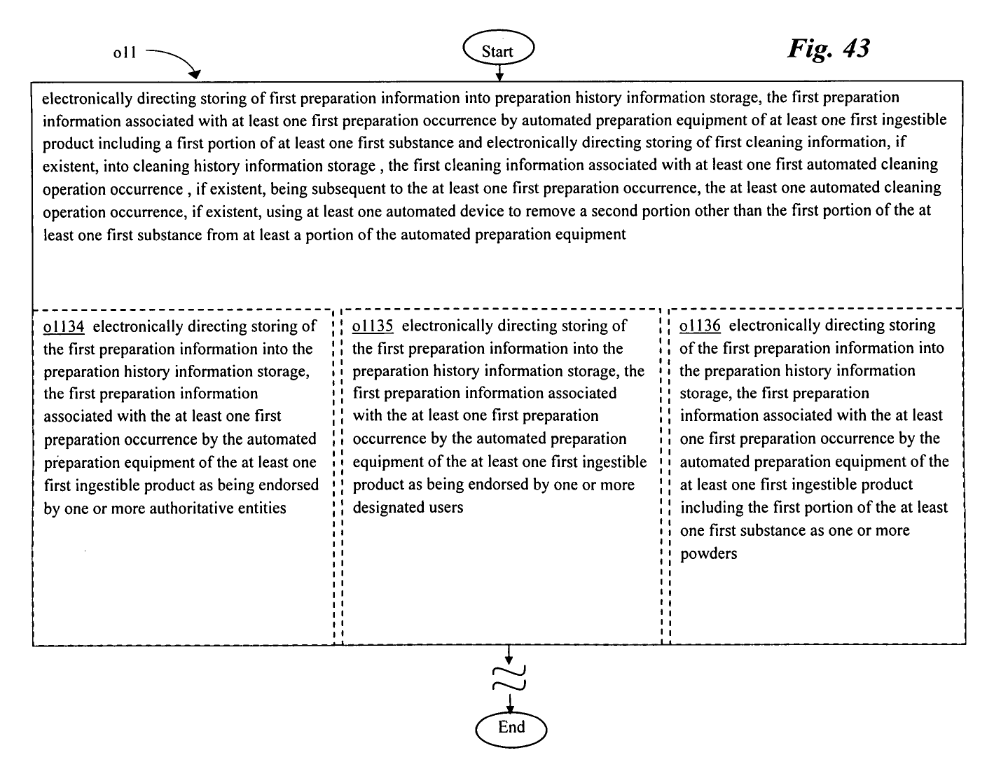

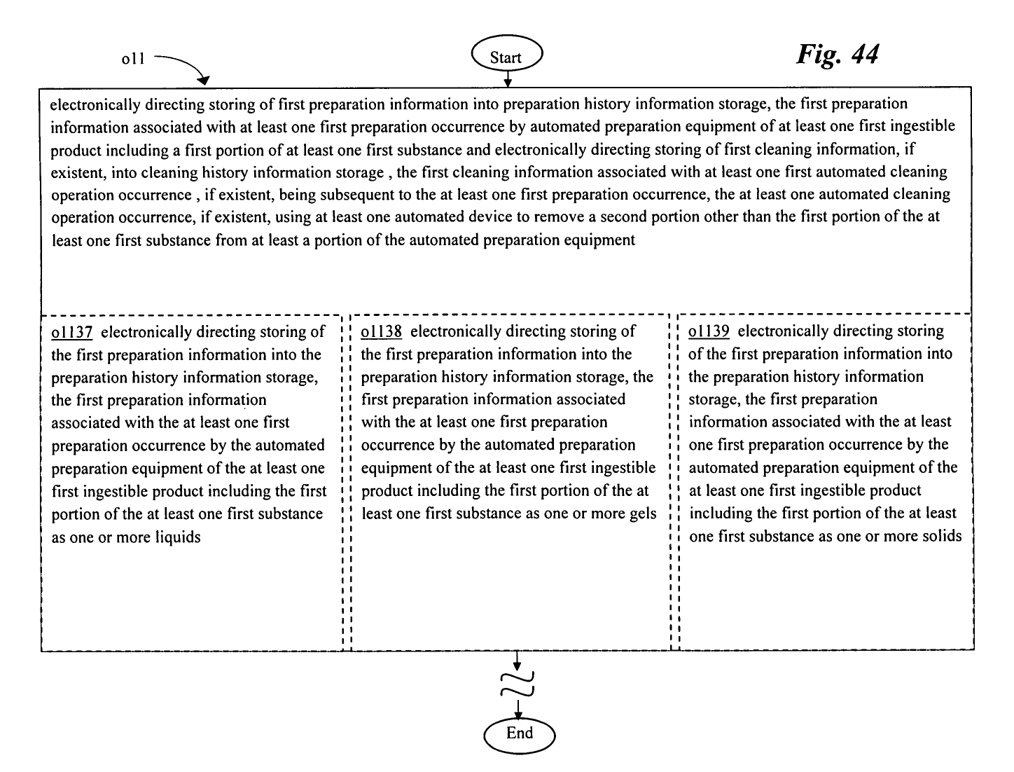

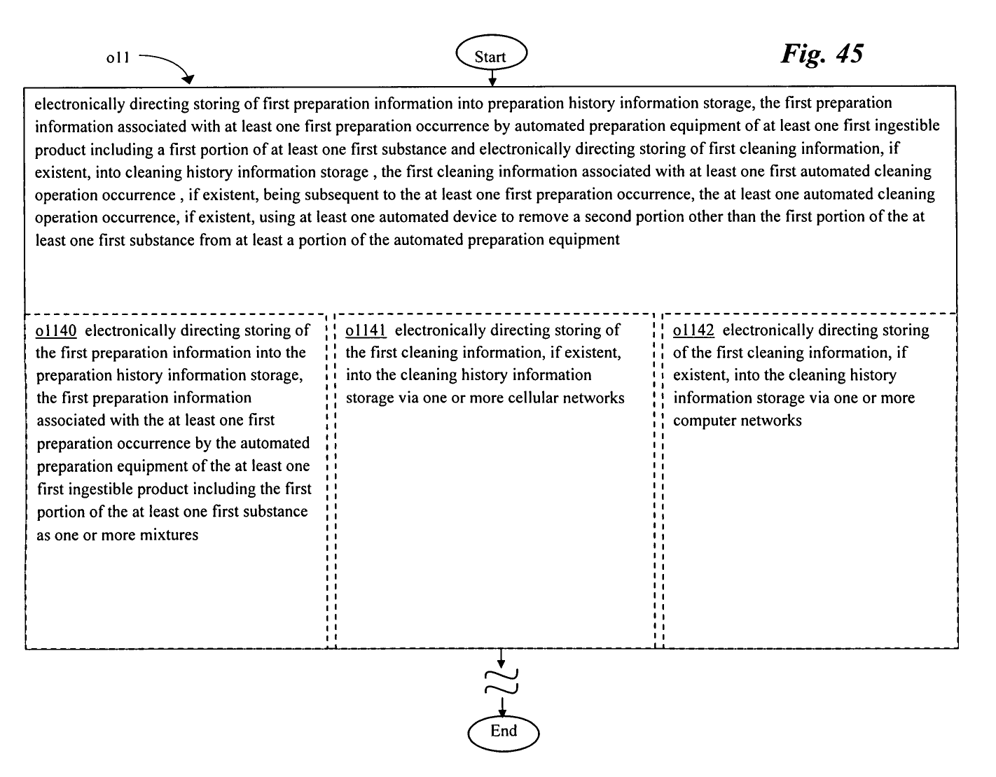

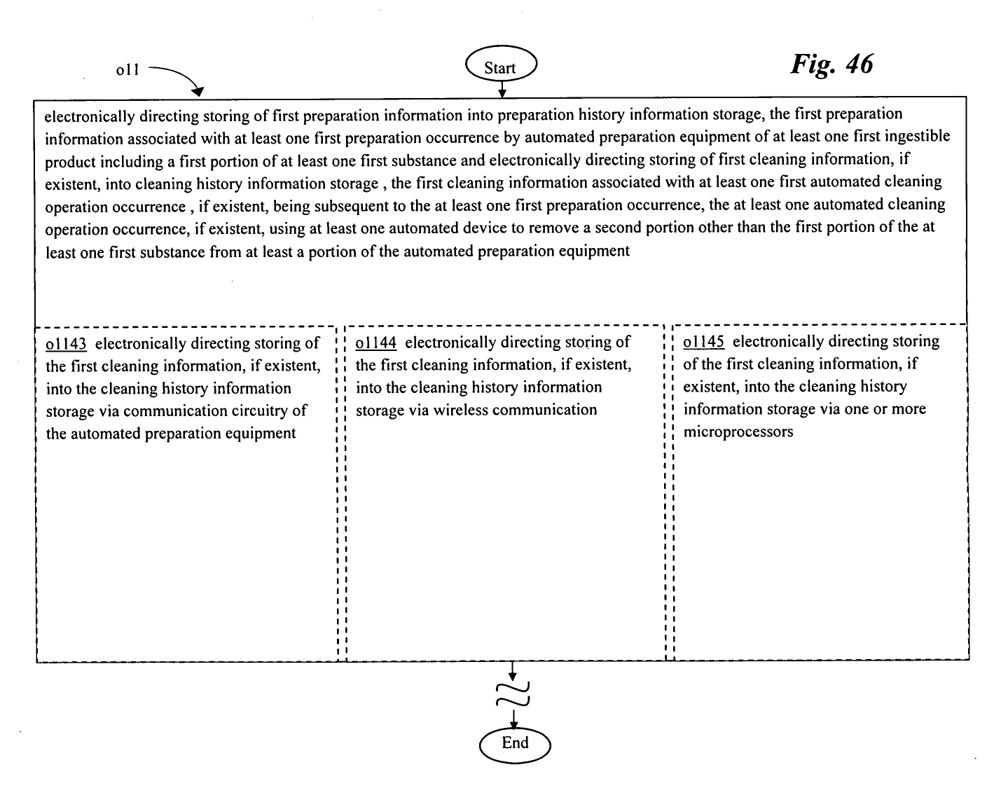

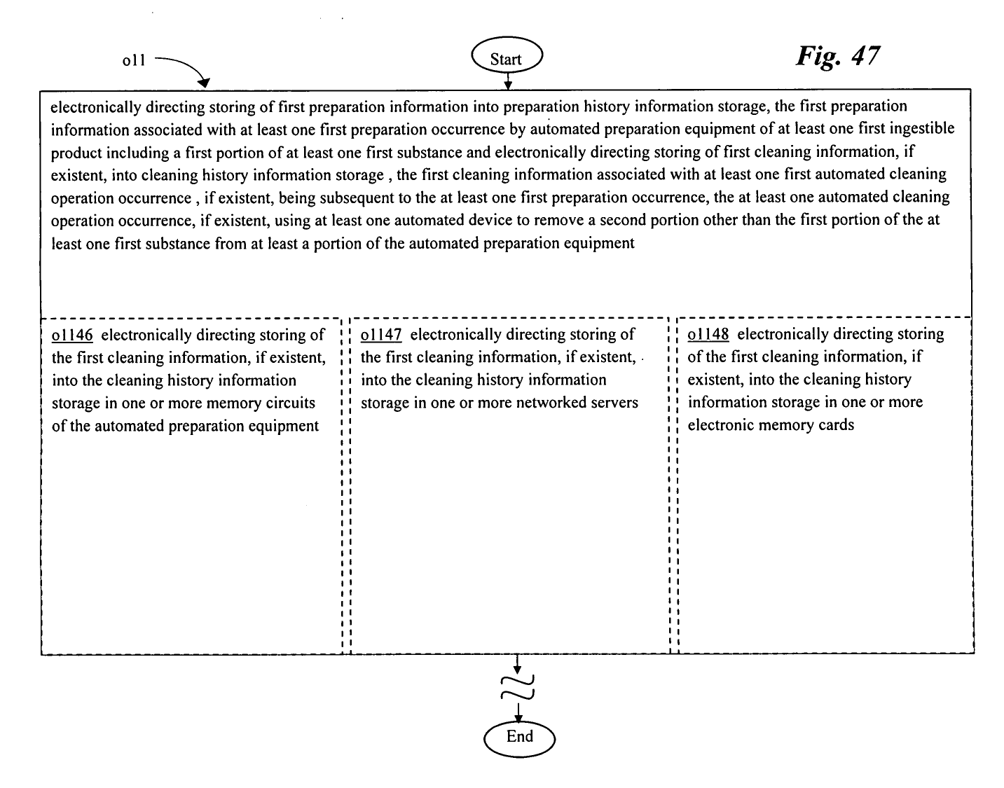

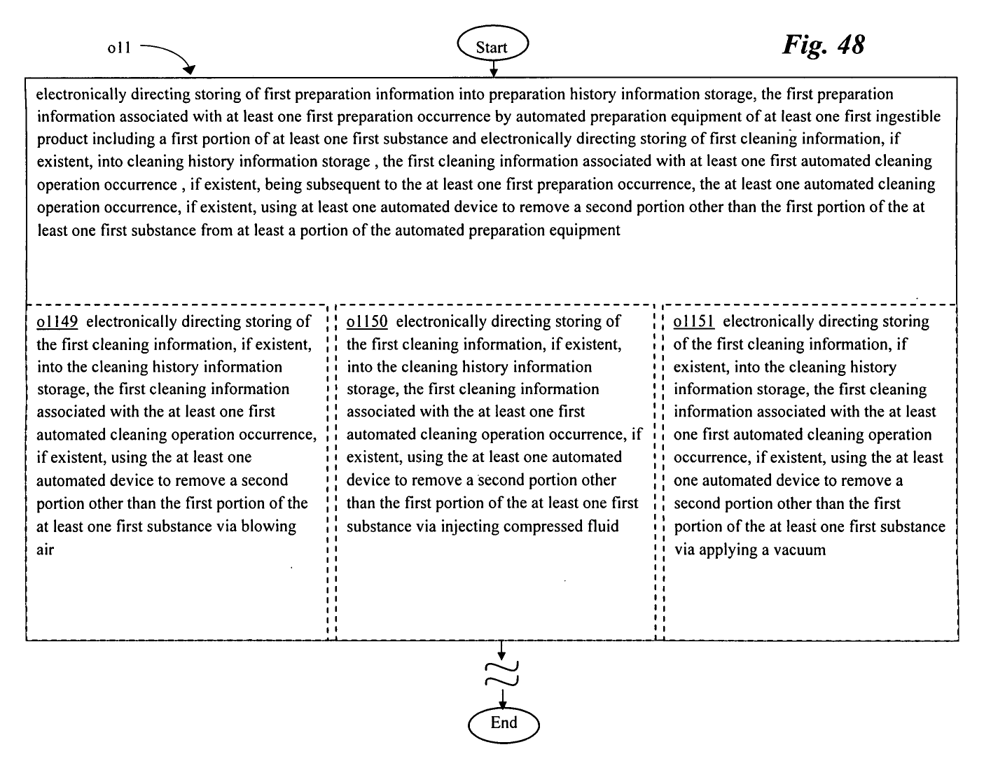

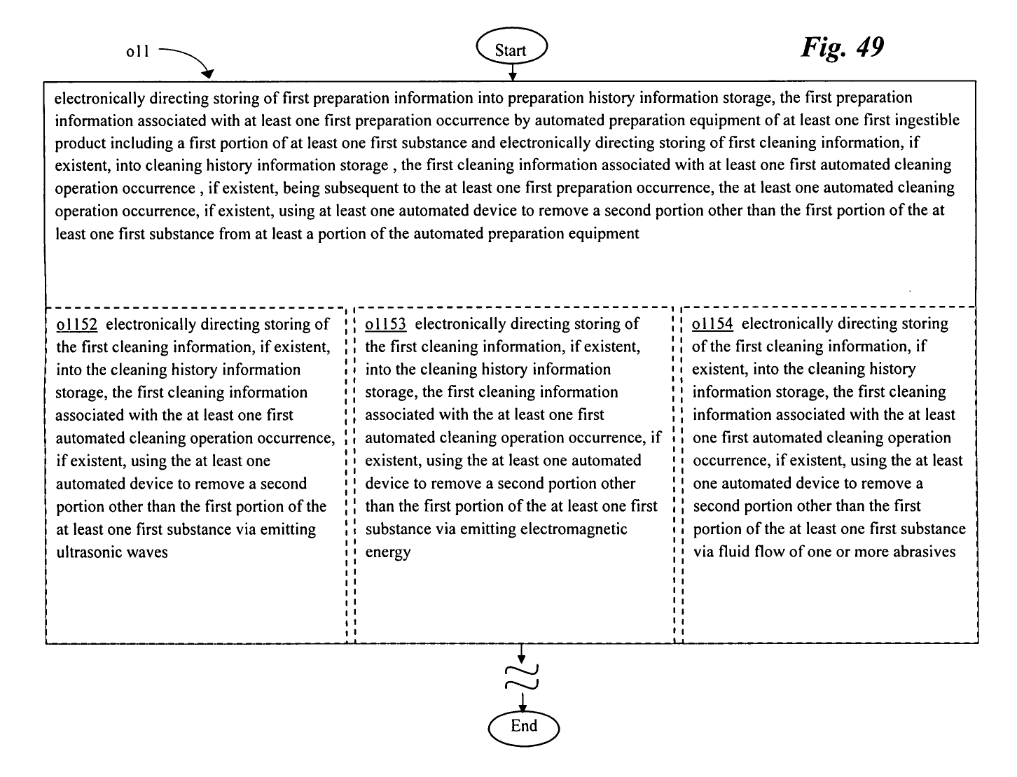

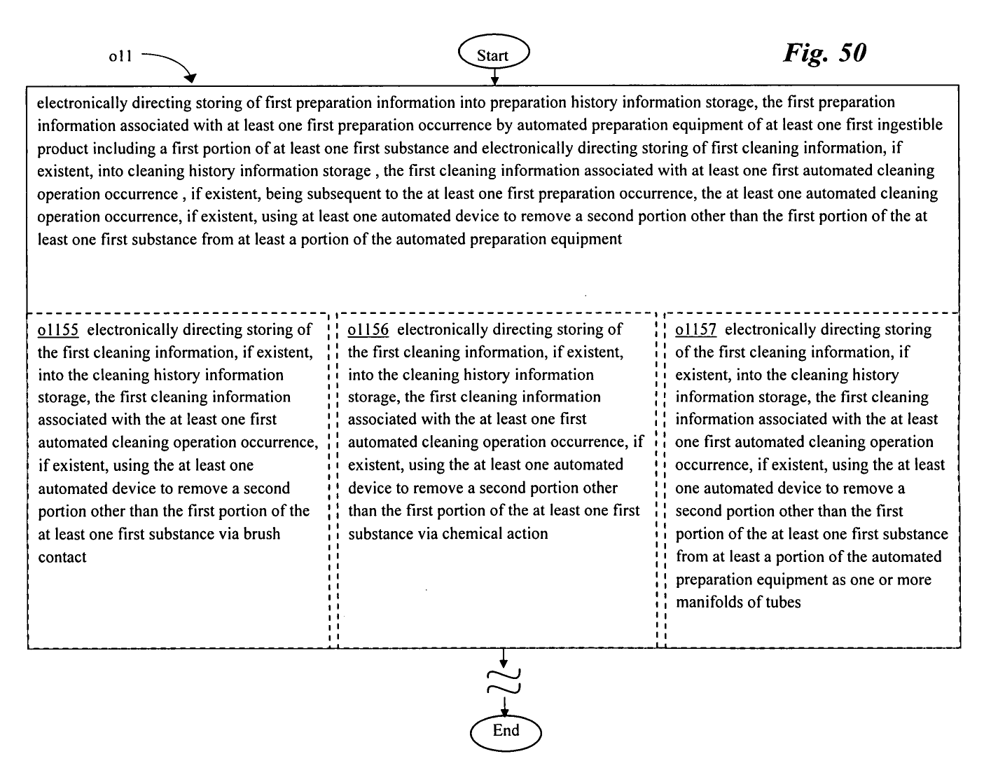

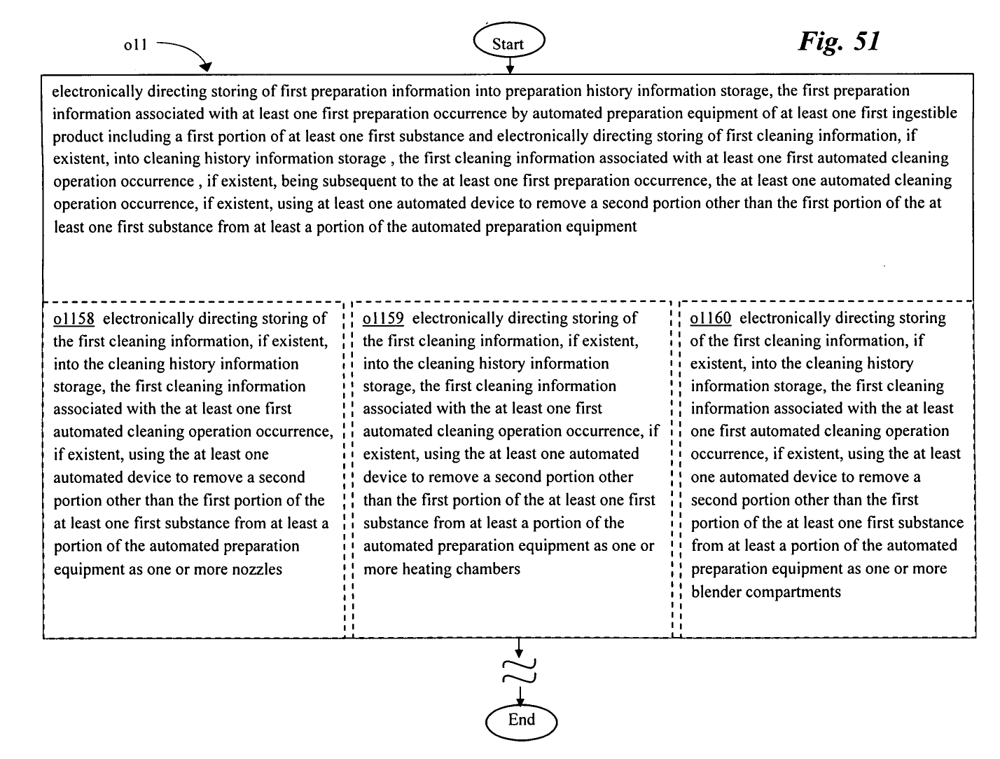

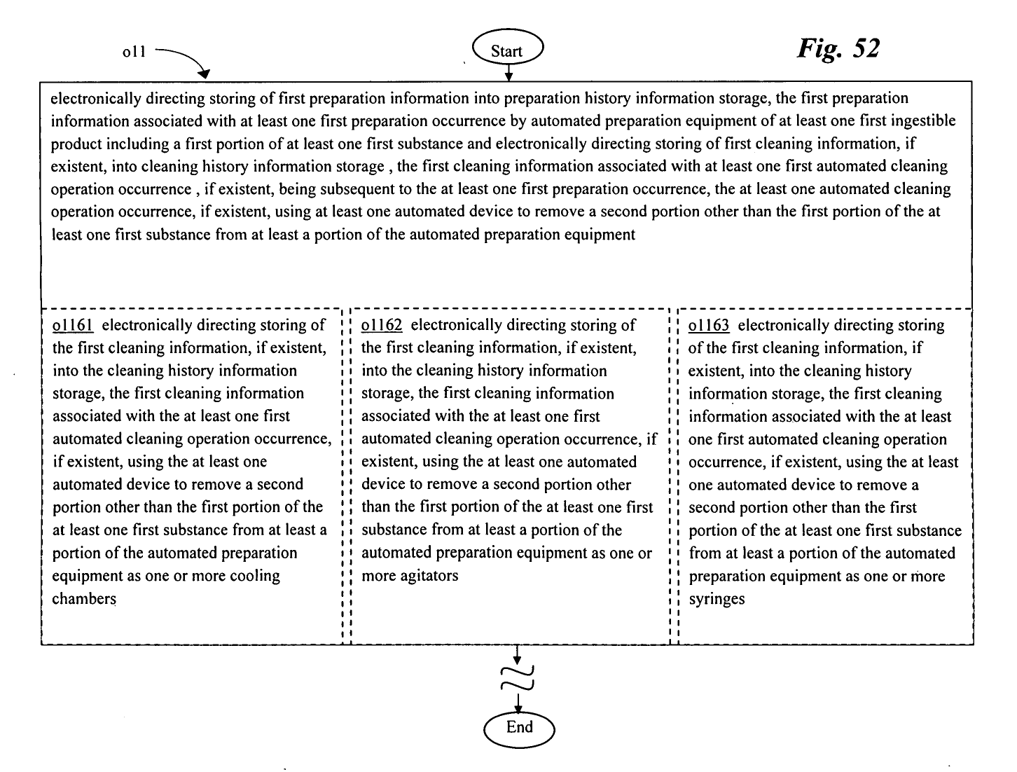

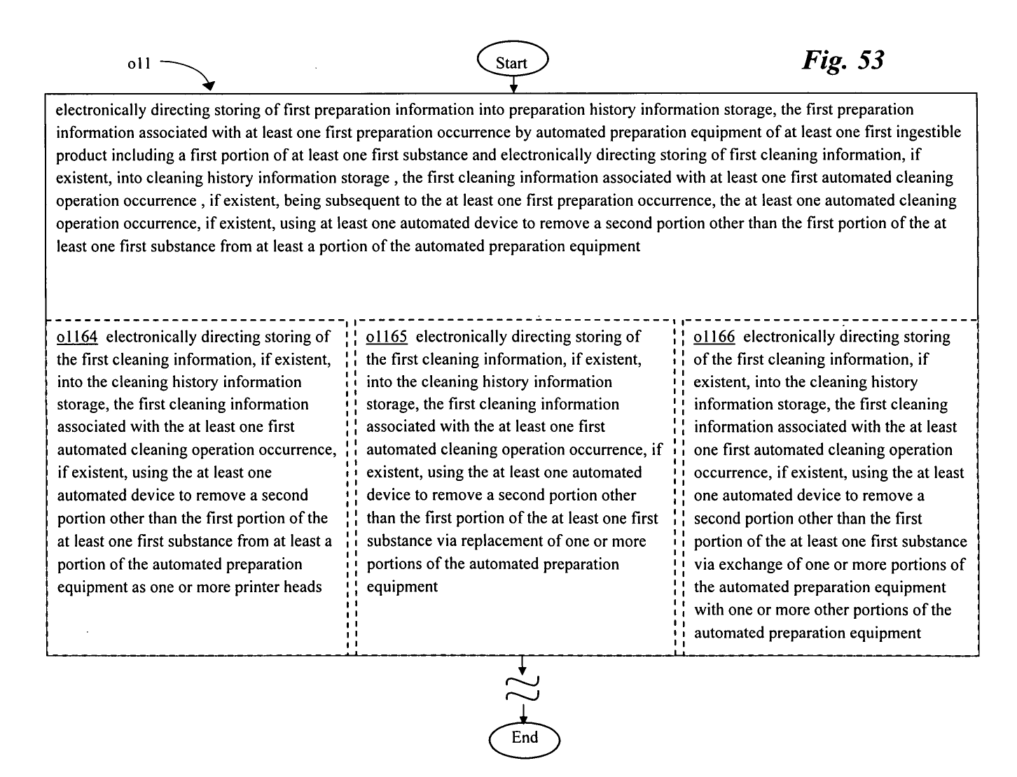

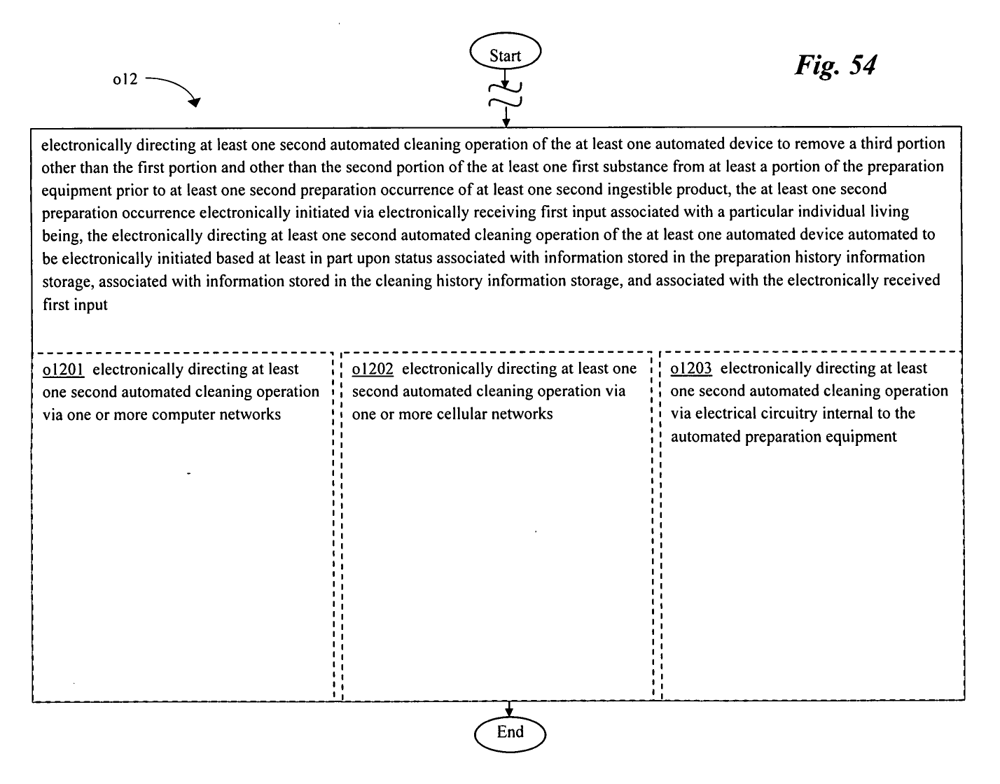

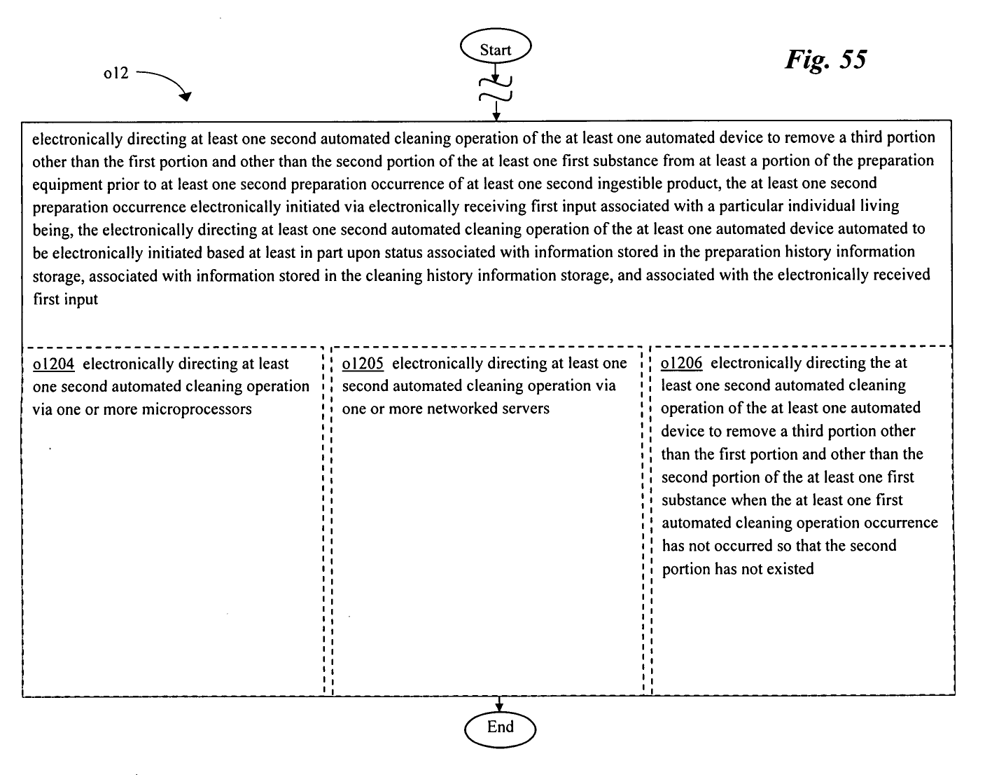

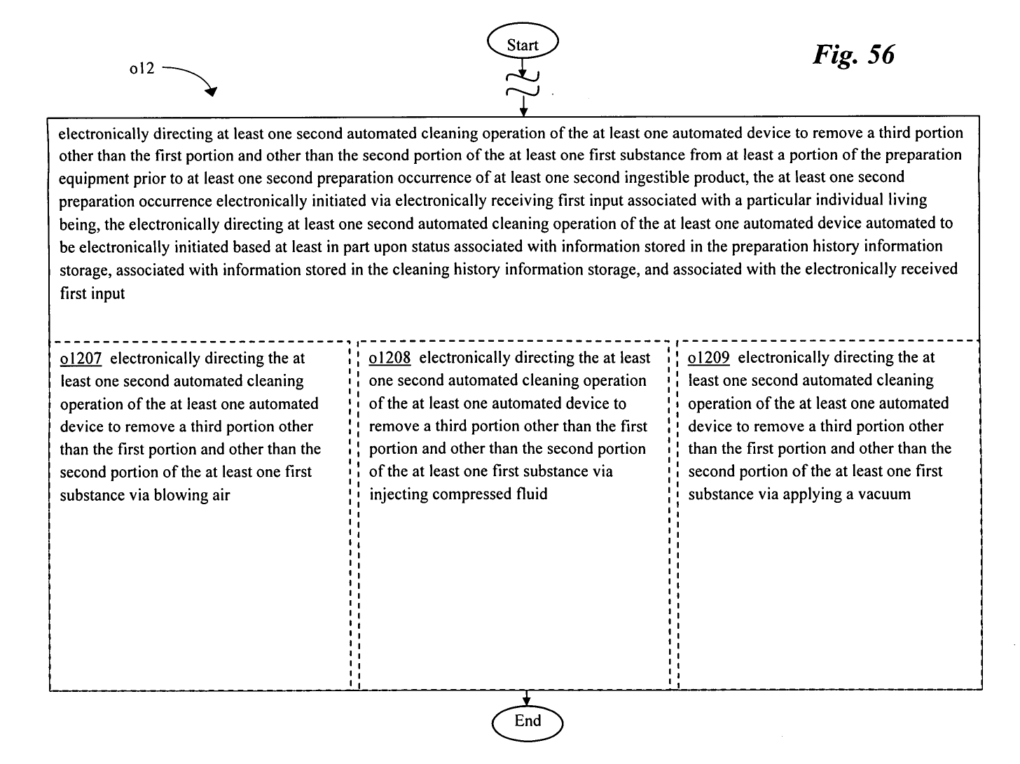

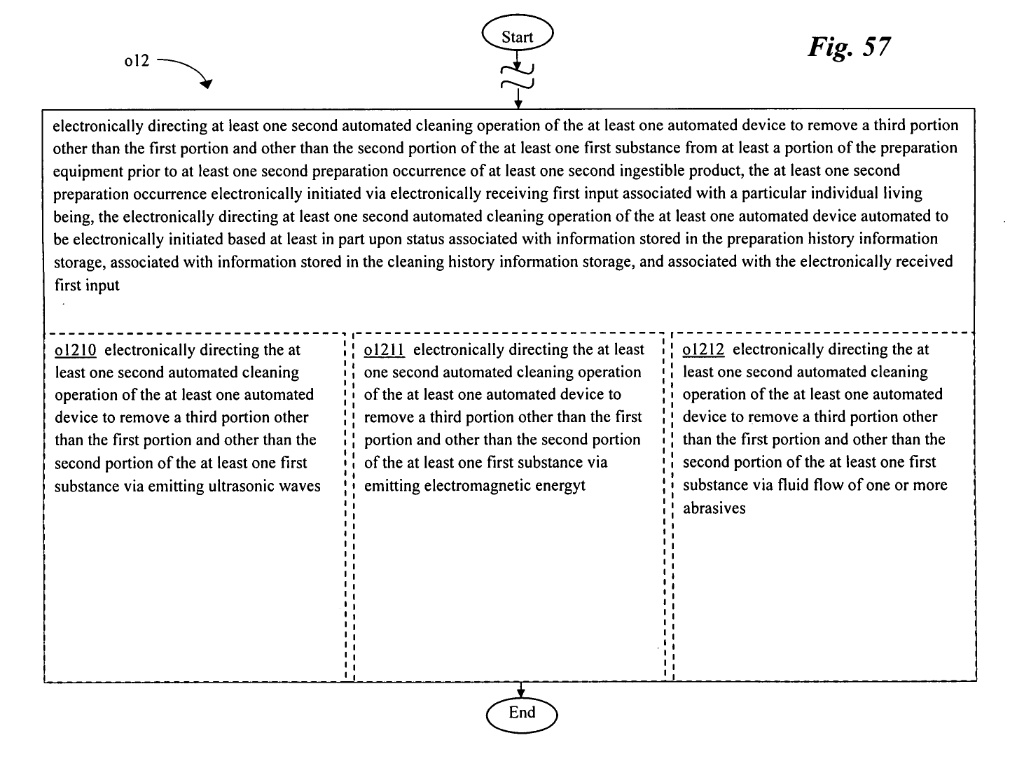

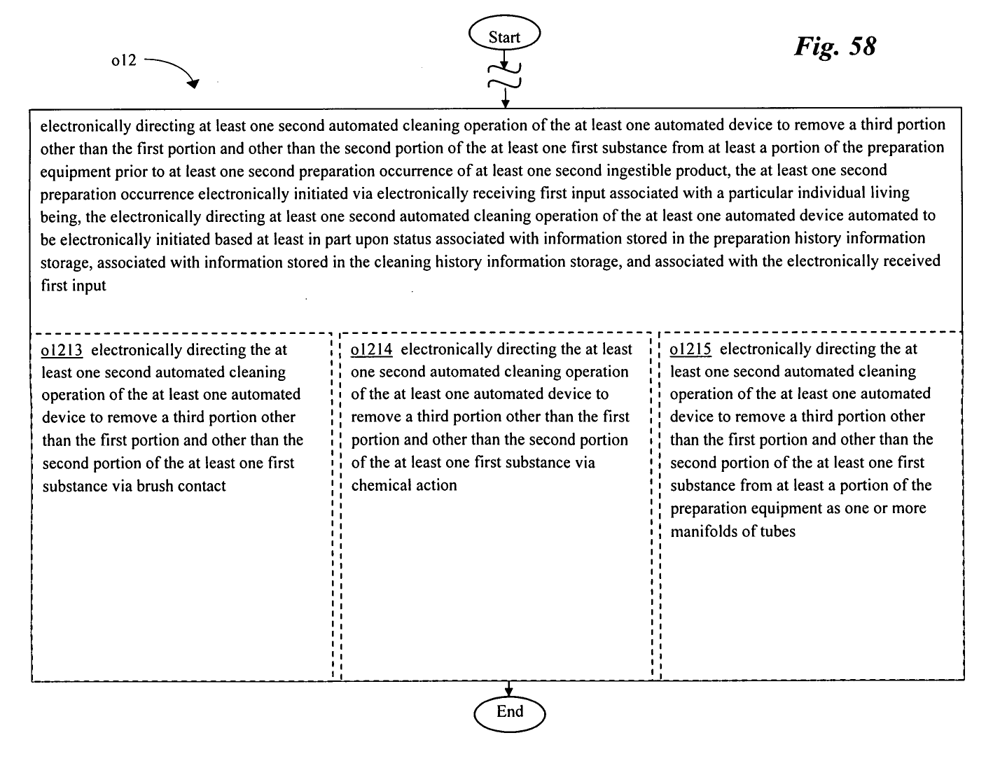

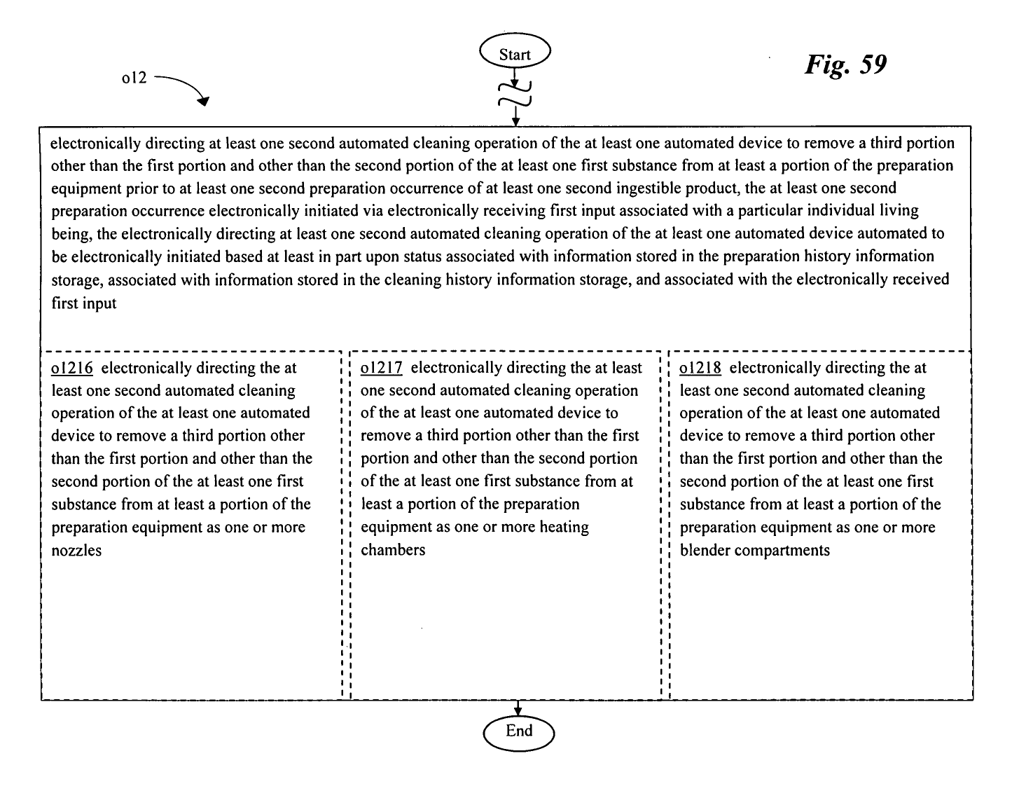

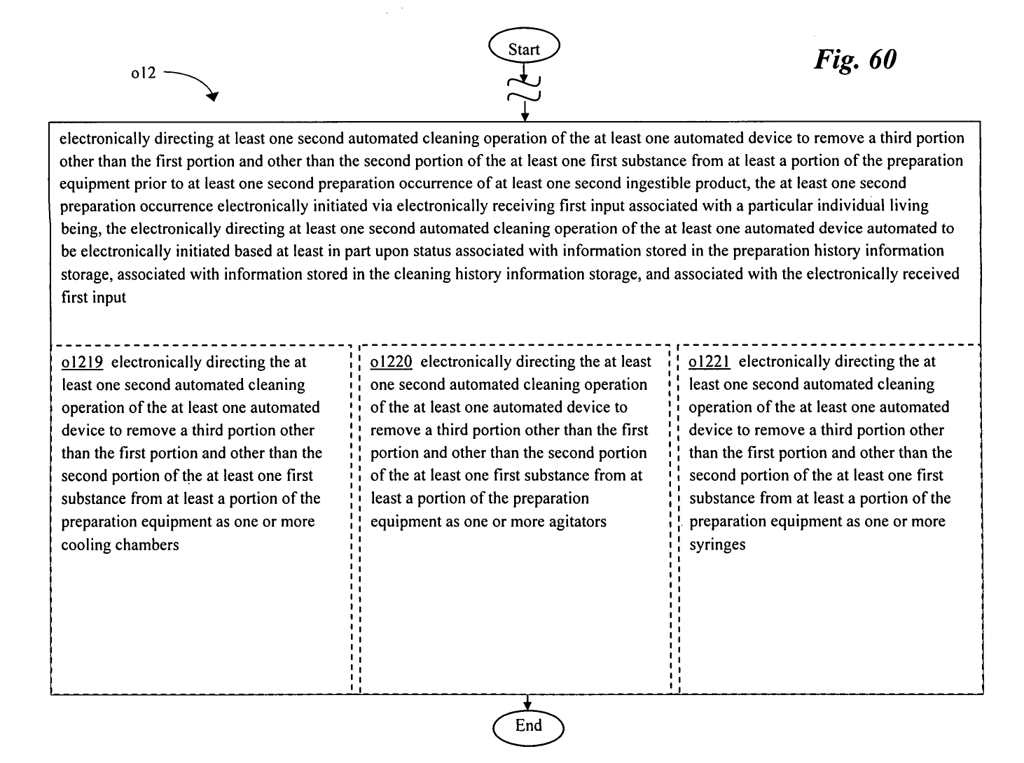

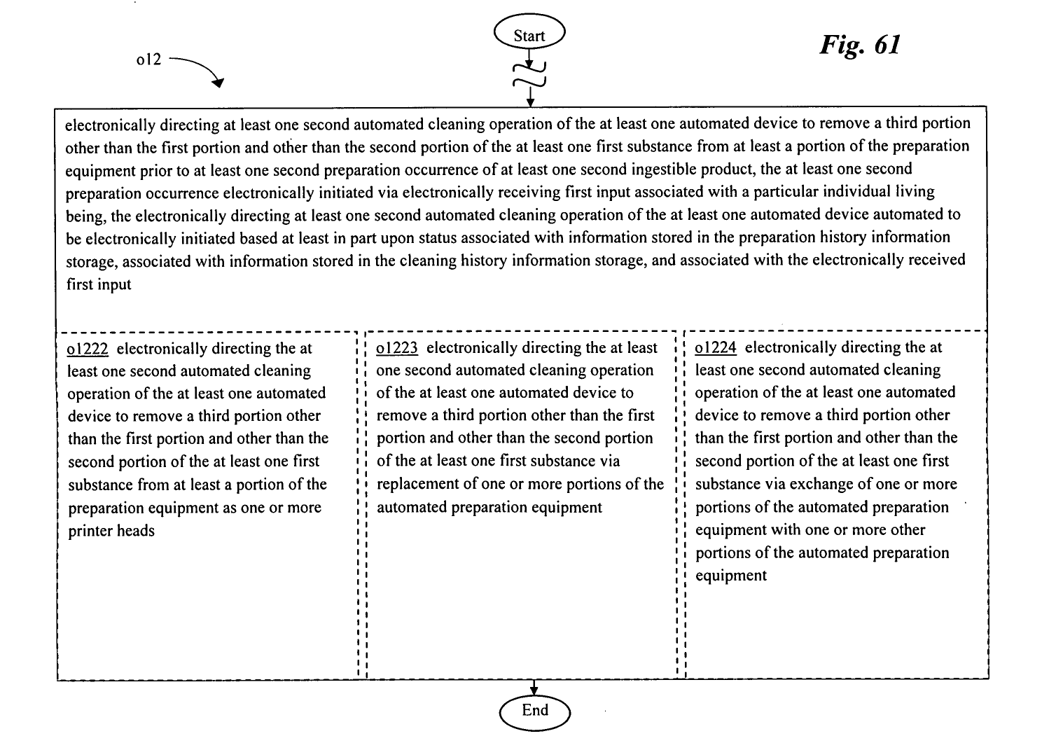

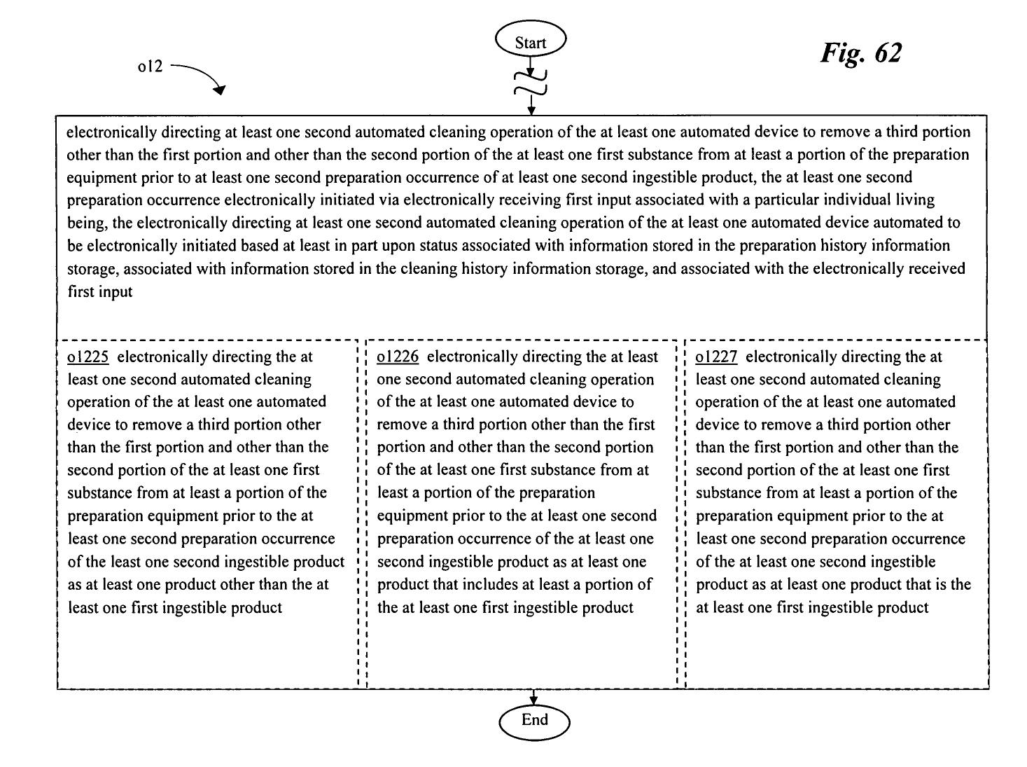

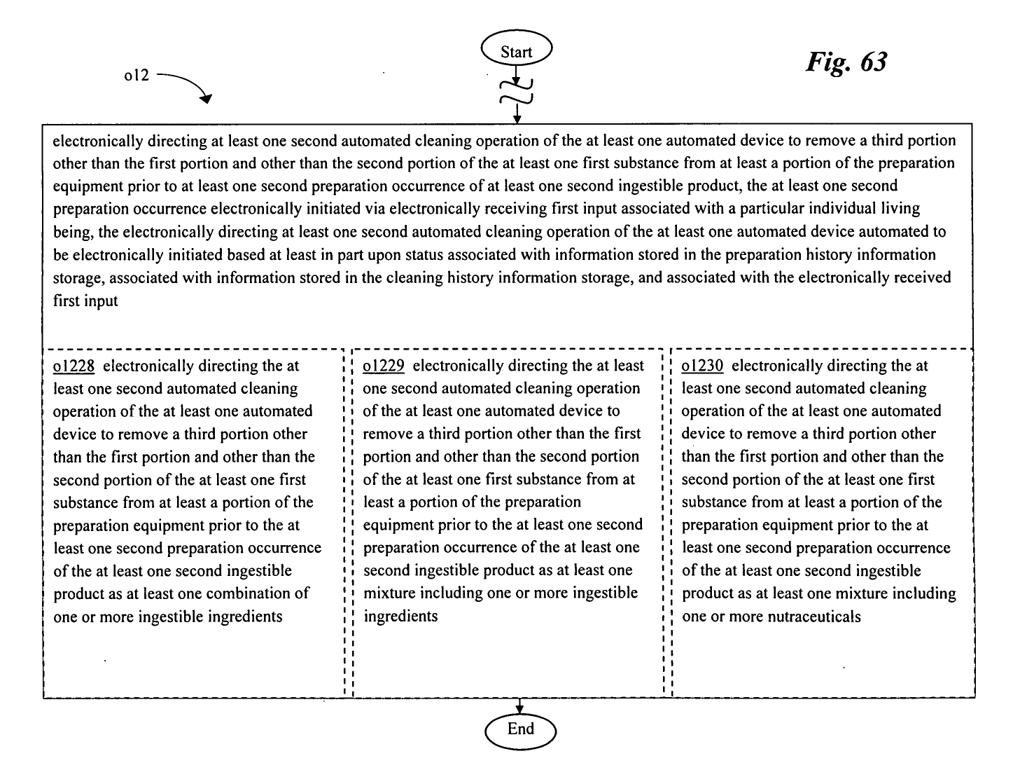

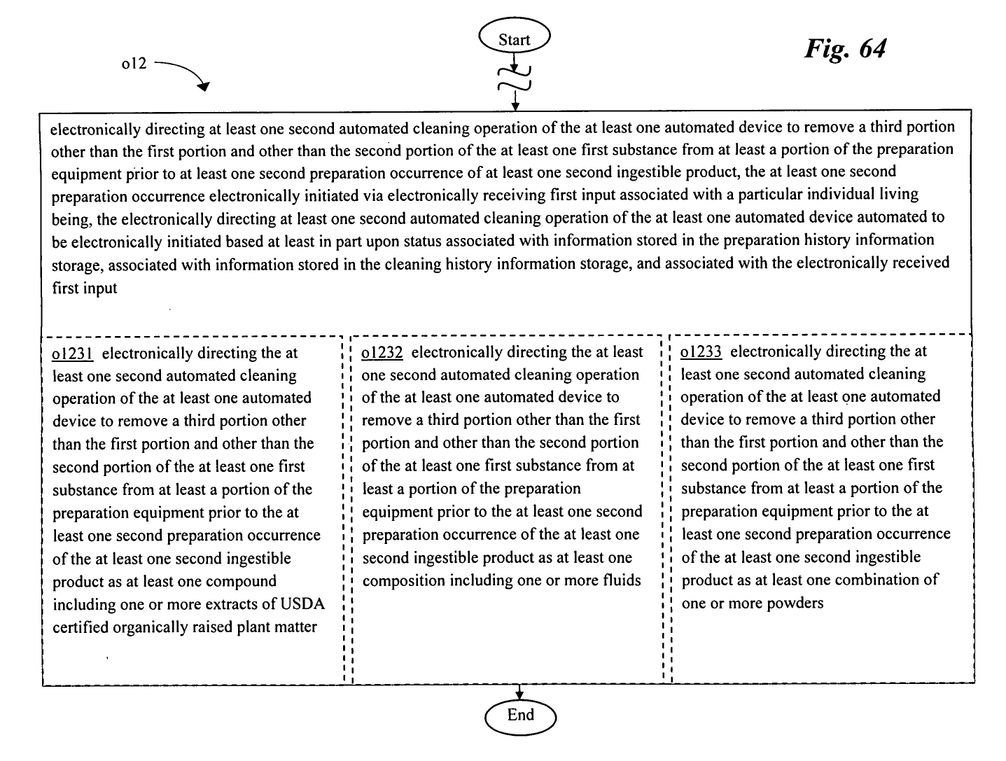

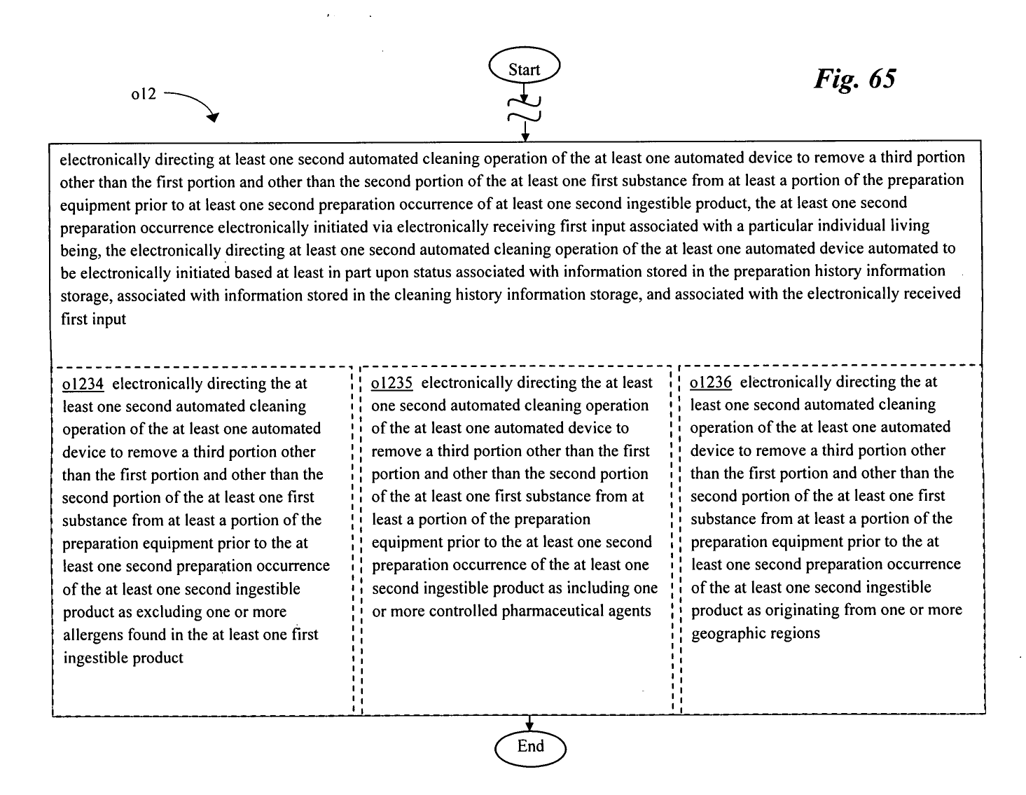

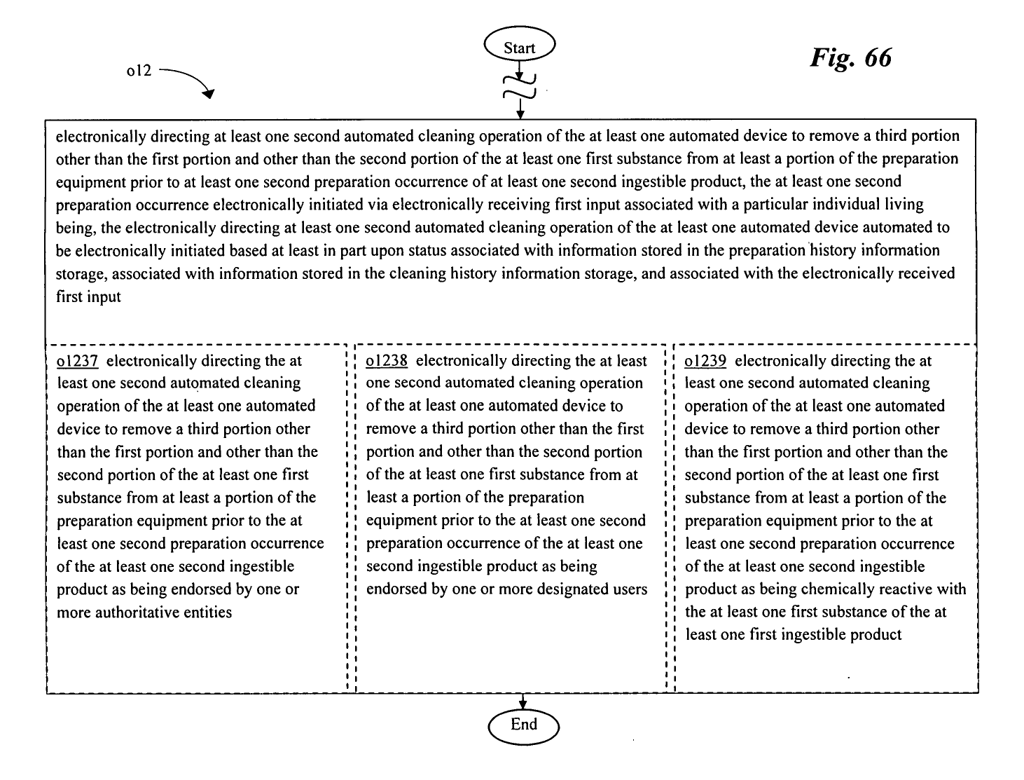

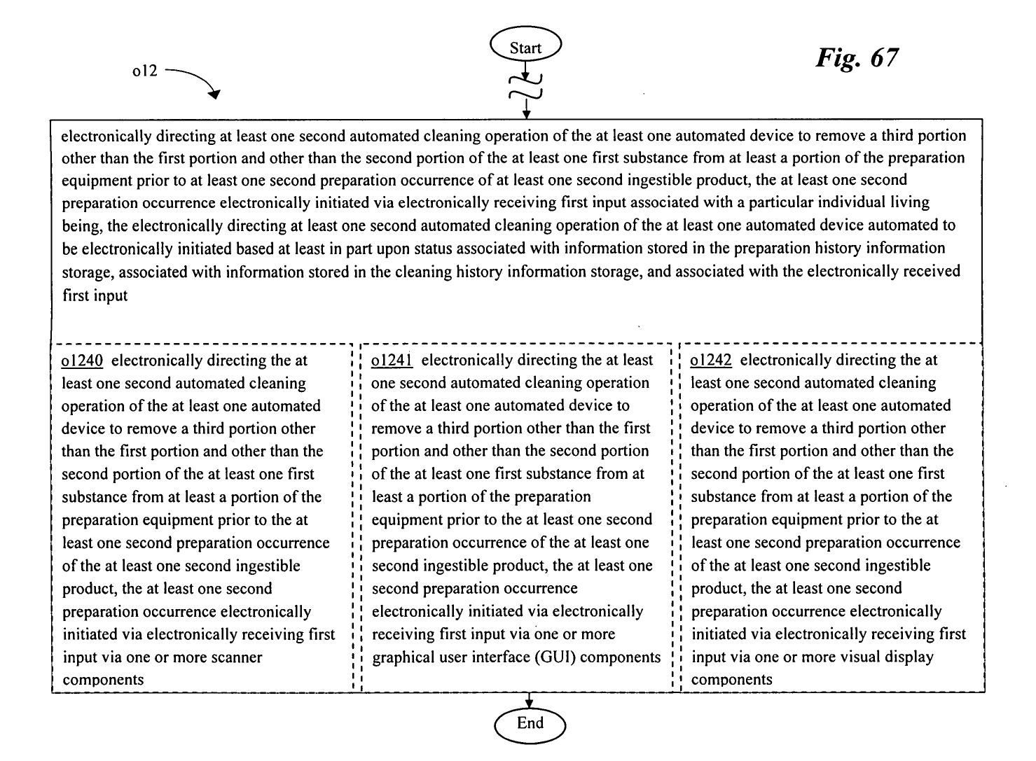

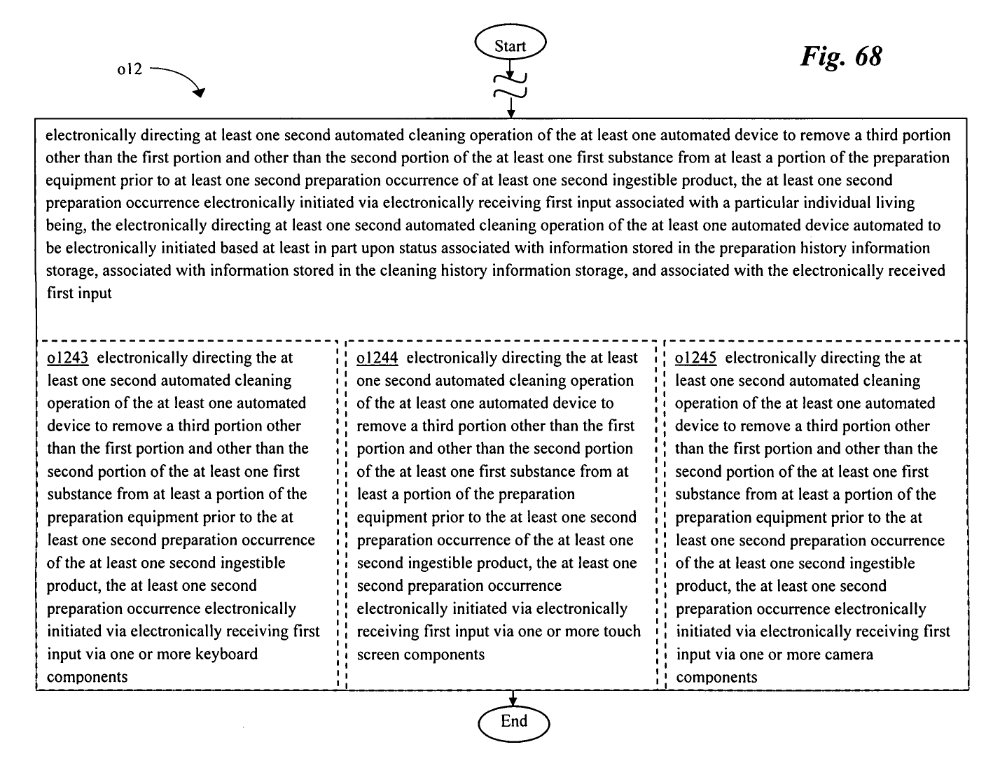

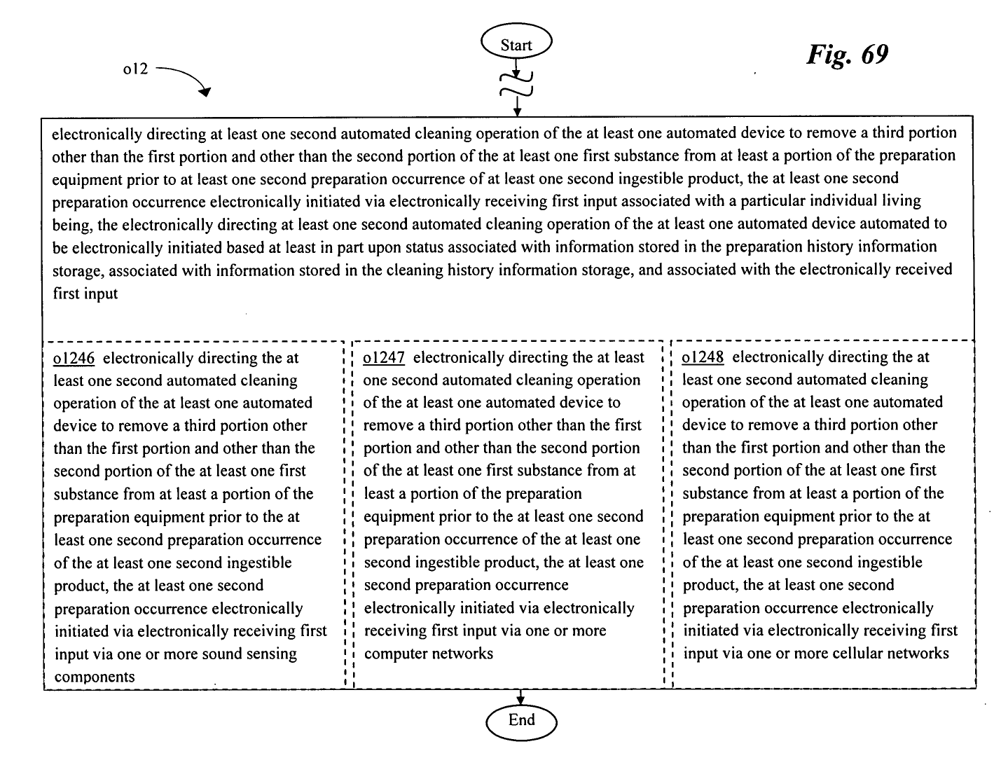

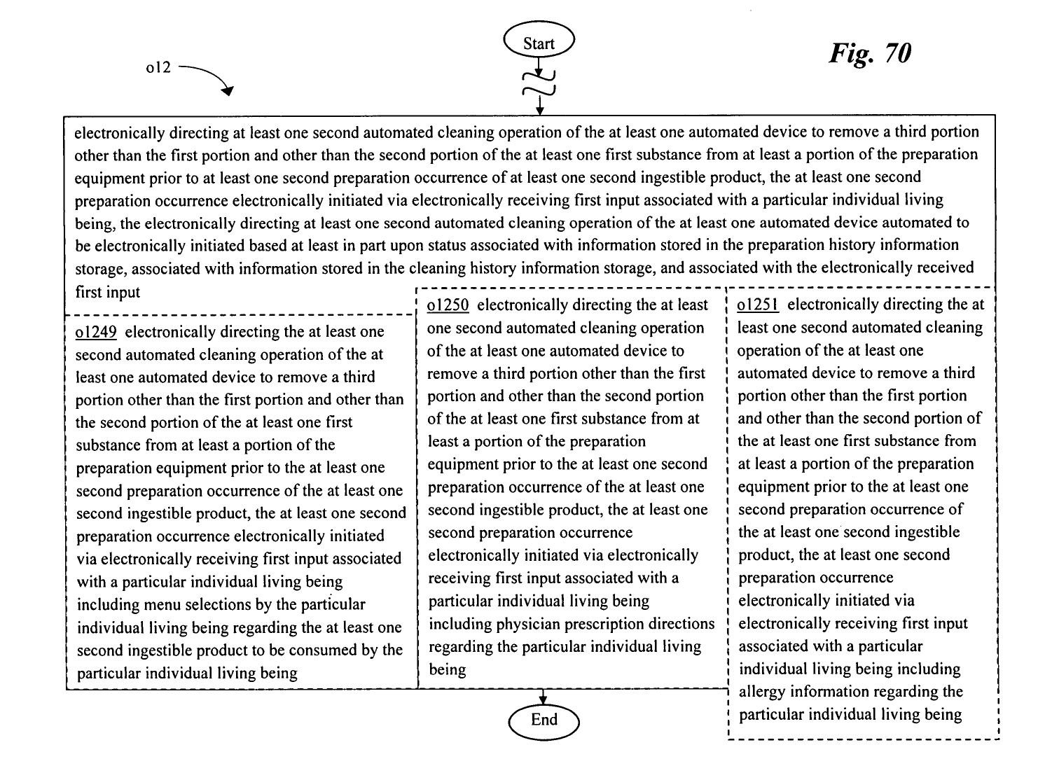

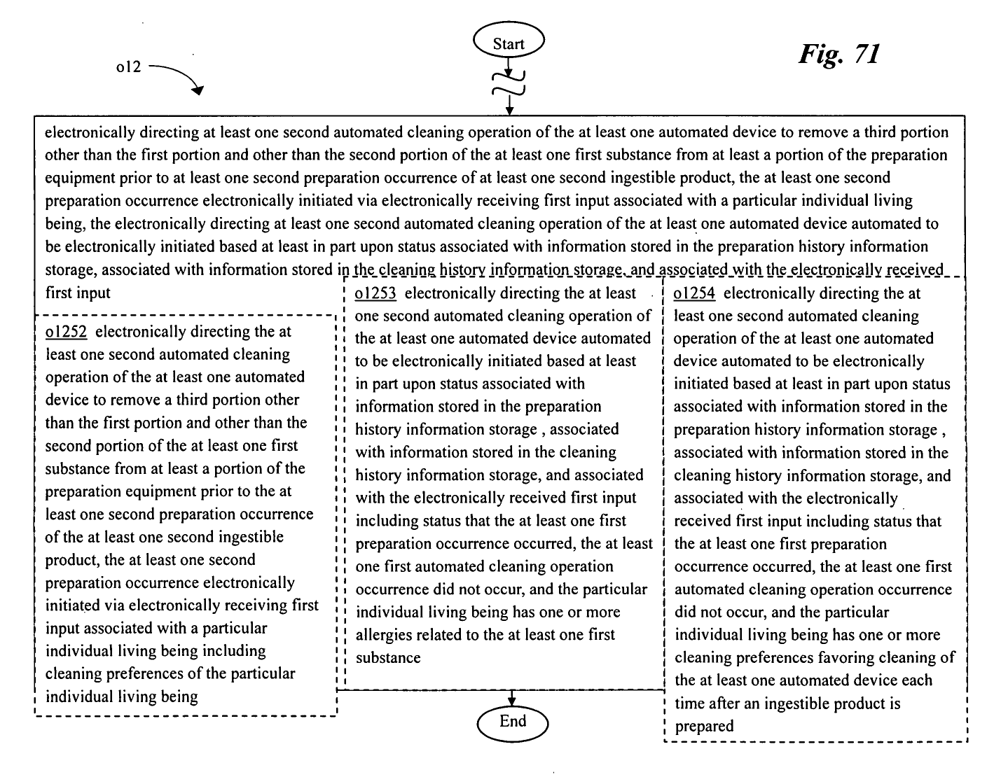

An exemplary implementation of the material processing subsystem s700 is shown in FIG. 15 to optionally include various components such as heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, and controlled substance containing assembly s738.

An exemplary implementation of the cleaning subsystem s800 is shown in FIG. 16 to optionally include various components such as air blower component s802, compressed fluid component s804, vacuum component s806, ultrasonic component s808, radiant energy component s810, abrasive component s812, brush component s814, squeegee brush component s816, pipe cleaner brush component s818, material flush abrasive component s820, fish tape system brush component s822, parts exchange component s824, parts replacement component s826, compressed air fluid component s828, compressed water fluid component s830, and chemical component s832.

Implementations involve different combinations (otherwise known as “electrical circuitry arrangements”) of components from the subsystems of the ingestible product preparation system 10. Exemplary depictions of some of these electrical circuitry arrangements are shown in FIG. 17 to include store and first clean electrical circuitry arrangement e11, store servers electrical circuitry arrangement e1101, store first preparation electrical circuitry arrangement e1102, store memory card electrical circuitry arrangement e1103, store first prior electrical circuitry arrangement e1104, store prior other electrical circuitry arrangement e1105, equipment heating electrical circuitry arrangement e1106, equipment cooling electrical circuitry arrangement e1107, equipment microwave electrical circuitry arrangement e1108, equipment laser electrical circuitry arrangement e1109, equipment LED electrical circuitry arrangement e1110, equipment peltier electrical circuitry arrangement e1111, equipment blending electrical circuitry arrangement e1112, equipment mixer electrical circuitry arrangement e1113, equipment acoustic electrical circuitry arrangement e1114, equipment stirring electrical circuitry arrangement e1115, equipment shaker electrical circuitry arrangement e1116, equipment energy electrical circuitry arrangement e1117, equipment pump electrical circuitry arrangement e1118, and equipment sorting electrical circuitry arrangement e1119.

Some of these electrical circuitry arrangements are depicted in FIG. 18 to include equipment infrared electrical circuitry arrangement e1120, equipment cutting electrical circuitry arrangement e1121, equipment material electrical circuitry arrangement e1122, equipment receiving electrical circuitry arrangement e1123, equipment containing electrical circuitry arrangement e1124, combination ingredients electrical circuitry arrangement e1125, mixture ingredients electrical circuitry arrangement e1126, mixture nutraceuticals electrical circuitry arrangement e1127, compound organic electrical circuitry arrangement e1128, composition fluids electrical circuitry arrangement e1129, combination powders electrical circuitry arrangement e1130, excluding allergens electrical circuitry arrangement e113, pharmaceutical agents electrical circuitry arrangement e1132, geographic regions electrical circuitry arrangement e1133, authoritative entities electrical circuitry arrangement e1134, designated users electrical circuitry arrangement e1135, substance powders electrical circuitry arrangement e1136, substance liquids electrical circuitry arrangement e1137, substance gel electrical circuitry arrangement e1138, and substance solids electrical circuitry arrangement e1139.

Some of these electrical circuitry arrangements are depicted in FIG. 19 to include substance mixtures electrical circuitry arrangement e1140, cleaning cellular electrical circuitry arrangement e1141, cleaning network electrical circuitry arrangement e1142, cleaning circuitry electrical circuitry arrangement e1143, cleaning wireless electrical circuitry arrangement e1144, cleaning microprocessor electrical circuitry arrangement e1145, cleaning memory electrical circuitry arrangement e1146, cleaning servers electrical circuitry arrangement e1147, cleaning card electrical circuitry arrangement e1148, cleaning blowing electrical circuitry arrangement e1149, cleaning compressed electrical circuitry arrangement e1150, cleaning vacuum electrical circuitry arrangement e1151, cleaning ultrasonic electrical circuitry arrangement e1152, cleaning electromagnetic electrical circuitry arrangement e1153, cleaning abrasives electrical circuitry arrangement e1154, cleaning brush electrical circuitry arrangement e1155, cleaning chemical electrical circuitry arrangement e1156, cleaning tubes electrical circuitry arrangement e1157, cleaning nozzles electrical circuitry arrangement e1158, and cleaning heating electrical circuitry arrangement e1159.

Some of these electrical circuitry arrangements are depicted in FIG. 20 to include cleaning blender electrical circuitry arrangement e1160, cleaning cooling electrical circuitry arrangement e1161, cleaning agitator electrical circuitry arrangement e1162, cleaning syringe electrical circuitry arrangement e1163, cleaning head electrical circuitry arrangement e1164, cleaning replacement electrical circuitry arrangement e1165, and cleaning exchange electrical circuitry arrangement e1166.

Some of these electrical circuitry arrangements are depicted in FIG. 21 to include second clean electrical circuitry arrangement e12, cleaning network electrical circuitry arrangement e1201, cleaning cellular electrical circuitry arrangement e1202, cleaning circuitry electrical circuitry arrangement e1203, cleaning microprocessors electrical circuitry arrangement e1204, cleaning servers electrical circuitry arrangement e1205, cleaning not existed electrical circuitry arrangement e1206, cleaning blowing electrical circuitry arrangement e1207, cleaning compressed electrical circuitry arrangement e1208, cleaning vacuum electrical circuitry arrangement e1209, cleaning ultrasonic electrical circuitry arrangement e1210, cleaning electromagnetic electrical circuitry arrangement e1211, and cleaning abrasives electrical circuitry arrangement e1212, cleaning brush electrical circuitry arrangement e1213, cleaning chemical electrical circuitry arrangement e1214, cleaning tubes electrical circuitry arrangement e1215, cleaning nozzles electrical circuitry arrangement e1216, cleaning heating electrical circuitry arrangement e1217, cleaning blender electrical circuitry arrangement e1218, and cleaning cooling electrical circuitry arrangement e1219.

Some of these electrical circuitry arrangements are depicted in FIG. 22 to include cleaning agitator electrical circuitry arrangement e1220, cleaning syringe electrical circuitry arrangement e1221, cleaning head electrical circuitry arrangement e1222, cleaning replacement electrical circuitry arrangement e1223, cleaning exchange electrical circuitry arrangement e1224, cleaning other electrical circuitry arrangement e1225, cleaning includes electrical circuitry arrangement e1226, cleaning first electrical circuitry arrangement e1227, cleaning combination electrical circuitry arrangement e1228, cleaning mixture electrical circuitry arrangement e1229, cleaning nutraceuticals electrical circuitry arrangement e1230, cleaning organic electrical circuitry arrangement e123, cleaning fluids electrical circuitry arrangement e1232, cleaning powders electrical circuitry arrangement e1233, cleaning allergens electrical circuitry arrangement e1234, cleaning agents electrical circuitry arrangement e1235, cleaning regions electrical circuitry arrangement e1236, cleaning authoritative electrical circuitry arrangement e1237, cleaning designated electrical circuitry arrangement e1238, and cleaning reactive electrical circuitry arrangement e1239.

Some of these electrical circuitry arrangements are depicted in FIG. 23 to include cleaning receiving electrical circuitry arrangement e1240, cleaning GUI electrical circuitry arrangement e1241, cleaning display electrical circuitry arrangement e1242, cleaning keyboard electrical circuitry arrangement e1243, cleaning screen electrical circuitry arrangement e1244, cleaning camera electrical circuitry arrangement e1245, cleaning sound electrical circuitry arrangement e1246, cleaning network electrical circuitry arrangement e1247, cleaning cellular electrical circuitry arrangement e1248, cleaning menu electrical circuitry arrangement e1249, cleaning prescription electrical circuitry arrangement e1250, cleaning allergy electrical circuitry arrangement e1251, cleaning preferences electrical circuitry arrangement e1252, cleaning allergies electrical circuitry arrangement e1253, and cleaning each electrical circuitry arrangement e1254.

In implementations one or more instructions are stored and/or otherwise borne in various subsystems, components, and/or accessories of the ingestible product preparation system 10 such as being borne in a non-transitory signal bearing medium of information storage subsystem s200. One or more exemplary instructions depicted in FIG. 24 as being borne in an exemplary version of a non-transitory signal bearing medium of information storage subsystem s200 include one or more store and first clean instructions i11, one or more store servers instructions i1101, one or more store first preparation instructions i1102, one or more store memory card instructions i1103, one or more store first prior instructions i1104, one or more store prior other instructions i1105, one or more equipment heating instructions i1106, one or more equipment cooling instructions i1107, one or more equipment microwave instructions i1108, one or more equipment laser instructions i1109, one or more equipment LED instructions i1110, one or more equipment peltier instructions i1111, one or more equipment blending instructions i1112, one or more equipment mixer instructions i1113, one or more equipment acoustic instructions i1114, one or more equipment stirring instructions i1115, one or more equipment shaker instructions i1116, one or more equipment energy instructions i1117, one or more equipment pump instructions i1118, and one or more equipment sorting instructions i1119.

One or more exemplary instructions depicted in FIG. 25 as being borne in an exemplary version of a non-transitory signal bearing medium of information storage subsystem s200 include one or more equipment infrared instructions i1120, one or more equipment cutting instructions i1121, one or more equipment material instructions i1122, one or more equipment receiving instructions i1123, one or more equipment containing instructions i1124, one or more combination ingredients instructions i1125, one or more mixture ingredients instructions i1126, one or more mixture nutraceuticals instructions i1127, one or more compound organic instructions i1128, one or more composition fluids instructions i1129, one or more combination powders instructions i1130, one or more excluding allergens instructions i1131, one or more pharmaceutical agents instructions i1132, one or more geographic regions instructions i1133, one or more authoritative entities instructions i1134, one or more designated users instructions i1135, one or more substance powders instructions i1136, one or more substance liquids instructions i1137, one or more substance gel instructions i1138, and one or more substance solids instructions i1139.

One or more exemplary instructions depicted in FIG. 26 as being borne in an exemplary version of a non-transitory signal bearing medium of information storage subsystem s200 include one or more substance mixtures instructions i1140, one or more cleaning cellular instructions i1141, one or more cleaning network instructions i1142, one or more cleaning circuitry instructions i1143, one or more cleaning wireless instructions i1144, one or more cleaning microprocessor instructions i1145, one or more cleaning memory instructions i1146, one or more cleaning servers instructions i1147, one or more cleaning card instructions i1148, one or more cleaning blowing instructions i1149, one or more cleaning compressed instructions i1150, one or more cleaning vacuum instructions i1151, one or more cleaning ultrasonic instructions i1152, one or more cleaning electromagnetic instructions i1153, one or more cleaning abrasives instructions i1154, one or more cleaning brush instructions i1155, one or more cleaning chemical instructions i1156, one or more cleaning tubes instructions i1157, one or more cleaning nozzles instructions i1158, and one or more cleaning heating instructions i1159.

One or more exemplary instructions depicted in FIG. 27 as being borne in an exemplary version of a non-transitory signal bearing medium of information storage subsystem s200 include one or more cleaning blender instructions i1160, one or more cleaning cooling instructions i1161, one or more cleaning agitator instructions i1162, one or more cleaning syringe instructions i1163, one or more cleaning head instructions i1164, one or more cleaning replacement instructions i1165, and one or more cleaning exchange instructions i1166.

One or more exemplary instructions depicted in FIG. 28 as being borne in an exemplary version of a non-transitory signal bearing medium of information storage subsystem s200 include one or more second clean instructions i12, one or more cleaning network instructions i1201, one or more cleaning cellular instructions i1202, one or more cleaning circuitry instructions i1203, one or more cleaning microprocessors instructions i1204, one or more cleaning servers instructions i1205, one or more cleaning not existed instructions i1206, one or more cleaning blowing instructions i1207, one or more cleaning compressed instructions i1208, one or more cleaning vacuum instructions i1209, one or more cleaning ultrasonic instructions i1210, one or more cleaning electromagnetic instructions i1211, one or more cleaning abrasives instructions i1212, one or more cleaning brush instructions i1213, one or more cleaning chemical instructions i1214, one or more cleaning tubes instructions i1215, one or more cleaning nozzles instructions i1216, one or more cleaning heating instructions i1217, one or more cleaning blender instructions i1218, and one or more cleaning cooling instructions i1219.

One or more exemplary instructions depicted in FIG. 29 as being borne in an exemplary version of a non-transitory signal bearing medium of information storage subsystem s200 include one or more cleaning agitator instructions i1220, one or more cleaning syringe instructions i1221, one or more cleaning head instructions i1222, one or more cleaning replacement instructions i1223, one or more cleaning exchange instructions i1224, one or more cleaning other instructions i1225, one or more cleaning includes instructions i1226, one or more cleaning first instructions i1227, one or more cleaning combination instructions i1228, one or more cleaning mixture instructions i1229, one or more cleaning nutraceuticals instructions i1230, one or more cleaning organic instructions i1231, one or more cleaning fluids instructions i1232, one or more cleaning powders instructions i1233, one or more cleaning allergens instructions i1234, one or more cleaning agents instructions i1235, one or more cleaning regions instructions i1236, one or more cleaning authoritative instructions i1237, one or more cleaning designated instructions i1238, and one or more cleaning reactive instructions i1239.

One or more exemplary instructions depicted in FIG. 30 as being borne in an exemplary version of a non-transitory signal bearing medium of information storage subsystem s200 include one or more cleaning receiving instructions i1240, one or more cleaning GUI instructions i1241, one or more cleaning display instructions i1242, one or more cleaning keyboard instructions i1243, one or more cleaning screen instructions i1244, one or more cleaning camera instructions i1245, one or more cleaning sound instructions i1246, one or more cleaning network instructions i1247, one or more cleaning cellular instructions i1248, one or more cleaning menu instructions i1249, one or more cleaning prescription instructions i1250, one or more cleaning allergy instructions i1251, one or more cleaning preferences instructions i1252, one or more cleaning allergies instructions i1253, and one or more cleaning each instructions i1254.

An operational flow o10 as shown in FIG. 31 represents example operations related to electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment and electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input.

FIG. 31 and those figures that follow may have various examples of operational flows, and explanation may be provided with respect to the above-described examples of FIGS. 1-7 and/or with respect to other examples and contexts. Nonetheless, it should be understood that the operational flows may be executed in a number of other environments and contexts, and/or in modified versions of FIGS. 1-7. Furthermore, although the various operational flows are presented in the sequence(s) illustrated, it should be understood that the various operations may be performed in other orders than those which are illustrated, or may be performed concurrently.

In FIG. 31 and those figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

As shown in FIG. 31, the operational flow o10 proceeds to operation o11 for electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment. An exemplary version of a non-transitory signal bearing medium of information storage subsystem s200 is depicted as bearing one or more store and first clean instructions i11 that when executed will direct performance of the operation o11. In an implementation, the one or more store and first clean instructions i11 when executed direct electronically directing storing of first preparation information into preparation history information storage (e.g. one or more of the microprocessor components s102 of the control and information processing subsystem s100 can direct storing the first preparation information into one or more instances of the disk cluster component s226 via the network cable component s502, etc.), the first preparation information associated with at least one first preparation occurrence by automated preparation equipment of at least one first ingestible product including a first portion of at least one first substance (e.g. the first preparation information contains recorded log information of when the ingestible product preparation system 10 prepared a ham sandwich using devices including one or more instances of heating component s702) and electronically directing storing of first cleaning information, if existent, into cleaning history information storage (e.g. one or more of the microprocessor components s102 of the control and information processing subsystem s100 can direct storing the first preparation information into one or more instances of the other volatile memory component s206, etc.), the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment (e.g. after the ham sandwich is prepared as the first preparation occurrence, portions of remnant ingestible material, as the second portion, left over from the preparation of the ham sandwich can be removed from the ingestible product preparation system 10 as part of the first automated cleaning operation occurrence, etc.). Furthermore, the store and first clean electrical circuitry arrangement (“elec circ arrange”) e11 when activated will perform the operation o11. In an implementation, the store and first clean electrical circuitry arrangement e11, when activated performs electronically directing storing of first preparation information into preparation history information storage (e.g. one or more of the microprocessor components s102 of the control and information processing subsystem s100 can direct storing the first preparation information into one or more instances of the disk cluster component s226 via the network cable component s502, etc.), the first preparation information associated with at least one first preparation occurrence by automated preparation equipment of at least one first ingestible product including a first portion of at least one first substance (e.g. the first preparation information contains recorded log information of when the ingestible product preparation system 10 prepared a ham sandwich using devices including one or more instances of heating component s702) and electronically directing storing of first cleaning information, if existent, into cleaning history information storage (e.g. one or more of the microprocessor components s102 of the control and information processing subsystem s100 can direct storing the first preparation information into one or more instances of the other volatile memory component s206, etc.), the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment (e.g. after the ham sandwich is prepared as the first preparation occurrence, portions of remnant ingestible material, as the second portion, left over from the preparation of the ham sandwich can be removed from the ingestible product preparation system 10 as part of the first automated cleaning operation occurrence, etc.). In an implementation, the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment is carried out by electronically directing storing of first preparation information into preparation history information storage (e.g. one or more of the microprocessor components s102 of the control and information processing subsystem s100 can direct storing the first preparation information into one or more instances of the disk cluster component s226 via the network cable component s502, etc.), the first preparation information associated with at least one first preparation occurrence by automated preparation equipment of at least one first ingestible product including a first portion of at least one first substance (e.g. the first preparation information contains recorded log information of when the ingestible product preparation system 10 prepared a ham sandwich using devices including one or more instances of heating component s702) and electronically directing storing of first cleaning information, if existent, into cleaning history information storage (e.g. one or more of the microprocessor components s102 of the control and information processing subsystem s100 can direct storing the first preparation information into one or more instances of the other volatile memory component s206, etc.), the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment (e.g. after the ham sandwich is prepared as the first preparation occurrence, portions of remnant ingestible material, as the second portion, left over from the preparation of the ham sandwich can be removed from the ingestible product preparation system 10 as part of the first automated cleaning operation occurrence, etc.).

In one or more implementations, as shown in FIG. 32, operation o11 includes an operation o1101 for electronically directing storing of the first preparation information into the preparation history information storage as one or more networked servers. An exemplary version of a non-transitory signal bearing medium of information storage subsystem s200 is depicted as bearing one or more store servers instructions i1101 that when executed will direct performance of the operation o1101. In an implementation, the one or more store servers instructions i1101 when executed direct electronically directing storing of the first preparation information into the preparation history information storage as one or more networked servers (e.g. one or more of the microprocessor components s102 of the control and information processing subsystem s100 can direct storing the first preparation information into one or more instances of the server component s230 via the wide area network component s512, etc.). Furthermore, the store servers electrical circuitry arrangement (“elec circ arrange”) e1101 when activated will perform the operation o1101. In an implementation, the store servers electrical circuitry arrangement e1101, when activated performs electronically directing storing of the first preparation information into the preparation history information storage as one or more networked servers (e.g. one or more of the microprocessor components s102 of the control and information processing subsystem s100 can direct storing the first preparation information into one or more instances of the server component s230 via the wide area network component s512, etc.). In an implementation, the electronically directing storing of the first preparation information into the preparation history information storage as one or more networked servers is carried out by electronically directing storing of the first preparation information into the preparation history information storage as one or more networked servers (e.g. one or more of the microprocessor components s102 of the control and information processing subsystem s100 can direct storing the first preparation information into one or more instances of the server component s230 via the wide area network component s512, etc.).

In one or more implementations, operation o11 includes an operation o1102 for electronically directing storing of the first preparation information into the preparation history information storage as one or more electronic memories internal to the automated preparation equipment. An exemplary version of a non-transitory signal bearing medium of information storage subsystem s200 is depicted as bearing one or more store first preparation instructions i1102 that when executed will direct performance of the operation o1102. In an implementation, the one or more store first preparation instructions i1102 when executed direct electronically directing storing of the first preparation information into the preparation history information storage as one or more electronic memories internal to the automated preparation equipment (e.g. one or more instances of the central processing unit (CPU) component s104 of the control and information processing subsystem s100 can direct storing the first preparation information into one or more instances of the persistent memory component s208, etc.). Furthermore, the store first preparation electrical circuitry arrangement e1102 when activated will perform the operation o1102. In an implementation, the store first preparation electrical circuitry arrangement e1102, when activated performs electronically directing storing of the first preparation information into the preparation history information storage as one or more electronic memories internal to the automated preparation equipment (e.g. one or more instances of the central processing unit (CPU) component s104 of the control and information processing subsystem s100 can direct storing the first preparation information into one or more instances of the persistent memory component s208, etc.). In an implementation, the electronically directing storing of the first preparation information into the preparation history information storage as one or more electronic memories internal to the automated preparation equipment is carried out by electronically directing storing of the first preparation information into the preparation history information storage as one or more electronic memories internal to the automated preparation equipment (e.g. one or more instances of the central processing unit (CPU) component s104 of the control and information processing subsystem s100 can direct storing the first preparation information into one or more instances of the persistent memory component s208, etc.).

In one or more implementations, operation o11 includes an operation o1103 for electronically directing storing of the first preparation information into the preparation history information storage as one or more electronic memory cards. An exemplary version of a non-transitory signal bearing medium of information storage subsystem s200 is depicted as bearing one or more store memory card instructions i1103 that when executed will direct performance of the operation o1103. In an implementation, the one or more store memory card instructions i1103 when executed direct electronically directing storing of the first preparation information into the preparation history information storage as one or more electronic memory cards (e.g. one or more instances of the digital signal processor (DSP) component s106 of the control and information processing subsystem s100 can direct storing the first preparation information into one or more instances of the flash memory component s218 fashioned as memory cards, etc.). Furthermore, the store memory card electrical circuitry arrangement e1103 when activated will perform the operation o1103. In an implementation, the store memory card electrical circuitry arrangement e1103, when activated performs electronically directing storing of the first preparation information into the preparation history information storage as one or more electronic memory cards (e.g. one or more instances of the digital signal processor (DSP) component s106 of the control and information processing subsystem s100 can direct storing the first preparation information into one or more instances of the flash memory component s218 fashioned as memory cards, etc.). In an implementation, the is electronically directing storing of the first preparation information into the preparation history information storage as one or more electronic memory cards carried out by electronically directing storing of the first preparation information into the preparation history information storage as one or more electronic memory cards (e.g. one or more instances of the digital signal processor (DSP) component s106 of the control and information processing subsystem s100 can direct storing the first preparation information into one or more instances of the flash memory component s218 fashioned as memory cards, etc.).

In one or more implementations, as shown in FIG. 33, operation o11 includes an operation o1104 for electronically directing storing of the first preparation information into the preparation history information storage in addition to preparation history information associated with a preparation occurrence by the automated preparation equipment of the first ingestible product prior to the at least one first preparation occurrence by the automated preparation equipment of the at least one first ingestible product. An exemplary version of a non-transitory signal bearing medium of information storage subsystem s200 is depicted as bearing one or more store first prior instructions i1104 that when executed will direct performance of the operation o1104. In an implementation, the one or more store first prior instructions i1104 when executed direct electronically directing storing of the first preparation information into the preparation history information storage in addition to preparation history information associated with a preparation occurrence by the automated preparation equipment of the first ingestible product prior to the at least one first preparation occurrence by the automated preparation equipment of the at least one first ingestible product (e.g. one or more instances of the application specific integrated circuit (ASIC) component s108 of the control and information processing subsystem s100 can direct storing the first preparation information into one or more instances of the random access memory (RAM) component s202 along with information about other preparation of the first ingestible product as a hamburger prior to the first preparation information, etc.). Furthermore, the store first prior electrical circuitry arrangement e1104 when activated will perform the operation o1104. In an implementation, the store first prior electrical circuitry arrangement e1104, when activated performs electronically directing storing of the first preparation information into the preparation history information storage in addition to preparation history information associated with a preparation occurrence by the automated preparation equipment of the first ingestible product prior to the at least one first preparation occurrence by the automated preparation equipment of the at least one first ingestible product (e.g. one or more instances of the application specific integrated circuit (ASIC) component s108 of the control and information processing subsystem s100 can direct storing the first preparation information into one or more instances of the random access memory (RAM) component s202 along with information about other preparation of the first ingestible product as a hamburger prior to the first preparation information, etc.). In an implementation, the is electronically directing storing of the first preparation information into the preparation history information storage in addition to preparation history information associated with a preparation occurrence by the automated preparation equipment of the first ingestible product prior to the at least one first preparation occurrence by the automated preparation equipment of the at least one first ingestible product carried out by electronically directing storing of the first preparation information into the preparation history information storage in addition to preparation history information associated with a preparation occurrence by the automated preparation equipment of the first ingestible product prior to the at least one first preparation occurrence by the automated preparation equipment of the at least one first ingestible product (e.g. one or more instances of the application specific integrated circuit (ASIC) component s108 of the control and information processing subsystem s100 can direct storing the first preparation information into one or more instances of the random access memory (RAM) component s202 along with information about other preparation of the first ingestible product as a hamburger prior to the first preparation information, etc.).

In one or more implementations, operation o11 includes an operation o1105 for electronically directing storing of the first preparation information into the preparation history information storage in addition to preparation history information associated with a preparation occurrence by the automated preparation equipment of an ingestible product other than the first ingestible product prior to the at least one first preparation occurrence by the automated preparation equipment of the at least one first ingestible product. An exemplary version of a non-transitory signal bearing medium of information storage subsystem s200 is depicted as bearing one or more store prior other instructions i1105 that when executed will direct performance of the operation o1105. In an implementation, the one or more store prior other instructions i1105 when executed direct electronically directing storing of the first preparation information into the preparation history information storage in addition to preparation history information associated with a preparation occurrence by the automated preparation equipment of an ingestible product other than the first ingestible product prior to the at least one first preparation occurrence by the automated preparation equipment of the at least one first ingestible product (e.g. one or more instances of the field programmable gate array (FPGA) component s110 of the control and information processing subsystem s100 can direct storing the first preparation information into one or more instances of the dynamic random access memory (DRAM) component s204 along with information about preparation of other than the first ingestible product as a smoothie prior to the first preparation information, etc.). Furthermore, the store prior other electrical circuitry arrangement e1105 when activated will perform the operation o1105. In an implementation, the store prior other electrical circuitry arrangement e1105, when activated performs electronically directing storing of the first preparation information into the preparation history information storage in addition to preparation history information associated with a preparation occurrence by the automated preparation equipment of an ingestible product other than the first ingestible product prior to the at least one first preparation occurrence by the automated preparation equipment of the at least one first ingestible product (e.g. one or more instances of the field programmable gate array (FPGA) component s110 of the control and information processing subsystem s100 can direct storing the first preparation information into one or more instances of the dynamic random access memory (DRAM) component s204 along with information about preparation of other than the first ingestible product as a smoothie prior to the first preparation information, etc.). In an implementation, the electronically directing storing of the first preparation information into the preparation history information storage in addition to preparation history information associated with a preparation occurrence by the automated preparation equipment of an ingestible product other than the first ingestible product prior to the at least one first preparation occurrence by the automated preparation equipment of the at least one first ingestible product is carried out by electronically directing storing of the first preparation information into the preparation history information storage in addition to preparation history information associated with a preparation occurrence by the automated preparation equipment of an ingestible product other than the first ingestible product prior to the at least one first preparation occurrence by the automated preparation equipment of the at least one first ingestible product (e.g. one or more instances of the field programmable gate array (FPGA) component s110 of the control and information processing subsystem s100 can direct storing the first preparation information into one or more instances of the dynamic random access memory (DRAM) component s204 along with information about preparation of other than the first ingestible product as a smoothie prior to the first preparation information, etc.).

In one or more implementations, operation o11 includes an operation o1106 for electronically directing storing of the first preparation information into the preparation history information storage, the first preparation information associated with the at least one first preparation occurrence by the automated preparation equipment as including one or more heating components. An exemplary version of a non-transitory signal bearing medium of information storage subsystem s200 is depicted as bearing one or more equipment heating instructions i1106 that when executed will direct performance of the operation o1106. In an implementation, the one or more equipment heating instructions i1106 when executed direct electronically directing storing of the first preparation information into the preparation history information storage, the first preparation information associated with the at least one first preparation occurrence by the automated preparation equipment as including one or more heating components (e.g. one or more of instances of the multiprocessor component s112 of the control and information processing subsystem s100 can direct storing the first preparation information into one or more instances of the other volatile memory component s206 along with information about other preparation of the first ingestible product as a candy bar prior to the first preparation information, the first preparation occurrence involving one or more instances of the heating component s702, etc.). Furthermore, the equipment heating electrical circuitry arrangement e1106 when activated will perform the operation o1106. In an implementation, the equipment heating electrical circuitry arrangement e1106, when activated performs electronically directing storing of the first preparation information into the preparation history information storage, the first preparation information associated with the at least one first preparation occurrence by the automated preparation equipment as including one or more heating components (e.g. one or more of instances of the multiprocessor component s112 of the control and information processing subsystem s100 can direct storing the first preparation information into one or more instances of the other volatile memory component s206 along with information about other preparation of the first ingestible product as a candy bar prior to the first preparation information, the first preparation occurrence involving one or more instances of the heating component s702, etc.). In an implementation, the electronically directing storing of the first preparation information into the preparation history information storage, the first preparation information associated with the at least one first preparation occurrence by the automated preparation equipment as including one or more heating components is carried out by electronically directing storing of the first preparation information into the preparation history information storage, the first preparation information associated with the at least one first preparation occurrence by the automated preparation equipment as including one or more heating components (e.g. one or more of instances of the multiprocessor component s112 of the control and information processing subsystem s100 can direct storing the first preparation information into one or more instances of the other volatile memory component s206 along with information about other preparation of the first ingestible product as a candy bar prior to the first preparation information, the first preparation occurrence involving one or more instances of the heating component s702, etc.).

In one or more implementations, as shown in FIG. 34, operation o11 includes an operation o1107 for electronically directing storing of the first preparation information into the preparation history information storage, the first preparation information associated with the at least one first preparation occurrence by the automated preparation equipment as including one or more cooling components. An exemplary version of a non-transitory signal bearing medium of information storage subsystem s200 is depicted as bearing one or more equipment cooling instructions i1107 that when executed will direct performance of the operation o1107. In an implementation, the one or more equipment cooling instructions i1107 when executed direct electronically directing storing of the first preparation information into the preparation history information storage, the first preparation information associated with the at least one first preparation occurrence by the automated preparation equipment as including one or more cooling components (e.g. one or more of instances of the optical processing component s114 of the control and information processing subsystem s100 can direct storing the first preparation information into one or more instances of the persistent memory component s208, the first preparation occurrence involving one or more instances of the cooling component s704, etc.). Furthermore, the equipment cooling electrical circuitry arrangement e1107 when activated will perform the operation o1107. In an implementation, the equipment cooling electrical circuitry arrangement e1107, when activated performs electronically directing storing of the first preparation information into the preparation history information storage, the first preparation information associated with the at least one first preparation occurrence by the automated preparation equipment as including one or more cooling components (e.g. one or more of instances of the optical processing component s114 of the control and information processing subsystem s100 can direct storing the first preparation information into one or more instances of the persistent memory component s208, the first preparation occurrence involving one or more instances of the cooling component s704, etc.). In an implementation, the electronically directing storing of the first preparation information into the preparation history information storage, the first preparation information associated with the at least one first preparation occurrence by the automated preparation equipment as including one or more cooling components is carried out by electronically directing storing of the first preparation information into the preparation history information storage, the first preparation information associated with the at least one first preparation occurrence by the automated preparation equipment as including one or more cooling components (e.g. one or more of instances of the optical processing component s114 of the control and information processing subsystem s100 can direct storing the first preparation information into one or more instances of the persistent memory component s208, the first preparation occurrence involving one or more instances of the cooling component s704, etc.).

In one or more implementations, operation o11 includes an operation o1108 for electronically directing storing of the first preparation information into the preparation history information storage, the first preparation information associated with the at least one first preparation occurrence by the automated preparation equipment as including one or more microwave components. An exemplary version of a non-transitory signal bearing medium of information storage subsystem s200 is depicted as bearing one or more equipment microwave instructions i1108 that when executed will direct performance of the operation o1108. In an implementation, the one or more equipment microwave instructions i1108 when executed direct electronically directing storing of the first preparation information into the preparation history information storage, the first preparation information associated with the at least one first preparation occurrence by the automated preparation equipment as including one or more microwave components (e.g. one or more of instances of the microprocessor component s102 of the control and information processing subsystem s100 can direct storing the first preparation information into one or more instances of the read only memory (ROM) component s210, the first preparation occurrence involving one or more instances of the microwave component s706, etc.). Furthermore, the equipment microwave electrical circuitry arrangement e1108 when activated will perform the operation o1108. In an implementation, the equipment microwave electrical circuitry arrangement e1108, when activated performs electronically directing storing of the first preparation information into the preparation history information storage, the first preparation information associated with the at least one first preparation occurrence by the automated preparation equipment as including one or more microwave components (e.g. one or more of instances of the microprocessor component s102 of the control and information processing subsystem s100 can direct storing the first preparation information into one or more instances of the read only memory (ROM) component s210, the first preparation occurrence involving one or more instances of the microwave component s706, etc.). In an implementation, the electronically directing storing of the first preparation information into the preparation history information storage, the first preparation information associated with the at least one first preparation occurrence by the automated preparation equipment as including one or more microwave components is carried out by electronically directing storing of the first preparation information into the preparation history information storage, the first preparation information associated with the at least one first preparation occurrence by the automated preparation equipment as including one or more microwave components (e.g. one or more of instances of the microprocessor component s102 of the control and information processing subsystem s100 can direct storing the first preparation information into one or more instances of the read only memory (ROM) component s210, the first preparation occurrence involving one or more instances of the microwave component s706, etc.).

In one or more implementations, operation o11 includes an operation o1109 for electronically directing storing of the first preparation information into the preparation history information storage, the first preparation information associated with the at least one first preparation occurrence by the automated preparation equipment as including one or more laser components. An exemplary version of a non-transitory signal bearing medium of information storage subsystem s200 is depicted as bearing one or more equipment laser instructions i1109 that when executed will direct performance of the operation o1109. In an implementation, the one or more equipment laser instructions i1109 when executed direct electronically directing storing of the first preparation information into the preparation history information storage, the first preparation information associated with the at least one first preparation occurrence by the automated preparation equipment as including one or more laser component (e.g. one or more of instances of the central processing unit (CPU) component s104 of the control and information processing subsystem s100 can direct storing the first preparation information into one or more instances of the electrically erasable programmable read only memory (EEPROM) component s212, the first preparation occurrence involving one or more instances of the laser component s708, etc.). Furthermore, the equipment laser electrical circuitry arrangement e1109 when activated will perform the operation o1109. In an implementation, the equipment laser electrical circuitry arrangement e1109, when activated performs electronically directing storing of the first preparation information into the preparation history information storage, the first preparation information associated with the at least one first preparation occurrence by the automated preparation equipment as including one or more laser component (e.g. one or more of instances of the central processing unit (CPU) component s104 of the control and information processing subsystem s100 can direct storing the first preparation information into one or more instances of the electrically erasable programmable read only memory (EEPROM) component s212, the first preparation occurrence involving one or more instances of the laser component s708, etc.). In an implementation, the electronically directing storing of the first preparation information into the preparation history information storage, the first preparation information associated with the at least one first preparation occurrence by the automated preparation equipment as including one or more laser components is carried out by electronically directing storing of the first preparation information into the preparation history information storage, the first preparation information associated with the at least one first preparation occurrence by the automated preparation equipment as including one or more laser component (e.g. one or more of instances of the central processing unit (CPU) component s104 of the control and information processing subsystem s100 can direct storing the first preparation information into one or more instances of the electrically erasable programmable read only memory (EEPROM) component s212, the first preparation occurrence involving one or more instances of the laser component s708, etc.).

In one or more implementations, as shown in FIG. 35, operation o11 includes an operation o1110 for electronically directing storing of the first preparation information into the preparation history information storage, the first preparation information associated with the at least one first preparation occurrence by the automated preparation equipment as including one or more light emitting diode (LED) components. An exemplary version of a non-transitory signal bearing medium of information storage subsystem s200 is depicted as bearing one or more equipment LED instructions i1110 that when executed will direct performance of the operation o1110. In an implementation, the one or more equipment LED instructions i1110 when executed direct electronically directing storing of the first preparation information into the preparation history information storage, the first preparation information associated with the at least one first preparation occurrence by the automated preparation equipment as including one or more light emitting diode (LED) components (e.g. one or more of instances of the digital signal processor (DSP) component s106 of the control and information processing subsystem s100 can direct storing the first preparation information into one or more instances of the compact disk (CD) component s214, the first preparation occurrence involving one or more instances of the light emitting diode (LED) component s710, etc.). Furthermore, the equipment LED electrical circuitry arrangement e1110 when activated will perform the operation o1110. In an implementation, the equipment LED electrical circuitry arrangement e1110, when activated performs electronically directing storing of the first preparation information into the preparation history information storage, the first preparation information associated with the at least one first preparation occurrence by the automated preparation equipment as including one or more light emitting diode (LED) components (e.g. one or more of instances of the digital signal processor (DSP) component s106 of the control and information processing subsystem s100 can direct storing the first preparation information into one or more instances of the compact disk (CD) component s214, the first preparation occurrence involving one or more instances of the light emitting diode (LED) component s710, etc.). In an implementation, the electronically directing storing of the first preparation information into the preparation history information storage, the first preparation information associated with the at least one first preparation occurrence by the automated preparation equipment as including one or more light emitting diode (LED) components is carried out by electronically directing storing of the first preparation information into the preparation history information storage, the first preparation information associated with the at least one first preparation occurrence by the automated preparation equipment as including one or more light emitting diode (LED) components (e.g. one or more of instances of the digital signal processor (DSP) component s106 of the control and information processing subsystem s100 can direct storing the first preparation information into one or more instances of the compact disk (CD) component s214, the first preparation occurrence involving one or more instances of the light emitting diode (LED) component s710, etc.).

In one or more implementations, operation o11 includes an operation o1111 for electronically directing storing of the first preparation information into the preparation history information storage, the first preparation information associated with the at least one first preparation occurrence by the automated preparation equipment as including one or more peltier cooling components. An exemplary version of a non-transitory signal bearing medium of information storage subsystem s200 is depicted as bearing one or more equipment peltier instructions i1111 that when executed will direct performance of the operation o1111. In an implementation, the one or more equipment peltier instructions i1111 when executed direct electronically directing storing of the first preparation information into the preparation history information storage, the first preparation information associated with the at least one first preparation occurrence by the automated preparation equipment as including one or more peltier cooling components (e.g. one or more of instances of the application specific integrated circuit (ASIC) component s108 of the control and information processing subsystem s100 can direct storing the first preparation information into one or more instances of the digital versatile disk (DVD) component s216, the first preparation occurrence involving one or more instances of the peltier cooling component s712, etc.). Furthermore, the equipment peltier electrical circuitry arrangement e1111 when activated will perform the operation o1111. In an implementation, the equipment peltier electrical circuitry arrangement e1111, when activated performs electronically directing storing of the first preparation information into the preparation history information storage, the first preparation information associated with the at least one first preparation occurrence by the automated preparation equipment as including one or more peltier cooling components (e.g. one or more of instances of the application specific integrated circuit (ASIC) component s108 of the control and information processing subsystem s100 can direct storing the first preparation information into one or more instances of the digital versatile disk (DVD) component s216, the first preparation occurrence involving one or more instances of the peltier cooling component s712, etc.). In an implementation, the electronically directing storing of the first preparation information into the preparation history information storage, the first preparation information associated with the at least one first preparation occurrence by the automated preparation equipment as including one or more peltier cooling components is carried out by electronically directing storing of the first preparation information into the preparation history information storage, the first preparation information associated with the at least one first preparation occurrence by the automated preparation equipment as including one or more peltier cooling components (e.g. one or more of instances of the application specific integrated circuit (ASIC) component s108 of the control and information processing subsystem s100 can direct storing the first preparation information into one or more instances of the digital versatile disk (DVD) component s216, the first preparation occurrence involving one or more instances of the peltier cooling component s712, etc.).

In one or more implementations, operation o11 includes an operation o1112 for electronically directing storing of the first preparation information into the preparation history information storage, the first preparation information associated with the at least one first preparation occurrence by the automated preparation equipment as including one or more blending components. An exemplary version of a non-transitory signal bearing medium of information storage subsystem s200 is depicted as bearing one or more equipment blending instructions i1112 that when executed will direct performance of the operation o1112. In an implementation, the one or more equipment blending instructions i1112 when executed direct electronically directing storing of the first preparation information into the preparation history information storage, the first preparation information associated with the at least one first preparation occurrence by the automated preparation equipment as including one or more blending components (e.g. one or more of instances of the application specific integrated circuit (ASIC) component s108 of the control and information processing subsystem s100 can direct storing the first preparation information into one or more instances of the flash memory component s218, the first preparation occurrence involving one or more instances of the blending component s714, etc.). Furthermore, the equipment blending electrical circuitry arrangement e1112 when activated will perform the operation o1112. In an implementation, the equipment blending electrical circuitry arrangement e1112, when activated performs electronically directing storing of the first preparation information into the preparation history information storage, the first preparation information associated with the at least one first preparation occurrence by the automated preparation equipment as including one or more blending components (e.g. one or more of instances of the application specific integrated circuit (ASIC) component s108 of the control and information processing subsystem s100 can direct storing the first preparation information into one or more instances of the flash memory component s218, the first preparation occurrence involving one or more instances of the blending component s714, etc.). In an implementation, the electronically directing storing of the first preparation information into the preparation history information storage, the first preparation information associated with the at least one first preparation occurrence by the automated preparation equipment as including one or more blending components is carried out by electronically directing storing of the first preparation information into the preparation history information storage, the first preparation information associated with the at least one first preparation occurrence by the automated preparation equipment as including one or more blending components (e.g. one or more of instances of the application specific integrated circuit (ASIC) component s108 of the control and information processing subsystem s100 can direct storing the first preparation information into one or more instances of the flash memory component s218, the first preparation occurrence involving one or more instances of the blending component s714, etc.).

In one or more implementations, as shown in FIG. 36, operation o11 includes an operation o1113 for electronically directing storing of the first preparation information into the preparation history information storage, the first preparation information associated with the at least one first preparation occurrence by the automated preparation equipment as including one or more mixer components. An exemplary version of a non-transitory signal bearing medium of information storage subsystem s200 is depicted as bearing one or more equipment mixer instructions i1113 that when executed will direct performance of the operation o1113. In an implementation, the one or more equipment mixer instructions i1113 when executed direct electronically directing storing of the first preparation information into the preparation history information storage, the first preparation information associated with the at least one first preparation occurrence by the automated preparation equipment as including one or more mixer components (e.g. one or more of instances of the field programmable gate array (FPGA) component s110 of the control and information processing subsystem s100 can direct storing the first preparation information into one or more instances of the other nonvolatile memory component s220, the first preparation occurrence involving one or more instances of the mixer component s716, etc.). Furthermore, the equipment mixer electrical circuitry arrangement e1113 when activated will perform the operation o1113. In an implementation, the equipment mixer electrical circuitry arrangement e1113, when activated performs electronically directing storing of the first preparation information into the preparation history information storage, the first preparation information associated with the at least one first preparation occurrence by the automated preparation equipment as including one or more mixer components (e.g. one or more of instances of the field programmable gate array (FPGA) component s110 of the control and information processing subsystem s100 can direct storing the first preparation information into one or more instances of the other nonvolatile memory component s220, the first preparation occurrence involving one or more instances of the mixer component s716, etc.). In an implementation, the electronically directing storing of the first preparation information into the preparation history information storage, the first preparation information associated with the at least one first preparation occurrence by the automated preparation equipment as including one or more mixer components is carried out by electronically directing storing of the first preparation information into the preparation history information storage, the first preparation information associated with the at least one first preparation occurrence by the automated preparation equipment as including one or more mixer components (e.g. one or more of instances of the field programmable gate array (FPGA) component s110 of the control and information processing subsystem s100 can direct storing the first preparation information into one or more instances of the other nonvolatile memory component s220, the first preparation occurrence involving one or more instances of the mixer component s716, etc.).

In one or more implementations, operation o11 includes an operation o1114 for electronically directing storing of the first preparation information into the preparation history information storage, the first preparation information associated with the at least one first preparation occurrence by the automated preparation equipment as including one or more acoustic energy components. An exemplary version of a non-transitory signal bearing medium of information storage subsystem s200 is depicted as bearing one or more equipment acoustic instructions i1114 that when executed will direct performance of the operation o1114. In an implementation, the one or more equipment acoustic instructions i1114 when executed direct electronically directing storing of the first preparation information into the preparation history information storage, the first preparation information associated with the at least one first preparation occurrence by the automated preparation equipment as including one or more acoustic energy components (e.g. one or more of instances of the multiprocessor component s112 of the control and information processing subsystem s100 can direct storing the first preparation information into one or more instances of the hard drive component s222, the first preparation occurrence involving one or more instances of the acoustic energy component s718, etc.). Furthermore, the equipment acoustic electrical circuitry arrangement e1114 when activated will perform the operation o1114. In an implementation, the equipment acoustic electrical circuitry arrangement e1114, when activated performs electronically directing storing of the first preparation information into the preparation history information storage, the first preparation information associated with the at least one first preparation occurrence by the automated preparation equipment as including one or more acoustic energy components (e.g. one or more of instances of the multiprocessor component s112 of the control and information processing subsystem s100 can direct storing the first preparation information into one or more instances of the hard drive component s222, the first preparation occurrence involving one or more instances of the acoustic energy component s718, etc.). In an implementation, the electronically directing storing of the first preparation information into the preparation history information storage, the first preparation information associated with the at least one first preparation occurrence by the automated preparation equipment as including one or more acoustic energy components is carried out by electronically directing storing of the first preparation information into the preparation history information storage, the first preparation information associated with the at least one first preparation occurrence by the automated preparation equipment as including one or more acoustic energy components (e.g. one or more of instances of the multiprocessor component s112 of the control and information processing subsystem s100 can direct storing the first preparation information into one or more instances of the hard drive component s222, the first preparation occurrence involving one or more instances of the acoustic energy component s718, etc.).

In one or more implementations, operation o11 includes an operation o1115 for electronically directing storing of the first preparation information into the preparation history information storage, the first preparation information associated with the at least one first preparation occurrence by the automated preparation equipment as including one or more stirring components. An exemplary version of a non-transitory signal bearing medium of information storage subsystem s200 is depicted as bearing one or more equipment stirring instructions i1115 that when executed will direct performance of the operation o1115. In an implementation, the one or more equipment stirring instructions i1115 when executed direct electronically directing storing of the first preparation information into the preparation history information storage, the first preparation information associated with the at least one first preparation occurrence by the automated preparation equipment as including one or more stirring components (e.g. one or more of instances of the optical processing component s114 of the control and information processing subsystem s100 can direct storing the first preparation information into one or more instances of the disk farm component s224, the first preparation occurrence involving one or more instances of the stirring component s720, etc.). Furthermore, the equipment stirring electrical circuitry arrangement e1115 when activated will perform the operation o1115. In an implementation, the equipment stirring electrical circuitry arrangement e1115, when activated performs electronically directing storing of the first preparation information into the preparation history information storage, the first preparation information associated with the at least one first preparation occurrence by the automated preparation equipment as including one or more stirring components (e.g. one or more of instances of the optical processing component s114 of the control and information processing subsystem s100 can direct storing the first preparation information into one or more instances of the disk farm component s224, the first preparation occurrence involving one or more instances of the stirring component s720, etc.). In an implementation, the electronically directing storing of the first preparation information into the preparation history information storage, the first preparation information associated with the at least one first preparation occurrence by the automated preparation equipment as including one or more stirring components is carried out by electronically directing storing of the first preparation information into the preparation history information storage, the first preparation information associated with the at least one first preparation occurrence by the automated preparation equipment as including one or more stirring components (e.g. one or more of instances of the optical processing component s114 of the control and information processing subsystem s100 can direct storing the first preparation information into one or more instances of the disk farm component s224, the first preparation occurrence involving one or more instances of the stirring component s720, etc.).

In one or more implementations, as shown in FIG. 37, operation o11 includes an operation o1116 for electronically directing storing of the first preparation information into the preparation history information storage, the first preparation information associated with the at least one first preparation occurrence by the automated preparation equipment as including one or more shaker components. An exemplary version of a non-transitory signal bearing medium of information storage subsystem s200 is depicted as bearing one or more equipment shaker instructions i1116 that when executed will direct performance of the operation o1116. In an implementation, the one or more equipment shaker instructions i1116 when executed direct electronically directing storing of the first preparation information into the preparation history information storage, the first preparation information associated with the at least one first preparation occurrence by the automated preparation equipment as including one or more shaker components (e.g. one or more of instances of the microprocessor component s102 of the control and information processing subsystem s100 can direct storing the first preparation information into one or more instances of the disk cluster component s226, the first preparation occurrence involving one or more instances of the shaker component s722, etc.). Furthermore, the equipment shaker electrical circuitry arrangement e1116 when activated will perform the operation o1116. In an implementation, the equipment shaker electrical circuitry arrangement e1116, when activated performs electronically directing storing of the first preparation information into the preparation history information storage, the first preparation information associated with the at least one first preparation occurrence by the automated preparation equipment as including one or more shaker components (e.g. one or more of instances of the microprocessor component s102 of the control and information processing subsystem s100 can direct storing the first preparation information into one or more instances of the disk cluster component s226, the first preparation occurrence involving one or more instances of the shaker component s722, etc.). In an implementation, the electronically directing storing of the first preparation information into the preparation history information storage, the first preparation information associated with the at least one first preparation occurrence by the automated preparation equipment as including one or more shaker components is carried out by electronically directing storing of the first preparation information into the preparation history information storage, the first preparation information associated with the at least one first preparation occurrence by the automated preparation equipment as including one or more shaker components (e.g. one or more of instances of the microprocessor component s102 of the control and information processing subsystem s100 can direct storing the first preparation information into one or more instances of the disk cluster component s226, the first preparation occurrence involving one or more instances of the shaker component s722, etc.).

In one or more implementations, operation o11 includes an operation o1117 for electronically directing storing of the first preparation information into the preparation history information storage, the first preparation information associated with the at least one first preparation occurrence by the automated preparation equipment as including one or more energy emitting components. An exemplary version of a non-transitory signal bearing medium of information storage subsystem s200 is depicted as bearing one or more equipment energy instructions i1117 that when executed will direct performance of the operation o1117. In an implementation, the one or more equipment energy instructions i1117 when executed direct electronically directing storing of the first preparation information into the preparation history information storage, the first preparation information associated with the at least one first preparation occurrence by the automated preparation equipment as including one or more energy emitting components (e.g. one or more of instances of the central processing unit (CPU) component s104 of the control and information processing subsystem s100 can direct storing the first preparation information into one or more instances of the remote backup component s228, the first preparation occurrence involving one or more instances of the energy emitting component s724, etc.). Furthermore, the equipment energy electrical circuitry arrangement e1117 when activated will perform the operation o1117. In an implementation, the equipment energy electrical circuitry arrangement e1117, when activated performs electronically directing storing of the first preparation information into the preparation history information storage, the first preparation information associated with the at least one first preparation occurrence by the automated preparation equipment as including one or more energy emitting components (e.g. one or more of instances of the central processing unit (CPU) component s104 of the control and information processing subsystem s100 can direct storing the first preparation information into one or more instances of the remote backup component s228, the first preparation occurrence involving one or more instances of the energy emitting component s724, etc.). In an implementation, the electronically directing storing of the first preparation information into the preparation history information storage, the first preparation information associated with the at least one first preparation occurrence by the automated preparation equipment as including one or more energy emitting components is carried out by electronically directing storing of the first preparation information into the preparation history information storage, the first preparation information associated with the at least one first preparation occurrence by the automated preparation equipment as including one or more energy emitting components (e.g. one or more of instances of the central processing unit (CPU) component s104 of the control and information processing subsystem s100 can direct storing the first preparation information into one or more instances of the remote backup component s228, the first preparation occurrence involving one or more instances of the energy emitting component s724, etc.).

In one or more implementations, operation o11 includes an operation o1118 for electronically directing storing of the first preparation information into the preparation history information storage, the first preparation information associated with the at least one first preparation occurrence by the automated preparation equipment as including one or more pump components. An exemplary version of a non-transitory signal bearing medium of information storage subsystem s200 is depicted as bearing one or more equipment pump instructions i1118 that when executed will direct performance of the operation o1118. In an implementation, the one or more equipment pump instructions i1118 when executed direct electronically directing storing of the first preparation information into the preparation history information storage, the first preparation information associated with the at least one first preparation occurrence by the automated preparation equipment as including one or more pump components (e.g. one or more of instances of the digital signal processor (DSP) component s106 of the control and information processing subsystem s100 can direct storing the first preparation information into one or more instances of the server component s230, the first preparation occurrence involving one or more instances of the pump component s726, etc.). Furthermore, the equipment pump electrical circuitry arrangement e1118 when activated will perform the operation o1118. In an implementation, the equipment pump electrical circuitry arrangement e1118, when activated performs electronically directing storing of the first preparation information into the preparation history information storage, the first preparation information associated with the at least one first preparation occurrence by the automated preparation equipment as including one or more pump components (e.g. one or more of instances of the digital signal processor (DSP) component s106 of the control and information processing subsystem s100 can direct storing the first preparation information into one or more instances of the server component s230, the first preparation occurrence involving one or more instances of the pump component s726, etc.). In an implementation, the electronically directing storing of the first preparation information into the preparation history information storage, the first preparation information associated with the at least one first preparation occurrence by the automated preparation equipment as including one or more pump components is carried out by electronically directing storing of the first preparation information into the preparation history information storage, the first preparation information associated with the at least one first preparation occurrence by the automated preparation equipment as including one or more pump components (e.g. one or more of instances of the digital signal processor (DSP) component s106 of the control and information processing subsystem s100 can direct storing the first preparation information into one or more instances of the server component s230, the first preparation occurrence involving one or more instances of the pump component s726, etc.).

In one or more implementations, as shown in FIG. 38, operation o11 includes an operation o1119 for electronically directing storing of the first preparation information into the preparation history information storage, the first preparation information associated with the at least one first preparation occurrence by the automated preparation equipment as including one or more sorting components. An exemplary version of a non-transitory signal bearing medium of information storage subsystem s200 is depicted as bearing one or more equipment sorting instructions i1119 that when executed will direct performance of the operation o1119. In an implementation, the one or more equipment sorting instructions i1119 when executed direct electronically directing storing of the first preparation information into the preparation history information storage, the first preparation information associated with the at least one first preparation occurrence by the automated preparation equipment as including one or more sorting components (e.g. one or more of instances of the application specific integrated circuit (ASIC) component s108 of the control and information processing subsystem s100 can direct storing the first preparation information into one or more instances of the digital tape component s232, the first preparation occurrence involving one or more instances of the sorting component s728, etc.). Furthermore, the equipment sorting electrical circuitry arrangement e1119 when activated will perform the operation o1119. In an implementation, the equipment sorting electrical circuitry arrangement e1119, when activated performs electronically directing storing of the first preparation information into the preparation history information storage, the first preparation information associated with the at least one first preparation occurrence by the automated preparation equipment as including one or more sorting components (e.g. one or more of instances of the application specific integrated circuit (ASIC) component s108 of the control and information processing subsystem s100 can direct storing the first preparation information into one or more instances of the digital tape component s232, the first preparation occurrence involving one or more instances of the sorting component s728, etc.). In an implementation, the electronically directing storing of the first preparation information into the preparation history information storage, the first preparation information associated with the at least one first preparation occurrence by the automated preparation equipment as including one or more sorting components is carried out by electronically directing storing of the first preparation information into the preparation history information storage, the first preparation information associated with the at least one first preparation occurrence by the automated preparation equipment as including one or more sorting components (e.g. one or more of instances of the application specific integrated circuit (ASIC) component s108 of the control and information processing subsystem s100 can direct storing the first preparation information into one or more instances of the digital tape component s232, the first preparation occurrence involving one or more instances of the sorting component s728, etc.).

In one or more implementations, operation o11 includes an operation o1120 for electronically directing storing of the first preparation information into the preparation history information storage, the first preparation information associated with the at least one first preparation occurrence by the automated preparation equipment as including one or more infrared components. An exemplary version of a non-transitory signal bearing medium of information storage subsystem s200 is depicted as bearing one or more equipment infrared instructions i1120 that when executed will direct performance of the operation o1120. In an implementation, the one or more equipment infrared instructions i1120 when executed direct electronically directing storing of the first preparation information into the preparation history information storage, the first preparation information associated with the at least one first preparation occurrence by the automated preparation equipment as including one or more infrared components (e.g. one or more of instances of the field programmable gate array (FPGA) component s110 of the control and information processing subsystem s100 can direct storing the first preparation information into one or more instances of the optical storage component s234, the first preparation occurrence involving one or more instances of the infrared component s730, etc.). Furthermore, the equipment infrared electrical circuitry arrangement e1120 when activated will perform the operation electronically directing storing of the first preparation information into the preparation history information storage, the first preparation information associated with the at least one first preparation occurrence by the automated preparation equipment as including one or more infrared components. In an implementation, the equipment infrared electrical circuitry arrangement e1120, when activated performs electronically directing storing of the first preparation information into the preparation history information storage, the first preparation information associated with the at least one first preparation occurrence by the automated preparation equipment as including one or more infrared components (e.g. one or more of instances of the field programmable gate array (FPGA) component s110 of the control and information processing subsystem s100 can direct storing the first preparation information into one or more instances of the optical storage component s234, the first preparation occurrence involving one or more instances of the infrared component s730, etc.). In an implementation, the electronically directing storing of the first preparation information into the preparation history information storage, the first preparation information associated with the at least one first preparation occurrence by the automated preparation equipment as including one or more infrared components is carried out by electronically directing storing of the first preparation information into the preparation history information storage, the first preparation information associated with the at least one first preparation occurrence by the automated preparation equipment as including one or more infrared components (e.g. one or more of instances of the field programmable gate array (FPGA) component s110 of the control and information processing subsystem s100 can direct storing the first preparation information into one or more instances of the optical storage component s234, the first preparation occurrence involving one or more instances of the infrared component s730, etc.).

In one or more implementations, operation o11 includes an operation o1121 for electronically directing storing of the first preparation information into the preparation history information storage, the first preparation information associated with the at least one first preparation occurrence by the automated preparation equipment as including one or more cutting components. An exemplary version of a non-transitory signal bearing medium of information storage subsystem s200 is depicted as bearing one or more equipment cutting instructions i1121 that when executed will direct performance of the operation o1121. In an implementation, the one or more equipment cutting instructions i1121 when executed direct electronically directing storing of the first preparation information into the preparation history information storage, the first preparation information associated with the at least one first preparation occurrence by the automated preparation equipment as including one or more cutting components (e.g. one or more of instances of the multiprocessor component s112 of the control and information processing subsystem s100 can direct storing the first preparation information into one or more instances of the optical storage component s236, the first preparation occurrence involving one or more instances of the cutting component s732, etc.). Furthermore, the equipment cutting electrical circuitry arrangement e1121 when activated will perform the operation o1121. In an implementation, the equipment cutting electrical circuitry arrangement e1121, when activated performs electronically directing storing of the first preparation information into the preparation history information storage, the first preparation information associated with the at least one first preparation occurrence by the automated preparation equipment as including one or more cutting components (e.g. one or more of instances of the multiprocessor component s112 of the control and information processing subsystem s100 can direct storing the first preparation information into one or more instances of the optical storage component s236, the first preparation occurrence involving one or more instances of the cutting component s732, etc.). In an implementation, the electronically directing storing of the first preparation information into the preparation history information storage, the first preparation information associated with the at least one first preparation occurrence by the automated preparation equipment as including one or more cutting components is carried out by electronically directing storing of the first preparation information into the preparation history information storage, the first preparation information associated with the at least one first preparation occurrence by the automated preparation equipment as including one or more cutting components (e.g. one or more of instances of the multiprocessor component s112 of the control and information processing subsystem s100 can direct storing the first preparation information into one or more instances of the optical storage component s236, the first preparation occurrence involving one or more instances of the cutting component s732, etc.).

In one or more implementations, as shown in FIG. 39, operation o11 includes an operation o1122 for electronically directing storing of the first preparation information into the preparation history information storage, the first preparation information associated with the at least one first preparation occurrence by the automated preparation equipment as including one or more material storage components. An exemplary version of a non-transitory signal bearing medium of information storage subsystem s200 is depicted as bearing one or more equipment material instructions i1122 that when executed will direct performance of the operation o1122. In an implementation, the one or more equipment material instructions i1122 when executed direct electronically directing storing of the first preparation information into the preparation history information storage, the first preparation information associated with the at least one first preparation occurrence by the automated preparation equipment as including one or more material storage components (e.g. one or more of instances of the optical processing component s114 of the control and information processing subsystem s100 can direct storing the first preparation information into one or more instances of the computer readable signal bearing medium s238, the first preparation occurrence involving one or more instances of the material storage component s734, etc.). Furthermore, the equipment material electrical circuitry arrangement e1122 when activated will perform the operation o1122. In an implementation, the equipment material electrical circuitry arrangement e1122, when activated performs electronically directing storing of the first preparation information into the preparation history information storage, the first preparation information associated with the at least one first preparation occurrence by the automated preparation equipment as including one or more material storage components (e.g. one or more of instances of the optical processing component s114 of the control and information processing subsystem s100 can direct storing the first preparation information into one or more instances of the computer readable signal bearing medium s238, the first preparation occurrence involving one or more instances of the material storage component s734, etc.). In an implementation, the electronically directing storing of the first preparation information into the preparation history information storage, the first preparation information associated with the at least one first preparation occurrence by the automated preparation equipment as including one or more material storage components is carried out by electronically directing storing of the first preparation information into the preparation history information storage, the first preparation information associated with the at least one first preparation occurrence by the automated preparation equipment as including one or more material storage components (e.g. one or more of instances of the optical processing component s114 of the control and information processing subsystem s100 can direct storing the first preparation information into one or more instances of the computer readable signal bearing medium s238, the first preparation occurrence involving one or more instances of the material storage component s734, etc.).

In one or more implementations, operation o11 includes an operation o1123 for electronically directing storing of the first preparation information into the preparation history information storage, the first preparation information associated with the at least one first preparation occurrence by the automated preparation equipment as including one or more controlled substance receiving components. An exemplary version of a non-transitory signal bearing medium of information storage subsystem s200 is depicted as bearing one or more equipment receiving instructions i1123 that when executed will direct performance of the operation o1123. In an implementation, the one or more equipment receiving instructions i1123 when executed direct electronically directing storing of the first preparation information into the preparation history information storage, the first preparation information associated with the at least one first preparation occurrence by the automated preparation equipment as including one or more controlled substance receiving components (e.g. one or more of instances of the logic component s116 of the control and information processing subsystem s100 can direct storing the first preparation information into one or more instances of the Blu Ray disk component s240, the first preparation occurrence involving one or more instances of the controlled substance receiving assembly s736, etc.). Furthermore, the equipment receiving electrical circuitry arrangement e1123 when activated will perform the operation o1123. In an implementation, the equipment receiving electrical circuitry arrangement e1123, when activated performs electronically directing storing of the first preparation information into the preparation history information storage, the first preparation information associated with the at least one first preparation occurrence by the automated preparation equipment as including one or more controlled substance receiving components (e.g. one or more of instances of the logic component s116 of the control and information processing subsystem s100 can direct storing the first preparation information into one or more instances of the Blu Ray disk component s240, the first preparation occurrence involving one or more instances of the controlled substance receiving assembly s736, etc.). In an implementation, the electronically directing storing of the first preparation information into the preparation history information storage, the first preparation information associated with the at least one first preparation occurrence by the automated preparation equipment as including one or more controlled substance receiving components is carried out by electronically directing storing of the first preparation information into the preparation history information storage, the first preparation information associated with the at least one first preparation occurrence by the automated preparation equipment as including one or more controlled substance receiving components (e.g. one or more of instances of the logic component s116 of the control and information processing subsystem s100 can direct storing the first preparation information into one or more instances of the Blu Ray disk component s240, the first preparation occurrence involving one or more instances of the controlled substance receiving assembly s736, etc.).

In one or more implementations, operation o11 includes an operation o1124 for electronically directing storing of the first preparation information into the preparation history information storage, the first preparation information associated with the at least one first preparation occurrence by the automated preparation equipment as including one or more controlled substance containing components. An exemplary version of a non-transitory signal bearing medium of information storage subsystem s200 is depicted as bearing one or more equipment containing instructions i1124 that when executed will direct performance of the operation o1124. In an implementation, the one or more equipment containing instructions i1124 when executed direct electronically directing storing of the first preparation information into the preparation history information storage, the first preparation information associated with the at least one first preparation occurrence by the automated preparation equipment as including one or more controlled substance containing components (e.g. one or more of instances of the microprocessor component s102 of the control and information processing subsystem s100 can direct storing the first preparation information into one or more instances of the random access memory (RAM) component s202, the first preparation occurrence involving one or more instances of the controlled substance containing assembly s738, etc.). Furthermore, the equipment containing electrical circuitry arrangement e1124 when activated will perform the operation o1124. In an implementation, the equipment containing electrical circuitry arrangement e1124, when activated performs electronically directing storing of the first preparation information into the preparation history information storage, the first preparation information associated with the at least one first preparation occurrence by the automated preparation equipment as including one or more controlled substance containing components (e.g. one or more of instances of the microprocessor component s102 of the control and information processing subsystem s100 can direct storing the first preparation information into one or more instances of the random access memory (RAM) component s202, the first preparation occurrence involving one or more instances of the controlled substance containing assembly s738, etc.). In an implementation, the electronically directing storing of the first preparation information into the preparation history information storage, the first preparation information associated with the at least one first preparation occurrence by the automated preparation equipment as including one or more controlled substance containing components is carried out by electronically directing storing of the first preparation information into the preparation history information storage, the first preparation information associated with the at least one first preparation occurrence by the automated preparation equipment as including one or more controlled substance containing components (e.g. one or more of instances of the microprocessor component s102 of the control and information processing subsystem s100 can direct storing the first preparation information into one or more instances of the random access memory (RAM) component s202, the first preparation occurrence involving one or more instances of the controlled substance containing assembly s738, etc.).

In one or more implementations, as shown in FIG. 40, operation o11 includes an operation o1125 for electronically directing storing of the first preparation information into the preparation history information storage, the first preparation information associated with the at least one first preparation occurrence by the automated preparation equipment of the at least one first ingestible product as at least one combination of one or more ingestible ingredients. An exemplary version of a non-transitory signal bearing medium of information storage subsystem s200 is depicted as bearing one or more combination ingredients instructions i1125 that when executed will direct performance of the operation o1125. In an implementation, the one or more combination ingredients instructions i1125 when executed direct electronically directing storing of the first preparation information into the preparation history information storage, the first preparation information associated with the at least one first preparation occurrence by the automated preparation equipment of the at least one first ingestible product as at least one combination of one or more ingestible ingredients (e.g. one or more of instances of the microprocessor component s102 of the control and information processing subsystem s100 can direct storing the first preparation information into one or more instances of the dynamic random access memory (DRAM) component s204, involving preparation of one or more pizzas, etc.). Furthermore, the combination ingredients electrical circuitry arrangement e1125 when activated will perform the operation o1125. In an implementation, the combination ingredients electrical circuitry arrangement e1125, when activated performs electronically directing storing of the first preparation information into the preparation history information storage, the first preparation information associated with the at least one first preparation occurrence by the automated preparation equipment of the at least one first ingestible product as at least one combination of one or more ingestible ingredients (e.g. one or more of instances of the microprocessor component s102 of the control and information processing subsystem s100 can direct storing the first preparation information into one or more instances of the dynamic random access memory (DRAM) component s204, involving preparation of one or more pizzas, etc.). In an implementation, the electronically directing storing of the first preparation information into the preparation history information storage, the first preparation information associated with the at least one first preparation occurrence by the automated preparation equipment of the at least one first ingestible product as at least one combination of one or more ingestible ingredients is carried out by electronically directing storing of the first preparation information into the preparation history information storage, the first preparation information associated with the at least one first preparation occurrence by the automated preparation equipment of the at least one first ingestible product as at least one combination of one or more ingestible ingredients (e.g. one or more of instances of the microprocessor component s102 of the control and information processing subsystem s100 can direct storing the first preparation information into one or more instances of the dynamic random access memory (DRAM) component s204, involving preparation of one or more pizzas, etc.).

In one or more implementations, operation o11 includes an operation o1126 for electronically directing storing of the first preparation information into the preparation history information storage, the first preparation information associated with the at least one first preparation occurrence by the automated preparation equipment of the at least one first ingestible product as at least one mixture including one or more ingestible ingredients. An exemplary version of a non-transitory signal bearing medium of information storage subsystem s200 is depicted as bearing one or more mixture ingredients instructions i1126 that when executed will direct performance of the operation o1126. In an implementation, the one or more mixture ingredients instructions i1126 when executed direct electronically directing storing of the first preparation information into the preparation history information storage, the first preparation information associated with the at least one first preparation occurrence by the automated preparation equipment of the at least one first ingestible product as at least one mixture including one or more ingestible ingredients (e.g. one or more of instances of the logic component s116 of the control and information processing subsystem s100 can direct storing the first preparation information into one or more instances of the other volatile memory component s206, involving preparation of one or more salad mixes, etc.). Furthermore, the mixture ingredients electrical circuitry arrangement e1126 when activated will perform the operation o1126. In an implementation, the mixture ingredients electrical circuitry arrangement e1126, when activated performs electronically directing storing of the first preparation information into the preparation history information storage, the first preparation information associated with the at least one first preparation occurrence by the automated preparation equipment of the at least one first ingestible product as at least one mixture including one or more ingestible ingredients (e.g. one or more of instances of the logic component s116 of the control and information processing subsystem s100 can direct storing the first preparation information into one or more instances of the other volatile memory component s206, involving preparation of one or more salad mixes, etc.). In an implementation, the electronically directing storing of the first preparation information into the preparation history information storage, the first preparation information associated with the at least one first preparation occurrence by the automated preparation equipment of the at least one first ingestible product as at least one mixture including one or more ingestible ingredients is carried out by electronically directing storing of the first preparation information into the preparation history information storage, the first preparation information associated with the at least one first preparation occurrence by the automated preparation equipment of the at least one first ingestible product as at least one mixture including one or more ingestible ingredients (e.g. one or more of instances of the logic component s116 of the control and information processing subsystem s100 can direct storing the first preparation information into one or more instances of the other volatile memory component s206, involving preparation of one or more salad mixes, etc.).

In one or more implementations, operation o11 includes an operation o1127 for electronically directing storing of the first preparation information into the preparation history information storage, the first preparation information associated with the at least one first preparation occurrence by the automated preparation equipment of the at least one first ingestible product as at least one mixture including one or more nutraceuticals. An exemplary version of a non-transitory signal bearing medium of information storage subsystem s200 is depicted as bearing one or more mixture nutraceuticals instructions i1127 that when executed will direct performance of the operation o1127. In an implementation, the one or more mixture nutraceuticals instructions i1127 when executed direct electronically directing storing of the first preparation information into the preparation history information storage, the first preparation information associated with the at least one first preparation occurrence by the automated preparation equipment of the at least one first ingestible product as at least one mixture including one or more nutraceuticals (e.g. one or more of instances of the central processing unit (CPU) component s104 of the control and information processing subsystem s100 can direct storing the first preparation information into one or more instances of the persistent memory component s208, involving preparation of one or more sports drinks, etc.). Furthermore, the mixture nutraceuticals electrical circuitry arrangement e1127 when activated will perform the operation o1127. In an implementation, the mixture nutraceuticals electrical circuitry arrangement e1127, when activated performs electronically directing storing of the first preparation information into the preparation history information storage, the first preparation information associated with the at least one first preparation occurrence by the automated preparation equipment of the at least one first ingestible product as at least one mixture including one or more nutraceuticals (e.g. one or more of instances of the central processing unit (CPU) component s104 of the control and information processing subsystem s100 can direct storing the first preparation information into one or more instances of the persistent memory component s208, involving preparation of one or more sports drinks, etc.). In an implementation, the electronically directing storing of the first preparation information into the preparation history information storage, the first preparation information associated with the at least one first preparation occurrence by the automated preparation equipment of the at least one first ingestible product as at least one mixture including one or more nutraceuticals is carried out by electronically directing storing of the first preparation information into the preparation history information storage, the first preparation information associated with the at least one first preparation occurrence by the automated preparation equipment of the at least one first ingestible product as at least one mixture including one or more nutraceuticals (e.g. one or more of instances of the central processing unit (CPU) component s104 of the control and information processing subsystem s100 can direct storing the first preparation information into one or more instances of the persistent memory component s208, involving preparation of one or more sports drinks, etc.).

In one or more implementations, as shown in FIG. 41, operation o11 includes an operation o1128 for electronically directing storing of the first preparation information into the preparation history information storage, the first preparation information associated with the at least one first preparation occurrence by the automated preparation equipment of the at least one first ingestible product as at least one compound including one or more extracts of USDA certified organically raised plant matter. An exemplary version of a non-transitory signal bearing medium of information storage subsystem s200 is depicted as bearing one or more compound organic instructions i1128 that when executed will direct performance of the operation o1128. In an implementation, the one or more compound organic instructions i1128 when executed direct electronically directing storing of the first preparation information into the preparation history information storage, the first preparation information associated with the at least one first preparation occurrence by the automated preparation equipment of the at least one first ingestible product as at least one compound including one or more extracts of USDA certified organically raised plant matter (e.g. one or more of instances of the digital signal processor (DSP) component s106 of the control and information processing subsystem s100 can direct storing the first preparation information into one or more instances of the read only memory (ROM) component s210, involving preparation of one or more fruit smoothies, etc.). Furthermore, the compound organic electrical circuitry arrangement e1128 when activated will perform the operation o1128. In an implementation, the compound organic electrical circuitry arrangement e1128, when activated performs electronically directing storing of the first preparation information into the preparation history information storage, the first preparation information associated with the at least one first preparation occurrence by the automated preparation equipment of the at least one first ingestible product as at least one compound including one or more extracts of USDA certified organically raised plant matter (e.g. one or more of instances of the digital signal processor (DSP) component s106 of the control and information processing subsystem s100 can direct storing the first preparation information into one or more instances of the read only memory (ROM) component s210, involving preparation of one or more fruit smoothies, etc.). In an implementation, the electronically directing storing of the first preparation information into the preparation history information storage, the first preparation information associated with the at least one first preparation occurrence by the automated preparation equipment of the at least one first ingestible product as at least one compound including one or more extracts of USDA certified organically raised plant matter is carried out by electronically directing storing of the first preparation information into the preparation history information storage, the first preparation information associated with the at least one first preparation occurrence by the automated preparation equipment of the at least one first ingestible product as at least one compound including one or more extracts of USDA certified organically raised plant matter (e.g. one or more of instances of the digital signal processor (DSP) component s106 of the control and information processing subsystem s100 can direct storing the first preparation information into one or more instances of the read only memory (ROM) component s210, involving preparation of one or more fruit smoothies, etc.).

In one or more implementations, operation o11 includes an operation o1129 for electronically directing storing of the first preparation information into the preparation history information storage, the first preparation information associated with the at least one first preparation occurrence by the automated preparation equipment of the at least one first ingestible product as at least one composition including one or more fluids. An exemplary version of a non-transitory signal bearing medium of information storage subsystem s200 is depicted as bearing one or more composition fluids instructions i1129 that when executed will direct performance of the operation o1129. In an implementation, the one or more composition fluids instructions i1129 when executed direct electronically directing storing of the first preparation information into the preparation history information storage, the first preparation information associated with the at least one first preparation occurrence by the automated preparation equipment of the at least one first ingestible product as at least one composition including one or more fluids (e.g. one or more of instances of the application specific integrated circuit (ASIC) component s108 of the control and information processing subsystem s100 can direct storing the first preparation information into one or more instances of the electrically erasable programmable read only memory (EEPROM) component s212, involving preparation of one or more soft drinks, etc.). Furthermore, the composition fluids electrical circuitry arrangement e1129 when activated will perform the operation o1129. In an implementation, the composition fluids electrical circuitry arrangement e1129, when activated performs electronically directing storing of the first preparation information into the preparation history information storage, the first preparation information associated with the at least one first preparation occurrence by the automated preparation equipment of the at least one first ingestible product as at least one composition including one or more fluids (e.g. one or more of instances of the application specific integrated circuit (ASIC) component s108 of the control and information processing subsystem s100 can direct storing the first preparation information into one or more instances of the electrically erasable programmable read only memory (EEPROM) component s212, involving preparation of one or more soft drinks, etc.). In an implementation, the electronically directing storing of the first preparation information into the preparation history information storage, the first preparation information associated with the at least one first preparation occurrence by the automated preparation equipment of the at least one first ingestible product as at least one composition including one or more fluids is carried out by electronically directing storing of the first preparation information into the preparation history information storage, the first preparation information associated with the at least one first preparation occurrence by the automated preparation equipment of the at least one first ingestible product as at least one composition including one or more fluids (e.g. one or more of instances of the application specific integrated circuit (ASIC) component s108 of the control and information processing subsystem s100 can direct storing the first preparation information into one or more instances of the electrically erasable programmable read only memory (EEPROM) component s212, involving preparation of one or more soft drinks, etc.).

In one or more implementations, operation o11 includes an operation o1130 for electronically directing storing of the first preparation information into the preparation history information storage, the first preparation information associated with the at least one first preparation occurrence by the automated preparation equipment of the at least one first ingestible product as at least one combination of one or more powders. An exemplary version of a non-transitory signal bearing medium of information storage subsystem s200 is depicted as bearing one or more combination powders instructions i1130 that when executed will direct performance of the operation o1130. In an implementation, the one or more combination powders instructions i1130 when executed direct electronically directing storing of the first preparation information into the preparation history information storage, the first preparation information associated with the at least one first preparation occurrence by the automated preparation equipment of the at least one first ingestible product as at least one combination of one or more powders (e.g. one or more of instances of the field programmable gate array (FPGA) component s110 of the control and information processing subsystem s100 can direct storing the first preparation information into one or more instances of the compact disk (CD) component s214, involving one or more skin treatments, etc.). Furthermore, the combination powders electrical circuitry arrangement e1130 when activated will perform the operation o1130. In an implementation, the combination powders electrical circuitry arrangement e1130, when activated performs electronically directing storing of the first preparation information into the preparation history information storage, the first preparation information associated with the at least one first preparation occurrence by the automated preparation equipment of the at least one first ingestible product as at least one combination of one or more powders (e.g. one or more of instances of the field programmable gate array (FPGA) component s110 of the control and information processing subsystem s100 can direct storing the first preparation information into one or more instances of the compact disk (CD) component s214, involving one or more skin treatments, etc.). In an implementation, the electronically directing storing of the first preparation information into the preparation history information storage, the first preparation information associated with the at least one first preparation occurrence by the automated preparation equipment of the at least one first ingestible product as at least one combination of one or more powders is carried out by electronically directing storing of the first preparation information into the preparation history information storage, the first preparation information associated with the at least one first preparation occurrence by the automated preparation equipment of the at least one first ingestible product as at least one combination of one or more powders (e.g. one or more of instances of the field programmable gate array (FPGA) component s110 of the control and information processing subsystem s100 can direct storing the first preparation information into one or more instances of the compact disk (CD) component s214, involving one or more skin treatments, etc.).

In one or more implementations, as shown in FIG. 42, operation o11 includes an operation o1131 for electronically directing storing of the first preparation information into the preparation history information storage, the first preparation information associated with the at least one first preparation occurrence by the automated preparation equipment of the at least one first ingestible product as excluding one or more allergens. An exemplary version of a non-transitory signal bearing medium of information storage subsystem s200 is depicted as bearing one or more excluding allergens instructions i1131 that when executed will direct performance of the operation o1131. In an implementation, the one or more excluding allergens instructions i1131 when executed direct electronically directing storing of the first preparation information into the preparation history information storage, the first preparation information associated with the at least one first preparation occurrence by the automated preparation equipment of the at least one first ingestible product as excluding one or more allergens (e.g. one or more of instances of the multiprocessor component s112 of the control and information processing subsystem s100 can direct storing the first preparation information into one or more instances of the digital versatile disk (DVD) component s216, involving preparation excluding soybeans and peanuts due to user allergies, etc.). Furthermore, the excluding allergens electrical circuitry arrangement e1131 when activated will perform the operation o1131. In an implementation, the excluding allergens electrical circuitry arrangement e1131, when activated performs electronically directing storing of the first preparation information into the preparation history information storage, the first preparation information associated with the at least one first preparation occurrence by the automated preparation equipment of the at least one first ingestible product as excluding one or more allergens (e.g. one or more of instances of the multiprocessor component s112 of the control and information processing subsystem s100 can direct storing the first preparation information into one or more instances of the digital versatile disk (DVD) component s216, involving preparation excluding soybeans and peanuts due to user allergies, etc.). In an implementation, the electronically directing storing of the first preparation information into the preparation history information storage, the first preparation information associated with the at least one first preparation occurrence by the automated preparation equipment of the at least one first ingestible product as excluding one or more allergens is carried out by electronically directing storing of the first preparation information into the preparation history information storage, the first preparation information associated with the at least one first preparation occurrence by the automated preparation equipment of the at least one first ingestible product as excluding one or more allergens (e.g. one or more of instances of the multiprocessor component s112 of the control and information processing subsystem s100 can direct storing the first preparation information into one or more instances of the digital versatile disk (DVD) component s216, involving preparation excluding soybeans and peanuts due to user allergies, etc.).

In one or more implementations, operation o11 includes an operation o1132 for electronically directing storing of the first preparation information into the preparation history information storage, the first preparation information associated with the at least one first preparation occurrence by the automated preparation equipment of the at least one first ingestible product as including one or more controlled pharmaceutical agents. An exemplary version of a non-transitory signal bearing medium of information storage subsystem s200 is depicted as bearing one or more pharmaceutical agents instructions i1132 that when executed will direct performance of the operation o1132. In an implementation, the one or more pharmaceutical agents instructions i1132 when executed direct electronically directing storing of the first preparation information into the preparation history information storage, the first preparation information associated with the at least one first preparation occurrence by the automated preparation equipment of the at least one first ingestible product as including one or more controlled pharmaceutical agents (e.g. one or more of instances of the optical processing component s114 of the control and information processing subsystem s100 can direct storing the first preparation information into one or more instances of the flash memory component s218, involving preparation including the first preparation occurrence involving one or more instances of the heating component s702, involving preparation including acetaminophen and diazepam, etc.). Furthermore, the pharmaceutical agents electrical circuitry arrangement e1132 when activated will perform the operation o1132. In an implementation, the pharmaceutical agents electrical circuitry arrangement e1132, when activated performs electronically directing storing of the first preparation information into the preparation history information storage, the first preparation information associated with the at least one first preparation occurrence by the automated preparation equipment of the at least one first ingestible product as including one or more controlled pharmaceutical agents (e.g. one or more of instances of the optical processing component s114 of the control and information processing subsystem s100 can direct storing the first preparation information into one or more instances of the flash memory component s218, involving preparation including the first preparation occurrence involving one or more instances of the heating component s702, involving preparation including acetaminophen and diazepam, etc.). In an implementation, the electronically directing storing of the first preparation information into the preparation history information storage, the first preparation information associated with the at least one first preparation occurrence by the automated preparation equipment of the at least one first ingestible product as including one or more controlled pharmaceutical agents is carried out by electronically directing storing of the first preparation information into the preparation history information storage, the first preparation information associated with the at least one first preparation occurrence by the automated preparation equipment of the at least one first ingestible product as including one or more controlled pharmaceutical agents (e.g. one or more of instances of the optical processing component s114 of the control and information processing subsystem s100 can direct storing the first preparation information into one or more instances of the flash memory component s218, involving preparation including the first preparation occurrence involving one or more instances of the heating component s702, involving preparation including acetaminophen and diazepam, etc.).

In one or more implementations, operation o11 includes an operation o1133 for electronically directing storing of the first preparation information into the preparation history information storage, the first preparation information associated with the at least one first preparation occurrence by the automated preparation equipment of the at least one first ingestible product as originating from one or more geographic regions. An exemplary version of a non-transitory signal bearing medium of information storage subsystem s200 is depicted as bearing one or more geographic regions instructions i1133 that when executed will direct performance of the operation o1133. In an implementation, the one or more geographic regions instructions i1133 when executed direct electronically directing storing of the first preparation information into the preparation history information storage, the first preparation information associated with the at least one first preparation occurrence by the automated preparation equipment of the at least one first ingestible product as originating from one or more geographic regions (e.g. one or more of instances of the logic component s116 of the control and information processing subsystem s100 can direct storing the first preparation information into one or more instances of the other nonvolatile memory component s220, involving preparation using ingredients only from the western United States, etc.). Furthermore, the geographic regions electrical circuitry arrangement e1133 when activated will perform the operation o1133. In an implementation, the geographic regions electrical circuitry arrangement e1133, when activated performs electronically directing storing of the first preparation information into the preparation history information storage, the first preparation information associated with the at least one first preparation occurrence by the automated preparation equipment of the at least one first ingestible product as originating from one or more geographic regions (e.g. one or more of instances of the logic component s116 of the control and information processing subsystem s100 can direct storing the first preparation information into one or more instances of the other nonvolatile memory component s220, involving preparation using ingredients only from the western United States, etc.). In an implementation, the electronically directing storing of the first preparation information into the preparation history information storage, the first preparation information associated with the at least one first preparation occurrence by the automated preparation equipment of the at least one first ingestible product as originating from one or more geographic regions is carried out by electronically directing storing of the first preparation information into the preparation history information storage, the first preparation information associated with the at least one first preparation occurrence by the automated preparation equipment of the at least one first ingestible product as originating from one or more geographic regions (e.g. one or more of instances of the logic component s116 of the control and information processing subsystem s100 can direct storing the first preparation information into one or more instances of the other nonvolatile memory component s220, involving preparation using ingredients only from the western United States, etc.).

In one or more implementations, as shown in FIG. 43, operation o11 includes an operation o1134 for electronically directing storing of the first preparation information into the preparation history information storage, the first preparation information associated with the at least one first preparation occurrence by the automated preparation equipment of the at least one first ingestible product as being endorsed by one or more authoritative entities. An exemplary version of a non-transitory signal bearing medium of information storage subsystem s200 is depicted as bearing one or more authoritative entities instructions i1134 that when executed will direct performance of the operation o1134. In an implementation, the one or more authoritative entities instructions i1134 when executed direct electronically directing storing of the first preparation information into the preparation history information storage, the first preparation information associated with the at least one first preparation occurrence by the automated preparation equipment of the at least one first ingestible product as being endorsed by one or more authoritative entities (e.g. one or more of instances of the microprocessor component s102 of the control and information processing subsystem s100 can direct storing the first preparation information into one or more instances of the hard drive component s222, involving preparation being endorsed by five major league baseball players, etc.). Furthermore, the authoritative entities electrical circuitry arrangement e1134 when activated will perform the operation o1134. In an implementation, the authoritative entities electrical circuitry arrangement e1134, when activated performs electronically directing storing of the first preparation information into the preparation history information storage, the first preparation information associated with the at least one first preparation occurrence by the automated preparation equipment of the at least one first ingestible product as being endorsed by one or more authoritative entities (e.g. one or more of instances of the microprocessor component s102 of the control and information processing subsystem s100 can direct storing the first preparation information into one or more instances of the hard drive component s222, involving preparation being endorsed by five major league baseball players, etc.). In an implementation, the electronically directing storing of the first preparation information into the preparation history information storage, the first preparation information associated with the at least one first preparation occurrence by the automated preparation equipment of the at least one first ingestible product as being endorsed by one or more authoritative entities is carried out by electronically directing storing of the first preparation information into the preparation history information storage, the first preparation information associated with the at least one first preparation occurrence by the automated preparation equipment of the at least one first ingestible product as being endorsed by one or more authoritative entities (e.g. one or more of instances of the microprocessor component s102 of the control and information processing subsystem s100 can direct storing the first preparation information into one or more instances of the hard drive component s222, involving preparation being endorsed by five major league baseball players, etc.).

In one or more implementations, operation o11 includes an operation o1135 for electronically directing storing of the first preparation information into the preparation history information storage, the first preparation information associated with the at least one first preparation occurrence by the automated preparation equipment of the at least one first ingestible product as being endorsed by one or more designated users. An exemplary version of a non-transitory signal bearing medium of information storage subsystem s200 is depicted as bearing one or more designated users instructions i1135 that when executed will direct performance of the operation o1135. In an implementation, the one or more designated users instructions i1135 when executed direct electronically directing storing of the first preparation information into the preparation history information storage, the first preparation information associated with the at least one first preparation occurrence by the automated preparation equipment of the at least one first ingestible product as being endorsed by one or more designated users (e.g. one or more of instances of the logic component s116 of the control and information processing subsystem s100 can direct storing the first preparation information into one or more instances of the disk farm component s224, involving preparation used for and endorsed by famous actors that suffer migraine headaches, etc.). Furthermore, the designated users electrical circuitry arrangement e1135 when activated will perform the operation o1135. In an implementation, the designated users electrical circuitry arrangement e1135, when activated performs electronically directing storing of the first preparation information into the preparation history information storage, the first preparation information associated with the at least one first preparation occurrence by the automated preparation equipment of the at least one first ingestible product as being endorsed by one or more designated users (e.g. one or more of instances of the logic component s116 of the control and information processing subsystem s100 can direct storing the first preparation information into one or more instances of the disk farm component s224, involving preparation used for and endorsed by famous actors that suffer migraine headaches, etc.). In an implementation, the electronically directing storing of the first preparation information into the preparation history information storage, the first preparation information associated with the at least one first preparation occurrence by the automated preparation equipment of the at least one first ingestible product as being endorsed by one or more designated users is carried out by electronically directing storing of the first preparation information into the preparation history information storage, the first preparation information associated with the at least one first preparation occurrence by the automated preparation equipment of the at least one first ingestible product as being endorsed by one or more designated users (e.g. one or more of instances of the logic component s116 of the control and information processing subsystem s100 can direct storing the first preparation information into one or more instances of the disk farm component s224, involving preparation used for and endorsed by famous actors that suffer migraine headaches, etc.).

In one or more implementations, operation o11 includes an operation o1136 for electronically directing storing of the first preparation information into the preparation history information storage, the first preparation information associated with the at least one first preparation occurrence by the automated preparation equipment of the at least one first ingestible product including the first portion of the at least one first substance as one or more powders. An exemplary version of a non-transitory signal bearing medium of information storage subsystem s200 is depicted as bearing one or more substance powders instructions i1136 that when executed will direct performance of the operation o1136. In an implementation, the one or more substance powders instructions i1136 when executed direct electronically directing storing of the first preparation information into the preparation history information storage, the first preparation information associated with the at least one first preparation occurrence by the automated preparation equipment of the at least one first ingestible product including the first portion of the at least one first substance as one or more powders (e.g. one or more of instances of the central processing unit (CPU) component s104 of the control and information processing subsystem s100 can direct storing the first preparation information into one or more instances of the disk cluster component s226, involving preparation using ingredients including one or more powdered bulking agents, etc.). Furthermore, the substance powders electrical circuitry arrangement e1136 when activated will perform the operation o1136. In an implementation, the substance powders electrical circuitry arrangement e1136, when activated performs electronically directing storing of the first preparation information into the preparation history information storage, the first preparation information associated with the at least one first preparation occurrence by the automated preparation equipment of the at least one first ingestible product including the first portion of the at least one first substance as one or more powders (e.g. one or more of instances of the central processing unit (CPU) component s104 of the control and information processing subsystem s100 can direct storing the first preparation information into one or more instances of the disk cluster component s226, involving preparation using ingredients including one or more powdered bulking agents, etc.). In an implementation, the electronically directing storing of the first preparation information into the preparation history information storage, the first preparation information associated with the at least one first preparation occurrence by the automated preparation equipment of the at least one first ingestible product including the first portion of the at least one first substance as one or more powders is carried out by electronically directing storing of the first preparation information into the preparation history information storage, the first preparation information associated with the at least one first preparation occurrence by the automated preparation equipment of the at least one first ingestible product including the first portion of the at least one first substance as one or more powders (e.g. one or more of instances of the central processing unit (CPU) component s104 of the control and information processing subsystem s100 can direct storing the first preparation information into one or more instances of the disk cluster component s226, involving preparation using ingredients including one or more powdered bulking agents, etc.).

In one or more implementations, as shown in FIG. 44, operation o11 includes an operation o1137 for electronically directing storing of the first preparation information into the preparation history information storage, the first preparation information associated with the at least one first preparation occurrence by the automated preparation equipment of the at least one first ingestible product including the first portion of the at least one first substance as one or more liquids. An exemplary version of a non-transitory signal bearing medium of information storage subsystem s200 is depicted as bearing one or more substance liquids instructions i1137 that when executed will direct performance of the operation o1137. In an implementation, the one or more substance liquids instructions i1137 when executed direct electronically directing storing of the first preparation information into the preparation history information storage, the first preparation information associated with the at least one first preparation occurrence by the automated preparation equipment of the at least one first ingestible product including the first portion of the at least one first substance as one or more liquids (e.g. one or more of instances of the digital signal processor (DSP) component s106 of the control and information processing subsystem s100 can direct storing the first preparation information into one or more instances of the remote backup component s228, involving preparation using ingredients including water and apple juice, etc.). Furthermore, the substance liquids electrical circuitry arrangement e1137 when activated will perform the operation o1137. In an implementation, the substance liquids electrical circuitry arrangement e1137, when activated performs electronically directing storing of the first preparation information into the preparation history information storage, the first preparation information associated with the at least one first preparation occurrence by the automated preparation equipment of the at least one first ingestible product including the first portion of the at least one first substance as one or more liquids (e.g. one or more of instances of the digital signal processor (DSP) component s106 of the control and information processing subsystem s100 can direct storing the first preparation information into one or more instances of the remote backup component s228, involving preparation using ingredients including water and apple juice, etc.). In an implementation, the electronically directing storing of the first preparation information into the preparation history information storage, the first preparation information associated with the at least one first preparation occurrence by the automated preparation equipment of the at least one first ingestible product including the first portion of the at least one first substance as one or more liquids is carried out by electronically directing storing of the first preparation information into the preparation history information storage, the first preparation information associated with the at least one first preparation occurrence by the automated preparation equipment of the at least one first ingestible product including the first portion of the at least one first substance as one or more liquids (e.g. one or more of instances of the digital signal processor (DSP) component s106 of the control and information processing subsystem s100 can direct storing the first preparation information into one or more instances of the remote backup component s228, involving preparation using ingredients including water and apple juice, etc.).

In one or more implementations, operation o11 includes an operation o1138 for electronically directing storing of the first preparation information into the preparation history information storage, the first preparation information associated with the at least one first preparation occurrence by the automated preparation equipment of the at least one first ingestible product including the first portion of the at least one first substance as one or more gels. An exemplary version of a non-transitory signal bearing medium of information storage subsystem s200 is depicted as bearing one or more substance gel instructions i1138 that when executed will direct performance of the operation o1138. In an implementation, the one or more substance gel instructions i1138 when executed direct electronically directing storing of the first preparation information into the preparation history information storage, the first preparation information associated with the at least one first preparation occurrence by the automated preparation equipment of the at least one first ingestible product including the first portion of the at least one first substance as one or more gels (e.g. one or more of instances of the application specific integrated circuit (ASIC) component s108 of the control and information processing subsystem s100 can direct storing the first preparation information into one or more instances of the server component s230, involving preparation using ingredients including glycerol, etc.). Furthermore, the substance gel electrical circuitry arrangement e1138 when activated will perform the operation o1138. In an implementation, the substance gel electrical circuitry arrangement e1138, when activated performs electronically directing storing of the first preparation information into the preparation history information storage, the first preparation information associated with the at least one first preparation occurrence by the automated preparation equipment of the at least one first ingestible product including the first portion of the at least one first substance as one or more gels (e.g. one or more of instances of the application specific integrated circuit (ASIC) component s108 of the control and information processing subsystem s100 can direct storing the first preparation information into one or more instances of the server component s230, involving preparation using ingredients including glycerol, etc.). In an implementation, the electronically directing storing of the first preparation information into the preparation history information storage, the first preparation information associated with the at least one first preparation occurrence by the automated preparation equipment of the at least one first ingestible product including the first portion of the at least one first substance as one or more gels is carried out by electronically directing storing of the first preparation information into the preparation history information storage, the first preparation information associated with the at least one first preparation occurrence by the automated preparation equipment of the at least one first ingestible product including the first portion of the at least one first substance as one or more gels (e.g. one or more of instances of the application specific integrated circuit (ASIC) component s108 of the control and information processing subsystem s100 can direct storing the first preparation information into one or more instances of the server component s230, involving preparation using ingredients including glycerol, etc.).

In one or more implementations, operation o11 includes an operation o1139 for electronically directing storing of the first preparation information into the preparation history information storage, the first preparation information associated with the at least one first preparation occurrence by the automated preparation equipment of the at least one first ingestible product including the first portion of the at least one first substance as one or more solids. An exemplary version of a non-transitory signal bearing medium of information storage subsystem s200 is depicted as bearing one or more substance solids instructions i1139 that when executed will direct performance of the operation o1139. In an implementation, the one or more substance solids instructions i1139 when executed direct electronically directing storing of the first preparation information into the preparation history information storage, the first preparation information associated with the at least one first preparation occurrence by the automated preparation equipment of the at least one first ingestible product including the first portion of the at least one first substance as one or more solids (e.g. one or more of instances of the field programmable gate array (FPGA) component s110 of the control and information processing subsystem s100 can direct storing the first preparation information into one or more instances of the digital tape component s232, involving preparation using ingredients including frozen coconut oil, etc.). Furthermore, the substance solids electrical circuitry arrangement e1139 when activated will perform the operation o1139. In an implementation, the substance solids electrical circuitry arrangement e1139, when activated performs electronically directing storing of the first preparation information into the preparation history information storage, the first preparation information associated with the at least one first preparation occurrence by the automated preparation equipment of the at least one first ingestible product including the first portion of the at least one first substance as one or more solids (e.g. one or more of instances of the field programmable gate array (FPGA) component s110 of the control and information processing subsystem s100 can direct storing the first preparation information into one or more instances of the digital tape component s232, involving preparation using ingredients including frozen coconut oil, etc.). In an implementation, the electronically directing storing of the first preparation information into the preparation history information storage, the first preparation information associated with the at least one first preparation occurrence by the automated preparation equipment of the at least one first ingestible product including the first portion of the at least one first substance as one or more solids is carried out by electronically directing storing of the first preparation information into the preparation history information storage, the first preparation information associated with the at least one first preparation occurrence by the automated preparation equipment of the at least one first ingestible product including the first portion of the at least one first substance as one or more solids (e.g. one or more of instances of the field programmable gate array (FPGA) component s110 of the control and information processing subsystem s100 can direct storing the first preparation information into one or more instances of the digital tape component s232, involving preparation using ingredients including frozen coconut oil, etc.).

In one or more implementations, as shown in FIG. 45, operation o11 includes an operation o1140 for electronically directing storing of the first preparation information into the preparation history information storage, the first preparation information associated with the at least one first preparation occurrence by the automated preparation equipment of the at least one first ingestible product including the first portion of the at least one first substance as one or more mixtures. An exemplary version of a non-transitory signal bearing medium of information storage subsystem s200 is depicted as bearing one or more substance mixtures instructions i1140 that when executed will direct performance of the operation o1140. In an implementation, the one or more substance mixtures instructions i1140 when executed direct electronically directing storing of the first preparation information into the preparation history information storage, the first preparation information associated with the at least one first preparation occurrence by the automated preparation equipment of the at least one first ingestible product including the first portion of the at least one first substance as one or more mixtures (e.g. one or more of instances of the multiprocessor component s112 of the control and information processing subsystem s100 can direct storing the first preparation information into one or more instances of the optical storage component s234, involving preparation using ingredients including a multivitamin formula, etc.). Furthermore, the substance mixtures electrical circuitry arrangement e1140 when activated will perform the operation o1140. In an implementation, the substance mixtures electrical circuitry arrangement e1140, when activated performs electronically directing storing of the first preparation information into the preparation history information storage, the first preparation information associated with the at least one first preparation occurrence by the automated preparation equipment of the at least one first ingestible product including the first portion of the at least one first substance as one or more mixtures (e.g. one or more of instances of the multiprocessor component s112 of the control and information processing subsystem s100 can direct storing the first preparation information into one or more instances of the optical storage component s234, involving preparation using ingredients including a multivitamin formula, etc.). In an implementation, the electronically directing storing of the first preparation information into the preparation history information storage, the first preparation information associated with the at least one first preparation occurrence by the automated preparation equipment of the at least one first ingestible product including the first portion of the at least one first substance as one or more mixtures is carried out by electronically directing storing of the first preparation information into the preparation history information storage, the first preparation information associated with the at least one first preparation occurrence by the automated preparation equipment of the at least one first ingestible product including the first portion of the at least one first substance as one or more mixtures (e.g. one or more of instances of the multiprocessor component s112 of the control and information processing subsystem s100 can direct storing the first preparation information into one or more instances of the optical storage component s234, involving preparation using ingredients including a multivitamin formula, etc.).

In one or more implementations, operation o11 includes an operation o1141 for electronically directing storing of the first cleaning information, if existent, into the cleaning history information storage via one or more cellular networks. An exemplary version of a non-transitory signal bearing medium of information storage subsystem s200 is depicted as bearing one or more cleaning cellular instructions i1141 that when executed will direct performance of the operation o1141. In an implementation, the one or more cleaning cellular instructions i1141 when executed direct electronically directing storing of the first cleaning information, if existent, into the cleaning history information storage via one or more cellular networks (e.g. one or more of instances of the optical processing component s114 of the control and information processing subsystem s100 can direct storing the first cleaning information into one or more instances of the optical storage component s236, via one or more instances of the cellular network component s514, etc.). Furthermore, the cleaning cellular electrical circuitry arrangement e1141 when activated will perform the operation o1141. In an implementation, the cleaning cellular electrical circuitry arrangement e1141, when activated performs electronically directing storing of the first cleaning information, if existent, into the cleaning history information storage via one or more cellular networks (e.g. one or more of instances of the optical processing component s114 of the control and information processing subsystem s100 can direct storing the first cleaning information into one or more instances of the optical storage component s236, via one or more instances of the cellular network component s514, etc.). In an implementation, the electronically directing storing of the first cleaning information, if existent, into the cleaning history information storage via one or more cellular networks is carried out by electronically directing storing of the first cleaning information, if existent, into the cleaning history information storage via one or more cellular networks (e.g. one or more of instances of the optical processing component s114 of the control and information processing subsystem s100 can direct storing the first cleaning information into one or more instances of the optical storage component s236, via one or more instances of the cellular network component s514, etc.).

In one or more implementations, operation o11 includes an operation o1142 for electronically directing storing of the first cleaning information, if existent, into the cleaning history information storage via one or more computer networks. An exemplary version of a non-transitory signal bearing medium of information storage subsystem s200 is depicted as bearing one or more cleaning network instructions i1142 that when executed will direct performance of the operation o1142. In an implementation, the one or more cleaning network instructions i1142 when executed direct electronically directing storing of the first cleaning information, if existent, into the cleaning history information storage via one or more computer networks (e.g. one or more of instances of the logic component s116 of the control and information processing subsystem s100 can direct storing the first cleaning information into one or more instances of the computer readable signal bearing medium s238, via one or more instances of the network cable component s502, etc.). Furthermore, the cleaning network electrical circuitry arrangement e1142 when activated will perform the operation o1142. In an implementation, the cleaning network electrical circuitry arrangement e1142, when activated performs electronically directing storing of the first cleaning information, if existent, into the cleaning history information storage via one or more computer networks (e.g. one or more of instances of the logic component s116 of the control and information processing subsystem s100 can direct storing the first cleaning information into one or more instances of the computer readable signal bearing medium s238, via one or more instances of the network cable component s502, etc.). In an implementation, the electronically directing storing of the first cleaning information, if existent, into the cleaning history information storage via one or more computer networks is carried out by electronically directing storing of the first cleaning information, if existent, into the cleaning history information storage via one or more computer networks (e.g. one or more of instances of the logic component s116 of the control and information processing subsystem s100 can direct storing the first cleaning information into one or more instances of the computer readable signal bearing medium s238, via one or more instances of the network cable component s502, etc.).

In one or more implementations, as shown in FIG. 46, operation o11 includes an operation o1143 for electronically directing storing of the first cleaning information, if existent, into the cleaning history information storage via communication circuitry of the automated preparation equipment. An exemplary version of a non-transitory signal bearing medium of information storage subsystem s200 is depicted as bearing one or more cleaning circuitry instructions i1143 that when executed will direct performance of the operation o1143. In an implementation, the one or more cleaning circuitry instructions i1143 when executed direct electronically directing storing of the first cleaning information, if existent, into the cleaning history information storage via communication circuitry of the automated preparation equipment (e.g. one or more of instances of the microprocessor component s102 of the control and information processing subsystem s100 can direct storing the first cleaning information into one or more instances of the Blu Ray disk component s240, via one or more instances of the transceiver component s522, etc.). Furthermore, the cleaning circuitry electrical circuitry arrangement e1143 when activated will perform the operation o1143. In an implementation, the cleaning circuitry electrical circuitry arrangement e1143, when activated performs electronically directing storing of the first cleaning information, if existent, into the cleaning history information storage via communication circuitry of the automated preparation equipment (e.g. one or more of instances of the microprocessor component s102 of the control and information processing subsystem s100 can direct storing the first cleaning information into one or more instances of the Blu Ray disk component s240, via one or more instances of the transceiver component s522, etc.). In an implementation, the electronically directing storing of the first cleaning information, if existent, into the cleaning history information storage via communication circuitry of the automated preparation equipment is carried out by electronically directing storing of the first cleaning information, if existent, into the cleaning history information storage via communication circuitry of the automated preparation equipment (e.g. one or more of instances of the microprocessor component s102 of the control and information processing subsystem s100 can direct storing the first cleaning information into one or more instances of the Blu Ray disk component s240, via one or more instances of the transceiver component s522, etc.).

In one or more implementations, operation o11 includes an operation o1144 for electronically directing storing of the first cleaning information, if existent, into the cleaning history information storage via wireless communication. An exemplary version of a non-transitory signal bearing medium of information storage subsystem s200 is depicted as bearing one or more cleaning wireless instructions i1144 that when executed will direct performance of the operation o1144. In an implementation, the one or more cleaning wireless instructions i1144 when executed direct electronically directing storing of the first cleaning information, if existent, into the cleaning history information storage via wireless communication (e.g. one or more of instances of the central processing unit (CPU) component s104 of the control and information processing subsystem s100 can direct storing the first cleaning information into one or more instances of the random access memory (RAM) component s202, via one or more instances of the wireless network component s510, etc.). Furthermore, the cleaning wireless electrical circuitry arrangement e1144 when activated will perform the operation o1144. In an implementation, the cleaning wireless electrical circuitry arrangement e1144, when activated performs electronically directing storing of the first cleaning information, if existent, into the cleaning history information storage via wireless communication (e.g. one or more of instances of the central processing unit (CPU) component s104 of the control and information processing subsystem s100 can direct storing the first cleaning information into one or more instances of the random access memory (RAM) component s202, via one or more instances of the wireless network component s510, etc.). In an implementation, the electronically directing storing of the first cleaning information, if existent, into the cleaning history information storage via wireless communication is carried out by electronically directing storing of the first cleaning information, if existent, into the cleaning history information storage via wireless communication (e.g. one or more of instances of the central processing unit (CPU) component s104 of the control and information processing subsystem s100 can direct storing the first cleaning information into one or more instances of the random access memory (RAM) component s202, via one or more instances of the wireless network component s510, etc.).

In one or more implementations, operation o11 includes an operation o1145 for electronically directing storing of the first cleaning information, if existent, into the cleaning history information storage via one or more microprocessors. An exemplary version of a non-transitory signal bearing medium of information storage subsystem s200 is depicted as bearing one or more cleaning microprocessor instructions i1145 that when executed will direct performance of the operation o1145. In an implementation, the one or more cleaning microprocessor instructions i1145 when executed direct electronically directing storing of the first cleaning information, if existent, into the cleaning history information storage via one or more microprocessors (e.g. one or more of instances of the digital signal processor (DSP) component s106 of the control and information processing subsystem s100 can direct storing the first cleaning information into one or more instances of the dynamic random access memory (DRAM) component s204, via one or more instances of the encrypted communication component s520, etc.). Furthermore, the cleaning microprocessor electrical circuitry arrangement e1145 when activated will perform the operation o1145. In an implementation, the cleaning microprocessor electrical circuitry arrangement e1145, when activated performs electronically directing storing of the first cleaning information, if existent, into the cleaning history information storage via one or more microprocessors (e.g. one or more of instances of the digital signal processor (DSP) component s106 of the control and information processing subsystem s100 can direct storing the first cleaning information into one or more instances of the dynamic random access memory (DRAM) component s204, via one or more instances of the encrypted communication component s520, etc.). In an implementation, the electronically directing storing of the first cleaning information, if existent, into the cleaning history information storage via one or more microprocessors is carried out by electronically directing storing of the first cleaning information, if existent, into the cleaning history information storage via one or more microprocessors (e.g. one or more of instances of the digital signal processor (DSP) component s106 of the control and information processing subsystem s100 can direct storing the first cleaning information into one or more instances of the dynamic random access memory (DRAM) component s204, via one or more instances of the encrypted communication component s520, etc.).

In one or more implementations, as shown in FIG. 47, operation o11 includes an operation o1146 for electronically directing storing of the first cleaning information, if existent, into the cleaning history information storage in one or more memory circuits of the automated preparation equipment. An exemplary version of a non-transitory signal bearing medium of information storage subsystem s200 is depicted as bearing one or more cleaning memory instructions i1146 that when executed will direct performance of the operation o1146. In an implementation, the one or more cleaning memory instructions i1146 when executed direct electronically directing storing of the first cleaning information, if existent, into the cleaning history information storage in one or more memory circuits of the automated preparation equipment (e.g. one or more of instances of the application specific integrated circuit (ASIC) component s108 of the control and information processing subsystem s100 can direct storing the first cleaning information into one or more instances of the other volatile memory component s206, via one or more instances of the transmitter component s526, etc.). Furthermore, the cleaning memory electrical circuitry arrangement e1146 when activated will perform the operation o1146. In an implementation, the cleaning memory electrical circuitry arrangement e1146, when activated performs electronically directing storing of the first cleaning information, if existent, into the cleaning history information storage in one or more memory circuits of the automated preparation equipment (e.g. one or more of instances of the application specific integrated circuit (ASIC) component s108 of the control and information processing subsystem s100 can direct storing the first cleaning information into one or more instances of the other volatile memory component s206, via one or more instances of the transmitter component s526, etc.). In an implementation, the electronically directing storing of the first cleaning information, if existent, into the cleaning history information storage in one or more memory circuits of the automated preparation equipment is carried out by electronically directing storing of the first cleaning information, if existent, into the cleaning history information storage in one or more memory circuits of the automated preparation equipment (e.g. one or more of instances of the application specific integrated circuit (ASIC) component s108 of the control and information processing subsystem s100 can direct storing the first cleaning information into one or more instances of the other volatile memory component s206, via one or more instances of the transmitter component s526, etc.).

In one or more implementations, operation o11 includes an operation o1147 for electronically directing storing of the first cleaning information, if existent, into the cleaning history information storage in one or more networked servers. An exemplary version of a non-transitory signal bearing medium of information storage subsystem s200 is depicted as bearing one or more cleaning servers instructions i1147 that when executed will direct performance of the operation o1147. In an implementation, the one or more cleaning servers instructions i1147 when executed direct electronically directing storing of the first cleaning information, if existent, into the cleaning history information storage in one or more networked servers (e.g. one or more of instances of the field programmable gate array (FPGA) component s110 of the control and information processing subsystem s100 can direct storing the first cleaning information into one or more instances of the server component s230, etc.). Furthermore, the cleaning servers electrical circuitry arrangement e1147 when activated will perform the operation o1147. In an implementation, the cleaning servers electrical circuitry arrangement e1147, when activated performs electronically directing storing of the first cleaning information, if existent, into the cleaning history information storage in one or more networked servers (e.g. one or more of instances of the field programmable gate array (FPGA) component s110 of the control and information processing subsystem s100 can direct storing the first cleaning information into one or more instances of the server component s230, etc.). In an implementation, the electronically directing storing of the first cleaning information, if existent, into the cleaning history information storage in one or more networked servers is carried out by electronically directing storing of the first cleaning information, if existent, into the cleaning history information storage in one or more networked servers (e.g. one or more of instances of the field programmable gate array (FPGA) component s110 of the control and information processing subsystem s100 can direct storing the first cleaning information into one or more instances of the server component s230, etc.).

In one or more implementations, operation o11 includes an operation o1148 for electronically directing storing of the first cleaning information, if existent, into the cleaning history information storage in one or more electronic memory cards. An exemplary version of a non-transitory signal bearing medium of information storage subsystem s200 is depicted as bearing one or more cleaning card instructions i1148 that when executed will direct performance of the operation o1148. In an implementation, the one or more cleaning card instructions i1148 when executed direct electronically directing storing of the first cleaning information, if existent, into the cleaning history information storage in one or more electronic memory cards (e.g. one or more of instances of the multiprocessor component s112 of the control and information processing subsystem s100 can direct storing the first cleaning information into one or more instances of the read only memory (ROM) component s210, etc.). Furthermore, the cleaning card electrical circuitry arrangement e1148 when activated will perform the operation o1148. In an implementation, the cleaning card electrical circuitry arrangement e1148, when activated performs electronically directing storing of the first cleaning information, if existent, into the cleaning history information storage in one or more electronic memory cards (e.g. one or more of instances of the multiprocessor component s112 of the control and information processing subsystem s100 can direct storing the first cleaning information into one or more instances of the read only memory (ROM) component s210, etc.). In an implementation, the electronically directing storing of the first cleaning information, if existent, into the cleaning history information storage in one or more electronic memory cards is carried out by electronically directing storing of the first cleaning information, if existent, into the cleaning history information storage in one or more electronic memory cards (e.g. one or more of instances of the multiprocessor component s112 of the control and information processing subsystem s100 can direct storing the first cleaning information into one or more instances of the read only memory (ROM) component s210, etc.).

In one or more implementations, as shown in FIG. 48, operation o11 includes an operation o1149 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via blowing air. An exemplary version of a non-transitory signal bearing medium of information storage subsystem s200 is depicted as bearing one or more cleaning blowing instructions i1149 that when executed will direct performance of the operation o1149. In an implementation, the one or more cleaning blowing instructions i1149 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via blowing air (e.g. one or more of instances of the optical processing component s114 of the control and information processing subsystem s100 can direct storing the first cleaning information into one or more instances of the electrically erasable programmable read only memory (EEPROM) component s212, involving use of one or more instances of the air blower component s802 to remove a second portion of an energy bar, etc.). Furthermore, the cleaning blowing electrical circuitry arrangement e1149 when activated will perform the operation o1149. In an implementation, the cleaning blowing electrical circuitry arrangement e1149, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via blowing air (e.g. one or more of instances of the optical processing component s114 of the control and information processing subsystem s100 can direct storing the first cleaning information into one or more instances of the electrically erasable programmable read only memory (EEPROM) component s212, involving use of one or more instances of the air blower component s802 to remove a second portion of an energy bar, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via blowing air is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via blowing air (e.g. one or more of instances of the optical processing component s114 of the control and information processing subsystem s100 can direct storing the first cleaning information into one or more instances of the electrically erasable programmable read only memory (EEPROM) component s212, involving use of one or more instances of the air blower component s802 to remove a second portion of an energy bar, etc.).

In one or more implementations, operation o11 includes an operation o1150 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via injecting compressed fluid. An exemplary version of a non-transitory signal bearing medium of information storage subsystem s200 is depicted as bearing one or more cleaning compressed instructions i1150 that when executed will direct performance of the operation o1150. In an implementation, the one or more cleaning compressed instructions i1150 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via injecting compressed fluid (e.g. one or more of instances of the logic component s116 of the control and information processing subsystem s100 can direct storing the first cleaning information into one or more instances of the compact disk (CD) component s214, involving use of one or more instances of the compressed water fluid component s830 to remove a second portion of a soft drink, etc.). Furthermore, the cleaning compressed electrical circuitry arrangement e1150 when activated will perform the operation o1150. In an implementation, the cleaning compressed electrical circuitry arrangement e1150, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via injecting compressed fluid (e.g. one or more of instances of the logic component s116 of the control and information processing subsystem s100 can direct storing the first cleaning information into one or more instances of the compact disk (CD) component s214, involving use of one or more instances of the compressed water fluid component s830 to remove a second portion of a soft drink, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via injecting compressed fluid is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via injecting compressed fluid (e.g. one or more of instances of the logic component s116 of the control and information processing subsystem s100 can direct storing the first cleaning information into one or more instances of the compact disk (CD) component s214, involving use of one or more instances of the compressed water fluid component s830 to remove a second portion of a soft drink, etc.).

In one or more implementations, operation o11 includes an operation o1151 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via applying a vacuum. An exemplary version of a non-transitory signal bearing medium of information storage subsystem s200 is depicted as bearing one or more cleaning vacuum instructions i1151 that when executed will direct performance of the operation o1151. In an implementation, the one or more cleaning vacuum instructions i1151 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via applying a vacuum (e.g. one or more of instances of the microprocessor component s102 of the control and information processing subsystem s100 can direct storing the first cleaning information into one or more instances of the digital versatile disk (DVD) component s216, involving use of one or more instances of the vacuum component s806 to remove a second portion of a soup mix, etc.). Furthermore, the cleaning vacuum electrical circuitry arrangement e1151 when activated will perform the operation o1151. In an implementation, the cleaning vacuum electrical circuitry arrangement e1151, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via applying a vacuum (e.g. one or more of instances of the microprocessor component s102 of the control and information processing subsystem s100 can direct storing the first cleaning information into one or more instances of the digital versatile disk (DVD) component s216, involving use of one or more instances of the vacuum component s806 to remove a second portion of a soup mix, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via applying a vacuum is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via applying a vacuum (e.g. one or more of instances of the microprocessor component s102 of the control and information processing subsystem s100 can direct storing the first cleaning information into one or more instances of the digital versatile disk (DVD) component s216, involving use of one or more instances of the vacuum component s806 to remove a second portion of a soup mix, etc.).

In one or more implementations, as shown in FIG. 49, operation o11 includes an operation o1152 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via emitting ultrasonic waves. An exemplary version of a non-transitory signal bearing medium of information storage subsystem s200 is depicted as bearing one or more cleaning ultrasonic instructions i1152 that when executed will direct performance of the operation o1152. In an implementation, the one or more cleaning ultrasonic instructions i1152 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via emitting ultrasonic waves (e.g. one or more of instances of the central processing unit (CPU) component s104 of the control and information processing subsystem s100 can direct storing the first cleaning information into one or more instances of the flash memory component s218, involving use of one or more instances of the ultrasonic component s808 to remove a second portion of a salad mix, etc.). Furthermore, the cleaning ultrasonic electrical circuitry arrangement e1152 when activated will perform the operation o1152. In an implementation, the cleaning ultrasonic electrical circuitry arrangement e1152, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via emitting ultrasonic waves (e.g. one or more of instances of the central processing unit (CPU) component s104 of the control and information processing subsystem s100 can direct storing the first cleaning information into one or more instances of the flash memory component s218, involving use of one or more instances of the ultrasonic component s808 to remove a second portion of a salad mix, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via emitting ultrasonic waves is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via emitting ultrasonic waves (e.g. one or more of instances of the central processing unit (CPU) component s104 of the control and information processing subsystem s100 can direct storing the first cleaning information into one or more instances of the flash memory component s218, involving use of one or more instances of the ultrasonic component s808 to remove a second portion of a salad mix, etc.).

In one or more implementations, operation o11 includes an operation o1153 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via emitting electromagnetic energy. An exemplary version of a non-transitory signal bearing medium of information storage subsystem s200 is depicted as bearing one or more cleaning electromagnetic instructions i1153 that when executed will direct performance of the operation o1153. In an implementation, the one or more cleaning electromagnetic instructions i1153 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via emitting electromagnetic energy (e.g. one or more of instances of the digital signal processor (DSP) component s106 of the control and information processing subsystem s100 can direct storing the first cleaning information into one or more instances of the other nonvolatile memory component s220, involving use of one or more instances of the radiant energy component s810 to remove a second portion of a smoothie, etc.). Furthermore, the cleaning electromagnetic electrical circuitry arrangement e1153 when activated will perform the operation o1153. In an implementation, the cleaning electromagnetic electrical circuitry arrangement e1153, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via emitting electromagnetic energy (e.g. one or more of instances of the digital signal processor (DSP) component s106 of the control and information processing subsystem s100 can direct storing the first cleaning information into one or more instances of the other nonvolatile memory component s220, involving use of one or more instances of the radiant energy component s810 to remove a second portion of a smoothie, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via emitting electromagnetic energy is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via emitting electromagnetic energy (e.g. one or more of instances of the digital signal processor (DSP) component s106 of the control and information processing subsystem s100 can direct storing the first cleaning information into one or more instances of the other nonvolatile memory component s220, involving use of one or more instances of the radiant energy component s810 to remove a second portion of a smoothie, etc.).

In one or more implementations, operation o11 includes an operation o1154 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via fluid flow of one or more abrasives. An exemplary version of a non-transitory signal bearing medium of information storage subsystem s200 is depicted as bearing one or more cleaning abrasives instructions i1154 that when executed will direct performance of the operation o1154. In an implementation, the one or more cleaning abrasives instructions i1154 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via fluid flow of one or more abrasives (e.g. one or more of instances of the application specific integrated circuit (ASIC) component s108 of the control and information processing subsystem s100 can direct storing the first cleaning information into one or more instances of the hard drive component s222, involving use of one or more instances of the material flush abrasive component s820 to remove a second portion of a chicken dinner, etc.). Furthermore, the cleaning abrasives electrical circuitry arrangement e1154 when activated will perform the operation o1154. In an implementation, the cleaning abrasives electrical circuitry arrangement e1154, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via fluid flow of one or more abrasives (e.g. one or more of instances of the application specific integrated circuit (ASIC) component s108 of the control and information processing subsystem s100 can direct storing the first cleaning information into one or more instances of the hard drive component s222, involving use of one or more instances of the material flush abrasive component s820 to remove a second portion of a chicken dinner, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via fluid flow of one or more abrasives is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via fluid flow of one or more abrasives (e.g. one or more of instances of the application specific integrated circuit (ASIC) component s108 of the control and information processing subsystem s100 can direct storing the first cleaning information into one or more instances of the hard drive component s222, involving use of one or more instances of the material flush abrasive component s820 to remove a second portion of a chicken dinner, etc.).

In one or more implementations, as shown in FIG. 50, operation o11 includes an operation o1155 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via brush contact. An exemplary version of a non-transitory signal bearing medium of information storage subsystem s200 is depicted as bearing one or more cleaning brush instructions i1155 that when executed will direct performance of the operation o1155. In an implementation, the one or more cleaning brush instructions i1155 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via brush contact (e.g. one or more of instances of the field programmable gate array (FPGA) component s110 of the control and information processing subsystem s100 can direct storing the first cleaning information into one or more instances of the disk farm component s224, involving use of one or more instances of the brush component s814 to remove a second portion of a latte, etc.). Furthermore, the cleaning brush electrical circuitry arrangement e1155 when activated will perform the operation o1155. In an implementation, the cleaning brush electrical circuitry arrangement e1155, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via brush contact (e.g. one or more of instances of the field programmable gate array (FPGA) component s110 of the control and information processing subsystem s100 can direct storing the first cleaning information into one or more instances of the disk farm component s224, involving use of one or more instances of the brush component s814 to remove a second portion of a latte, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via brush contact is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via brush contact (e.g. one or more of instances of the field programmable gate array (FPGA) component s110 of the control and information processing subsystem s100 can direct storing the first cleaning information into one or more instances of the disk farm component s224, involving use of one or more instances of the brush component s814 to remove a second portion of a latte, etc.).

In one or more implementations, operation o11 includes an operation o1156 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via chemical action. An exemplary version of a non-transitory signal bearing medium of information storage subsystem s200 is depicted as bearing one or more cleaning chemical instructions i1156 that when executed will direct performance of the operation o1156. In an implementation, the one or more cleaning chemical instructions i1156 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via chemical action (e.g. one or more of instances of the multiprocessor component s112 of the control and information processing subsystem s100 can direct storing the first cleaning information into one or more instances of the disk cluster component s226, involving use of one or more instances of the chemical component s832 to remove a second portion of a beef steak, etc.). Furthermore, the cleaning chemical electrical circuitry arrangement e1156 when activated will perform the operation o1156. In an implementation, the cleaning chemical electrical circuitry arrangement e1156, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via chemical action (e.g. one or more of instances of the multiprocessor component s112 of the control and information processing subsystem s100 can direct storing the first cleaning information into one or more instances of the disk cluster component s226, involving use of one or more instances of the chemical component s832 to remove a second portion of a beef steak, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via chemical action is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via chemical action (e.g. one or more of instances of the multiprocessor component s112 of the control and information processing subsystem s100 can direct storing the first cleaning information into one or more instances of the disk cluster component s226, involving use of one or more instances of the chemical component s832 to remove a second portion of a beef steak, etc.).

In one or more implementations, operation o11 includes an operation o1157 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more manifolds of tubes. An exemplary version of a non-transitory signal bearing medium of information storage subsystem s200 is depicted as bearing one or more cleaning tubes instructions i1157 that when executed will direct performance of the operation o1157. In an implementation, the one or more cleaning tubes instructions i1157 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more manifolds of tubes (e.g. one or more of instances of the optical processing component s114 of the control and information processing subsystem s100 can direct storing the first cleaning information into one or more instances of the remote backup component s228, involving use of one or more instances of the compressed water fluid component s830 to remove a second portion of a milk shake, etc.). Furthermore, the cleaning tubes electrical circuitry arrangement e1157 when activated will perform the operation o1157. In an implementation, the cleaning tubes electrical circuitry arrangement e1157, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more manifolds of tubes (e.g. one or more of instances of the optical processing component s114 of the control and information processing subsystem s100 can direct storing the first cleaning information into one or more instances of the remote backup component s228, involving use of one or more instances of the compressed water fluid component s830 to remove a second portion of a milk shake, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more manifolds of tubes is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more manifolds of tubes (e.g. one or more of instances of the optical processing component s114 of the control and information processing subsystem s100 can direct storing the first cleaning information into one or more instances of the remote backup component s228, involving use of one or more instances of the compressed water fluid component s830 to remove a second portion of a milk shake, etc.).

In one or more implementations, as shown in FIG. 51, operation o11 includes an operation o1158 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more nozzles. An exemplary version of a non-transitory signal bearing medium of information storage subsystem s200 is depicted as bearing one or more cleaning nozzles instructions i1158 that when executed will direct performance of the operation o1158. In an implementation, the one or more cleaning nozzles instructions i1158 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more nozzles (e.g. one or more of instances of the logic component s116 of the control and information processing subsystem s100 can direct storing the first cleaning information into one or more instances of the server component s230, involving one or more nozzles as part of one or more instances of the blending component s714 to remove a second portion of a sports drink, etc.). Furthermore, the cleaning nozzles electrical circuitry arrangement e1158 when activated will perform the operation o1158. In an implementation, the cleaning nozzles electrical circuitry arrangement e1158, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more nozzles (e.g. one or more of instances of the logic component s116 of the control and information processing subsystem s100 can direct storing the first cleaning information into one or more instances of the server component s230, involving one or more nozzles as part of one or more instances of the blending component s714 to remove a second portion of a sports drink, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more nozzles is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more nozzles (e.g. one or more of instances of the logic component s116 of the control and information processing subsystem s100 can direct storing the first cleaning information into one or more instances of the server component s230, involving one or more nozzles as part of one or more instances of the blending component s714 to remove a second portion of a sports drink, etc.).

In one or more implementations, operation o11 includes an operation o1159 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more heating chambers. An exemplary version of a non-transitory signal bearing medium of information storage subsystem s200 is depicted as bearing one or more cleaning heating instructions i1159 that when executed will direct performance of the operation o1159. In an implementation, the one or more cleaning heating instructions i1159 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more heating chambers (e.g. one or more of instances of the microprocessor component s102 of the control and information processing subsystem s100 can direct storing the first cleaning information into one or more instances of the digital tape component s232, involving one or more heating chambers as part of one or more instances of the heating component s702 to remove a second portion of a chocolate cake, etc.). Furthermore, the cleaning heating electrical circuitry arrangement e1159 when activated will perform the operation o1159. In an implementation, the cleaning heating electrical circuitry arrangement e1159, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more heating chambers (e.g. one or more of instances of the microprocessor component s102 of the control and information processing subsystem s100 can direct storing the first cleaning information into one or more instances of the digital tape component s232, involving one or more heating chambers as part of one or more instances of the heating component s702 to remove a second portion of a chocolate cake, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more heating chambers is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more heating chambers (e.g. one or more of instances of the microprocessor component s102 of the control and information processing subsystem s100 can direct storing the first cleaning information into one or more instances of the digital tape component s232, involving one or more heating chambers as part of one or more instances of the heating component s702 to remove a second portion of a chocolate cake, etc.).

In one or more implementations, operation o11 includes an operation o1160 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more blender compartments. An exemplary version of a non-transitory signal bearing medium of information storage subsystem s200 is depicted as bearing one or more cleaning blender instructions i1160 that when executed will direct performance of the operation o1160. In an implementation, the one or more cleaning blender instructions i1160 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more blender compartments (e.g. one or more of instances of the central processing unit (CPU) component s104 of the control and information processing subsystem s100 can direct storing the first cleaning information into one or more instances of the optical storage component s234, involving one or more blender compartments as part of one or more instances of the blending component s714 to remove a second portion of a fruit drink, etc.). Furthermore, the cleaning blender electrical circuitry arrangement e1160 when activated will perform the operation o1160. In an implementation, the cleaning blender electrical circuitry arrangement e1160, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more blender compartments (e.g. one or more of instances of the central processing unit (CPU) component s104 of the control and information processing subsystem s100 can direct storing the first cleaning information into one or more instances of the optical storage component s234, involving one or more blender compartments as part of one or more instances of the blending component s714 to remove a second portion of a fruit drink, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more blender compartments is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more blender compartments (e.g. one or more of instances of the central processing unit (CPU) component s104 of the control and information processing subsystem s100 can direct storing the first cleaning information into one or more instances of the optical storage component s234, involving one or more blender compartments as part of one or more instances of the blending component s714 to remove a second portion of a fruit drink, etc.).

In one or more implementations, as shown in FIG. 52, operation o11 includes an operation o1161 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more cooling chambers. An exemplary version of a non-transitory signal bearing medium of information storage subsystem s200 is depicted as bearing one or more cleaning cooling instructions i1161 that when executed will direct performance of the operation o1161. In an implementation, the one or more cleaning cooling instructions i1161 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more cooling chambers (e.g. one or more of instances of the digital signal processor (DSP) component s106 of the control and information processing subsystem s100 can direct storing the first cleaning information into one or more instances of the optical storage component s236, involving one or more cooling chambers as part of one or more instances of the cooling component s704 to remove a second portion of an ice cream sundae, etc.). Furthermore, the cleaning cooling electrical circuitry arrangement e1161 when activated will perform the operation o1161. In an implementation, the cleaning cooling electrical circuitry arrangement e1161, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more cooling chambers (e.g. one or more of instances of the digital signal processor (DSP) component s106 of the control and information processing subsystem s100 can direct storing the first cleaning information into one or more instances of the optical storage component s236, involving one or more cooling chambers as part of one or more instances of the cooling component s704 to remove a second portion of an ice cream sundae, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more cooling chambers is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more cooling chambers (e.g. one or more of instances of the digital signal processor (DSP) component s106 of the control and information processing subsystem s100 can direct storing the first cleaning information into one or more instances of the optical storage component s236, involving one or more cooling chambers as part of one or more instances of the cooling component s704 to remove a second portion of an ice cream sundae, etc.).

In one or more implementations, operation o11 includes an operation o1162 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more agitators. An exemplary version of a non-transitory signal bearing medium of information storage subsystem s200 is depicted as bearing one or more cleaning agitator instructions i1162 that when executed will direct performance of the operation o1162. In an implementation, the one or more cleaning agitator instructions i1162 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more agitators (e.g. one or more of instances of the application specific integrated circuit (ASIC) component s108 of the control and information processing subsystem s100 can direct storing the first cleaning information into one or more instances of the computer readable signal bearing medium s238, involving one or more agitators as part of one or more instances of the mixer component s716 to remove a second portion of a trail mix, etc.). Furthermore, the cleaning agitator electrical circuitry arrangement e1162 when activated will perform the operation o1162. In an implementation, the cleaning agitator electrical circuitry arrangement e1162, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more agitators (e.g. one or more of instances of the application specific integrated circuit (ASIC) component s108 of the control and information processing subsystem s100 can direct storing the first cleaning information into one or more instances of the computer readable signal bearing medium s238, involving one or more agitators as part of one or more instances of the mixer component s716 to remove a second portion of a trail mix, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more agitators is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more agitators (e.g. one or more of instances of the application specific integrated circuit (ASIC) component s108 of the control and information processing subsystem s100 can direct storing the first cleaning information into one or more instances of the computer readable signal bearing medium s238, involving one or more agitators as part of one or more instances of the mixer component s716 to remove a second portion of a trail mix, etc.).

In one or more implementations, operation o11 includes an operation o1163 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more syringes. An exemplary version of a non-transitory signal bearing medium of information storage subsystem s200 is depicted as bearing one or more cleaning syringe instructions i1163 that when executed will direct performance of the operation o1163. In an implementation, the one or more cleaning syringe instructions i1163 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more syringes (e.g. one or more of instances of the field programmable gate array (FPGA) component s110 of the control and information processing subsystem s100 can direct storing the first cleaning information into one or more instances of the Blu Ray disk component s240, involving one or more syringes as part of one or more instances of the deposition component s740 to remove a second portion of a layered pudding, etc.). Furthermore, the cleaning syringe electrical circuitry arrangement e1163 when activated will perform the operation o1163. In an implementation, the cleaning syringe electrical circuitry arrangement e1163, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more syringes (e.g. one or more of instances of the field programmable gate array (FPGA) component s110 of the control and information processing subsystem s100 can direct storing the first cleaning information into one or more instances of the Blu Ray disk component s240, involving one or more syringes as part of one or more instances of the deposition component s740 to remove a second portion of a layered pudding, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more syringes is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more syringes (e.g. one or more of instances of the field programmable gate array (FPGA) component s110 of the control and information processing subsystem s100 can direct storing the first cleaning information into one or more instances of the Blu Ray disk component s240, involving one or more syringes as part of one or more instances of the deposition component s740 to remove a second portion of a layered pudding, etc.).

In one or more implementations, as shown in FIG. 53, operation o11 includes an operation o1164 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more printer heads. An exemplary version of a non-transitory signal bearing medium of information storage subsystem s200 is depicted as bearing one or more cleaning head instructions i1164 that when executed will direct performance of the operation o1164. In an implementation, the one or more cleaning head instructions i1164 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more printer heads (e.g. one or more of instances of the multiprocessor component s112 of the control and information processing subsystem s100 can direct storing the first cleaning information into one or more instances of the random access memory (RAM) component s202, involving one or more printer heads as part of one or more instances of the deposition component s740 to remove a second portion of a sculptured pastry, etc.). Furthermore, the cleaning head electrical circuitry arrangement e1164 when activated will perform the operation o1164. In an implementation, the cleaning head electrical circuitry arrangement e1164, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more printer heads (e.g. one or more of instances of the multiprocessor component s112 of the control and information processing subsystem s100 can direct storing the first cleaning information into one or more instances of the random access memory (RAM) component s202, involving one or more printer heads as part of one or more instances of the deposition component s740 to remove a second portion of a sculptured pastry, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more printer heads is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more printer heads (e.g. one or more of instances of the multiprocessor component s112 of the control and information processing subsystem s100 can direct storing the first cleaning information into one or more instances of the random access memory (RAM) component s202, involving one or more printer heads as part of one or more instances of the deposition component s740 to remove a second portion of a sculptured pastry, etc.).

In one or more implementations, operation o11 includes an operation o1165 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via replacement of one or more portions of the automated preparation equipment. A non-transitory signal bearing medium includes one or more cleaning replacement instructions i1165 that when executed will direct performance of the operation o1165. In an implementation, the one or more cleaning replacement instructions i1165 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via replacement of one or more portions of the automated preparation equipment (e.g. one or more of instances of the optical processing component s114 of the control and information processing subsystem s100 can direct storing the first cleaning information into one or more instances of the dynamic random access memory (DRAM) component s204, involving the parts replacement component replacing one or more printer heads with new print heads as part of one or more instances of the deposition component s740 to remove a second portion of a second portion of a layered meal replacement bar, etc.). Furthermore, the cleaning replacement electrical circuitry arrangement e1165 when activated will perform the operation o1165. In an implementation, the cleaning replacement electrical circuitry arrangement e1165, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via replacement of one or more portions of the automated preparation equipment (e.g. one or more of instances of the optical processing component s114 of the control and information processing subsystem s100 can direct storing the first cleaning information into one or more instances of the dynamic random access memory (DRAM) component s204, involving the parts replacement component replacing one or more printer heads with new print heads as part of one or more instances of the deposition component s740 to remove a second portion of a second portion of a layered meal replacement bar, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via replacement of one or more portions of the automated preparation equipment is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via replacement of one or more portions of the automated preparation equipment (e.g. one or more of instances of the optical processing component s114 of the control and information processing subsystem s100 can direct storing the first cleaning information into one or more instances of the dynamic random access memory (DRAM) component s204, involving the parts replacement component replacing one or more printer heads with new print heads as part of one or more instances of the deposition component s740 to remove a second portion of a second portion of a layered meal replacement bar, etc.).

In one or more implementations, operation o11 includes an operation o1166 for electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via exchange of one or more portions of the automated preparation equipment with one or more other portions of the automated preparation equipment. A non-transitory signal bearing medium includes one or more cleaning exchange instructions i1166 that when executed will direct performance of the operation o1166. In an implementation, the one or more cleaning exchange instructions i1166 when executed direct electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via exchange of one or more portions of the automated preparation equipment with one or more other portions of the automated preparation equipment (e.g. one or more of instances of the logic component s116 of the control and information processing subsystem s100 can direct storing the first cleaning information into one or more instances of the other volatile memory component s206, involving exchanging one or more printer heads with one or more other printer heads as part of one or more instances of the deposition component s740 to remove a second portion of a layered turkey dinner, etc.). Furthermore, the cleaning exchange electrical circuitry arrangement e1166 when activated will perform the operation o1166. In an implementation, the cleaning exchange electrical circuitry arrangement e1166, when activated performs electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via exchange of one or more portions of the automated preparation equipment with one or more other portions of the automated preparation equipment (e.g. one or more of instances of the logic component s116 of the control and information processing subsystem s100 can direct storing the first cleaning information into one or more instances of the other volatile memory component s206, involving exchanging one or more printer heads with one or more other printer heads as part of one or more instances of the deposition component s740 to remove a second portion of a layered turkey dinner, etc.). In an implementation, the electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via exchange of one or more portions of the automated preparation equipment with one or more other portions of the automated preparation equipment is carried out by electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via exchange of one or more portions of the automated preparation equipment with one or more other portions of the automated preparation equipment (e.g. one or more of instances of the logic component s116 of the control and information processing subsystem s100 can direct storing the first cleaning information into one or more instances of the other volatile memory component s206, involving exchanging one or more printer heads with one or more other printer heads as part of one or more instances of the deposition component s740 to remove a second portion of a layered turkey dinner, etc.).

As shown in FIG. 31, the operational flow o10 proceeds to operation O12 for electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input. An exemplary version of a non-transitory signal bearing medium of information storage subsystem s200 is depicted as bearing one or more second clean instructions i12 that when executed will direct performance of the operation o12. In an implementation, the one or more second clean instructions i12 when executed direct electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product (e.g. one or more instances of the multiprocessor component s112 of the control and information processing subsystem s100 can direct, via one or more instances of the waveguide network component s506, one or more instances of the abrasive component s812 to assist in removing one or more portions of ingestible product as an electrolyte replacement drink from the ingestible product preparation system 10 as a cleaning operation, etc.), the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input (e.g. one or more instances of the multiprocessor component s112 of the control and information processing subsystem s100 can direct one or more instances of the parts replacement component s826 to assist in removing, from the ingestible product preparation system 10, one or more portions of ingestible product left behind by the first preparation occurrence of the first ingestible product as the electrolyte replacement drink from the ingestible product preparation system 10 as a cleaning operation prior to the second preparation occurrence of the second ingestible product as a chicken dinner based upon status determined to be that the ingestible product preparation system 10 had not been cleaned after an energy drink was prepared and the user preferred to have cleaning occur after any drink was prepared, as the second preparation occurrence being initiated by user input through one or more instances of the cellular network component s514, etc.). Furthermore, the second clean electrical circuitry arrangement e12 when activated will perform the operation o12. In an implementation, the second clean electrical circuitry arrangement e12, when activated performs electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product (e.g. one or more instances of the multiprocessor component s112 of the control and information processing subsystem s100 can direct, via one or more instances of the waveguide network component s506, one or more instances of the abrasive component s812 to assist in removing one or more portions of ingestible product as an electrolyte replacement drink from the ingestible product preparation system 10 as a cleaning operation, etc.), the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input (e.g. one or more instances of the multiprocessor component s112 of the control and information processing subsystem s100 can direct one or more instances of the parts replacement component s826 to assist in removing, from the ingestible product preparation system 10, one or more portions of ingestible product left behind by the first preparation occurrence of the first ingestible product as the electrolyte replacement drink from the ingestible product preparation system 10 as a cleaning operation prior to the second preparation occurrence of the second ingestible product as a chicken dinner based upon status determined to be that the ingestible product preparation system 10 had not been cleaned after an energy drink was prepared and the user preferred to have cleaning occur after any drink was prepared, as the second preparation occurrence being initiated by user input through one or more instances of the cellular network component s514, etc.). In an implementation, the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input is carried out by electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product (e.g. one or more instances of the multiprocessor component s112 of the control and information processing subsystem s100 can direct, via one or more instances of the waveguide network component s506, one or more instances of the abrasive component s812 to assist in removing one or more portions of ingestible product as an electrolyte replacement drink from the ingestible product preparation system 10 as a cleaning operation, etc.), the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input (e.g. one or more instances of the multiprocessor component s112 of the control and information processing subsystem s100 can direct one or more instances of the parts replacement component s826 to assist in removing, from the ingestible product preparation system 10, one or more portions of ingestible product left behind by the first preparation occurrence of the first ingestible product as the electrolyte replacement drink from the ingestible product preparation system 10 as a cleaning operation prior to the second preparation occurrence of the second ingestible product as a chicken dinner based upon status determined to be that the ingestible product preparation system 10 had not been cleaned after an energy drink was prepared and the user preferred to have cleaning occur after any drink was prepared, as the second preparation occurrence being initiated by user input through one or more instances of the cellular network component s514, etc.).

In one or more implementations, as shown in FIG. 54, operation o12 includes an operation o1201 for electronically directing at least one second automated cleaning operation via one or more computer networks. An exemplary version of a non-transitory signal bearing medium of information storage subsystem s200 is depicted as bearing one or more cleaning network instructions i1201 that when executed will direct performance of the operation o1201. In an implementation, the one or more cleaning network instructions i1201 when executed direct electronically directing at least one second automated cleaning operation via one or more computer networks (e.g. one or more instances of the microprocessor component s102 of the control and information processing subsystem s100 can direct, via one or more instances of the wide area network component s516, one or more instances of the air blower component s802 to assist in removing one or more portions of ingestible product as an energy drink from the ingestible product preparation system 10 as a cleaning operation, etc.). Furthermore, the cleaning network electrical circuitry arrangement e1201 when activated will perform the operation o1201. In an implementation, the cleaning network electrical circuitry arrangement e1201, when activated performs electronically directing at least one second automated cleaning operation via one or more computer networks (e.g. one or more instances of the microprocessor component s102 of the control and information processing subsystem s100 can direct, via one or more instances of the wide area network component s516, one or more instances of the air blower component s802 to assist in removing one or more portions of ingestible product as an energy drink from the ingestible product preparation system 10 as a cleaning operation, etc.). In an implementation, the electronically directing at least one second automated cleaning operation via one or more computer networks is carried out by electronically directing at least one second automated cleaning operation via one or more computer networks (e.g. one or more instances of the microprocessor component s102 of the control and information processing subsystem s100 can direct, via one or more instances of the wide area network component s516, one or more instances of the air blower component s802 to assist in removing one or more portions of ingestible product as an energy drink from the ingestible product preparation system 10 as a cleaning operation, etc.).

In one or more implementations, operation o12 includes an operation o1202 for electronically directing at least one second automated cleaning operation via one or more cellular networks. An exemplary version of a non-transitory signal bearing medium of information storage subsystem s200 is depicted as bearing one or more cleaning cellular instructions i1202 that when executed will direct performance of the operation o1202. In an implementation, the one or more cleaning cellular instructions i1202 when executed direct electronically directing at least one second automated cleaning operation via one or more cellular networks (e.g. one or more instances of the central processing unit (CPU) component s104 of the control and information processing subsystem s100 can direct via, one or more instances of the cellular network component s514, one or more instances of the compressed fluid component s804 to assist in removing one or more portions of ingestible product as a roast beef sandwich from the ingestible product preparation system 10 as a cleaning operation, etc.). Furthermore, the cleaning cellular electrical circuitry arrangement e1202 when activated will perform the operation o1202. In an implementation, the cleaning cellular electrical circuitry arrangement e1202, when activated performs electronically directing at least one second automated cleaning operation via one or more cellular networks (e.g. one or more instances of the central processing unit (CPU) component s104 of the control and information processing subsystem s100 can direct via, one or more instances of the cellular network component s514, one or more instances of the compressed fluid component s804 to assist in removing one or more portions of ingestible product as a roast beef sandwich from the ingestible product preparation system 10 as a cleaning operation, etc.). In an implementation, the electronically directing at least one second automated cleaning operation via one or more cellular networks is carried out by electronically directing at least one second automated cleaning operation via one or more cellular networks (e.g. one or more instances of the central processing unit (CPU) component s104 of the control and information processing subsystem s100 can direct via, one or more instances of the cellular network component s514, one or more instances of the compressed fluid component s804 to assist in removing one or more portions of ingestible product as a roast beef sandwich from the ingestible product preparation system 10 as a cleaning operation, etc.).

In one or more implementations, operation o12 includes an operation o1203 for electronically directing at least one second automated cleaning operation via electrical circuitry internal to the automated preparation equipment. An exemplary version of a non-transitory signal bearing medium of information storage subsystem s200 is depicted as bearing one or more cleaning circuitry instructions i1203 that when executed will direct performance of the operation o1203. In an implementation, the one or more cleaning circuitry instructions i1203 when executed direct electronically directing at least one second automated cleaning operation via electrical circuitry internal to the automated preparation equipment (e.g. one or more instances of the digital signal processor (DSP) component s106 of the control and information processing subsystem s100 can direct, via one or more instances of the wired network component s512, one or more instances of the vacuum component s806 to assist in removing one or more portions of ingestible product as a smoothie from the ingestible product preparation system 10 as a cleaning operation, etc.). Furthermore, the cleaning circuitry electrical circuitry arrangement e1203 when activated will perform the operation o1203. In an implementation, the cleaning circuitry electrical circuitry arrangement e1203, when activated performs electronically directing at least one second automated cleaning operation via electrical circuitry internal to the automated preparation equipment (e.g. one or more instances of the digital signal processor (DSP) component s106 of the control and information processing subsystem s100 can direct, via one or more instances of the wired network component s512, one or more instances of the vacuum component s806 to assist in removing one or more portions of ingestible product as a smoothie from the ingestible product preparation system 10 as a cleaning operation, etc.). In an implementation, the electronically directing at least one second automated cleaning operation via electrical circuitry internal to the automated preparation equipment is carried out by electronically directing at least one second automated cleaning operation via electrical circuitry internal to the automated preparation equipment (e.g. one or more instances of the digital signal processor (DSP) component s106 of the control and information processing subsystem s100 can direct, via one or more instances of the wired network component s512, one or more instances of the vacuum component s806 to assist in removing one or more portions of ingestible product as a smoothie from the ingestible product preparation system 10 as a cleaning operation, etc.).

In one or more implementations, as shown in FIG. 55, operation o12 includes an operation o1204 for electronically directing at least one second automated cleaning operation via one or more microprocessors. An exemplary version of a non-transitory signal bearing medium of information storage subsystem s200 is depicted as bearing one or more cleaning microprocessors instructions i1204 that when executed will direct performance of the operation o1204. In an implementation, the one or more cleaning microprocessors instructions i1204 when executed direct electronically directing at least one second automated cleaning operation via one or more microprocessors (e.g. one or more instances of the application specific integrated circuit (ASIC) component s108 of the control and information processing subsystem s100 can direct, via one or more instances of the microprocessor component s102, one or more instances of the ultrasonic component s808 to assist in removing one or more portions of ingestible product as an apple pie from the ingestible product preparation system 10 as a cleaning operation, etc.). Furthermore, the cleaning network electrical circuitry arrangement e1204 when activated will perform the operation o1204. In an implementation, the cleaning microprocessors electrical circuitry arrangement e1204, when activated performs electronically directing at least one second automated cleaning operation via one or more microprocessors (e.g. one or more instances of the application specific integrated circuit (ASIC) component s108 of the control and information processing subsystem s100 can direct, via one or more instances of the microprocessor component s102, one or more instances of the ultrasonic component s808 to assist in removing one or more portions of ingestible product as an apple pie from the ingestible product preparation system 10 as a cleaning operation, etc.). In an implementation, the electronically directing at least one second automated cleaning operation via one or more microprocessors is carried out by electronically directing at least one second automated cleaning operation via one or more microprocessors (e.g. one or more instances of the application specific integrated circuit (ASIC) component s108 of the control and information processing subsystem s100 can direct, via one or more instances of the microprocessor component s102, one or more instances of the ultrasonic component s808 to assist in removing one or more portions of ingestible product as an apple pie from the ingestible product preparation system 10 as a cleaning operation, etc.).

In one or more implementations, operation o12 includes an operation o1205 for electronically directing at least one second automated cleaning operation via one or more networked servers. An exemplary version of a non-transitory signal bearing medium of information storage subsystem s200 is depicted as bearing one or more cleaning servers instructions i1205 that when executed will direct performance of the operation o1205. In an implementation, the one or more cleaning servers instructions i1205 when executed direct electronically directing at least one second automated cleaning operation via one or more networked servers (e.g. one or more instances of the field programmable gate array (FPGA) component s102 of the control and information processing subsystem s100 can direct, via one or more instances of the server component s230, one or more instances of the radiant energy component s810 to assist in removing one or more portions of ingestible product as a protein drink from the ingestible product preparation system 10 as a cleaning operation, etc.). Furthermore, the cleaning servers electrical circuitry arrangement e1205 when activated will perform the operation o1205. In an implementation, the cleaning servers electrical circuitry arrangement e1205, when activated performs electronically directing at least one second automated cleaning operation via one or more networked servers (e.g. one or more instances of the field programmable gate array (FPGA) component s102 of the control and information processing subsystem s100 can direct, via one or more instances of the server component s230, one or more instances of the radiant energy component s810 to assist in removing one or more portions of ingestible product as a protein drink from the ingestible product preparation system 10 as a cleaning operation, etc.). In an implementation, the electronically directing at least one second automated cleaning operation via one or more networked servers is carried out by electronically directing at least one second automated cleaning operation via one or more networked servers (e.g. one or more instances of the field programmable gate array (FPGA) component s102 of the control and information processing subsystem s100 can direct, via one or more instances of the server component s230, one or more instances of the radiant energy component s810 to assist in removing one or more portions of ingestible product as a protein drink from the ingestible product preparation system 10 as a cleaning operation, etc.).

In one or more implementations, operation o12 includes an operation o1206 for electronically directing the at least one second automated cleaning operation of the at least one automated device to remove a third portion other than the first portion and other than the second portion of the at least one first substance when the at least one first automated cleaning operation occurrence has not occurred so that the second portion has not existed. An exemplary version of a non-transitory signal bearing medium of information storage subsystem s200 is depicted as bearing one or more cleaning not existed instructions i1206 that when executed will direct performance of the operation o1206. In an implementation, the one or more cleaning not existed instructions i1206 when executed direct electronically directing the at least one second automated cleaning operation of the at least one automated device to remove a third portion other than the first portion and other than the second portion of the at least one first substance when the at least one first automated cleaning operation occurrence has not occurred so that the second portion has not existed (e.g. one or more instances of the multiprocessor component s112 of the control and information processing subsystem s100 can direct one or more instances of the abrasive component s812 to assist in removing, from the ingestible product preparation system 10, one or more portions of ingestible product left behind by the first preparation occurrence of the first ingestible product as a latte from the ingestible product preparation system 10 as a cleaning operation, etc.). Furthermore, the cleaning not existed electrical circuitry arrangement e1206 when activated will perform the operation o1205. In an implementation, the cleaning not existed electrical circuitry arrangement e1206, when activated performs electronically directing the at least one second automated cleaning operation of the at least one automated device to remove a third portion other than the first portion and other than the second portion of the at least one first substance when the at least one first automated cleaning operation occurrence has not occurred so that the second portion has not existed (e.g. one or more instances of the multiprocessor component s112 of the control and information processing subsystem s100 can direct one or more instances of the abrasive component s812 to assist in removing, from the ingestible product preparation system 10, one or more portions of ingestible product left behind by the first preparation occurrence of the first ingestible product as a latte from the ingestible product preparation system 10 as a cleaning operation, etc.). In an implementation, the electronically directing the at least one second automated cleaning operation of the at least one automated device to remove a third portion other than the first portion and other than the second portion of the at least one first substance when the at least one first automated cleaning operation occurrence has not occurred so that the second portion has not existed is carried out by electronically directing the at least one second automated cleaning operation of the at least one automated device to remove a third portion other than the first portion and other than the second portion of the at least one first substance when the at least one first automated cleaning operation occurrence has not occurred so that the second portion has not existed (e.g. one or more instances of the multiprocessor component s112 of the control and information processing subsystem s100 can direct one or more instances of the abrasive component s812 to assist in removing, from the ingestible product preparation system 10, one or more portions of ingestible product left behind by the first preparation occurrence of the first ingestible product as a latte from the ingestible product preparation system 10 as a cleaning operation, etc.).

In one or more implementations, as shown in FIG. 56, operation o12 includes an operation o1207 for electronically directing the at least one second automated cleaning operation of the at least one automated device to remove a third portion other than the first portion and other than the second portion of the at least one first substance via blowing air. An exemplary version of a non-transitory signal bearing medium of information storage subsystem s200 is depicted as bearing one or more cleaning blowing instructions i1207 that when executed will direct performance of the operation o1207. In an implementation, the one or more cleaning blowing instructions i1207 when executed direct electronically directing the at least one second automated cleaning operation of the at least one automated device to remove a third portion other than the first portion and other than the second portion of the at least one first substance via blowing air (e.g. one or more instances of the optical processing component s114 of the control and information processing subsystem s100 can direct one or more instances of the air blower component s802 to assist in removing, from the ingestible product preparation system 10, one or more portions of ingestible product left behind by the first preparation occurrence of the first ingestible product as a fruit salad and was not yet cleaned from the ingestible product preparation system 10 as a cleaning operation, etc.). Furthermore, the cleaning blowing electrical circuitry arrangement e1207 when activated will perform the operation o1207. In an implementation, the cleaning blowing electrical circuitry arrangement e1207, when activated performs electronically directing the at least one second automated cleaning operation of the at least one automated device to remove a third portion other than the first portion and other than the second portion of the at least one first substance via blowing air (e.g. one or more instances of the optical processing component s114 of the control and information processing subsystem s100 can direct one or more instances of the air blower component s802 to assist in removing, from the ingestible product preparation system 10, one or more portions of ingestible product left behind by the first preparation occurrence of the first ingestible product as a fruit salad and was not yet cleaned from the ingestible product preparation system 10 as a cleaning operation, etc.). In an implementation, the electronically directing the at least one second automated cleaning operation of the at least one automated device to remove a third portion other than the first portion and other than the second portion of the at least one first substance via blowing air is carried out by electronically directing the at least one second automated cleaning operation of the at least one automated device to remove a third portion other than the first portion and other than the second portion of the at least one first substance via blowing air (e.g. one or more instances of the optical processing component s114 of the control and information processing subsystem s100 can direct one or more instances of the air blower component s802 to assist in removing, from the ingestible product preparation system 10, one or more portions of ingestible product left behind by the first preparation occurrence of the first ingestible product as a fruit salad and was not yet cleaned from the ingestible product preparation system 10 as a cleaning operation, etc.).

In one or more implementations, operation o12 includes an operation, o1208 for electronically directing the at least one second automated cleaning operation of the at least one automated device to remove a third portion other than the first portion and other than the second portion of the at least one first substance via injecting compressed fluid. An exemplary version of a non-transitory signal bearing medium of information storage subsystem s200 is depicted as bearing one or more cleaning compressed instructions i1208 that when executed will direct performance of the operation o1208. In an implementation, the one or more cleaning compressed instructions i1208 when executed direct electronically directing the at least one second automated cleaning operation of the at least one automated device to remove a third portion other than the first portion and other than the second portion of the at least one first substance via injecting compressed fluid (e.g. one or more instances of the logic component s116 of the control and information processing subsystem s100 can direct one or more instances of the compressed fluid component s804 to assist in removing, from the ingestible product preparation system 10, one or more portions of ingestible product left behind by the first preparation occurrence of the first ingestible product as a rice dish from the ingestible product preparation system 10 as a cleaning operation, etc.). Furthermore, the cleaning compressed electrical circuitry arrangement e1208 when activated will perform the operation o1208. In an implementation, the cleaning compressed electrical circuitry arrangement e1208, when activated performs electronically directing the at least one second automated cleaning operation of the at least one automated device to remove a third portion other than the first portion and other than the second portion of the at least one first substance via injecting compressed fluid (e.g. one or more instances of the logic component s116 of the control and information processing subsystem s100 can direct one or more instances of the compressed fluid component s804 to assist in removing, from the ingestible product preparation system 10, one or more portions of ingestible product left behind by the first preparation occurrence of the first ingestible product as a rice dish from the ingestible product preparation system 10 as a cleaning operation, etc.). In an implementation, the electronically directing the at least one second automated cleaning operation of the at least one automated device to remove a third portion other than the first portion and other than the second portion of the at least one first substance via injecting compressed fluid is carried out by electronically directing the at least one second automated cleaning operation of the at least one automated device to remove a third portion other than the first portion and other than the second portion of the at least one first substance via injecting compressed fluid (e.g. one or more instances of the logic component s116 of the control and information processing subsystem s100 can direct one or more instances of the compressed fluid component s804 to assist in removing, from the ingestible product preparation system 10, one or more portions of ingestible product left behind by the first preparation occurrence of the first ingestible product as a rice dish from the ingestible product preparation system 10 as a cleaning operation, etc.).

In one or more implementations, operation o12 includes an operation o1209 for electronically directing the at least one second automated cleaning operation of the at least one automated device to remove a third portion other than the first portion and other than the second portion of the at least one first substance via applying a vacuum. An exemplary version of a non-transitory signal bearing medium of information storage subsystem s200 is depicted as bearing one or more cleaning vacuum instructions i1209 that when executed will direct performance of the operation o1209. In an implementation, the one or more cleaning vacuum instructions i1209 when executed direct electronically directing the at least one second automated cleaning operation of the at least one automated device to remove a third portion other than the first portion and other than the second portion of the at least one first substance via applying a vacuum (e.g. one or more instances of the microprocessor component s102 of the control and information processing subsystem s100 can direct one or more instances of the vacuum component s806 to assist in removing, from the ingestible product preparation system 10, one or more portions of ingestible product left behind by the first preparation occurrence of the first ingestible product as a vegetable salad from the ingestible product preparation system 10 as a cleaning operation, etc.). Furthermore, the cleaning vacuum electrical circuitry arrangement e1209 when activated will perform the operation o1209. In an implementation, the cleaning vacuum electrical circuitry arrangement e1209, when activated performs electronically directing the at least one second automated cleaning operation of the at least one automated device to remove a third portion other than the first portion and other than the second portion of the at least one first substance via applying a vacuum (e.g. one or more instances of the microprocessor component s102 of the control and information processing subsystem s100 can direct one or more instances of the vacuum component s806 to assist in removing, from the ingestible product preparation system 10, one or more portions of ingestible product left behind by the first preparation occurrence of the first ingestible product as a vegetable salad from the ingestible product preparation system 10 as a cleaning operation, etc.). In an implementation, the electronically directing the at least one second automated cleaning operation of the at least one automated device to remove a third portion other than the first portion and other than the second portion of the at least one first substance via applying a vacuum is carried out by electronically directing the at least one second automated cleaning operation of the at least one automated device to remove a third portion other than the first portion and other than the second portion of the at least one first substance via applying a vacuum (e.g. one or more instances of the microprocessor component s102 of the control and information processing subsystem s100 can direct one or more instances of the vacuum component s806 to assist in removing, from the ingestible product preparation system 10, one or more portions of ingestible product left behind by the first preparation occurrence of the first ingestible product as a vegetable salad from the ingestible product preparation system 10 as a cleaning operation, etc.).

In one or more implementations, as shown in FIG. 57, operation o12 includes an operation o1210 for electronically directing the at least one second automated cleaning operation of the at least one automated device to remove a third portion other than the first portion and other than the second portion of the at least one first substance via emitting ultrasonic waves. An exemplary version of a non-transitory signal bearing medium of information storage subsystem s200 is depicted as bearing one or more cleaning ultrasonic instructions i1210 that when executed will direct performance of the operation o1210. In an implementation, the one or more cleaning ultrasonic instructions i1210 when executed direct electronically directing the at least one second automated cleaning operation of the at least one automated device to remove a third portion other than the first portion and other than the second portion of the at least one first substance via emitting ultrasonic waves (e.g. one or more instances of the central processing unit (CPU) component s104 of the control and information processing subsystem s100 can direct one or more instances of the ultrasonic component s808 to assist in removing, from the ingestible product preparation system 10, one or more portions of ingestible product left behind by the first preparation occurrence of the first ingestible product as a sports drink from the ingestible product preparation system 10 as a cleaning operation, etc.). Furthermore, the cleaning ultrasonic electrical circuitry arrangement e1210 when activated will perform the operation o1210. In an implementation, the cleaning ultrasonic electrical circuitry arrangement e1210, when activated performs electronically directing the at least one second automated cleaning operation of the at least one automated device to remove a third portion other than the first portion and other than the second portion of the at least one first substance via emitting ultrasonic waves (e.g. one or more instances of the central processing unit (CPU) component s104 of the control and information processing subsystem s100 can direct one or more instances of the ultrasonic component s808 to assist in removing, from the ingestible product preparation system 10, one or more portions of ingestible product left behind by the first preparation occurrence of the first ingestible product as a sports drink from the ingestible product preparation system 10 as a cleaning operation, etc.). In an implementation, the electronically directing the at least one second automated cleaning operation of the at least one automated device to remove a third portion other than the first portion and other than the second portion of the at least one first substance via emitting ultrasonic waves is carried out by electronically directing the at least one second automated cleaning operation of the at least one automated device to remove a third portion other than the first portion and other than the second portion of the at least one first substance via emitting ultrasonic waves (e.g. one or more instances of the central processing unit (CPU) component s104 of the control and information processing subsystem s100 can direct one or more instances of the ultrasonic component s808 to assist in removing, from the ingestible product preparation system 10, one or more portions of ingestible product left behind by the first preparation occurrence of the first ingestible product as a sports drink from the ingestible product preparation system 10 as a cleaning operation, etc.).

In one or more implementations, operation O12 includes an operation o1211 for electronically directing the at least one second automated cleaning operation of the at least one automated device to remove a third portion other than the first portion and other than the second portion of the at least one first substance via emitting electromagnetic energy. An exemplary version of a non-transitory signal bearing medium of information storage subsystem s200 is depicted as bearing one or more cleaning electromagnetic instructions i1211 that when executed will direct performance of the operation o1211. In an implementation, the one or more cleaning electromagnetic instructions i1211 when executed direct electronically directing the at least one second automated cleaning operation of the at least one automated device to remove a third portion other than the first portion and other than the second portion of the at least one first substance via emitting electromagnetic energy (e.g. one or more instances of the digital signal processor (DSP) component s106 of the control and information processing subsystem s100 can direct one or more instances of the radiant energy component s810 to assist in removing, from the ingestible product preparation system 10, one or more portions of ingestible product left behind by the first preparation occurrence of the first ingestible product as a turkey dinner from the ingestible product preparation system 10 as a cleaning operation, etc.). Furthermore, the cleaning electromagnetic electrical circuitry arrangement e1211 when activated will perform the operation o1211. In an implementation, the cleaning electromagnetic electrical circuitry arrangement e1211, when activated performs electronically directing the at least one second automated cleaning operation of the at least one automated device to remove a third portion other than the first portion and other than the second portion of the at least one first substance via emitting electromagnetic energy (e.g. one or more instances of the digital signal processor (DSP) component s106 of the control and information processing subsystem s100 can direct one or more instances of the radiant energy component s810 to assist in removing, from the ingestible product preparation system 10, one or more portions of ingestible product left behind by the first preparation occurrence of the first ingestible product as a turkey dinner from the ingestible product preparation system 10 as a cleaning operation, etc.). In an implementation, the electronically directing the at least one second automated cleaning operation of the at least one automated device to remove a third portion other than the first portion and other than the second portion of the at least one first substance via emitting electromagnetic energy is carried out by electronically directing the at least one second automated cleaning operation of the at least one automated device to remove a third portion other than the first portion and other than the second portion of the at least one first substance via emitting electromagnetic energy (e.g. one or more instances of the digital signal processor (DSP) component s106 of the control and information processing subsystem s100 can direct one or more instances of the radiant energy component s810 to assist in removing, from the ingestible product preparation system 10, one or more portions of ingestible product left behind by the first preparation occurrence of the first ingestible product as a turkey dinner from the ingestible product preparation system 10 as a cleaning operation, etc.).

In one or more implementations, operation o12 includes an operation o1212 for electronically directing the at least one second automated cleaning operation of the at least one automated device to remove a third portion other than the first portion and other than the second portion of the at least one first substance via fluid flow of one or more abrasives. An exemplary version of a non-transitory signal bearing medium of information storage subsystem s200 is depicted as bearing one or more cleaning abrasives instructions i1212 that when executed will direct performance of the operation o1212. In an implementation, the one or more cleaning abrasives instructions i1212 when executed direct electronically directing the at least one second automated cleaning operation of the at least one automated device to remove a third portion other than the first portion and other than the second portion of the at least one first substance via fluid flow of one or more abrasives (e.g. one or more instances of the application specific integrated circuit (ASIC) component s108 of the control and information processing subsystem s100 can direct one or more instances of the abrasive component s812 to assist in removing, from the ingestible product preparation system 10, one or more portions of ingestible product left behind by the first preparation occurrence of the first ingestible product as a fruit punch from the ingestible product preparation system 10 as a cleaning operation, etc.). Furthermore, the cleaning abrasives electrical circuitry arrangement e1212 when activated will perform the operation o1212. In an implementation, the cleaning abrasives electrical circuitry arrangement e1212, when activated performs electronically directing the at least one second automated cleaning operation of the at least one automated device to remove a third portion other than the first portion and other than the second portion of the at least one first substance via fluid flow of one or more abrasives (e.g. one or more instances of the application specific integrated circuit (ASIC) component s108 of the control and information processing subsystem s100 can direct one or more instances of the abrasive component s812 to assist in removing, from the ingestible product preparation system 10, one or more portions of ingestible product left behind by the first preparation occurrence of the first ingestible product as a fruit punch from the ingestible product preparation system 10 as a cleaning operation, etc.). In an implementation, the electronically directing the at least one second automated cleaning operation of the at least one automated device to remove a third portion other than the first portion and other than the second portion of the at least one first substance via fluid flow of one or more abrasives is carried out by electronically directing the at least one second automated cleaning operation of the at least one automated device to remove a third portion other than the first portion and other than the second portion of the at least one first substance via fluid flow of one or more abrasives (e.g. one or more instances of the application specific integrated circuit (ASIC) component s108 of the control and information processing subsystem s100 can direct one or more instances of the abrasive component s812 to assist in removing, from the ingestible product preparation system 10, one or more portions of ingestible product left behind by the first preparation occurrence of the first ingestible product as a fruit punch from the ingestible product preparation system 10 as a cleaning operation, etc.).

In one or more implementations, as shown in FIG. 58, operation o12 includes an operation o1213 for electronically directing the at least one second automated cleaning operation of the at least one automated device to remove a third portion other than the first portion and other than the second portion of the at least one first substance via brush contact. An exemplary version of a non-transitory signal bearing medium of information storage subsystem s200 is depicted as bearing one or more cleaning brush instructions i1213 that when executed will direct performance of the operation o1213. In an implementation, the one or more cleaning brush instructions i1213 when executed direct electronically directing the at least one second automated cleaning operation of the at least one automated device to remove a third portion other than the first portion and other than the second portion of the at least one first substance via brush contact (e.g. one or more instances of the field programmable gate array (FPGA) component s110 of the control and information processing subsystem s100 can direct one or more instances of the brush component s814 to assist in removing, from the ingestible product preparation system 10, one or more portions of ingestible product left behind by the first preparation occurrence of the first ingestible product as a rice dish from the ingestible product preparation system 10 as a cleaning operation, etc.). Furthermore, the cleaning brush electrical circuitry arrangement e1213 when activated will perform the operation o1213. In an implementation, the cleaning brush electrical circuitry arrangement e1213, when activated performs electronically directing the at least one second automated cleaning operation of the at least one automated device to remove a third portion other than the first portion and other than the second portion of the at least one first substance via brush contact (e.g. one or more instances of the field programmable gate array (FPGA) component s110 of the control and information processing subsystem s100 can direct one or more instances of the brush component s814 to assist in removing, from the ingestible product preparation system 10, one or more portions of ingestible product left behind by the first preparation occurrence of the first ingestible product as a rice dish from the ingestible product preparation system 10 as a cleaning operation, etc.). In an implementation, the electronically directing the at least one second automated cleaning operation of the at least one automated device to remove a third portion other than the first portion and other than the second portion of the at least one first substance via brush contact is carried out by electronically directing the at least one second automated cleaning operation of the at least one automated device to remove a third portion other than the first portion and other than the second portion of the at least one first substance via brush contact (e.g. one or more instances of the field programmable gate array (FPGA) component s110 of the control and information processing subsystem s100 can direct one or more instances of the brush component s814 to assist in removing, from the ingestible product preparation system 10, one or more portions of ingestible product left behind by the first preparation occurrence of the first ingestible product as a rice dish from the ingestible product preparation system 10 as a cleaning operation, etc.).

In one or more implementations, operation o12 includes an operation o1214 for electronically directing the at least one second automated cleaning operation of the at least one automated device to remove a third portion other than the first portion and other than the second portion of the at least one first substance via chemical action. An exemplary version of a non-transitory signal bearing medium of information storage subsystem s200 is depicted as bearing one or more cleaning chemical instructions i1214 that when executed will direct performance of the operation o1214. In an implementation, the one or more cleaning chemical instructions i1214 when executed direct electronically directing the at least one second automated cleaning operation of the at least one automated device to remove a third portion other than the first portion and other than the second portion of the at least one first substance via chemical action (e.g. one or more instances of the multiprocessor component s112 of the control and information processing subsystem s100 can direct one or more instances of the chemical component s832 to assist in removing, from the ingestible product preparation system 10, one or more portions of ingestible product left behind by the first preparation occurrence of the first ingestible product as a stuffed potato from the ingestible product preparation system 10 as a cleaning operation, etc.). Furthermore, the cleaning chemical electrical circuitry arrangement e1214 when activated will perform the operation o1214. In an implementation, the cleaning chemical electrical circuitry arrangement e1214, when activated performs electronically directing the at least one second automated cleaning operation of the at least one automated device to remove a third portion other than the first portion and other than the second portion of the at least one first substance via chemical action (e.g. one or more instances of the multiprocessor component s112 of the control and information processing subsystem s100 can direct one or more instances of the chemical component s832 to assist in removing, from the ingestible product preparation system 10, one or more portions of ingestible product left behind by the first preparation occurrence of the first ingestible product as a stuffed potato from the ingestible product preparation system 10 as a cleaning operation, etc.). In an implementation, the electronically directing the at least one second automated cleaning operation of the at least one automated device to remove a third portion other than the first portion and other than the second portion of the at least one first substance via chemical action is carried out by electronically directing the at least one second automated cleaning operation of the at least one automated device to remove a third portion other than the first portion and other than the second portion of the at least one first substance via chemical action (e.g. one or more instances of the multiprocessor component s112 of the control and information processing subsystem s100 can direct one or more instances of the chemical component s832 to assist in removing, from the ingestible product preparation system 10, one or more portions of ingestible product left behind by the first preparation occurrence of the first ingestible product as a stuffed potato from the ingestible product preparation system 10 as a cleaning operation, etc.).

In one or more implementations, operation o12 includes an operation o1215 for electronically directing the at least one second automated cleaning operation of the at least one automated device to remove a third portion other than the first portion and other than the second portion of the at least one first substance from at least a portion of the preparation equipment as one or more manifolds of tubes. An exemplary version of a non-transitory signal bearing medium of information storage subsystem s200 is depicted as bearing one or more cleaning tubes instructions i1215 that when executed will direct performance of the operation o1215. In an implementation, the one or more cleaning tubes instructions i1215 when executed direct electronically directing the at least one second automated cleaning operation of the at least one automated device to remove a third portion other than the first portion and other than the second portion of the at least one first substance from at least a portion of the preparation equipment as one or more manifolds of tubes (e.g. one or more instances of the optical processing component s114 of the control and information processing subsystem s100 can direct one or more instances of the squeegee brush component s816 to assist in removing, from the ingestible product preparation system 10, one or more portions of ingestible product left behind on one or more tube manifolds of one or more instances of the pump component s726 by the first preparation occurrence of the first ingestible product as a shrimp cocktail from the ingestible product preparation system 10 as a cleaning operation, etc.). Furthermore, the cleaning tubes electrical circuitry arrangement e1215 when activated will perform the operation o1215. In an implementation, the cleaning tubes electrical circuitry arrangement e1215, when activated performs electronically directing the at least one second automated cleaning operation of the at least one automated device to remove a third portion other than the first portion and other than the second portion of the at least one first substance from at least a portion of the preparation equipment as one or more manifolds of tubes (e.g. one or more instances of the optical processing component s114 of the control and information processing subsystem s100 can direct one or more instances of the squeegee brush component s816 to assist in removing, from the ingestible product preparation system 10, one or more portions of ingestible product left behind on one or more tube manifolds of one or more instances of the pump component s726 by the first preparation occurrence of the first ingestible product as a shrimp cocktail from the ingestible product preparation system 10 as a cleaning operation, etc.). In an implementation, the electronically directing the at least one second automated cleaning operation of the at least one automated device to remove a third portion other than the first portion and other than the second portion of the at least one first substance from at least a portion of the preparation equipment as one or more manifolds of tubes is carried out by electronically directing the at least one second automated cleaning operation of the at least one automated device to remove a third portion other than the first portion and other than the second portion of the at least one first substance from at least a portion of the preparation equipment as one or more manifolds of tubes (e.g. one or more instances of the optical processing component s114 of the control and information processing subsystem s100 can direct one or more instances of the squeegee brush component s816 to assist in removing, from the ingestible product preparation system 10, one or more portions of ingestible product left behind on one or more tube manifolds of one or more instances of the pump component s726 by the first preparation occurrence of the first ingestible product as a shrimp cocktail from the ingestible product preparation system 10 as a cleaning operation, etc.).

In one or more implementations, as shown in FIG. 59, operation o12 includes an operation o1216 for electronically directing the at least one second automated cleaning operation of the at least one automated device to remove a third portion other than the first portion and other than the second portion of the at least one first substance from at least a portion of the preparation equipment as one or more nozzles. An exemplary version of a non-transitory signal bearing medium of information storage subsystem s200 is depicted as bearing one or more cleaning nozzles instructions i1216 that when executed will direct performance of the operation o1216. In an implementation, the one or more cleaning nozzles instructions i1216 when executed direct electronically directing the at least one second automated cleaning operation of the at least one automated device to remove a third portion other than the first portion and other than the second portion of the at least one first substance from at least a portion of the preparation equipment as one or more nozzles (e.g. one or more instances of the logic component s116 of the control and information processing subsystem s100 can direct one or more instances of the pipe cleaner brush component s818 to assist in removing, from the ingestible product preparation system 10, one of more portions of ingestible product left behind on one or more nozzles of the blending component s714 by the first preparation occurrence of the first ingestible product as a energy drink from the ingestible product preparation system 10 as a cleaning operation, etc.). Furthermore, the cleaning nozzles electrical circuitry arrangement e1216 when activated will perform the operation o1216. In an implementation, the cleaning nozzles electrical circuitry arrangement e1216, when activated performs electronically directing the at least one second automated cleaning operation of the at least one automated device to remove a third portion other than the first portion and other than the second portion of the at least one first substance from at least a portion of the preparation equipment as one or more nozzles (e.g. one or more instances of the logic component s116 of the control and information processing subsystem s100 can direct one or more instances of the pipe cleaner brush component s818 to assist in removing, from the ingestible product preparation system 10, one of more portions of ingestible product left behind on one or more nozzles of the blending component s714 by the first preparation occurrence of the first ingestible product as a energy drink from the ingestible product preparation system 10 as a cleaning operation, etc.). In an implementation, the electronically directing the at least one second automated cleaning operation of the at least one automated device to remove a third portion other than the first portion and other than the second portion of the at least one first substance from at least a portion of the preparation equipment as one or more nozzles is carried out by electronically directing the at least one second automated cleaning operation of the at least one automated device to remove a third portion other than the first portion and other than the second portion of the at least one first substance from at least a portion of the preparation equipment as one or more nozzles (e.g. one or more instances of the logic component s116 of the control and information processing subsystem s100 can direct one or more instances of the pipe cleaner brush component s818 to assist in removing, from the ingestible product preparation system 10, one of more portions of ingestible product left behind on one or more nozzles of the blending component s714 by the first preparation occurrence of the first ingestible product as a energy drink from the ingestible product preparation system 10 as a cleaning operation, etc.).

In one or more implementations, operation o12 includes an operation o1217 for electronically directing the at least one second automated cleaning operation of the at least one automated device to remove a third portion other than the first portion and other than the second portion of the at least one first substance from at least a portion of the preparation equipment as one or more heating chambers. An exemplary version of a non-transitory signal bearing medium of information storage subsystem s200 is depicted as bearing one or more cleaning heating instructions i1217 that when executed will direct performance of the operation o1217. In an implementation, the one or more cleaning heating instructions i1217 when executed direct electronically directing the at least one second automated cleaning operation of the at least one automated device to remove a third portion other than the first portion and other than the second portion of the at least one first substance from at least a portion of the preparation equipment as one or more heating chambers (e.g. one or more instances of the microprocessor component s102 of the control and information processing subsystem s100 can direct one or more instances of the material flush abrasive component s820 to assist in removing, from the ingestible product preparation system 10, one or more portions of ingestible product left behind on one or more heating chambers of one or more instances of the heating component s702 by the first preparation occurrence of the first ingestible product as a chicken dinner from the ingestible product preparation system 10 as a cleaning operation, etc.). Furthermore, the cleaning heating electrical circuitry arrangement e1217 when activated will perform the operation o1217. In an implementation, the cleaning heating electrical circuitry arrangement e1217, when activated performs electronically directing the at least one second automated cleaning operation of the at least one automated device to remove a third portion other than the first portion and other than the second portion of the at least one first substance from at least a portion of the preparation equipment as one or more heating chambers (e.g. one or more instances of the microprocessor component s102 of the control and information processing subsystem s100 can direct one or more instances of the material flush abrasive component s820 to assist in removing, from the ingestible product preparation system 10, one or more portions of ingestible product left behind on one or more heating chambers of one or more instances of the heating component s702 by the first preparation occurrence of the first ingestible product as a chicken dinner from the ingestible product preparation system 10 as a cleaning operation, etc.). In an implementation, the electronically directing the at least one second automated cleaning operation of the at least one automated device to remove a third portion other than the first portion and other than the second portion of the at least one first substance from at least a portion of the preparation equipment as one or more heating chambers is carried out by electronically directing the at least one second automated cleaning operation of the at least one automated device to remove a third portion other than the first portion and other than the second portion of the at least one first substance from at least a portion of the preparation equipment as one or more heating chambers (e.g. one or more instances of the microprocessor component s102 of the control and information processing subsystem s100 can direct one or more instances of the material flush abrasive component s820 to assist in removing, from the ingestible product preparation system 10, one or more portions of ingestible product left behind on one or more heating chambers of one or more instances of the heating component s702 by the first preparation occurrence of the first ingestible product as a chicken dinner from the ingestible product preparation system 10 as a cleaning operation, etc.).

In one or more implementations, operation o12 includes an operation o1218 for electronically directing the at least one second automated cleaning operation of the at least one automated device to remove a third portion other than the first portion and other than the second portion of the at least one first substance from at least a portion of the preparation equipment as one or more blender compartments. An exemplary version of a non-transitory signal bearing medium of information storage subsystem s200 is depicted as bearing one or more cleaning blender instructions i1218 that when executed will direct performance of the operation o1218. In an implementation, the one or more cleaning blender instructions i1218 when executed direct electronically directing the at least one second automated cleaning operation of the at least one automated device to remove a third portion other than the first portion and other than the second portion of the at least one first substance from at least a portion of the preparation equipment as one or more blender compartments (e.g. one or more instances of the central processing unit (CPU) component s104 of the control and information processing subsystem s100 can direct one or more instances of the fish tape system brush component s822 to assist in removing, from the ingestible product preparation system 10, one or more portions of ingestible product left behind on one or more blender compartments of one or more instances of the blending component s714 by the first preparation occurrence of the first ingestible product as a fruit drink from the ingestible product preparation system 10 as a cleaning operation, etc.). Furthermore, the cleaning blender electrical circuitry arrangement e1218 when activated will perform the operation o1218. In an implementation, the cleaning blender electrical circuitry arrangement e1218, when activated performs electronically directing the at least one second automated cleaning operation of the at least one automated device to remove a third portion other than the first portion and other than the second portion of the at least one first substance from at least a portion of the preparation equipment as one or more blender compartments (e.g. one or more instances of the central processing unit (CPU) component s104 of the control and information processing subsystem s100 can direct one or more instances of the fish tape system brush component s822 to assist in removing, from the ingestible product preparation system 10, one or more portions of ingestible product left behind on one or more blender compartments of one or more instances of the blending component s714 by the first preparation occurrence of the first ingestible product as a fruit drink from the ingestible product preparation system 10 as a cleaning operation, etc.). In an implementation, the electronically directing the at least one second automated cleaning operation of the at least one automated device to remove a third portion other than the first portion and other than the second portion of the at least one first substance from at least a portion of the preparation equipment as one or more blender compartments is carried out by electronically directing the at least one second automated cleaning operation of the at least one automated device to remove a third portion other than the first portion and other than the second portion of the at least one first substance from at least a portion of the preparation equipment as one or more blender compartments (e.g. one or more instances of the central processing unit (CPU) component s104 of the control and information processing subsystem s100 can direct one or more instances of the fish tape system brush component s822 to assist in removing, from the ingestible product preparation system 10, one or more portions of ingestible product left behind on one or more blender compartments of one or more instances of the blending component s714 by the first preparation occurrence of the first ingestible product as a fruit drink from the ingestible product preparation system 10 as a cleaning operation, etc.).

In one or more implementations, as shown in FIG. 60, operation o12 includes an operation o1219 for electronically directing the at least one second automated cleaning operation of the at least one automated device to remove a third portion other than the first portion and other than the second portion of the at least one first substance from at least a portion of the preparation equipment as one or more cooling chambers. An exemplary version of a non-transitory signal bearing medium of information storage subsystem s200 is depicted as bearing one or more cleaning cooling instructions i1219 that when executed will direct performance of the operation o1219. In an implementation, the one or more cleaning cooling instructions i1219 when executed direct electronically directing the at least one second automated cleaning operation of the at least one automated device to remove a third portion other than the first portion and other than the second portion of the at least one first substance from at least a portion of the preparation equipment as one or more cooling chambers (e.g. one or more instances of the digital signal processor (DSP) component s106 of the control and information processing subsystem s100 can direct one or more instances of the abrasive component s812 to assist in removing, from the ingestible product preparation system 10, one or more portions of ingestible product left behind on one or more cooling chambers of one or more instances of the heating component s702 by the first preparation occurrence of the first ingestible product as a ice cream dish from the ingestible product preparation system 10 as a cleaning operation, etc.). Furthermore, the cleaning cooling electrical circuitry arrangement e1219 when activated will perform the operation o1219. In an implementation, the cleaning cooling electrical circuitry arrangement e1219, when activated performs electronically directing the at least one second automated cleaning operation of the at least one automated device to remove a third portion other than the first portion and other than the second portion of the at least one first substance from at least a portion of the preparation equipment as one or more cooling chambers (e.g. one or more instances of the digital signal processor (DSP) component s106 of the control and information processing subsystem s100 can direct one or more instances of the abrasive component s812 to assist in removing, from the ingestible product preparation system 10, one or more portions of ingestible product left behind on one or more cooling chambers of one or more instances of the heating component s702 by the first preparation occurrence of the first ingestible product as a ice cream dish from the ingestible product preparation system 10 as a cleaning operation, etc.). In an implementation, the electronically directing the at least one second automated cleaning operation of the at least one automated device to remove a third portion other than the first portion and other than the second portion of the at least one first substance from at least a portion of the preparation equipment as one or more cooling chambers is carried out by electronically directing the at least one second automated cleaning operation of the at least one automated device to remove a third portion other than the first portion and other than the second portion of the at least one first substance from at least a portion of the preparation equipment as one or more cooling chambers (e.g. one or more instances of the digital signal processor (DSP) component s106 of the control and information processing subsystem s100 can direct one or more instances of the abrasive component s812 to assist in removing, from the ingestible product preparation system 10, one or more portions of ingestible product left behind on one or more cooling chambers of one or more instances of the heating component s702 by the first preparation occurrence of the first ingestible product as a ice cream dish from the ingestible product preparation system 10 as a cleaning operation, etc.).

In one or more implementations, operation o12 includes an operation o1220 for electronically directing the at least one second automated cleaning operation of the at least one automated device to remove a third portion other than the first portion and other than the second portion of the at least one first substance from at least a portion of the preparation equipment as one or more agitators. An exemplary version of a non-transitory signal bearing medium of information storage subsystem s200 is depicted as bearing one or more cleaning agitator instructions i1220 that when executed will direct performance of the operation o1220. In an implementation, the one or more cleaning agitator instructions i1220 when executed direct electronically directing the at least one second automated cleaning operation of the at least one automated device to remove a third portion other than the first portion and other than the second portion of the at least one first substance from at least a portion of the preparation equipment as one or more agitators (e.g. one or more instances of the application specific integrated circuit (ASIC) component s108 of the control and information processing subsystem s100 can direct one or more instances of the chemical component s832 to assist in removing, from the ingestible product preparation system 10, one or more portions of ingestible product left behind on one or more agitators of one or more instances of the mixer component s716 by the first preparation occurrence of the first ingestible product as a trail mix from the ingestible product preparation system 10 as a cleaning operation, etc.). Furthermore, the cleaning agitator electrical circuitry arrangement e1220 when activated will perform the operation o1220. In an implementation, the cleaning agitator electrical circuitry arrangement e1220, when activated performs electronically directing the at least one second automated cleaning operation of the at least one automated device to remove a third portion other than the first portion and other than the second portion of the at least one first substance from at least a portion of the preparation equipment as one or more agitators (e.g. one or more instances of the application specific integrated circuit (ASIC) component s108 of the control and information processing subsystem s100 can direct one or more instances of the chemical component s832 to assist in removing, from the ingestible product preparation system 10, one or more portions of ingestible product left behind on one or more agitators of one or more instances of the mixer component s716 by the first preparation occurrence of the first ingestible product as a trail mix from the ingestible product preparation system 10 as a cleaning operation, etc.). In an implementation, the electronically directing the at least one second automated cleaning operation of the at least one automated device to remove a third portion other than the first portion and other than the second portion of the at least one first substance from at least a portion of the preparation equipment as one or more agitators is carried out by electronically directing the at least one second automated cleaning operation of the at least one automated device to remove a third portion other than the first portion and other than the second portion of the at least one first substance from at least a portion of the preparation equipment as one or more agitators (e.g. one or more instances of the application specific integrated circuit (ASIC) component s108 of the control and information processing subsystem s100 can direct one or more instances of the chemical component s832 to assist in removing, from the ingestible product preparation system 10, one or more portions of ingestible product left behind on one or more agitators of one or more instances of the mixer component s716 by the first preparation occurrence of the first ingestible product as a trail mix from the ingestible product preparation system 10 as a cleaning operation, etc.).

In one or more implementations, operation o12 includes an operation o1221 for electronically directing the at least one second automated cleaning operation of the at least one automated device to remove a third portion other than the first portion and other than the second portion of the at least one first substance from at least a portion of the preparation equipment as one or more syringes. An exemplary version of a non-transitory signal bearing medium of information storage subsystem s200 is depicted as bearing one or more cleaning syringe instructions i1221 that when executed will direct performance of the operation o1221. In an implementation, the one or more cleaning syringe instructions i1221 when executed direct electronically directing the at least one second automated cleaning operation of the at least one automated device to remove a third portion other than the first portion and other than the second portion of the at least one first substance from at least a portion of the preparation equipment as one or more syringes (e.g. one or more instances of the field programmable gate array (FPGA) component s110 of the control and information processing subsystem s100 can direct one or more instances of the compressed air fluid component s828 to assist in removing, from the ingestible product preparation system 10, one or more portions of ingestible product left behind on one or more syringes or one or more instances of the deposition component s740 by the first preparation occurrence of the first ingestible product as a layered dessert from the ingestible product preparation system 10 as a cleaning operation, etc.). Furthermore, the cleaning syringe electrical circuitry arrangement e1221 when activated will perform the operation o1221. In an implementation, the cleaning syringe electrical circuitry arrangement e1221, when activated performs electronically directing the at least one second automated cleaning operation of the at least one automated device to remove a third portion other than the first portion and other than the second portion of the at least one first substance from at least a portion of the preparation equipment as one or more syringes (e.g. one or more instances of the field programmable gate array (FPGA) component s110 of the control and information processing subsystem s100 can direct one or more instances of the compressed air fluid component s828 to assist in removing, from the ingestible product preparation system 10, one or more portions of ingestible product left behind on one or more syringes or one or more instances of the deposition component s740 by the first preparation occurrence of the first ingestible product as a layered dessert from the ingestible product preparation system 10 as a cleaning operation, etc.). In an implementation, the electronically directing the at least one second automated cleaning operation of the at least one automated device to remove a third portion other than the first portion and other than the second portion of the at least one first substance from at least a portion of the preparation equipment as one or more syringes is carried out by electronically directing the at least one second automated cleaning operation of the at least one automated device to remove a third portion other than the first portion and other than the second portion of the at least one first substance from at least a portion of the preparation equipment as one or more syringes (e.g. one or more instances of the field programmable gate array (FPGA) component s110 of the control and information processing subsystem s100 can direct one or more instances of the compressed air fluid component s828 to assist in removing, from the ingestible product preparation system 10, one or more portions of ingestible product left behind on one or more syringes or one or more instances of the deposition component s740 by the first preparation occurrence of the first ingestible product as a layered dessert from the ingestible product preparation system 10 as a cleaning operation, etc.).

In one or more implementations, as shown in FIG. 61, operation o12 includes an operation o1222 for electronically directing the at least one second automated cleaning operation of the at least one automated device to remove a third portion other than the first portion and other than the second portion of the at least one first substance from at least a portion of the preparation equipment as one or more printer heads. An exemplary version of a non-transitory signal bearing medium of information storage subsystem s200 is depicted as bearing one or more cleaning head instructions i1222 that when executed will direct performance of the operation o1222. In an implementation, the one or more cleaning head instructions i1222 when executed direct electronically directing the at least one second automated cleaning operation of the at least one automated device to remove a third portion other than the first portion and other than the second portion of the at least one first substance from at least a portion of the preparation equipment as one or more printer heads (e.g. one or more instances of the multiprocessor component s112 of the control and information processing subsystem s100 can direct one or more instances of the compressed water fluid component s830 to assist in removing, from the ingestible product preparation system 10, one or more portions of ingestible product left behind on one or more printer heads of one or more instances of the deposition component s740 by the first preparation occurrence of the first ingestible product a deposited sculptured cake from the ingestible product preparation system 10 as a cleaning operation, etc.). Furthermore, the cleaning head electrical circuitry arrangement e1222 when activated will perform the operation o1222. In an implementation, the cleaning head electrical circuitry arrangement e1222, when activated performs electronically directing the at least one second automated cleaning operation of the at least one automated device to remove a third portion other than the first portion and other than the second portion of the at least one first substance from at least a portion of the preparation equipment as one or more printer heads (e.g. one or more instances of the multiprocessor component s112 of the control and information processing subsystem s100 can direct one or more instances of the compressed water fluid component s830 to assist in removing, from the ingestible product preparation system 10, one or more portions of ingestible product left behind on one or more printer heads of one or more instances of the deposition component s740 by the first preparation occurrence of the first ingestible product a deposited sculptured cake from the ingestible product preparation system 10 as a cleaning operation, etc.). In an implementation, the electronically directing the at least one second automated cleaning operation of the at least one automated device to remove a third portion other than the first portion and other than the second portion of the at least one first substance from at least a portion of the preparation equipment as one or more printer heads is carried out by electronically directing the at least one second automated cleaning operation of the at least one automated device to remove a third portion other than the first portion and other than the second portion of the at least one first substance from at least a portion of the preparation equipment as one or more printer heads (e.g. one or more instances of the multiprocessor component s112 of the control and information processing subsystem s100 can direct one or more instances of the compressed water fluid component s830 to assist in removing, from the ingestible product preparation system 10, one or more portions of ingestible product left behind on one or more printer heads of one or more instances of the deposition component s740 by the first preparation occurrence of the first ingestible product a deposited sculptured cake from the ingestible product preparation system 10 as a cleaning operation, etc.).

In one or more implementations, operation o12 includes an operation o1223 for electronically directing the at least one second automated cleaning operation of the at least one automated device to remove a third portion other than the first portion and other than the second portion of the at least one first substance via replacement of one or more portions of the automated preparation equipment. An exemplary version of a non-transitory signal bearing medium of information storage subsystem s200 is depicted as bearing one or more cleaning replacement instructions i1223 that when executed will direct performance of the operation o1223. In an implementation, the one or more cleaning replacement instructions i1223 when executed direct electronically directing the at least one second automated cleaning operation of the at least one automated device to remove a third portion other than the first portion and other than the second portion of the at least one first substance via replacement of one or more portions of the automated preparation equipment (e.g. one or more instances of the optical processing component s114 of the control and information processing subsystem s100 can direct one or more instances of the parts replacement component s826 to assist in removing, from the ingestible product preparation system 10, one or more portions of ingestible product left behind via replacement of one or more printer heads of one or more instances of the deposition component s740 by the first preparation occurrence of the first ingestible product as a layer meat product from the ingestible product preparation system 10 as a cleaning operation, etc.). Furthermore, the cleaning replacement electrical circuitry arrangement e1223 when activated will perform the operation o1223. In an implementation, the cleaning replacement electrical circuitry arrangement e1223, when activated performs electronically directing the at least one second automated cleaning operation of the at least one automated device to remove a third portion other than the first portion and other than the second portion of the at least one first substance via replacement of one or more portions of the automated preparation equipment (e.g. one or more instances of the optical processing component s114 of the control and information processing subsystem s100 can direct one or more instances of the parts replacement component s826 to assist in removing, from the ingestible product preparation system 10, one or more portions of ingestible product left behind via replacement of one or more printer heads of one or more instances of the deposition component s740 by the first preparation occurrence of the first ingestible product as a layer meat product from the ingestible product preparation system 10 as a cleaning operation, etc.). In an implementation, the electronically directing the at least one second automated cleaning operation of the at least one automated device to remove a third portion other than the first portion and other than the second portion of the at least one first substance via replacement of one or more portions of the automated preparation equipment is carried out by electronically directing the at least one second automated cleaning operation of the at least one automated device to remove a third portion other than the first portion and other than the second portion of the at least one first substance via replacement of one or more portions of the automated preparation equipment (e.g. one or more instances of the optical processing component s114 of the control and information processing subsystem s100 can direct one or more instances of the parts replacement component s826 to assist in removing, from the ingestible product preparation system 10, one or more portions of ingestible product left behind via replacement of one or more printer heads of one or more instances of the deposition component s740 by the first preparation occurrence of the first ingestible product as a layer meat product from the ingestible product preparation system 10 as a cleaning operation, etc.).

In one or more implementations, operation o12 includes an operation o1224 for electronically directing the at least one second automated cleaning operation of the at least one automated device to remove a third portion other than the first portion and other than the second portion of the at least one first substance via exchange of one or more portions of the automated preparation equipment with one or more other portions of the automated preparation equipment. An exemplary version of a non-transitory signal bearing medium of information storage subsystem s200 is depicted as bearing one or more cleaning exchange instructions i1224 that when executed will direct performance of the operation o1224. In an implementation, the one or more cleaning exchange instructions i1224 when executed direct electronically directing the at least one second automated cleaning operation of the at least one automated device to remove a third portion other than the first portion and other than the second portion of the at least one first substance via exchange of one or more portions of the automated preparation equipment with one or more other portions of the automated preparation equipment (e.g. one or more instances of the logic component s116 of the control and information processing subsystem s100 can direct one or more instances of the parts exchange component s824 to assist in removing, from the ingestible product preparation system 10, one or more portions of ingestible product left behind via exchange of one or more printer heads of one or more instances of the deposition component s740 by the first preparation occurrence of the first ingestible product as a layered turkey dinner from the ingestible product preparation system 10 as a cleaning operation, etc. Furthermore, the cleaning exchange electrical circuitry arrangement e1224 when activated will perform the operation o1224. In an implementation, the cleaning exchange electrical circuitry arrangement e1224, when activated performs electronically directing the at least one second automated cleaning operation of the at least one automated device to remove a third portion other than the first portion and other than the second portion of the at least one first substance via exchange of one or more portions of the automated preparation equipment with one or more other portions of the automated preparation equipment (e.g. one or more instances of the logic component s116 of the control and information processing subsystem s100 can direct one or more instances of the parts exchange component s824 to assist in removing, from the ingestible product preparation system 10, one or more portions of ingestible product left behind via exchange of one or more printer heads of one or more instances of the deposition component s740 by the first preparation occurrence of the first ingestible product as a layered turkey dinner from the ingestible product preparation system 10 as a cleaning operation, etc. In an implementation, the electronically directing the at least one second automated cleaning operation of the at least one automated device to remove a third portion other than the first portion and other than the second portion of the at least one first substance via exchange of one or more portions of the automated preparation equipment with one or more other portions of the automated preparation equipment is carried out by electronically directing the at least one second automated cleaning operation of the at least one automated device to remove a third portion other than the first portion and other than the second portion of the at least one first substance via exchange of one or more portions of the automated preparation equipment with one or more other portions of the automated preparation equipment (e.g. one or more instances of the logic component s116 of the control and information processing subsystem s100 can direct one or more instances of the parts exchange component s824 to assist in removing, from the ingestible product preparation system 10, one or more portions of ingestible product left behind via exchange of one or more printer heads of one or more instances of the deposition component s740 by the first preparation occurrence of the first ingestible product as a layered turkey dinner from the ingestible product preparation system 10 as a cleaning operation, etc.

In one or more implementations, as shown in FIG. 62, operation o12 includes an operation o1225 for electronically directing the at least one second automated cleaning operation of the at least one automated device to remove a third portion other than the first portion and other than the second portion of the at least one first substance from at least a portion of the preparation equipment prior to the at least one second preparation occurrence of the least one second ingestible product as at least one product other than the at least one first ingestible product. An exemplary version of a non-transitory signal bearing medium of information storage subsystem s200 is depicted as bearing one or more cleaning other instructions i1225 that when executed will direct performance of the operation o1225. In an implementation, the one or more cleaning other instructions i1225 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the least one second ingestible product as at least one product other than the at least one first ingestible product (e.g. one or more instances of the microprocessor component s102 of the control and information processing subsystem s100 can direct one or more instances of the compressed water fluid component s830 to assist in removing, from the ingestible product preparation system 10, one or more portions of ingestible product left behind by the first preparation occurrence of the first ingestible product as a sports drink from the ingestible product preparation system 10 as a cleaning operation prior to the second preparation occurrence of the second ingestible product, etc.). Furthermore, the cleaning other electrical circuitry arrangement e1225 when activated will perform the operation o1225. In an implementation, the cleaning other electrical circuitry arrangement e1225, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the least one second ingestible product as at least one product other than the at least one first ingestible product (e.g. one or more instances of the microprocessor component s102 of the control and information processing subsystem s100 can direct one or more instances of the compressed water fluid component s830 to assist in removing, from the ingestible product preparation system 10, one or more portions of ingestible product left behind by the first preparation occurrence of the first ingestible product as a sports drink from the ingestible product preparation system 10 as a cleaning operation prior to the second preparation occurrence of the second ingestible product, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the least one second ingestible product as at least one product other than the at least one first ingestible product is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the least one second ingestible product as at least one product other than the at least one first ingestible product (e.g. one or more instances of the microprocessor component s102 of the control and information processing subsystem s100 can direct one or more instances of the compressed water fluid component s830 to assist in removing, from the ingestible product preparation system 10, one or more portions of ingestible product left behind by the first preparation occurrence of the first ingestible product as a sports drink from the ingestible product preparation system 10 as a cleaning operation prior to the second preparation occurrence of the second ingestible product, etc.).

In one or more implementations, operation o12 includes an operation o1226 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that includes at least a portion of the at least one first ingestible product. An exemplary version of a non-transitory signal bearing medium of information storage subsystem s200 is depicted as bearing one or more cleaning includes instructions i1226 that when executed will direct performance of the operation o1226. In an implementation, the one or more cleaning includes instructions i1226 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that includes at least a portion of the at least one first ingestible product (e.g. one or more instances of the central processing unit (CPU) component s104 of the control and information processing subsystem s100 can direct one or more instances of the air blower component s802 to assist in removing, from the ingestible product preparation system 10, one or more portions of ingestible product left behind by the first preparation occurrence of the first ingestible product as a meal replacement bar from the ingestible product preparation system 10 as a cleaning operation prior to the second preparation occurrence of the second ingestible product that includes at least a portion of the first ingestible product, etc.). Furthermore, the cleaning includes electrical circuitry arrangement e1226 when activated will perform the operation o1226. In an implementation, the cleaning includes electrical circuitry arrangement e1226, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that includes at least a portion of the at least one first ingestible product (e.g. one or more instances of the central processing unit (CPU) component s104 of the control and information processing subsystem s100 can direct one or more instances of the air blower component s802 to assist in removing, from the ingestible product preparation system 10, one or more portions of ingestible product left behind by the first preparation occurrence of the first ingestible product as a meal replacement bar from the ingestible product preparation system 10 as a cleaning operation prior to the second preparation occurrence of the second ingestible product that includes at least a portion of the first ingestible product, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that includes at least a portion of the at least one first ingestible product is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that includes at least a portion of the at least one first ingestible product (e.g. one or more instances of the central processing unit (CPU) component s104 of the control and information processing subsystem s100 can direct one or more instances of the air blower component s802 to assist in removing, from the ingestible product preparation system 10, one or more portions of ingestible product left behind by the first preparation occurrence of the first ingestible product as a meal replacement bar from the ingestible product preparation system 10 as a cleaning operation prior to the second preparation occurrence of the second ingestible product that includes at least a portion of the first ingestible product, etc.).

In one or more implementations, operation o12 includes an operation o1227 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that is the at least one first ingestible product. An exemplary version of a non-transitory signal bearing medium of information storage subsystem s200 is depicted as bearing one or more cleaning first instructions i1227 that when executed will direct performance of the operation o1227. In an implementation, the one or more cleaning first instructions i1227 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that is the at least one first ingestible product (e.g. one or more instances of the digital signal processor (DSP) component s106 of the control and information processing subsystem s100 can direct one or more instances of the compressed fluid component s804 to assist in removing, from the ingestible product preparation system 10, one or more portions of ingestible product left behind by the first preparation occurrence of the first ingestible product as a smoothie from the ingestible product preparation system 10 as a cleaning operation prior to the second preparation occurrence of the second ingestible product that includes at least a portion of the first ingestible product, etc.). Furthermore, the cleaning first electrical circuitry arrangement e1227 when activated will perform the operation o1227. In an implementation, the cleaning first electrical circuitry arrangement e1227, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that is the at least one first ingestible product (e.g. one or more instances of the digital signal processor (DSP) component s106 of the control and information processing subsystem s100 can direct one or more instances of the compressed fluid component s804 to assist in removing, from the ingestible product preparation system 10, one or more portions of ingestible product left behind by the first preparation occurrence of the first ingestible product as a smoothie from the ingestible product preparation system 10 as a cleaning operation prior to the second preparation occurrence of the second ingestible product that includes at least a portion of the first ingestible product, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that is the at least one first ingestible product is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that is the at least one first ingestible product (e.g. one or more instances of the digital signal processor (DSP) component s106 of the control and information processing subsystem s100 can direct one or more instances of the compressed fluid component s804 to assist in removing, from the ingestible product preparation system 10, one or more portions of ingestible product left behind by the first preparation occurrence of the first ingestible product as a smoothie from the ingestible product preparation system 10 as a cleaning operation prior to the second preparation occurrence of the second ingestible product that includes at least a portion of the first ingestible product, etc.).

In one or more implementations, as shown in FIG. 63, operation o12 includes an operation o1228 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more ingestible ingredients. An exemplary version of a non-transitory signal bearing medium of information storage subsystem s200 is depicted as bearing one or more cleaning combination instructions i1228 that when executed will direct performance of the operation o1228. In an implementation, the one or more cleaning combination instructions i1228 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more ingestible ingredients (e.g. one or more instances of the application specific integrated circuit (ASIC) component s108 of the control and information processing subsystem s100 can direct one or more instances of the vacuum component s806 to assist in removing, from the ingestible product preparation system 10, one or more portions of ingestible product left behind by the first preparation occurrence of the first ingestible product as a facial cream from the ingestible product preparation system 10 as a cleaning operation prior to the second preparation occurrence of the second ingestible product as a tooth paste, etc.). Furthermore, the cleaning combination electrical circuitry arrangement e1228 when activated will perform the operation o1228. In an implementation, the cleaning combination electrical circuitry arrangement e1228, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more ingestible ingredients (e.g. one or more instances of the application specific integrated circuit (ASIC) component s108 of the control and information processing subsystem s100 can direct one or more instances of the vacuum component s806 to assist in removing, from the ingestible product preparation system 10, one or more portions of ingestible product left behind by the first preparation occurrence of the first ingestible product as a facial cream from the ingestible product preparation system 10 as a cleaning operation prior to the second preparation occurrence of the second ingestible product as a tooth paste, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more ingestible ingredients is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more ingestible ingredients (e.g. one or more instances of the application specific integrated circuit (ASIC) component s108 of the control and information processing subsystem s100 can direct one or more instances of the vacuum component s806 to assist in removing, from the ingestible product preparation system 10, one or more portions of ingestible product left behind by the first preparation occurrence of the first ingestible product as a facial cream from the ingestible product preparation system 10 as a cleaning operation prior to the second preparation occurrence of the second ingestible product as a tooth paste, etc.).

In one or more implementations, operation o12 includes an operation o1229 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more ingestible ingredients. An exemplary version of a non-transitory signal bearing medium of information storage subsystem s200 is depicted as bearing one or more cleaning mixture instructions i1229 that when executed will direct performance of the operation o1229. In an implementation, the one or more cleaning mixture instructions i1229 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more ingestible ingredients (e.g. one or more instances of the field programmable gate array (FPGA) component s110 of the control and information processing subsystem s100 can direct one or more instances of the ultrasonic component s808 to assist in removing, from the ingestible product preparation system 10, one or more portions of ingestible product left behind by the first preparation occurrence of the first ingestible product as a hero sandwich from the ingestible product preparation system 10 as a cleaning operation prior to the second preparation occurrence of the second ingestible product as a trail mix, etc.). Furthermore, the cleaning mixture electrical circuitry arrangement e1229 when activated will perform the operation o1229. In an implementation, the cleaning mixture electrical circuitry arrangement e1229, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more ingestible ingredients (e.g. one or more instances of the field programmable gate array (FPGA) component s110 of the control and information processing subsystem s100 can direct one or more instances of the ultrasonic component s808 to assist in removing, from the ingestible product preparation system 10, one or more portions of ingestible product left behind by the first preparation occurrence of the first ingestible product as a hero sandwich from the ingestible product preparation system 10 as a cleaning operation prior to the second preparation occurrence of the second ingestible product as a trail mix, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more ingestible ingredients is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more ingestible ingredients (e.g. one or more instances of the field programmable gate array (FPGA) component s110 of the control and information processing subsystem s100 can direct one or more instances of the ultrasonic component s808 to assist in removing, from the ingestible product preparation system 10, one or more portions of ingestible product left behind by the first preparation occurrence of the first ingestible product as a hero sandwich from the ingestible product preparation system 10 as a cleaning operation prior to the second preparation occurrence of the second ingestible product as a trail mix, etc.).

In one or more implementations, operation o12 includes an operation o1230 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more nutraceuticals. An exemplary version of a non-transitory signal bearing medium of information storage subsystem s200 is depicted as bearing one or more cleaning nutraceuticals instructions i1230 that when executed will direct performance of the operation o1230. In an implementation, the one or more cleaning nutraceuticals instructions i1230 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more nutraceuticals (e.g. one or more instances of the multiprocessor component s112 of the control and information processing subsystem s100 can direct one or more instances of the radiant energy component s810 to assist in removing, from the ingestible product preparation system 10, one or more portions of ingestible product left behind by the first preparation occurrence of the first ingestible product as a daily supplement mix including vitamin B12 and calcium citrate from the ingestible product preparation system 10 as a cleaning operation prior to the second preparation occurrence of the second ingestible product as a sports drink containing amino acids and magnesium citrate, etc.). Furthermore, the cleaning nutraceuticals electrical circuitry arrangement e1230 when activated will perform the operation o1230. In an implementation, the cleaning nutraceuticals electrical circuitry arrangement e1230, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more nutraceuticals (e.g. one or more instances of the multiprocessor component s112 of the control and information processing subsystem s100 can direct one or more instances of the radiant energy component s810 to assist in removing, from the ingestible product preparation system 10, one or more portions of ingestible product left behind by the first preparation occurrence of the first ingestible product as a daily supplement mix including vitamin B12 and calcium citrate from the ingestible product preparation system 10 as a cleaning operation prior to the second preparation occurrence of the second ingestible product as a sports drink containing amino acids and magnesium citrate, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more nutraceuticals is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more nutraceuticals (e.g. one or more instances of the multiprocessor component s112 of the control and information processing subsystem s100 can direct one or more instances of the radiant energy component s810 to assist in removing, from the ingestible product preparation system 10, one or more portions of ingestible product left behind by the first preparation occurrence of the first ingestible product as a daily supplement mix including vitamin B12 and calcium citrate from the ingestible product preparation system 10 as a cleaning operation prior to the second preparation occurrence of the second ingestible product as a sports drink containing amino acids and magnesium citrate, etc.).

In one or more implementations, as shown in FIG. 64, operation o12 includes an operation o1231 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one compound including one or more extracts of USDA certified organically raised plant matter. An exemplary version of a non-transitory signal bearing medium of information storage subsystem s200 is depicted as bearing one or more cleaning organic instructions i1231 that when executed will direct performance of the operation o1231. In an implementation, the one or more cleaning organic instructions i1231 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one compound including one or more extracts of USDA certified organically raised plant matter (e.g. one or more instances of the optical processing component s114 of the control and information processing subsystem s100 can direct one or more instances of the abrasive component s812 to assist in removing, from the ingestible product preparation system 10, one or more portions of ingestible product left behind by the first preparation occurrence of the first ingestible product as an organic vegetable health drink from the ingestible product preparation system 10 as a cleaning operation prior to the second preparation occurrence of the second ingestible product as a organic fruit drink, etc.). Furthermore, the cleaning organic electrical circuitry arrangement e1231 when activated will perform the operation o1231. In an implementation, the cleaning organic electrical circuitry arrangement e1231, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one compound including one or more extracts of USDA certified organically raised plant matter (e.g. one or more instances of the optical processing component s114 of the control and information processing subsystem s100 can direct one or more instances of the abrasive component s812 to assist in removing, from the ingestible product preparation system 10, one or more portions of ingestible product left behind by the first preparation occurrence of the first ingestible product as an organic vegetable health drink from the ingestible product preparation system 10 as a cleaning operation prior to the second preparation occurrence of the second ingestible product as a organic fruit drink, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one compound including one or more extracts of USDA certified organically raised plant matter is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one compound including one or more extracts of USDA certified organically raised plant matter (e.g. one or more instances of the optical processing component s114 of the control and information processing subsystem s100 can direct one or more instances of the abrasive component s812 to assist in removing, from the ingestible product preparation system 10, one or more portions of ingestible product left behind by the first preparation occurrence of the first ingestible product as an organic vegetable health drink from the ingestible product preparation system 10 as a cleaning operation prior to the second preparation occurrence of the second ingestible product as a organic fruit drink, etc.).

In one or more implementations, operation o12 includes an operation o1232 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one composition including one or more fluids. An exemplary version of a non-transitory signal bearing medium of information storage subsystem s200 is depicted as bearing one or more cleaning fluids instructions i1232 that when executed will direct performance of the operation o1232. In an implementation, the one or more cleaning fluids instructions i1232 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one composition including one or more fluids (e.g. one or more instances of the logic component s116 of the control and information processing subsystem s100 can direct one or more instances of the brush component s814 to assist in removing, from the ingestible product preparation system 10, one or more portions of ingestible product left behind by the first preparation occurrence of the first ingestible product as a wine cooler from the ingestible product preparation system 10 as a cleaning operation prior to the second preparation occurrence of the second ingestible product as a milk shake, etc.). Furthermore, the cleaning fluids electrical circuitry arrangement e1232 when activated will perform the operation o1232. In an implementation, the cleaning fluids electrical circuitry arrangement e1232, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one composition including one or more fluids (e.g. one or more instances of the logic component s116 of the control and information processing subsystem s100 can direct one or more instances of the brush component s814 to assist in removing, from the ingestible product preparation system 10, one or more portions of ingestible product left behind by the first preparation occurrence of the first ingestible product as a wine cooler from the ingestible product preparation system 10 as a cleaning operation prior to the second preparation occurrence of the second ingestible product as a milk shake, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one composition including one or more fluids is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one composition including one or more fluids (e.g. one or more instances of the logic component s116 of the control and information processing subsystem s100 can direct one or more instances of the brush component s814 to assist in removing, from the ingestible product preparation system 10, one or more portions of ingestible product left behind by the first preparation occurrence of the first ingestible product as a wine cooler from the ingestible product preparation system 10 as a cleaning operation prior to the second preparation occurrence of the second ingestible product as a milk shake, etc.).

In one or more implementations, operation o12 includes an operation o1233 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more powders. An exemplary version of a non-transitory signal bearing medium of information storage subsystem s200 is depicted as bearing one or more cleaning powders instructions i1233 that when executed will direct performance of the operation o1233. In an implementation, the one or more cleaning powders instructions i1233 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more powders (e.g. one or more instances of the microprocessor component s102 of the control and information processing subsystem s100 can direct one or more instances of the squeegee brush component s816 to assist in removing, from the ingestible product preparation system 10, one or more portions of ingestible product left behind by the first preparation occurrence of the first ingestible product as a facial powder blend from the ingestible product preparation system 10 as a cleaning operation prior to the second preparation occurrence of the second ingestible product as a foot powder mix, etc.). Furthermore, the cleaning powders electrical circuitry arrangement e1233 when activated will perform the operation o1233. In an implementation, the cleaning powders electrical circuitry arrangement e1233, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more powders (e.g. one or more instances of the microprocessor component s102 of the control and information processing subsystem s100 can direct one or more instances of the squeegee brush component s816 to assist in removing, from the ingestible product preparation system 10, one or more portions of ingestible product left behind by the first preparation occurrence of the first ingestible product as a facial powder blend from the ingestible product preparation system 10 as a cleaning operation prior to the second preparation occurrence of the second ingestible product as a foot powder mix, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more powders is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more powders (e.g. one or more instances of the microprocessor component s102 of the control and information processing subsystem s100 can direct one or more instances of the squeegee brush component s816 to assist in removing, from the ingestible product preparation system 10, one or more portions of ingestible product left behind by the first preparation occurrence of the first ingestible product as a facial powder blend from the ingestible product preparation system 10 as a cleaning operation prior to the second preparation occurrence of the second ingestible product as a foot powder mix, etc.).

In one or more implementations, as shown in FIG. 65, operation O12 includes an operation o1234 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as excluding one or more allergens found in the at least one first ingestible product. An exemplary version of a non-transitory signal bearing medium of information storage subsystem s200 is depicted as bearing one or more cleaning allergens instructions i1234 that when executed will direct performance of the operation o1234. In an implementation, the one or more cleaning allergens instructions i1234 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as excluding one or more allergens found in the at least one first ingestible product (e.g. one or more instances of the central processing unit (CPU) component s104 of the control and information processing subsystem s100 can direct one or more instances of the pipe cleaner brush component s818 to assist in removing, from the ingestible product preparation system 10, one or more portions of ingestible product left behind by the first preparation occurrence of the first ingestible product as a wheat and diary containing pizza pie from the ingestible product preparation system 10 as a cleaning operation prior to the second preparation occurrence of the second ingestible product a gluten free, diary free pizza pie, etc.). Furthermore, the cleaning allergens electrical circuitry arrangement e1234 when activated will perform the operation o1234. In an implementation, the cleaning allergens electrical circuitry arrangement e1234, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as excluding one or more allergens found in the at least one first ingestible product (e.g. one or more instances of the central processing unit (CPU) component s104 of the control and information processing subsystem s100 can direct one or more instances of the pipe cleaner brush component s818 to assist in removing, from the ingestible product preparation system 10, one or more portions of ingestible product left behind by the first preparation occurrence of the first ingestible product as a wheat and diary containing pizza pie from the ingestible product preparation system 10 as a cleaning operation prior to the second preparation occurrence of the second ingestible product a gluten free, diary free pizza pie, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as excluding one or more allergens found in the at least one first ingestible product is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as excluding one or more allergens found in the at least one first ingestible product (e.g. one or more instances of the central processing unit (CPU) component s104 of the control and information processing subsystem s100 can direct one or more instances of the pipe cleaner brush component s818 to assist in removing, from the ingestible product preparation system 10, one or more portions of ingestible product left behind by the first preparation occurrence of the first ingestible product as a wheat and diary containing pizza pie from the ingestible product preparation system 10 as a cleaning operation prior to the second preparation occurrence of the second ingestible product a gluten free, diary free pizza pie, etc.).

In one or more implementations, operation o12 includes an operation o1235 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as including one or more controlled pharmaceutical agents. An exemplary version of a non-transitory signal bearing medium of information storage subsystem s200 is depicted as bearing one or more cleaning agents instructions i1235 that when executed will direct performance of the operation o1235. In an implementation, the one or more cleaning agents instructions i1235 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as including one or more controlled pharmaceutical agents (e.g. one or more instances of the digital signal processor (DSP) component s106 of the control and information processing subsystem s100 can direct one or more instances of the material flush abrasive component s820 to assist in removing, from the ingestible product preparation system 10, one or more portions of ingestible product left behind by the first preparation occurrence of the first ingestible product as a cold medication drink from the ingestible product preparation system 10 as a cleaning operation prior to the second preparation occurrence of the second ingestible product as a migraine medication, etc.). Furthermore, the cleaning agents electrical circuitry arrangement e1235 when activated will perform the operation o1235. In an implementation, the cleaning agents electrical circuitry arrangement e1235, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as including one or more controlled pharmaceutical agents (e.g. one or more instances of the digital signal processor (DSP) component s106 of the control and information processing subsystem s100 can direct one or more instances of the material flush abrasive component s820 to assist in removing, from the ingestible product preparation system 10, one or more portions of ingestible product left behind by the first preparation occurrence of the first ingestible product as a cold medication drink from the ingestible product preparation system 10 as a cleaning operation prior to the second preparation occurrence of the second ingestible product as a migraine medication, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as including one or more controlled pharmaceutical agents is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as including one or more controlled pharmaceutical agents (e.g. one or more instances of the digital signal processor (DSP) component s106 of the control and information processing subsystem s100 can direct one or more instances of the material flush abrasive component s820 to assist in removing, from the ingestible product preparation system 10, one or more portions of ingestible product left behind by the first preparation occurrence of the first ingestible product as a cold medication drink from the ingestible product preparation system 10 as a cleaning operation prior to the second preparation occurrence of the second ingestible product as a migraine medication, etc.).

In one or more implementations, operation o12 includes an operation o1236 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as originating from one or more geographic regions. An exemplary version of a non-transitory signal bearing medium of information storage subsystem s200 is depicted as bearing one or more cleaning regions instructions i1236 that when executed will direct performance of the operation o1236. In an implementation, the one or more cleaning regions instructions i1236 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as originating from one or more geographic regions (e.g. one or more instances of the application specific integrated circuit (ASIC) component s108 of the control and information processing subsystem s100 can direct one or more instances of the fish tape system brush component s822 to assist in removing, from the ingestible product preparation system 10, one or more portions of ingestible product left behind by the first preparation occurrence of the first ingestible product as a wine cooler made from grapes grown in northern California and Washington state from the ingestible product preparation system 10 as a cleaning operation prior to the second preparation occurrence of the second ingestible product as a milk product from the state of Oregon, etc.). Furthermore, the cleaning regions electrical circuitry arrangement e1236 when activated will perform the operation o1236. In an implementation, the cleaning regions electrical circuitry arrangement e1236, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as originating from one or more geographic regions (e.g. one or more instances of the application specific integrated circuit (ASIC) component s108 of the control and information processing subsystem s100 can direct one or more instances of the fish tape system brush component s822 to assist in removing, from the ingestible product preparation system 10, one or more portions of ingestible product left behind by the first preparation occurrence of the first ingestible product as a wine cooler made from grapes grown in northern California and Washington state from the ingestible product preparation system 10 as a cleaning operation prior to the second preparation occurrence of the second ingestible product as a milk product from the state of Oregon, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as originating from one or more geographic regions is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as originating from one or more geographic regions (e.g. one or more instances of the application specific integrated circuit (ASIC) component s108 of the control and information processing subsystem s100 can direct one or more instances of the fish tape system brush component s822 to assist in removing, from the ingestible product preparation system 10, one or more portions of ingestible product left behind by the first preparation occurrence of the first ingestible product as a wine cooler made from grapes grown in northern California and Washington state from the ingestible product preparation system 10 as a cleaning operation prior to the second preparation occurrence of the second ingestible product as a milk product from the state of Oregon, etc.).

In one or more implementations, as shown in FIG. 66, operation o12 includes an operation o1237 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more authoritative entities. An exemplary version of a non-transitory signal bearing medium of information storage subsystem s200 is depicted as bearing one or more cleaning authoritative instructions i1237 that when executed will direct performance of the operation o1237. In an implementation, the one or more cleaning authoritative instructions i1237 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more authoritative entities (e.g. one or more instances of the field programmable gate array (FPGA) component s110 of the control and information processing subsystem s100 can direct one or more instances of the parts exchange component s824 to assist in removing, from the ingestible product preparation system 10, one or more portions of ingestible product left behind by the first preparation occurrence of the first ingestible product as a sports bar endorsed by five soccer players from the ingestible product preparation system 10 as a cleaning operation prior to the second preparation occurrence of the second ingestible product, as another sports bar endorsed by six hockey players, etc.). Furthermore, the cleaning authoritative electrical circuitry arrangement e1237 when activated will perform the operation electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more authoritative entities. In an implementation, the cleaning authoritative electrical circuitry arrangement e1237, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more authoritative entities (e.g. one or more instances of the field programmable gate array (FPGA) component s110 of the control and information processing subsystem s100 can direct one or more instances of the parts exchange component s824 to assist in removing, from the ingestible product preparation system 10, one or more portions of ingestible product left behind by the first preparation occurrence of the first ingestible product as a sports bar endorsed by five soccer players from the ingestible product preparation system 10 as a cleaning operation prior to the second preparation occurrence of the second ingestible product, as another sports bar endorsed by six hockey players, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more authoritative entities is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more authoritative entities (e.g. one or more instances of the field programmable gate array (FPGA) component s110 of the control and information processing subsystem s100 can direct one or more instances of the parts exchange component s824 to assist in removing, from the ingestible product preparation system 10, one or more portions of ingestible product left behind by the first preparation occurrence of the first ingestible product as a sports bar endorsed by five soccer players from the ingestible product preparation system 10 as a cleaning operation prior to the second preparation occurrence of the second ingestible product, as another sports bar endorsed by six hockey players, etc.).

In one or more implementations, operation o12 includes an operation o1238 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more designated users. An exemplary version of a non-transitory signal bearing medium of information storage subsystem s200 is depicted as bearing one or more cleaning designated instructions i1238 that when executed will direct performance of the operation o1238. In an implementation, the one or more cleaning designated instructions i1238 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more designated users (e.g. one or more instances of the multiprocessor component s112 of the control and information processing subsystem s100 can direct one or more instances of the parts replacement component s826 to assist in removing, from the ingestible product preparation system 10, one or more portions of ingestible product left behind by the first preparation occurrence of the first ingestible product as a meal replacement weight loss bar endorsed by three successful users from the ingestible product preparation system 10 as a cleaning operation prior to the second preparation occurrence of the second ingestible product as a meal replacement weight gain bar endorsed by five body building athletes, etc.). Furthermore, the cleaning designated electrical circuitry arrangement e1238 when activated will perform the operation o1238. In an implementation, the cleaning designated electrical circuitry arrangement e1238, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more designated users (e.g. one or more instances of the multiprocessor component s112 of the control and information processing subsystem s100 can direct one or more instances of the parts replacement component s826 to assist in removing, from the ingestible product preparation system 10, one or more portions of ingestible product left behind by the first preparation occurrence of the first ingestible product as a meal replacement weight loss bar endorsed by three successful users from the ingestible product preparation system 10 as a cleaning operation prior to the second preparation occurrence of the second ingestible product as a meal replacement weight gain bar endorsed by five body building athletes, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more designated users is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being endorsed by one or more designated users (e.g. one or more instances of the multiprocessor component s112 of the control and information processing subsystem s100 can direct one or more instances of the parts replacement component s826 to assist in removing, from the ingestible product preparation system 10, one or more portions of ingestible product left behind by the first preparation occurrence of the first ingestible product as a meal replacement weight loss bar endorsed by three successful users from the ingestible product preparation system 10 as a cleaning operation prior to the second preparation occurrence of the second ingestible product as a meal replacement weight gain bar endorsed by five body building athletes, etc.).

In one or more implementations, operation o12 includes an operation o1239 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being chemically reactive with the at least one first substance of the at least one first ingestible product. An exemplary version of a non-transitory signal bearing medium of information storage subsystem s200 is depicted as bearing one or more cleaning reactive instructions i1239 that when executed will direct performance of the operation o1239. In an implementation, the one or more cleaning reactive instructions i1239 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being chemically reactive with the at least one first substance of the at least one first ingestible product (e.g. one or more instances of the optical processing component s114 of the control and information processing subsystem s100 can direct one or more instances of the compressed air fluid component s828 to assist in removing, from the ingestible product preparation system 10, one or more portions of ingestible product left behind by the first preparation occurrence of the first ingestible product as an energy drink containing amino acids reactive to pharmaceuticals in a drug cocktail scheduled to be prepared from the ingestible product preparation system 10 as a cleaning operation prior to the second preparation occurrence of the second ingestible product as the drug cocktail chemically containing the pharmaceuticals that are chemically reactive to the amino acids in the energy drink, etc.). Furthermore, the cleaning reactive electrical circuitry arrangement e1239 when activated will perform the operation o1239. In an implementation, the cleaning reactive electrical circuitry arrangement e1239, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being chemically reactive with the at least one first substance of the at least one first ingestible product (e.g. one or more instances of the optical processing component s114 of the control and information processing subsystem s100 can direct one or more instances of the compressed air fluid component s828 to assist in removing, from the ingestible product preparation system 10, one or more portions of ingestible product left behind by the first preparation occurrence of the first ingestible product as an energy drink containing amino acids reactive to pharmaceuticals in a drug cocktail scheduled to be prepared from the ingestible product preparation system 10 as a cleaning operation prior to the second preparation occurrence of the second ingestible product as the drug cocktail chemically containing the pharmaceuticals that are chemically reactive to the amino acids in the energy drink, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being chemically reactive with the at least one first substance of the at least one first ingestible product is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being chemically reactive with the at least one first substance of the at least one first ingestible product (e.g. one or more instances of the optical processing component s114 of the control and information processing subsystem s100 can direct one or more instances of the compressed air fluid component s828 to assist in removing, from the ingestible product preparation system 10, one or more portions of ingestible product left behind by the first preparation occurrence of the first ingestible product as an energy drink containing amino acids reactive to pharmaceuticals in a drug cocktail scheduled to be prepared from the ingestible product preparation system 10 as a cleaning operation prior to the second preparation occurrence of the second ingestible product as the drug cocktail chemically containing the pharmaceuticals that are chemically reactive to the amino acids in the energy drink, etc.).

In one or more implementations, as shown in FIG. 67, operation o12 includes an operation o1240 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more scanner components. An exemplary version of a non-transitory signal bearing medium of information storage subsystem s200 is depicted as bearing one or more cleaning receiving instructions i1240 that when executed will direct performance of the operation o1240. In an implementation, the one or more cleaning receiving instructions i1240 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more scanner components (e.g. one or more instances of the logic component s116 of the control and information processing subsystem s100 can direct one or more instances of the compressed water fluid component s830 to assist in removing, from the ingestible product preparation system 10, one or more portions of ingestible product left behind by the first preparation occurrence of the first ingestible product as a Caesar salad from the ingestible product preparation system 10 as a cleaning operation prior to the second preparation occurrence of the second ingestible product as a hamburger initiated by scanning of a user's face by one or more instances of the scanner component s338, etc.). Furthermore, the cleaning receiving electrical circuitry arrangement e1240 when activated will perform the operation o1240. In an implementation, the cleaning receiving electrical circuitry arrangement e1240, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more scanner components (e.g. one or more instances of the logic component s116 of the control and information processing subsystem s100 can direct one or more instances of the compressed water fluid component s830 to assist in removing, from the ingestible product preparation system 10, one or more portions of ingestible product left behind by the first preparation occurrence of the first ingestible product as a Caesar salad from the ingestible product preparation system 10 as a cleaning operation prior to the second preparation occurrence of the second ingestible product as a hamburger initiated by scanning of a user's face by one or more instances of the scanner component s338, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more scanner components is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more scanner components (e.g. one or more instances of the logic component s116 of the control and information processing subsystem s100 can direct one or more instances of the compressed water fluid component s830 to assist in removing, from the ingestible product preparation system 10, one or more portions of ingestible product left behind by the first preparation occurrence of the first ingestible product as a Caesar salad from the ingestible product preparation system 10 as a cleaning operation prior to the second preparation occurrence of the second ingestible product as a hamburger initiated by scanning of a user's face by one or more instances of the scanner component s338, etc.).

In one or more implementations, operation o12 includes an operation o1241 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more graphical user interface (GUI) components. An exemplary version of a non-transitory signal bearing medium of information storage subsystem s200 is depicted as bearing one or more cleaning GUI instructions i1241 that when executed will direct performance of the operation o1241. In an implementation, the one or more cleaning GUI instructions i1241 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more graphical user interface (GUI) components (e.g. one or more instances of the microprocessor component s102 of the control and information processing subsystem s100 can direct one or more instances of the chemical component s832 to assist in removing, from the ingestible product preparation system 10, one or more portions of ingestible product left behind by the first preparation occurrence of the first ingestible product as a turkey dinner from the ingestible product preparation system 10 as a cleaning operation prior to the second preparation occurrence of the second ingestible product as a hotdog sandwich initiated by user input through one or more instances of the graphical user interface (GUI) component s302, etc.). Furthermore, the cleaning GUI electrical circuitry arrangement e1241 when activated will perform the operation o1241. In an implementation, the cleaning GUI electrical circuitry arrangement e1241, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more graphical user interface (GUI) components (e.g. one or more instances of the microprocessor component s102 of the control and information processing subsystem s100 can direct one or more instances of the chemical component s832 to assist in removing, from the ingestible product preparation system 10, one or more portions of ingestible product left behind by the first preparation occurrence of the first ingestible product as a turkey dinner from the ingestible product preparation system 10 as a cleaning operation prior to the second preparation occurrence of the second ingestible product as a hotdog sandwich initiated by user input through one or more instances of the graphical user interface (GUI) component s302, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more graphical user interface (GUI) components is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more graphical user interface (GUI) components (e.g. one or more instances of the microprocessor component s102 of the control and information processing subsystem s100 can direct one or more instances of the chemical component s832 to assist in removing, from the ingestible product preparation system 10, one or more portions of ingestible product left behind by the first preparation occurrence of the first ingestible product as a turkey dinner from the ingestible product preparation system 10 as a cleaning operation prior to the second preparation occurrence of the second ingestible product as a hotdog sandwich initiated by user input through one or more instances of the graphical user interface (GUI) component s302, etc.).

In one or more implementations, operation o12 includes an operation o1242 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more visual display components. An exemplary version of a non-transitory signal bearing medium of information storage subsystem s200 is depicted as bearing one or more cleaning display instructions i1242 that when executed will direct performance of the operation o1242. In an implementation, the one or more cleaning display instructions i1242 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more visual display components (e.g. one or more instances of the central processing unit (CPU) component s104 of the control and information processing subsystem s100 can direct one or more instances of the air blower component s802 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a sirloin steak initiated by user input through one or more instances of the visual display component s304, etc.). Furthermore, the cleaning display electrical circuitry arrangement e1242 when activated will perform the operation o1242. In an implementation, the cleaning display electrical circuitry arrangement e1242, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more visual display components (e.g. one or more instances of the central processing unit (CPU) component s104 of the control and information processing subsystem s100 can direct one or more instances of the air blower component s802 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a sirloin steak initiated by user input through one or more instances of the visual display component s304, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more visual display components is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more visual display components (e.g. one or more instances of the central processing unit (CPU) component s104 of the control and information processing subsystem s100 can direct one or more instances of the air blower component s802 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a sirloin steak initiated by user input through one or more instances of the visual display component s304, etc.).

In one or more implementations, as shown in FIG. 68, operation o12 includes an operation o1243 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more keyboard components. An exemplary version of a non-transitory signal bearing medium of information storage subsystem s200 is depicted as bearing one or more cleaning keyboard instructions i1243 that when executed will direct performance of the operation o1243. In an implementation, the one or more cleaning keyboard instructions i1243 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more keyboard components (e.g. one or more instances of the digital signal processor (DSP) component s106 of the control and information processing subsystem s100 can direct one or more instances of the compressed fluid component s804 to assist in removing, from the ingestible product preparation system 10, one or more portions of ingestible product left behind by the first preparation occurrence of the first ingestible product as a bowl of kimchee from the ingestible product preparation system 10 as a cleaning operation prior to the second preparation occurrence of the second ingestible product as a chicken teriyaki initiated by user input through one or more instances of the keyboard component s306, etc.). Furthermore, the cleaning keyboard electrical circuitry arrangement e1243 when activated will perform the operation o1243. In an implementation, the cleaning keyboard electrical circuitry arrangement e1243, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more keyboard components (e.g. one or more instances of the digital signal processor (DSP) component s106 of the control and information processing subsystem s100 can direct one or more instances of the compressed fluid component s804 to assist in removing, from the ingestible product preparation system 10, one or more portions of ingestible product left behind by the first preparation occurrence of the first ingestible product as a bowl of kimchee from the ingestible product preparation system 10 as a cleaning operation prior to the second preparation occurrence of the second ingestible product as a chicken teriyaki initiated by user input through one or more instances of the keyboard component s306, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more keyboard components is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more keyboard components (e.g. one or more instances of the digital signal processor (DSP) component s106 of the control and information processing subsystem s100 can direct one or more instances of the compressed fluid component s804 to assist in removing, from the ingestible product preparation system 10, one or more portions of ingestible product left behind by the first preparation occurrence of the first ingestible product as a bowl of kimchee from the ingestible product preparation system 10 as a cleaning operation prior to the second preparation occurrence of the second ingestible product as a chicken teriyaki initiated by user input through one or more instances of the keyboard component s306, etc.).

In one or more implementations, operation o12 includes an operation o1244 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more touch screen components. An exemplary version of a non-transitory signal bearing medium of information storage subsystem s200 is depicted as bearing one or more cleaning screen instructions i1244 that when executed will direct performance of the operation o1244. In an implementation, the one or more cleaning screen instructions i1244 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more touch screen components (e.g. one or more instances of the application specific integrated circuit (ASIC) component s108 of the control and information processing subsystem s100 can direct one or more instances of the vacuum component s806 to assist in removing, from the ingestible product preparation system 10, one or more portions of ingestible product left behind by the first preparation occurrence of the first ingestible product as a spaghetti dish from the ingestible product preparation system 10 as a cleaning operation prior to the second preparation occurrence of the second ingestible product as a ravioli initiated by user input through one or more instances of the touch screen component s314, etc.). Furthermore, the cleaning screen electrical circuitry arrangement e1244 when activated will perform the operation o1244. In an implementation, the cleaning screen electrical circuitry arrangement e1244, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more touch screen components (e.g. one or more instances of the application specific integrated circuit (ASIC) component s108 of the control and information processing subsystem s100 can direct one or more instances of the vacuum component s806 to assist in removing, from the ingestible product preparation system 10, one or more portions of ingestible product left behind by the first preparation occurrence of the first ingestible product as a spaghetti dish from the ingestible product preparation system 10 as a cleaning operation prior to the second preparation occurrence of the second ingestible product as a ravioli initiated by user input through one or more instances of the touch screen component s314, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more touch screen components is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more touch screen components (e.g. one or more instances of the application specific integrated circuit (ASIC) component s108 of the control and information processing subsystem s100 can direct one or more instances of the vacuum component s806 to assist in removing, from the ingestible product preparation system 10, one or more portions of ingestible product left behind by the first preparation occurrence of the first ingestible product as a spaghetti dish from the ingestible product preparation system 10 as a cleaning operation prior to the second preparation occurrence of the second ingestible product as a ravioli initiated by user input through one or more instances of the touch screen component s314, etc.).

In one or more implementations, operation o12 includes an operation o1245 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more camera components. An exemplary version of a non-transitory signal bearing medium of information storage subsystem s200 is depicted as bearing one or more cleaning camera instructions i1245 that when executed will direct performance of the operation o1245. In an implementation, the one or more cleaning camera instructions i1245 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more camera components (e.g. one or more instances of the field programmable gate array (FPGA) component s110 of the control and information processing subsystem s100 can direct one or more instances of the ultrasonic component s808 to assist in removing, from the ingestible product preparation system 10, one or more portions of ingestible product left behind by the first preparation occurrence of the first ingestible product as a milk shake from the ingestible product preparation system 10 as a cleaning operation prior to the second preparation occurrence of the second ingestible product as a salmon steak initiated by user input through one or more instances of the camera component s336, etc.). Furthermore, the cleaning camera electrical circuitry arrangement e1245 when activated will perform the operation o1245. In an implementation, the cleaning camera electrical circuitry arrangement e1245, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more camera components (e.g. one or more instances of the field programmable gate array (FPGA) component s110 of the control and information processing subsystem s100 can direct one or more instances of the ultrasonic component s808 to assist in removing, from the ingestible product preparation system 10, one or more portions of ingestible product left behind by the first preparation occurrence of the first ingestible product as a milk shake from the ingestible product preparation system 10 as a cleaning operation prior to the second preparation occurrence of the second ingestible product as a salmon steak initiated by user input through one or more instances of the camera component s336, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more camera components is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more camera components (e.g. one or more instances of the field programmable gate array (FPGA) component s110 of the control and information processing subsystem s100 can direct one or more instances of the ultrasonic component s808 to assist in removing, from the ingestible product preparation system 10, one or more portions of ingestible product left behind by the first preparation occurrence of the first ingestible product as a milk shake from the ingestible product preparation system 10 as a cleaning operation prior to the second preparation occurrence of the second ingestible product as a salmon steak initiated by user input through one or more instances of the camera component s336, etc.).

In one or more implementations, as shown in FIG. 69, operation o12 includes an operation o1246 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more sound sensing components. An exemplary version of a non-transitory signal bearing medium of information storage subsystem s200 is depicted as bearing one or more cleaning sound instructions i1246 that when executed will direct performance of the operation o1246. In an implementation, the one or more cleaning sound instructions i1246 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more sound sensing components (e.g. one or more instances of the multiprocessor component s112 of the control and information processing subsystem s100 can direct one or more instances of the radiant energy component s810 to assist in removing, from the ingestible product preparation system 10, one or more portions of ingestible product left behind by the first preparation occurrence of the first ingestible product as a fruit drink from the ingestible product preparation system 10 as a cleaning operation prior to the second preparation occurrence of the second ingestible product as a vegetable juice drink initiated by user input through one or more instances of the sound sensing component s420, etc.). Furthermore, the cleaning sound electrical circuitry arrangement e1246 when activated will perform the operation o1246. In an implementation, the cleaning sound electrical circuitry arrangement e1246, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more sound sensing components (e.g. one or more instances of the multiprocessor component s112 of the control and information processing subsystem s100 can direct one or more instances of the radiant energy component s810 to assist in removing, from the ingestible product preparation system 10, one or more portions of ingestible product left behind by the first preparation occurrence of the first ingestible product as a fruit drink from the ingestible product preparation system 10 as a cleaning operation prior to the second preparation occurrence of the second ingestible product as a vegetable juice drink initiated by user input through one or more instances of the sound sensing component s420, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more sound sensing components is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more sound sensing components (e.g. one or more instances of the multiprocessor component s112 of the control and information processing subsystem s100 can direct one or more instances of the radiant energy component s810 to assist in removing, from the ingestible product preparation system 10, one or more portions of ingestible product left behind by the first preparation occurrence of the first ingestible product as a fruit drink from the ingestible product preparation system 10 as a cleaning operation prior to the second preparation occurrence of the second ingestible product as a vegetable juice drink initiated by user input through one or more instances of the sound sensing component s420, etc.).

In one or more implementations, operation o12 includes an operation o1247 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more computer networks. An exemplary version of a non-transitory signal bearing medium of information storage subsystem s200 is depicted as bearing one or more cleaning network instructions i1247 that when executed will direct performance of the operation o1247. In an implementation, the one or more cleaning network instructions i1247 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more computer networks (e.g. one or more instances of the optical processing component s114 of the control and information processing subsystem s100 can direct one or more instances of the abrasive component s812 to assist in removing, from the ingestible product preparation system 10, one or more portions of ingestible product left behind by the first preparation occurrence of the first ingestible product as fresh made French fries from the ingestible product preparation system 10 as a cleaning operation prior to the second preparation occurrence of the second ingestible product as a fresh made potato chips initiated by user input through one or more instances of the wide area network component s516, etc.). Furthermore, the cleaning network electrical circuitry arrangement e1247 when activated will perform the operation o1247. In an implementation, the cleaning network electrical circuitry arrangement e1247, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more computer networks (e.g. one or more instances of the optical processing component s114 of the control and information processing subsystem s100 can direct one or more instances of the abrasive component s812 to assist in removing, from the ingestible product preparation system 10, one or more portions of ingestible product left behind by the first preparation occurrence of the first ingestible product as fresh made French fries from the ingestible product preparation system 10 as a cleaning operation prior to the second preparation occurrence of the second ingestible product as a fresh made potato chips initiated by user input through one or more instances of the wide area network component s516, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more computer networks is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more computer networks (e.g. one or more instances of the optical processing component s114 of the control and information processing subsystem s100 can direct one or more instances of the abrasive component s812 to assist in removing, from the ingestible product preparation system 10, one or more portions of ingestible product left behind by the first preparation occurrence of the first ingestible product as fresh made French fries from the ingestible product preparation system 10 as a cleaning operation prior to the second preparation occurrence of the second ingestible product as a fresh made potato chips initiated by user input through one or more instances of the wide area network component s516, etc.).

In one or more implementations, operation o12 includes an operation o1248 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more cellular networks. An exemplary version of a non-transitory signal bearing medium of information storage subsystem s200 is depicted as bearing one or more cleaning cellular instructions i1248 that when executed will direct performance of the operation o1248. In an implementation, the one or more cleaning cellular instructions i1248 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more cellular network (e.g. one or more instances of the logic component s116 of the control and information processing subsystem s100 can direct one or more instances of the brush component s814 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a sirloin steak initiated by user input through one or more instances of the cellular network component s514, etc.). Furthermore, the cleaning cellular electrical circuitry arrangement e1248 when activated will perform the operation o1248. In an implementation, the cleaning cellular electrical circuitry arrangement e1248, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more cellular network (e.g. one or more instances of the logic component s116 of the control and information processing subsystem s100 can direct one or more instances of the brush component s814 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a sirloin steak initiated by user input through one or more instances of the cellular network component s514, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more cellular networks is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more cellular network (e.g. one or more instances of the logic component s116 of the control and information processing subsystem s100 can direct one or more instances of the brush component s814 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a sirloin steak initiated by user input through one or more instances of the cellular network component s514, etc.).

In one or more implementations, as shown in FIG. 70, operation o12 includes an operation o1249 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including menu selections by the particular individual living being regarding the at least one second ingestible product to be consumed by the particular individual living being. An exemplary version of a non-transitory signal bearing medium of information storage subsystem s200 is depicted as bearing one or more cleaning menu instructions i1249 that when executed will direct performance of the operation o1249. In an implementation, the one or more cleaning menu instructions i1249 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including menu selections by the particular individual living being regarding the at least one second ingestible product to be consumed by the particular individual living being (e.g. one or more instances of the microprocessor component s102 of the control and information processing subsystem s100 can direct one or more instances of the squeegee brush component s816 to assist in removing, from the ingestible product preparation system 10, one or more portions of ingestible product left behind by the first preparation occurrence of the first ingestible product as a pumpkin pie from the ingestible product preparation system 10 as a cleaning operation prior to the second preparation occurrence of the second ingestible product as a blue berry pie initiated by user menu selections one or more instances of the graphical user interface (GUI) component s302, etc.). Furthermore, the cleaning menu electrical circuitry arrangement e1249 when activated will perform the operation o1249. In an implementation, the cleaning menu electrical circuitry arrangement e1249, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including menu selections by the particular individual living being regarding the at least one second ingestible product to be consumed by the particular individual living being (e.g. one or more instances of the microprocessor component s102 of the control and information processing subsystem s100 can direct one or more instances of the squeegee brush component s816 to assist in removing, from the ingestible product preparation system 10, one or more portions of ingestible product left behind by the first preparation occurrence of the first ingestible product as a pumpkin pie from the ingestible product preparation system 10 as a cleaning operation prior to the second preparation occurrence of the second ingestible product as a blue berry pie initiated by user menu selections one or more instances of the graphical user interface (GUI) component s302, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including menu selections by the particular individual living being regarding the at least one second ingestible product to be consumed by the particular individual living being is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including menu selections by the particular individual living being regarding the at least one second ingestible product to be consumed by the particular individual living being (e.g. one or more instances of the microprocessor component s102 of the control and information processing subsystem s100 can direct one or more instances of the squeegee brush component s816 to assist in removing, from the ingestible product preparation system 10, one or more portions of ingestible product left behind by the first preparation occurrence of the first ingestible product as a pumpkin pie from the ingestible product preparation system 10 as a cleaning operation prior to the second preparation occurrence of the second ingestible product as a blue berry pie initiated by user menu selections one or more instances of the graphical user interface (GUI) component s302, etc.).

In one or more implementations, operation o12 includes an operation o1250 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including physician prescription directions regarding the particular individual living being. An exemplary version of a non-transitory signal bearing medium of information storage subsystem s200 is depicted as bearing one or more cleaning prescription instructions i1250 that when executed will direct performance of the operation o1250. In an implementation, the one or more cleaning prescription instructions i1250 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including physician prescription directions regarding the particular individual living being (e.g. one or more instances of the central processing unit (CPU) component s104 of the control and information processing subsystem s100 can direct one or more instances of the pipe cleaner brush component s818 to assist in removing, from the ingestible product preparation system 10, one or more portions of ingestible product left behind by the first preparation occurrence of the first ingestible product as a peanut brittle from the ingestible product preparation system 10 as a cleaning operation prior to the second preparation occurrence of the second ingestible product as a fruit punch initiated by user input including pharmaceutical prescription information associated with the user through one or more instances of the scanner component s338, etc.). Furthermore, the cleaning prescription electrical circuitry arrangement e1250 when activated will perform the operation o1250. In an implementation, the cleaning prescription electrical circuitry arrangement e1250, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including physician prescription directions regarding the particular individual living being (e.g. one or more instances of the central processing unit (CPU) component s104 of the control and information processing subsystem s100 can direct one or more instances of the pipe cleaner brush component s818 to assist in removing, from the ingestible product preparation system 10, one or more portions of ingestible product left behind by the first preparation occurrence of the first ingestible product as a peanut brittle from the ingestible product preparation system 10 as a cleaning operation prior to the second preparation occurrence of the second ingestible product as a fruit punch initiated by user input including pharmaceutical prescription information associated with the user through one or more instances of the scanner component s338, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including physician prescription directions regarding the particular individual living being is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including physician prescription directions regarding the particular individual living being (e.g. one or more instances of the central processing unit (CPU) component s104 of the control and information processing subsystem s100 can direct one or more instances of the pipe cleaner brush component s818 to assist in removing, from the ingestible product preparation system 10, one or more portions of ingestible product left behind by the first preparation occurrence of the first ingestible product as a peanut brittle from the ingestible product preparation system 10 as a cleaning operation prior to the second preparation occurrence of the second ingestible product as a fruit punch initiated by user input including pharmaceutical prescription information associated with the user through one or more instances of the scanner component s338, etc.).

In one or more implementations, operation o12 includes an operation o1251 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including allergy information regarding the particular individual living being. An exemplary version of a non-transitory signal bearing medium of information storage subsystem s200 is depicted as bearing one or more cleaning allergy instructions i1251 that when executed will direct performance of the operation o1251. In an implementation, the one or more cleaning allergy instructions i1251 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including allergy information regarding the particular individual living being (e.g. one or more instances of the digital signal processor (DSP) component s106 of the control and information processing subsystem s100 can direct one or more instances of the material flush abrasive component s820 to assist in removing, from the ingestible product preparation system 10, one or more portions of ingestible product left behind by the first preparation occurrence of the first ingestible product as mashed potatoes from the ingestible product preparation system 10 as a cleaning operation prior to the second preparation occurrence of the second ingestible product as green beans initiated by user input including allergy information associated with the user through one or more instances of the joystick component s312, etc.). Furthermore, the cleaning allergy electrical circuitry arrangement e1251 when activated will perform the operation o1251. In an implementation, the cleaning allergy electrical circuitry arrangement e1251, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including allergy information regarding the particular individual living being (e.g. one or more instances of the digital signal processor (DSP) component s106 of the control and information processing subsystem s100 can direct one or more instances of the material flush abrasive component s820 to assist in removing, from the ingestible product preparation system 10, one or more portions of ingestible product left behind by the first preparation occurrence of the first ingestible product as mashed potatoes from the ingestible product preparation system 10 as a cleaning operation prior to the second preparation occurrence of the second ingestible product as green beans initiated by user input including allergy information associated with the user through one or more instances of the joystick component s312, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including allergy information regarding the particular individual living being is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including allergy information regarding the particular individual living being (e.g. one or more instances of the digital signal processor (DSP) component s106 of the control and information processing subsystem s100 can direct one or more instances of the material flush abrasive component s820 to assist in removing, from the ingestible product preparation system 10, one or more portions of ingestible product left behind by the first preparation occurrence of the first ingestible product as mashed potatoes from the ingestible product preparation system 10 as a cleaning operation prior to the second preparation occurrence of the second ingestible product as green beans initiated by user input including allergy information associated with the user through one or more instances of the joystick component s312, etc.).

In one or more implementations, as shown in FIG. 71, operation o12 includes an operation o1252 for electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including cleaning preferences of the particular individual living being. An exemplary version of a non-transitory signal bearing medium of information storage subsystem s200 is depicted as bearing one or more cleaning preferences instructions i1252 that when executed will direct performance of the operation o1252. In an implementation, the one or more cleaning preferences instructions i1252 when executed direct electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including cleaning preferences of the particular individual living being (e.g. one or more instances of the application specific integrated circuit (ASIC) component s108 of the control and information processing subsystem s100 can direct one or more instances of the fish tape system brush component s822 to assist in removing, from the ingestible product preparation system 10, one or more portions of ingestible product left behind by the first preparation occurrence of the first ingestible product as carrot cake from the ingestible product preparation system 10 as a cleaning operation prior to the second preparation occurrence of the second ingestible product as chicken soup initiated by user input including user input regarding certain conditions in which the user prefers to have cleaning occur through one or more instances of the touch screen component s314, etc.). Furthermore, the cleaning preferences electrical circuitry arrangement e1252 when activated will perform the operation o1252. In an implementation, the cleaning preferences electrical circuitry arrangement e1252, when activated performs electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including cleaning preferences of the particular individual living being (e.g. one or more instances of the application specific integrated circuit (ASIC) component s108 of the control and information processing subsystem s100 can direct one or more instances of the fish tape system brush component s822 to assist in removing, from the ingestible product preparation system 10, one or more portions of ingestible product left behind by the first preparation occurrence of the first ingestible product as carrot cake from the ingestible product preparation system 10 as a cleaning operation prior to the second preparation occurrence of the second ingestible product as chicken soup initiated by user input including user input regarding certain conditions in which the user prefers to have cleaning occur through one or more instances of the touch screen component s314, etc.). In an implementation, the electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including cleaning preferences of the particular individual living being is carried out by electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including cleaning preferences of the particular individual living being (e.g. one or more instances of the application specific integrated circuit (ASIC) component s108 of the control and information processing subsystem s100 can direct one or more instances of the fish tape system brush component s822 to assist in removing, from the ingestible product preparation system 10, one or more portions of ingestible product left behind by the first preparation occurrence of the first ingestible product as carrot cake from the ingestible product preparation system 10 as a cleaning operation prior to the second preparation occurrence of the second ingestible product as chicken soup initiated by user input including user input regarding certain conditions in which the user prefers to have cleaning occur through one or more instances of the touch screen component s314, etc.).

In one or more implementations, operation o12 includes an operation o1253 for electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more allergies related to the at least one first substance. An exemplary version of a non-transitory signal bearing medium of information storage subsystem s200 is depicted as bearing one or more cleaning allergies instructions i1253 that when executed will direct performance of the operation o1253. In an implementation, the one or more cleaning allergies instructions i1253 when executed direct electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more allergies related to the at least one first substance (e.g. one or more instances of the field programmable gate array (FPGA) component s110 of the control and information processing subsystem s100 can direct one or more instances of the parts exchange component s824 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a hamburger based upon status determined to be that the ingestible product preparation system 10 had not been cleaned after a latte was prepared, which the user initiating preparation of a hamburger was allergic to, etc.). Furthermore, the cleaning allergies electrical circuitry arrangement e1253 when activated will perform the operation o1253. In an implementation, the cleaning allergies electrical circuitry arrangement e1253, when activated performs electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more allergies related to the at least one first substance (e.g. one or more instances of the field programmable gate array (FPGA) component s110 of the control and information processing subsystem s100 can direct one or more instances of the parts exchange component s824 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a hamburger based upon status determined to be that the ingestible product preparation system 10 had not been cleaned after a latte was prepared, which the user initiating preparation of a hamburger was allergic to, etc.). In an implementation, the electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more allergies related to the at least one first substance is carried out by electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more allergies related to the at least one first substance (e.g. one or more instances of the field programmable gate array (FPGA) component s110 of the control and information processing subsystem s100 can direct one or more instances of the parts exchange component s824 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a hamburger based upon status determined to be that the ingestible product preparation system 10 had not been cleaned after a latte was prepared, which the user initiating preparation of a hamburger was allergic to, etc.).

In one or more implementations, operation o12 includes an operation o1254 for electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more cleaning preferences favoring cleaning of the at least one automated device each time after an ingestible product is prepared. An exemplary version of a non-transitory signal bearing medium of information storage subsystem s200 is depicted as bearing one or more cleaning each instructions i1254 that when executed will direct performance of the operation o1254. In an implementation, the one or more cleaning each instructions i1254 when executed direct electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more cleaning preferences favoring cleaning of the at least one automated device each time after an ingestible product is prepared (e.g. one or more instances of the multiprocessor component s112 of the control and information processing subsystem s100 can direct one or more instances of the parts replacement component s826 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a chicken dinner based upon status determined to be that the ingestible product preparation system 10 had not been cleaned after an energy drink was prepared and the user preferred to have cleaning occur after any drink was prepared, etc.). Furthermore, the cleaning each electrical circuitry arrangement e1254 when activated will perform the operation o1254. In an implementation, the cleaning each electrical circuitry arrangement e1254, when activated performs electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more cleaning preferences favoring cleaning of the at least one automated device each time after an ingestible product is prepared (e.g. one or more instances of the multiprocessor component s112 of the control and information processing subsystem s100 can direct one or more instances of the parts replacement component s826 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a chicken dinner based upon status determined to be that the ingestible product preparation system 10 had not been cleaned after an energy drink was prepared and the user preferred to have cleaning occur after any drink was prepared, etc.). In an implementation, the electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more cleaning preferences favoring cleaning of the at least one automated device each time after an ingestible product is prepared is carried out by electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more cleaning preferences favoring cleaning of the at least one automated device each time after an ingestible product is prepared (e.g. one or more instances of the multiprocessor component s112 of the control and information processing subsystem s100 can direct one or more instances of the parts replacement component s826 to assist in removing, from the ingestible product preparation system 10, one or more portions of ingestible product left behind by the first preparation occurrence of the first ingestible product as a latte from the ingestible product preparation system 10 as a cleaning operation prior to the second preparation occurrence of the second ingestible product as a chicken dinner based upon status determined to be that the ingestible product preparation system 10 had not been cleaned after an energy drink was prepared and the user preferred to have cleaning occur after any drink was prepared, etc.).

Those having skill in the art will recognize that the state of the art has progressed to the point where there is little distinction left between hardware and software implementations of aspects of systems; the use of hardware or software is generally (but not always, in that in certain contexts the choice between hardware an d software can become significant) a design choice representing cost vs. efficiency tradeoffs. Those having skill in the art will appreciate that there are various vehicles by which processes and/or systems and/or other technologies described herein can be effected (e.g., hardware, software, and/or firmware in one or more machines or articles of manufacture), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation that is implemented in one or more machines or articles of manufacture; or, yet again alternatively, the implementer may opt for some combination of hardware, software, and/or firmware in one or more machines or articles of manufacture (limited to patentable subject matter under 35 USC 101). Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware in one or more machines or articles of manufacture.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof (limited to patentable subject matter under 35 U.S.C. 101). In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure (limited to patentable subject matter under 35 USC 101). In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof (limited to patentable subject matter under 35 U.S.C. 101) can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1. A method comprising:
electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment; and
electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input.

2. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage as one or more networked servers.

3. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage as one or more electronic memories internal to the automated preparation equipment.

4. (canceled)

5. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage in addition to preparation history information associated with a preparation occurrence by the automated preparation equipment of the first ingestible product prior to the at least one first preparation occurrence by the automated preparation equipment of the at least one first ingestible product.

6.-11. (canceled)

12. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment as including one or more peltier cooling components.

13. (canceled)

14. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment as including one or more mixer components.

15.-18. (canceled)

19. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment as including one or more pump components.

20. (canceled)

21. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment as including one or more infrared components.

22. (canceled)

23. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment as including one or more material storage components.

24.-26. (canceled)

27. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment of the at least one first ingestible product as at least one mixture including one or more ingestible ingredients.

28. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment of the at least one first ingestible product as at least one mixture including one or more nutraceuticals.

29. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment of the at least one first ingestible product as at least one compound including one or more extracts of USDA certified organically raised plant matter.

30.-32. (canceled)

33. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment of the at least one first ingestible product as including one or more controlled pharmaceutical agents.

34.-36. (canceled)

37. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment of the at least one first ingestible product including the first portion of the at least one first substance as one or more powders.

38.-39. (canceled)

40. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment of the at least one first ingestible product including the first portion of the at least one first substance as one or more solids.

41. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first preparation information into the preparation history information storage, the first preparation information associated with the at least one first preparation occurrence by the automated preparation equipment of the at least one first ingestible product including the first portion of the at least one first substance as one or more mixtures.

42. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage via one or more cellular networks.

43. (canceled)

44. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage via communication circuitry of the automated preparation equipment.

45. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage via wireless communication.

46.-47. (canceled)

48. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage in one or more networked servers.

49.-51. (canceled)

52. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via applying a vacuum.

53.-54. (canceled)

55. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via fluid flow of one or more abrasives.

56.-59. (canceled)

60. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more heating chambers.

61. (canceled)

62. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more cooling chambers.

63. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more agitators.

64. (canceled)

65. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance from at least a portion of the automated preparation equipment as one or more printer heads.

66. (canceled)

67. The method of claim 1, wherein the electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment comprises:
electronically directing storing of the first cleaning information, if existent, into the cleaning history information storage, the first cleaning information associated with the at least one first automated cleaning operation occurrence, if existent, using the at least one automated device to remove a second portion other than the first portion of the at least one first substance via exchange of one or more portions of the automated preparation equipment with one or more other portions of the automated preparation equipment.

68.-69. (canceled)

70. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing at least one second automated cleaning operation via one or more cellular networks.

71.-72. (canceled)

73. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing at least one second automated cleaning operation via one or more networked servers.

74. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance when the at least one first automated cleaning operation occurrence has not occurred so that the second portion has not existed.

75.-77. (canceled)

78. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance via emitting ultrasonic waves.

79. (canceled)

80. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance via fluid flow of one or more abrasives.

81. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance via brush contact.

82. (canceled)

83. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment as one or more manifolds of tubes.

84. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment as one or more nozzles.

85.-86. (canceled)

87. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment as one or more cooling chambers.

88. (canceled)

89. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment as one or more syringes.

90. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment as one or more printer heads.

91.-92. (canceled)

93. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the least one second ingestible product as at least one product other than the at least one first ingestible product.

94. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that includes at least a portion of the at least one first ingestible product.

95. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one product that is the at least one first ingestible product.

96. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one combination of one or more ingestible ingredients.

97. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more ingestible ingredients.

98. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one mixture including one or more nutraceuticals.

99. (canceled)

100. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as at least one composition including one or more fluids.

101. (canceled)

102. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as excluding one or more allergens found in the at least one first ingestible product.

103.-106. (canceled)

107. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product as being chemically reactive with the at least one first substance of the at least one first ingestible product.

108. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more scanner components.

109. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more graphical user interface (GUI) components.

110.-111. (canceled)

112. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more touch screen components.

113. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more camera components.

114. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input via one or more sound sensing components.

115.-116. (canceled)

117. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including menu selections by the particular individual living being regarding the at least one second ingestible product to be consumed by the particular individual living being.

118. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including physician prescription directions regarding the particular individual living being.

119. (canceled)

120. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device to remove a third portion other than the first portion and other than the second portion of the at least one first substance from at least a portion of the preparation equipment prior to the at least one second preparation occurrence of the at least one second ingestible product, the at least one second preparation occurrence electronically initiated via electronically receiving first input associated with a particular individual living being including cleaning preferences of the particular individual living being.

121. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more allergies related to the at least one first substance.

122. The method of claim 1, wherein the electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input comprises:
electronically directing the at least one second automated cleaning operation of the at least one automated device automated to be electronically initiated based at least in part upon status associated with information stored in the preparation history information storage, associated with information stored in the cleaning history information storage, and associated with the electronically received first input including status that the at least one first preparation occurrence occurred, the at least one first automated cleaning operation occurrence did not occur, and the particular individual living being has one or more cleaning preferences favoring cleaning of the at least one automated device each time after an ingestible product is prepared.

123. A system comprising:
means for electronically directing storing of first preparation information into preparation history information storage, the first preparation information associated with at least one first preparation occurrence by automated preparation equipment of at least one first ingestible product including a first portion of at least one first substance and electronically directing storing of first cleaning information, if existent, into cleaning history information storage, the first cleaning information associated with at least one first automated cleaning operation occurrence, if existent, being subsequent to the at least one first preparation occurrence, the at least one automated cleaning operation occurrence, if existent, using at least one automated device to remove a second portion other than the first portion of the at least one first substance from at least a portion of the automated preparation equipment; and
means for electronically directing at least one second automated cleaning operation of the at least one automated device to remove a third portion other than the first portion and other than the second portion of the at least one first substance from at least a portion of the preparation equipment prior to at least one second preparation occurrence of at least one second ingestible product, the at least one second preparation occurrence electronically initiated via electronically receiving first input associated with a particular individual living being, the electronically directing at least one second automated cleaning operation of the at least one automated device automated to be electronically initiated based at least in part upon status associated with information stored in the preparation history information storage, associated with information stored in the cleaning history information storage, and associated with the electronically received first input.

124.-243. (canceled)
